(19) United States
(12) Patent Application Publication
(10) Pub. No.: US 2007/0132674 A1
(43) Pub. Date: Jun. 14, 2007

(54) Driving method of self-luminous type display unit, display control device of self-luminous type display unit, current output type drive circuit of self-luminous type display unit

(75) Inventor: Hitoshi Tsuge, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku, Tokyo (JP)

(21) Appl. No.: 10/581,528

(22) PCT Filed: Nov. 29, 2004
(86) PCT No.: PCT/JP04/17735

§ 371 Date: Feb. 7, 2007

(30) Foreign Application Priority Data
Dec. 2, 2003 (JP) 2003-403547
Nov. 4, 2004 (JP) 2004-321167

(51) Int. Cl. G09G 3/30

(52) U.S. Cl. 345/77

(57) ABSTRACT

The method includes applying a gray level current corresponding to a display gray level to each of pixel circuits for a first period, applying a display current based on the gray level current to the self-luminescent elements during a second period succeeding the first period to display corresponding the display gray level, and applying a precharge current to the self-luminescent device during a third period before the first period on the basis of a predetermined first condition.

### TECHNICAL FIELD

The present invention relates to a method of driving a self-luminescent type display apparatus, a display control device for the self-luminescent type display apparatus, and a current output type driving circuit for the self-luminescent type display apparatus, which implement a method of driving a display apparatus using an organic light emitting device, for example, an organic field light emitting device, which is used in a driving semiconductor circuit or the like for current output which circuit is used for a display apparatus providing gray level display on the basis of a current quantity.

### BACKGROUND ART

An organic light emitting device is a self-luminescent element and thus has the advantages of, for example, eliminating the need for a backlight required for a liquid crystal display apparatus and providing a large field of view. Accordingly, the organic light emitting device is expected as a next generation display apparatus.

FIG. 4 is a sectional view of the structure of a common organic luminescent element. In this configuration, an organic layer 42 is sandwiched between a cathode 41 and an anode 43. When a DC power source 44 is connected to this structure, holes and electrons are injected into the organic layer 42 through the anode 43 and the cathode 41, respectively. The injected holes and electrons are migrated through the organic layer 42 to a counter electrode by electric fields formed by the power source 44. During the migration, the electrons and holes recoupled together in the organic layer 42 to generate excitons. Luminescence is observed while the energy of the excitons is being deactivated. The luminescent color varies depending on the energy of the excitons. The light has a wavelength of energy substantially corresponding to the value for the energy band gap of the organic layer 42.

To externally capture light generated in the organic layer, at least one of the electrodes is composed of a material that is transparent in a visible light region. A material with a low work function is used for the cathode in order to facilitate the injection of electrons into the organic layer. Materials for the cathode include, for example, aluminum, magnesium, and calcium. An alloy of these metals or an alloy such as an aluminum-lithium alloy may be used in order to improve durability or further reduce the work function.

On the other hand, the anode used has a high ionization potential in order to facilitate the injection of holes. Further, since the cathode is not transparent, a transparent material is often used for the anode. Thus, ITO (Indium Tin Oxide), gold, an indium zinc oxide (IZO), or the like is commonly used.

In some recent organic luminescent elements using a monomeric material, the organic layer 42 is composed of a plurality of layers for higher light emission efficiency. This enables the following functions to be assigned to the respective layers: carrier injection, migration of carriers to a luminescent area, and emission of light of a desired wavelength. By using efficient materials for the respective layers, it is possible to produce a more efficient organic light emitting device.

The organic light emitting device thus formed has a luminance which is proportional to current as shown in FIG. 5 (a) and which has a nonlinear relationship with voltage as shown in FIG. 5 (b). Accordingly, gray level control should be performed on the basis of a current value.

An active matrix type employs two types of control, a voltage driving system and a current driving system.

The voltage driving system is a method of using a voltage output type source driver to convert a voltage into a current inside a pixel and supplying the converted current to an organic light emitting device.

This method executes a voltage-current conversion using a transistor provided for each pixel. Thus, disadvantageously, output current may vary depending on a variation in characteristics among transistors. As a result, luminance may be uneven.

The current driving system is a method of using a current output type source driver having only a function for retaining, inside a pixel, a current value output during one horizontal scan period and supplying the organic light emitting device with the same current value as that from the source driver.

FIG. 6 shows an example of the current driving system. The system in FIG. 6 uses a current copier system for a pixel circuit.

FIG. 7 shows a circuit in which a pixel 67 in FIG. 6 is in operation.

When the pixel is selected, a gate driver 35 outputs a signal so that a gate signal line 61a for that row energizes the corresponding switch, while a gate signal line 61b for that row deenergizes the corresponding switch as shown in FIG. 7 (a). The state of a pixel circuit at this time is shown. At this time, a current flowing through a source signal line 60 and which is drawn into a source driver 36 flows through a path shown by a dotted line 71. Thus, the same current as that flowing through the source signal line 60 flows through a transistor 62. Then, the potential at a node 72 is set at the value corresponding to the current/voltage characteristic of the transistor 62.

Then, in an unselected state, the gate signal line 61 forms such a circuit as shown in FIG. 7 (b). A current flows from an EL power supply line 64 to an organic light emitting device 63 through a path shown by a dotted line at 73. The current is determined by the potential at the node 72 and the current/voltage characteristic of the transistor 62.

In FIGS. 7 (a) and 7 (b), the potential at the node 72 does not vary. Consequently, a drain current flowing through the same transistor 62 is the same in both FIGS. 7 (a) and 7 (b). Thus, a current which has the same value as that of a current flowing through the same signal line 60 flows through the organic light emitting device 63. Consequently, a variation in the current/voltage characteristic of the transistor 62 in principle does not affect the values of the currents 71 and 73. It is thus possible to provide uniform display not affected by a variation in the characteristic of the transistor.

Therefore, the current driving system must be used in order to obtain uniform display. For this purpose, the source driver 36 must be a current output type driver IC.

FIG. 10 shows an example of an output stage of a current driver IC that outputs the current value corresponding to the gray level. For display gray level data 54, a digital/analog converting section 106 provides an analog current output from 104. The analog/digital converting section is composed of a plurality of (at least the number of bits in the gray level data 54) gray level display current sources 103 and switches 108 and a common gate line 107 that defines the value of a current provided by each gray level display current source 103.

In FIG. 10, an analog current is output in response to a 3-bit input 105. By using a switch 108 to select whether or not to connect a number of current sources 103 corresponding to the weight of bits to the current output 104, it is possible to output the current corresponding to the gray level; the current corresponds to one current source 103 for data 1 and to seven current sources 103 for data 7. A current output type driver can be provided by arranging a number of digital/analog converting sections 106 corresponding to the number of outputs of the driver. To compensate for the temperature characteristic of the transistor 103, the voltage across the common gate line 107 is determined by a distributing mirror transistor 102. The transistor 102 and the group of current sources 103 have a current mirror configuration. A current per gray level is determined on the basis of the value of a reference current 89. This configuration allows the output current to be varied depending on the gray level. The current per gray level is determined on the basis of the reference current.

FIGS. 21 to 23 show a display apparatus as an example of an electronic apparatus according to the present invention which uses an organic light emitting device. FIG. 21 shows (a perspective view (FIG. 21 (a)) and a block diagram (FIG. 21 (b)) of) a television. FIG. 22 shows a digital camera or a digital video camera. FIG. 23 shows a portable information terminal. The organic light emitting device is a display panel suitable for these display apparatuses, which often display motion pictures owing to their high response speeds (see, for example, Japanese Patent Laid Open No. 2001-147659).

In such a current driver as shown in FIG. 10, (the number of gray levels minus 1) transistors 103 of the same size are arranged so that in response to input data, a current is output by varying the number of transistors 103 associated with the output. Thus, the output current is in proportion to the gray level. The direct output of the current makes the image appear generally whitish owing to human visual characteristics (lower gray level parts of the image appear whitish).

A driving device for a common display applies gamma correction to the output corresponding to each gray level. Since a liquid crystal display is voltage-driven, it is necessary to provide the voltage value corresponding to each gray level. (With voltage, it is impossible to express gray levels by additions for the gray levels as in the case of current. Accordingly, different voltages are required for the respective gray levels). Thus, at each gray level voltage level, the voltage value is adjusted so as to offer the voltage output corresponding to gamma correction. Consequently, even a 6-bit driver is subjected to gamma correction. This makes it possible to provide sufficient gray level display.

For the current driver, even with the same 6 bits, the data is not subjected to gamma correction. To allow smaller increments to be used for the lower gray level parts, it is necessary to provide a gray level output of a size smaller than 6 bits. Achieving this by frame reduction (FRC) requires frame reduction to be carried out among at least four frames. This may result in flickers because of the high response speed of the organic light emitting device. Thus, fine gray level expression must be made without FRC. For example, the data must be composed of 8 bits.

This problem is characteristic of the combination of the current driver, for which the output current is in proportion to the gray level, and the current output type display element, for which the input current is in proportion to the luminance.

To avoid the gamma correction based on FRC, it is possible to increase the output from the current driver from 6 to 8 bits and to execute gamma processing before an input to the source driver so that a gamma-processed 8-bit signal can be input to the source driver.

In order to increase the output from the current driver from 6 to 8 bits, it is possible to provide 255 transistors 103. This method requires four times as many transistors 103 as those required for the conventional method (63 transistors 103). This correspondingly increases the area of the source driver. An output stage transistor accounts for about 70% of the total chip area, so that simply, the area of the source driver according to this method is about three times as larger as that in the case of 6 bits. This significantly affects costs.

### DISCLOSURE OF THE INVENTION

In view of the above problems, it is an object of the present invention to provide a current output type semiconductor circuit, a display driving device, a display apparatus, and a method of outputting a current with which an increase in circuit scale can be suppressed even with an increase in the number of output bits for a current driver.

The 1^{st} aspect of the present invention is a method of driving a self-luminescent display apparatus having self-luminescent elements arranged in a pattern of matrix and each of pixel circuits provided in association with each of said self-luminescent elements, said method comprising the steps of:

applying a gray level current corresponding to a display gray level to each of said pixel circuits for a first period;

applying a display current based on said gray level current to said self-luminescent elements during a second period succeeding said first period to display corresponding said display gray level; and

applying a precharge current to said self-luminescent elements during a third period before said first period on the basis of a predetermined first condition.

The 2^{nd} aspect of the present invention is the method of driving a self-luminescent display apparatus according to the 1^{st} aspect of the present invention, wherein said third period is varied depending on a display gray level that provides a display current applied to said self-luminescent elements.

The 3^{rd} aspect of the present invention is the method of driving a self-luminescent display apparatus according to the 1^{st} aspect of the present invention, wherein a current value corresponding to a display gray level of display provided by said self-luminescent elements in a predetermined row on the same column of said matrix is compared with a current value corresponding to a display gray level of display to be provided by said self-luminescent elements in a row next to said predetermined row, and

as said predetermined first condition, if a difference between said current values has a value equal to or larger than at least a predetermined value, when said next row is displayed, the precharge current is applied to said self-luminescent elements in said next row during said third period.

The 4^{th} aspect of the present invention is the method of driving a self-luminescent display apparatus according to the 3^{rd} aspect of the present invention, wherein said third period is varied depending on the magnitude of said difference.

The 5^{th} aspect of the present invention is the method of driving a self-luminescent display apparatus according to the 1^{st} or the 3^{rd} aspect of the present invention, wherein the current value corresponding to the display gray level of the display provided by said self-luminescent elements in the predetermined row on the same column of said matrix is compared with the current value corresponding to the display gray level of the display to be provided by said self-luminescent elements in the row next to said predetermined row, and as said predetermined first condition, if the difference between said current values has a value smaller than a predetermined value, when said self-luminescent elements in said next row provide display, said precharge current is not applied.

The 6^{th} aspect of the present invention is the method of driving a self-luminescent display apparatus according to the 1^{st} aspect of the present invention, wherein as said predetermined first condition, if the display gray level of display provided by said self-luminescent elements has a current value corresponding to black display, when said display gray level is displayed, said precharge current is not applied.

The 7^{th} aspect of the present invention is the method of driving a self-luminescent display apparatus according to the 1^{st} aspect of the present invention, wherein a value for said precharge current is a current value corresponding to white display.

The 8^{th} aspect of the present invention is the method of driving a self-luminescent display apparatus according to the 1^{st} aspect of the present invention, wherein said third period is selected from a group of third periods corresponding to a plurality of pulse lengths prepared for a driving circuit.

The 9^{th} aspect of the present invention is the method of driving a self-luminescent display apparatus according to claim 1, further comprising a step of applying a predetermined voltage to said self-luminescent elements during a fourth period before said third period on the basis of a predetermined second condition.

The 10^{th} aspect of the present invention is the method of driving a self-luminescent display apparatus according to the 9^{th} aspect of the present invention, wherein the current value corresponding to the display gray level of the display provided by said self-luminescent elements in the predetermined row on the same column of said matrix is compared with the current value corresponding to the display gray level of the display to be provided by said self-luminescent elements in the row next to said predetermined row, and as said predetermined second condition, if the difference between said current values has a value equal to or larger than a predetermined value, when said self-luminescent elements in said next row provide display, said predetermined voltage is applied to said self-luminescent elements in said next row during said fourth period.

The 11^{th} aspect of the present invention is the method of driving a self-luminescent display apparatus according to the 9^{th} aspect of the present invention, wherein as said predetermined second condition, if the display gray level of the display provided by said self-luminescent elements has a current value corresponding to the black display, when said display gray level is displayed, said predetermine voltage is applied to said self-luminescent elements during said fourth period.

The 12^{th} aspect of the present invention is the method of driving a self-luminescent display apparatus according to the 9^{th} aspect of the present invention, wherein said predetermined voltage is equal to a voltage corresponding to a value for a current applied during a last display provided by said self-luminescent elements or corresponds to low gray level color display.

The 13^{th} aspect of the present invention is the method of driving a self-luminescent display apparatus according to the 12^{th} aspect of the present invention, wherein said first voltage corresponds to the voltage for black display.

The 14^{th} aspect of the present invention is a display control device for a self-luminescent display apparatus having self-luminescent elements arranged in a pattern of a matrix and each of pixel circuits provided in association with each of said self-luminescent elements, said self-luminescent display apparatus applying a gray level current corresponding to a display gray level to each of said pixel circuits for a first period, and applying a display current based on said gray level current to said self-luminescent elements during a second period succeeding said first period to display the corresponding said display gray level, said display control device comprising:

precharge current applying instrument of applying a precharge current to said self-luminescent device during a third period before said first period on the basis of a predetermined first condition.

The 15^{th} aspect of the present invention is the display control device for the self-luminescent display apparatus according to the 14^{th} aspect of the present invention, wherein said third period is varied depending on a display gray level that provides a display current applied to said self-luminescent elements.

The 16^{th} aspect of the present invention is the display control device for the self-luminescent display apparatus according to the 14^{th} aspect of the present invention, wherein a current value corresponding to a display gray level of display provided by said self-luminescent elements in a predetermined row on the same column of said matrix is compared with a current value corresponding to a display gray level of display to be provided by said self-luminescent elements in a row next to said predetermined row, and as said predetermined first condition, if a difference between said current values has a value equal to or larger than a predetermined value, when said next display is displayed, the precharge current is applied to said self-luminescent elements in said next row during said third period.

The 17^{th} aspect of the present invention is the display control device for the self-luminescent display apparatus according to the 16^{th} aspect of the present invention, wherein said third period is varied depending on the magnitude of said difference.

The 8^{th} aspect of the present invention is the display control device for the self-luminescent display apparatus according to the 14^{th} or the 16^{th} aspect of the present invention, wherein the current value corresponding to the display gray level of the display provided by said self-luminescent elements in the predetermined row on the same column of said matrix is compared with the current value corresponding to the display gray level of the display to be provided by said self-luminescent elements in the row next to said predetermined row, and as said predetermined first condition, if the difference between said current values has a value smaller than a predetermined value, when said self-luminescent elements in said next row provide display, a precharge current is not applied.

The 19^{th} aspect of the present invention is the display control device for the self-luminescent display apparatus according to the 14^{th} aspect of the present invention, wherein as said predetermined first condition, if the display gray level of display provided by said self-luminescent elements has a current value corresponding to black display, when said display gray level is displayed, said precharge current is not applied.

The 20^{th} aspect of the present invention is the display control device for the self-luminescent display apparatus according to the 14^{th} aspect of the present invention, wherein a value for said precharge current is a current value corresponding to the value for white display.

The 21^{st} aspect of the present invention is a current output driving circuit for a self-luminescent display apparatus having self-luminescent elements arranged in a pattern of a matrix and each of pixel circuits provided in association with each of said self-luminescent elements, said self-luminescent display apparatus applying a gray level current corresponding to a display gray level to each of said pixel circuits for a first period, and applying a display current based on said gray level current to said self-luminescent elements during a second period succeeding said first period to display corresponding said display gray level, said current output driving circuit applying a precharge current to said self-luminescent device during a third period before said first period on the basis of a predetermined first condition, the current output driving circuit comprising:

third period generating instrument which simultaneously generates a plurality of said third periods having different time lengths.

The 22^{nd} aspect of the present invention is the current output driving circuit for the self-luminescent display apparatus according to the 21^{st} aspect of the present invention, wherein said plurality of third periods are generated on the basis of pulse lengths used when said precharge current is applied.

The 23^{rd} aspect of the present invention is the current output driving circuit for the self-luminescent display apparatus according to the 21^{st} aspect of the present invention, wherein said current output driving circuit is used as a current output source driver circuit.

The 24^{th} aspect of the present invention is a self-luminescent display apparatus comprising:

self-luminescent elements arranged in a pattern of a matrix;

each of pixel circuits provided in association with each of said self-luminescent elements; and

a driving circuit that drives said self-luminescent elements and said pixel circuit,

wherein said driving circuit has at least one of the current output driving circuit according to the 21^{st} aspect of the present invention.

The 25^{th} aspect of the present invention is a self-luminescent display apparatus comprising:

self-luminescent elements arranged in a pattern of a matrix;

each of pixel circuits provided in association with each of said self-luminescent elements;

the display control device for the self-luminescent display apparatus according to the 14^{th} aspect of the present invention; and the current output driving circuit for the self-luminescent display apparatus according to the 21^{st} aspect of the present invention,

wherein said display control device performs an operation for application of said precharge current.

The 26^{th} aspect of the present invention is the self-luminescent display apparatus according to the 24^{th} or the 25^{th} aspect of the present invention, wherein said self-luminescent elements are organic EL elements.

The 27^{th} aspect of the present invention is electronic equipment comprising the self-luminescent display apparatus according to the 26^{th} aspect of the present invention as display instrument.

The 28^{th} aspect of the present invention is the electronic equipment according to the 21^{th} aspect of the present invention, wherein the electronic apparatus is used as a television.

The 29^{th} aspect of the present invention is a program for allowing a computer to execute a step of applying a gray level current corresponding to a display gray level to each of said pixel circuits for a first period, a step of applying a display current based on said gray level current to said self-luminescent elements during a second period succeeding said first period to display the corresponding said display gray level, and a step of applying a precharge current to said self-luminescent device during a third period before said first period on the basis of a predetermined first condition, the steps being included in the method of driving the self-luminescent display apparatus according to the 1^{st} aspect of the present invention.

The 30^{th} aspect of the present invention is a recording medium on which the program according to the 29^{th} aspect of the present invention is recorded, wherein the recording medium can be processed by a computer.

The current output type semiconductor circuit, a display driving device, a display apparatus, and a method of outputting a current according to the present invention can suppress the increase in circuit scale lower when the number of output bits for a current driver increases.

### BRIEF DESCRIPTION OF THE DRAWINGS

FIG. 1 is a diagram showing the waveforms of input signals to a current output type semiconductor circuit according to the present invention;

FIG. 2 is a block diagram of a driver IC that allows the external selection as to whether or not to carry out precharge, for each video signal for 1 dot;

FIG. 3 is a diagram showing a display panel using a plurality of source driver ICs;

FIG. 4 is a diagram showing the structure of an organic light emitting device;

FIG. 5 (a) is a diagram showing the current/voltage/luminance characteristic of the organic light emitting device, and FIG. 5 (b) is a diagram showing the current/voltage/luminance characteristic of the organic light emitting device;

FIG. 6 is a diagram showing a circuit in an active matrix type display apparatus which uses a pixel circuit of a current copier configuration;

FIG. 7 (a) is a diagram showing an operation of the current copier circuit, and FIG. 7 (b) is a diagram showing an operation of the current copier circuit;

FIG. 8 is a diagram showing an example of a constant current power supply circuit;

FIG. 9 is a diagram showing the relationship between a precharge pulse and a precharge determination signal and an output from an application determining section;

FIG. 10 is a diagram showing a circuit used to output a current to each output of a conventional current output type driver;

FIG. 11 is a diagram showing the relationship between the size of a transistor in a gray level display current source 103 in FIG. 10 and a variation in output current;

FIG. 12 (a) is a diagram showing an equivalent circuit for a pixel circuit of a current copier configuration in which a source signal line current flows through a pixel, and FIG. 12 (b) is a diagram showing the equivalent circuit for the pixel circuit of the current copier configuration in which the source signal line current flows through the pixel;

FIG. 13 is a diagram showing the relationship between a current output at one output terminal and a precharge voltage applying section and a switch;

FIG. 14 (a) is a diagram showing the relationship between the size of a channel of each of the transistors constituting each transistor group and a variation, and

FIG. 14 (b) is a diagram showing the relationship between the size of the channel of each of the transistors constituting each transistor group and the variation;

FIG. 15 is a diagram showing the relationship between a period in which a precharge voltage is provided and a period in which a current based on gray level data is output, both periods being contained in one horizontal scan period;

FIG. 16 is a diagram showing the circuit configuration of an input section of a source driver to which differential inputs can be provided;

FIG. 17 (a) is a diagram showing the relationship between gray level data and a precharge determination signal, FIG. 17 (b) is a diagram showing the relationship between the gray level data and the precharge determination signal, and FIG. 17 (c) is a diagram showing the relationship between the gray level data and the precharge determination signal;

FIG. 18 is a diagram showing a circuit that distributes an input serial current to each signal;

FIG. 19 is a diagram showing the relationship between gray levels and a variation in output current between adjacent terminals in a source driver using the output stage shown in FIGS. 25 and 14 (a);

FIG. 20 is a diagram showing a pixel circuit using a current copier and an n-type transistor;

FIG. 21 is a diagram showing a display apparatus using an embodiment of the present invention, that is, an application to a television;

FIG. 22 is a diagram showing a display apparatus using the embodiment of the present invention, that is, an application to a digital camera;

FIG. 23 is a diagram showing a display apparatus using the embodiment of the present invention, that is, an application to a portable information terminal;

FIG. 24 is a diagram showing the concept of a current output section of a semiconductor circuit using the embodiment of the present invention;

FIG. 25 is a diagram showing the configuration in FIG. 24 in which a current source is composed of transistors;

FIG. 26 is a diagram showing the relationship between the gray level of an input signal and an output current from the current output section shown in FIG. 24 or 25;

FIG. 27 is a diagram showing a current output stage in which a lower 1 bit of 8 bit data is output by a transistor arrangement of a certain size and in which the remaining higher 7 bits are provided by transistors having a drain current quantity larger than that provided by the transistor for the lower 1 bit so that gray level display is provided on the basis of the number of transistors;

FIG. 28 is a time chart of data transfers in which the number of input signal lines of the source driver is reduced by serially inputting data for each color at high speed;

FIG. 29 is a time chart of command transfers in which the number of input signal lines of the source driver is reduced by serially inputting data for each color at high speed;

FIG. 30 is a diagram showing the order of the transfers shown in FIGS. 28 and 29, during one horizontal scan period;

FIG. 31 is a diagram showing wiring for the EL power supply lines shown in FIG. 6 or 44;

FIG. 32 is a diagram showing the configuration of the output stage in which the width of the transistor channel is used to adjust the difference in the magnitude of current between the lower 2 bits and higher 6 bits of an 8-bit video input and in which within each bit, the current is varied on the basis of the number of transistors, the configuration allowing a current source to be added to a current source for the most significant bit;

FIG. 33 is a diagram showing the difference in current between gray level 127 and gray level 128;

FIG. 34 is a diagram showing the relationship between display gray levels and tolerance limits on a deviation from a theoretical value for an output current from a transistor 241, in the driver for 256 gray level display shown in FIG. 25;

FIG. 35 is a diagram showing a circuit configuration in a source driver having the output stage shown in FIG. 39, the configuration being used to detect a gray level inversion and then make corrections;

FIG. 36 is a diagram showing the difference between gray level 3 and gray level 4;

FIG. 37 is a diagram showing the difference between gray level 131 and gray level 132;

FIG. 38 is a diagram showing the configuration of an output stage in which either the current corresponding to the gray level or the voltage corresponding to the gray level is selected and output during one horizontal period or the current and the voltage are temporally sequentially output;

FIG. 39 is a diagram showing a current output stage with a most significant bit current source current padding function which stage using a padding signal line;

FIG. 40 is a diagram showing the relationship between a precharge pulse, a precharge determination signal, and a source signal line in a source driver that has a plurality of voltages for a precharge power source 24 so that any of the plurality of voltages can be selected and output for a current output or that only a current output can be provided;

FIG. 41 is a flowchart useful for determining whether or not to output a precharge voltage according to the present invention;

FIG. 42 is a diagram showing a precharge determination signal generating section used to provide a precharge applying system according to the present invention;

FIG. 43 is a diagram showing an example of the configuration of a source driver having a function for avoiding gray level inversion by changing the level of a padder signal if gray level inversion occurs;

FIG. 44 is a diagram showing a display apparatus using a pixel configuration in a current mirror form;

FIG. 45 is a diagram showing an example of a display pattern that does not provide a predetermined luminance in a region 452;

FIG. 46 is a diagram showing an example of a display pattern in which the luminance is higher in about one to five rows above a region 462;

FIG. 47 is a diagram showing variations in source signal line current and source signal line voltage from gray level 0 to gray level 4 and from gray level 0 to gray level 255;

FIG. 48 is a diagram showing variations in source signal line current and source signal line voltage from gray level 255 to gray level 4 and from gray level 255 to gray level 0;

FIG. 49 is a diagram showing the relationship between the source signal line current and source signal line voltage observed if a period is set in which the maximum current is passed during a change from gray level 0 to gray level 4;

FIG. 50 is a diagram showing the flow of the determination as to whether or not to carry out voltage and current precharge;

FIG. 51 is a diagram showing the relationship between the gray level of a video signal and data written to a memory 522;

FIG. 52 is a diagram showing a circuit block that compares the current data with the data in the preceding row;

FIG. 53 is a diagram showing a circuit block that compares the current data with the data in the preceding row to change a method of processing current precharge;

FIG. 54 is a diagram showing the relationship between the value for a command A and a condition for avoiding current precharge;

FIG. 55 is a diagram showing a circuit block that determines whether or not to carry out current precharge and voltage precharge on first row data;

FIG. 56 is a diagram showing a block that determines whether or not to carry out current precharge on the basis of the data in the preceding row;

FIG. 57 is a diagram showing a block that determines in which period current precharge is carried out or whether or not to carry out current precharge on the basis of the gray level of a video signal;

FIG. 58 is a diagram showing a block that sets whether or not to carry out current precharge using tailing measures as well as the period in which the current precharge is carried out;

FIG. 59 is a diagram showing the relationship between a determination criterion for current precharge and a command for a circuit that operates in response to the input command to change a current precharge period determined by current precharge period selecting instrument so that precharge is not to be carried out;

FIG. 60 is a diagram showing a block that makes determination for voltage precharge;

FIG. 61 is a diagram showing the relationship between values for a command L in FIG. 60 and a criterion for determining whether or not to carry out voltage precharge;

FIG. 62 is a diagram showing a precharge determination signal generating section that determines whether or not current precharge and voltage precharge are carried out on an input video signal as well as a period of current precharge;

FIG. 63 is a diagram showing the relationship between a precharge operation and a precharge determination signal;

FIG. 64 is a diagram showing the circuit configuration of a display apparatus into which a source driver and a control IC using the present invention are incorporated;

FIG. 65 is a block diagram of a source driver comprising a current precharge function and a function for outputting a gate driver control signal;

FIG. 66 is a diagram showing the relationship between a gate line 651 and a gate driver control line 652;

FIG. 67 is a diagram showing a block that generates a precharge determination signal from a video signal to serially output data;

FIG. 68 is a timing chart for a memory 522 and a data converting section 521;

FIG. 69 is a diagram showing a circuit block used to generate a current precharge pulse and a voltage precharge pulse;

FIG. 70 is a block diagram of a driver IC in which a current copier circuit is used for an output stage;

FIG. 71 is a diagram showing an example of a circuit that implements a digital/analog converting section;

FIG. 72 is a diagram showing wiring for a gray level reference current signal which is used to connect a plurality of driver ICs together;

FIG. 73 is a diagram showing a circuit for current holding instrument;

FIG. 74 is a diagram showing variations in the voltage of a node 742 and in the drain current from a driving transistor 731 which variations are caused by a gate signal line 741;

FIG. 75 is a diagram showing the drain current/gate voltage characteristic of the driving transistor;

FIG. 76 is a diagram showing a difference in drain current caused by “punch-through” if transistors with different mobility levels are used as driving transistors for respective outputs;

FIG. 77 is a diagram showing current holding instrument into which one transistor is inserted in order to suppress “punch-through” in a current copier circuit;

FIG. 78 is a diagram showing a circuit for gray level reference current generating instrument;

FIG. 79 is a diagram showing the waveforms of two gate signal lines in FIG. 77;

FIG. 80 is a diagram showing a circuit in the gray level reference current generating section;

FIG. 81 is a diagram showing a reference current generating section;

FIG. 82 is a diagram showing a circuit in a digital/analog converting section containing an enable signal;

FIG. 83 is a diagram showing the relationship between a timing pulse, a chip enable signal, and a select signal during one horizontal scan period;

FIG. 84 is a diagram showing the current/voltage characteristic of transistors with different W/L levels;

FIG. 85 is a diagram showing an example of the configuration of a display panel using a source driver which transfers a video signal and a precharge flag at low amplitude and high speed and which has a 1-bit command line for setting an electronic regulator and a precharge period;

FIG. 86 is a diagram showing an example of a transmission pattern in which the precharge flag and the video signal are transmitted through the same signal line at high speed;

FIG. 87 is a timing chart for a command line;

FIG. 88 is a diagram showing the circuit configuration of a precharge voltage converting section that generates a precharge voltage corresponding to the gray level;

FIG. 89 is an internal block diagram of a source driver used in FIG. 85;

FIG. 90 is a diagram showing the relationship between the current output and voltage output corresponding to gray level data and an example of a precharge determination signal transferred in synchronism with the gray level data;

FIG. 91 is a diagram showing examples of transfer patterns obtained if a reference current setting signal and a precharge application period setting signal are input to a video signal line;

FIG. 92 is a diagram showing the relationship between a period in which data is transferred and a blanking period, the two periods being contained in one horizontal scan period;

FIG. 93 is a diagram showing the internal configuration of a source driver in which the video signal line is also used as the reference current and precharge period setting signal line;

FIG. 94 is a diagram showing the wiring between driver ICs in which a source driver used has a gate driver control line output;

FIG. 95 is a diagram showing a method for data transfer according to an embodiment of the present invention

FIG. 96 is a diagram showing an example of data transfer during one horizontal scan period;

FIG. 97 is a diagram showing signal line waveforms obtained after gray level data, a precharge inversion signal, and a gate driver control line have been separated from the video signal line inside the source driver;

FIG. 98 is a diagram showing the internal configuration of a source driver having a gate driver control line output function;

FIG. 99 is a diagram showing the precharge voltage generating section shown in FIG. 98;

FIG. 100 is a diagram showing the precharge voltage selecting and application determining section shown in FIG. 98;

FIG. 101 is a diagram showing the relationship between inputs to and outputs from the decode section 1001 shown in FIG. 100;

FIG. 102 is a diagram showing the relationship between the source signal line current and source signal line voltage observed when the pixel circuit shown in FIG. 6 is used;

FIG. 103 is a diagram showing that a current output stage is provided with not only the current source corresponding to the gray level but also a current source used to supply a current through a current precharge line;

FIG. 104 is a diagram showing how the source signal line current varies from 10 nA to 0 nA;

FIG. 105 is a diagram showing how the source signal line current varies from 0 nA to 10 nA;

FIG. 106 is a diagram showing the variations in FIGS. 104 and 105, with respect to the current/voltage characteristic of the source signal line;

FIG. 107 is a diagram showing how the source signal line current varies when current precharge is carried out;

FIG. 108 is a diagram showing a temporal variation in source driver output caused when a current 10 times as large as a predetermined one is output at the beginning of a horizontal scan period;

FIG. 109 is a diagram showing the configuration of a source driver used to provide such a current output as shown in FIG. 108;

FIG. 110 is a diagram showing the configuration of a reference current generating section and current output stage of the source driver accommodating multicolor outputs;

FIG. 111 is a diagram showing a precharge current output arrangement (precharge reference current generating section and precharge current output stage) of the source driver accommodating multicolor outputs;

FIG. 112 is a diagram showing the configuration of a source driver that enables a precharge current and a precharge voltage to be output to the source signal line;

FIG. 113 is a diagram showing the internal configuration of the precharge current voltage output stage shown in FIG. 112;

FIG. 114 is a diagram showing the relationship between an input to a determination signal decode section 1131 and the states of switches 1132 to 1135, shown in FIG. 113;

FIG. 115 is a flowchart illustrating the output of a precharge flag 862 input to the source driver;

FIG. 116 is a diagram showing a precharge flag generating section and a section for transmissions to the source driver;

FIG. 117 is a diagram showing the configuration of a source driver which can carry out voltage precharge and which can also carry out current precharge by selecting one of a plurality of different periods;

FIG. 118 is a diagram showing a circuit in a current output section 1171 having a function for carrying out current precharge;

FIG. 119 is a diagram showing the relationship between signals input to and output from a pulse selecting section 1175;

FIG. 120 is a diagram showing temporal variations in precharge pulses 1174 and 451, precharge determination line 984, and output which variations occur when a pulse selecting section is operated on the basis of FIG. 119;

FIG. 121 is a diagram showing the format of a signal input to a driver IC configured as shown in FIG. 117;

FIG. 122 is a diagram showing a circuit in the current output section 1171 having the function for carrying out current precharge;

FIG. 123 is a diagram showing the relationship between display gray levels and required precharge current output periods;

FIG. 124 is a diagram showing a variation in current occurring when current precharge is used;

FIG. 125 is a diagram showing how the source signal line current varies if a precharge voltage and a precharge current are output during each horizontal scan period;

FIG. 126 is a diagram showing how the source signal line current varies when a precharge voltage application period 1251 and a precharge current output period 1252 are not set if the source signal line current does not vary over a plurality of horizontal scan periods;

FIG. 127 is a diagram showing an example of display pattern in which the source signal line may continuously output the same current or vary the current;

FIG. 128 is a diagram showing how the source signal line current varies if the present invention shown in FIG. 127 is used;

FIG. 129 is a diagram showing a method for determination used to generate a period in which a precharge voltage or precharge current is output only if the current flowing through the source signal line varies;

FIG. 130 is a diagram showing that the relationship between the drain current and gate voltage of the driving transistor 62 varies with temperature;

FIG. 131 is a diagram showing an arrangement in which a resistance element and a temperature compensation element are used outside the source driver to input a voltage varying with temperature to the precharge voltage generating section;

FIG. 132 is a diagram showing an example of a variation in precharge voltage which occurs when the precharge voltage is varied depending on temperature;

FIG. 133 is a diagram showing how the drain current from the transistor 62 varies with temperature when the precharge voltage is output as shown in FIG. 132;

FIG. 134 is a diagram showing a circuit block in which the precharge voltage is applied to the pixel circuit if the temperature compensation circuit is externally provided;

FIG. 135 is a diagram showing a circuit block that utilizes data from temperature sensing instrument to vary the value of a precharge voltage generating electronic regulator depending on temperature, in accordance with command control by a controller;

FIG. 136 is a diagram showing electronic regulator output voltage vs; temperature in the circuit configuration shown in FIG. 135;

FIG. 137 is a diagram showing how the transistor 62 varies with temperature if the precharge voltage is controlled on the basis of the relationship between temperature and electronic regulator shown in FIG. 136;

FIG. 138 is a diagram showing a circuit configuration when a precharge voltage generating transistor is formed in an array forming a pixel circuit;

FIG. 139 is a diagram showing the relationship between the gate voltage and drain current of transistors 1381 and 62;

FIG. 140 is a diagram showing a planned arrangement of precharge voltage generating transistor according to the present invention;

FIG. 141 is a diagram showing a circuit in which one of the precharge voltage circuits formed in the array is selectively connected to a source driver input terminal;

FIG. 142 is a diagram showing a circuit configuration in which a precharge voltage generating section formed in an array is divided into a plurality of parts arranged properly;

FIG. 143 is a diagram showing the gate voltage and drain current characteristics of the transistors 62 and 1381 at higher temperature;

FIG. 144 is a diagram showing that the quantity of current flowing through an EL element is increased by the early effect of the driving transistor 62;

FIG. 145 is a diagram showing an adjusting circuit that measures the sum of currents flowing through EL elements in a display apparatus using organic luminescent elements, the adjusting circuit fixing the current value regardless of a panel;

FIG. 146 is a diagram showing a method for adjustments executed in the adjusting circuit in FIG. 145;

FIG. 147 is a diagram showing an example in which the precharge voltage is adjusted using a trimmer;

FIG. 148 is a diagram showing a circuit configuration in which results from temperature sensing instrument are input to the controller and in which signal control for the source and gate drivers is varied on the basis of the results;

FIG. 149 is a diagram showing the waveform, during one frame, of signals from a gate driver 61b in the configuration shown in FIG. 148;

FIG. 150 is a diagram showing the waveform of signals obtained when a non-illuminated period of a gate signal line is controlled using an output enable signal;

FIG. 151 is a diagram showing the relationship between gray level and luminance;

FIG. 152 is a diagram showing the relationship between video signal gray levels and source driver output gray levels which relationship is observed when gamma correction is applied;

FIG. 153 is a diagram showing a circuit configuration that determines whether or not to carry out precharge after an input video signal has been subjected to gamma correction;

FIG. 154 is a diagram showing a precharge determination signal generating section according to an embodiment of the present invention;

FIG. 155 is a diagram showing the display gray levels of pixels in a certain frame which gray levels are obtained if a gray level 1 is displayed all over the screen;

FIG. 156 is a diagram showing a block that applies gray level conversion to a signal subjected to gamma correction, on the basis of the number of gray levels output by the source driver;

FIG. 157 is a diagram showing the display gray levels of the pixels in a certain frame which gray levels are obtained if a first row is displayed at gray level 0;25 and a second to fourth rows are displayed at gray level 3, using the display gray level from the source driver as a reference;

FIG. 158 is a diagram showing, for each pixel, whether or not to carry out precharge in a display pattern in FIG. 157;

FIG. 159 is a diagram showing the display gray levels of the pixels in a certain frame which gray levels are obtained if the first row is displayed at gray level 0;25 and the second to fourth rows are displayed at gray level 3, using the display gray level from the source driver as a reference;

FIG. 160 is a diagram showing the display gray levels and carry signal values of the pixels in a certain frame which gray levels are obtained if the first row is displayed at gray level 0.25 and the second to fourth rows are displayed at gray level 3, using the display gray level of the source driver as a reference, as well as the results of determinations for precharge;

FIG. 161 is a diagram showing an example of a circuit block that executes gamma correction and precharge processing on a video signal;

FIG. 162 is a diagram showing an example of a circuit block that executes gamma correction and precharge processing on the video signal;

FIG. 163 is a diagram showing the data corresponding to pixels in data input to the precharge determination signal generating section shown in FIG. 162;

FIG. 164 is a diagram showing the display gray levels of the pixels in a certain frame which gray levels are obtained if the first row is displayed at gray level 0 and the second to fourth rows are displayed at gray level 2.75, using the display gray level from the source driver as a reference;

FIG. 165 is a diagram showing the data corresponding to pixels in data input to the precharge determination signal generating section shown in FIG. 162;

FIG. 166 is a diagram showing the results of determination for precharge based on carry signal values for the preceding row and current row when the difference from the data in the preceding row is N−1 gray levels if precharge is carried out when the difference from the data in the preceding row is at least N gray levels;

FIG. 167 is a diagram showing the results of determination for precharge based on carry signal values for the preceding row and current row when the difference from the data in the preceding row is N gray levels if precharge is carried out when the difference from the data in the preceding row is at least N gray levels;

FIG. 168 is a diagram showing an example of a circuit block that executes gamma correction and precharge processing on the video signal;

FIG. 169 is a diagram showing the circuit configuration of a pulse generating section that allows the current precharge period to be varied depending on a luminescent color;

FIG. 170 is a diagram showing an example of an internal circuit in a pulse synthesizing section;

FIG. 171 is a diagram showing how a voltage precharge pulse, a current difference correcting pulse, and a current precharge pulse vary during a certain horizontal scan period;

FIG. 172 is a diagram showing the circuit configuration of a pulse generating section that allows the current precharge period to be varied depending on the luminescent color;

FIG. 173 is a diagram showing an output stage of a source driver that can vary both current precharge period and precharge current value;

FIG. 174 is a diagram showing the relationship between a precharge determination line and a precharge operation;

FIG. 175 is a diagram showing a temporal variation in output current value according to the present invention;

FIG. 176 is a diagram showing the circuit configuration of a precharge voltage generating section which can adjust the precharge voltage on the basis of the electronic regulator and which can compensate for a variation in voltage caused by the temperature characteristic of pixel transistors;

FIG. 177 is a diagram showing an output stage of a source driver that can vary both current precharge period and precharge current value;

FIG. 178 is a diagram showing a circuit configuration in which a data enable signal is used to insert gray level 0 into the video signal during a vertical blanking period and to cause the precharge determination signal generating section to output a particular signal;

FIG. 179 is a diagram showing operations of the black data inserting section shown in FIG. 178;

FIG. 180 is a diagram showing operations of the precharge determination signal varying section shown in FIG. 178;

FIG. 181 is a diagram showing how a source signal line potential varies depending on a variation in source driver output during a vertical blanking period;

FIG. 182 is a diagram showing how the source signal line potential varies when voltage precharge and gray level 0 output control is performed during the final horizontal scan period of a vertical blanking period;

FIG. 183 is a diagram showing how the source signal line varies if current precharge is carried out on the first row;

FIG. 184 is a diagram showing how the source signal line varies if current precharge is carried out on the first row;

FIG. 185 is a diagram showing operations of an output enable signal according to the present invention;

FIG. 186 is a diagram showing an example of a circuit in an output stage having an output enable function, a voltage precharge function, and a current precharge function;

FIG. 187 is a diagram showing that the voltage precharge pulse varies between a pixel selection period and a vertical blanking period;

FIG. 188 is a diagram showing how the voltage precharge pulse, precharge flag, and source signal line voltage behave during a vertical blanking period;

FIG. 189 is a diagram showing the relationship between a command transfer period and a timing pulse and a command register update timing; and

FIG. 190 is a diagram showing the internal configuration of a source driver according to the present invention.

### DESCRIPTION OF SYMBOLS

11 Video data
12 Data line
13 Address
14 Assigned data
15 Clock
16 Start pulse
241 Transistor

### BEST MODE FOR CARRYING OUT THE INVENTION

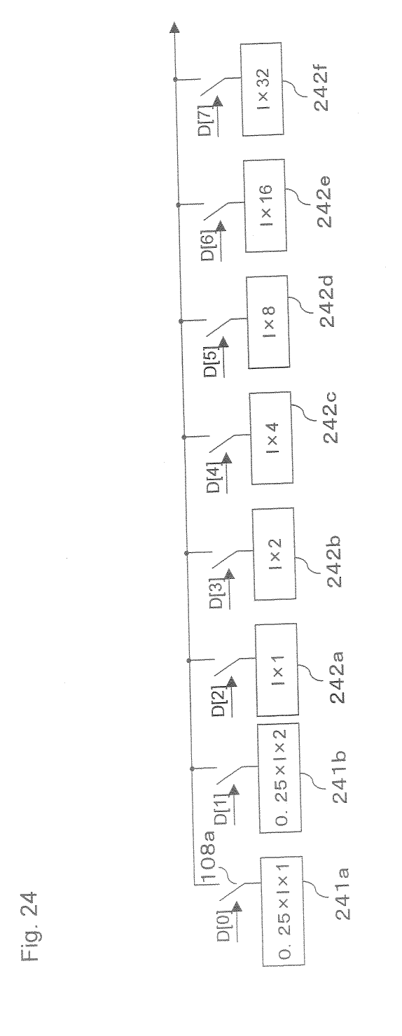

A current output type semiconductor circuit according to the present invention adds 2 bits to the lower side of conventional 6 bits. Thus, a current source is provided which outputs a quarter of a current value for a gray level display current source 103 conventionally used for 6-bit outputs. Then, three such current sources are added to allow 256-gray-level outputs. FIG. 24 shows a conceptual drawing of a current output stage that outputs 8 bits.

Since the use of 8-bit outputs increases the number of transistors by three, a configuration can be provided which requires only a small increase in circuit scale compared to an addition on the upper side.

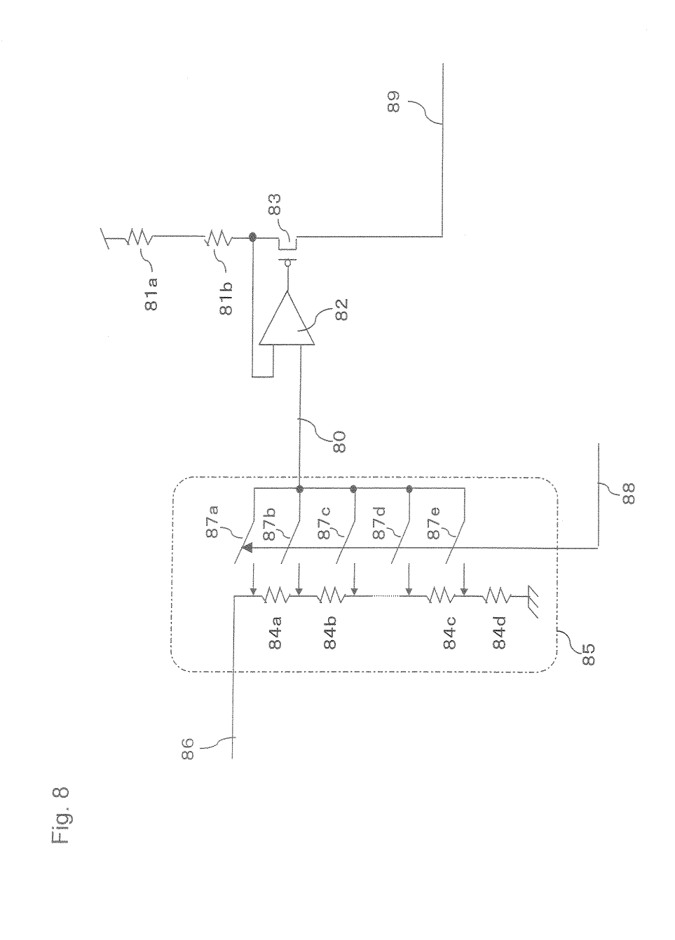

An “I” value may be used to adjust a current value for white display (highest gray level display). The I value can be varied by controlling a reference current 89 in a configuration in FIG. 8. Accordingly, the adjustment can be accomplished by inputting control data 88 depending on an application.

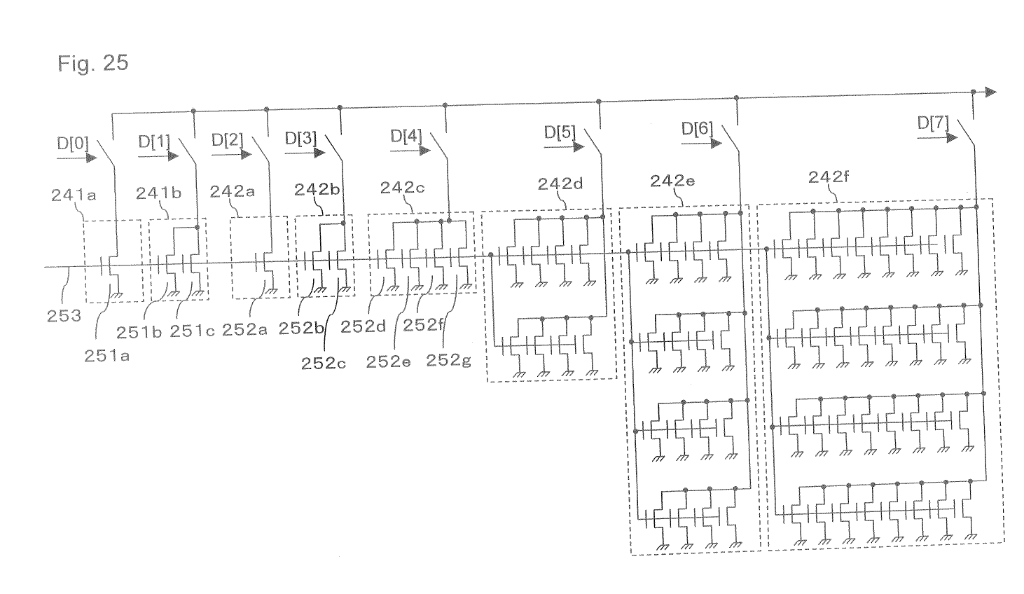

FIG. 25 shows an example of a configuration in FIG. 24 implemented using transistors. A transistor 252 for upper 6 bits corresponds to a first unit transistor according to the present invention by way of example. A transistor 251 for lower 2 bits corresponds to a second unit transistor according to the present invention by way of example. Transistor groups 241a and 241b correspond to a first current source group according to the present invention by way of example. Transistor groups 242a, 242b, 242c, 242d, 242e, and 242f correspond to a second current source group according to the present invention by way of example. For D[0] to D[1] and D[2] to D[7] of input video signal data D[7:0], the weight of each bit is expressed by varying the number of transistors connected to the output. The weighting between the lower 2 bits and upper 4 bits is determined on the basis of the channel width of the transistors. The transistors 251 and 252 are designed so that the transistor 252 has a channel width about four times as large as that of the transistor 251. However, channel width ratio does not precisely match output current ratio. Accordingly, an output stage with a high gradation characteristic can be realized by determining the rate of channel width of the transistors from 3.3 times to 4 times on the basis of simulations or TEG transistor measurements.

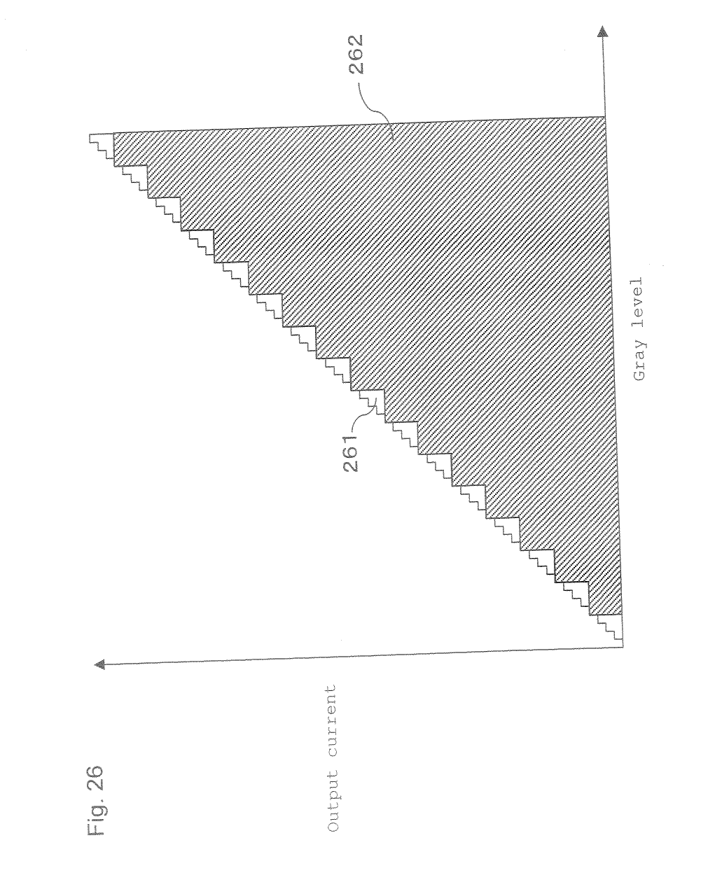

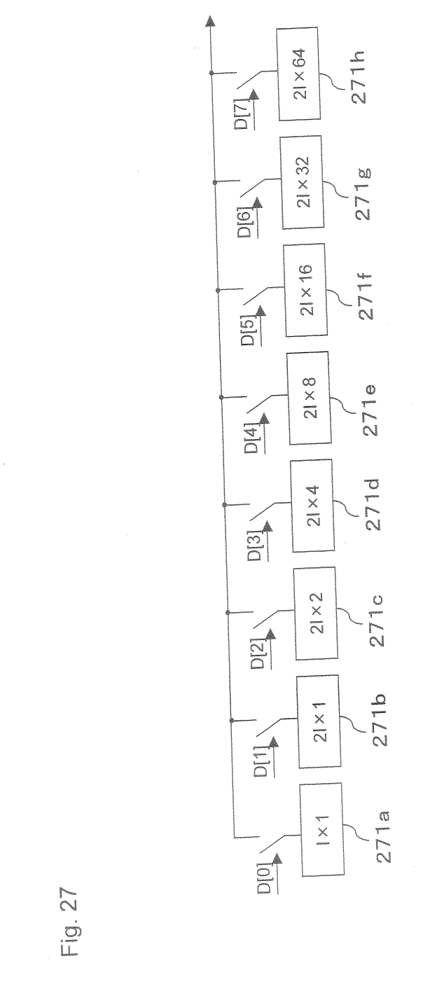

An output current is determined by the number of current source transistors connected to each bit. The output current is varied in such a way that the quantities of currents flowing through the respective transistors are stacked. FIG. 26 shows the gray level and output current characteristic for the 8 bit output shown in FIGS. 24 and 25. (For illustration, only lower 64 gray levels are shown). The transistor 252 for the upper 6 bits outputs a current shown by an area 262. The transistor 251 for the lower 2 bits outputs a current shown by an area 261. Since a current from the transistor 262 has its value varied depending on the number of transistors, a variation in the magnitude of increments can be reduced to at most 1%. Most of the output current is obtained from the transistor 262, so that a slight variation in the current from the transistor 261 does not affect the linearity of the gray level. Further, even if the magnitude of increments in the transistor 261 increases or decreases compared to a predetermined value, a different increment appears only once per four gray levels. Consequently, this does not pose any problems in terms of practical use taking into account the rates of the total output current taken up by the transistors 262 and 261. In a low gray level region in which the transistor 262 has a low current rate, a difference in luminance is difficult to perceive owing to the characteristics of human eyes. The variation in the magnitude of increments is much more unnoticeable and does not pose any problems.

A variation in output between adjacent terminals caused by the transistor 252 for the upper 6 bits is the same as that in a 6-bit driver. Accordingly, the variation is at most 2.5%. The inventor has confirmed that no streaks occur which result from a variation in output current.

On the other hand, for the newly added transistor for the 2-bits, simply quartering the channel width reduces the channel area of the transistor. As a result, the variation increases beyond 2.5% (the variation in output current between adjacent terminals is in inverse proportion to the square root of the transistor area).

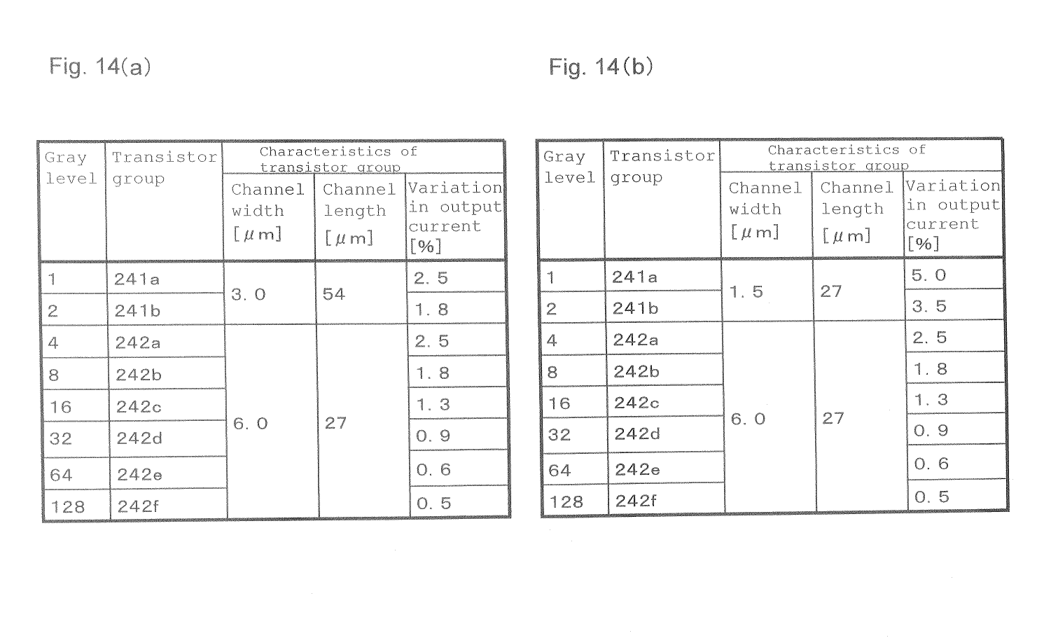

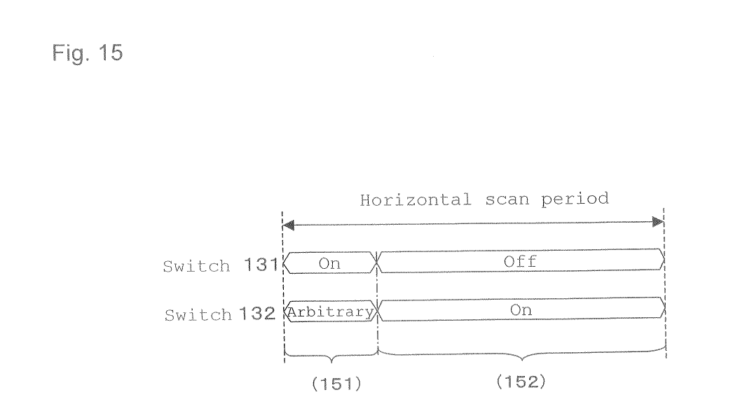

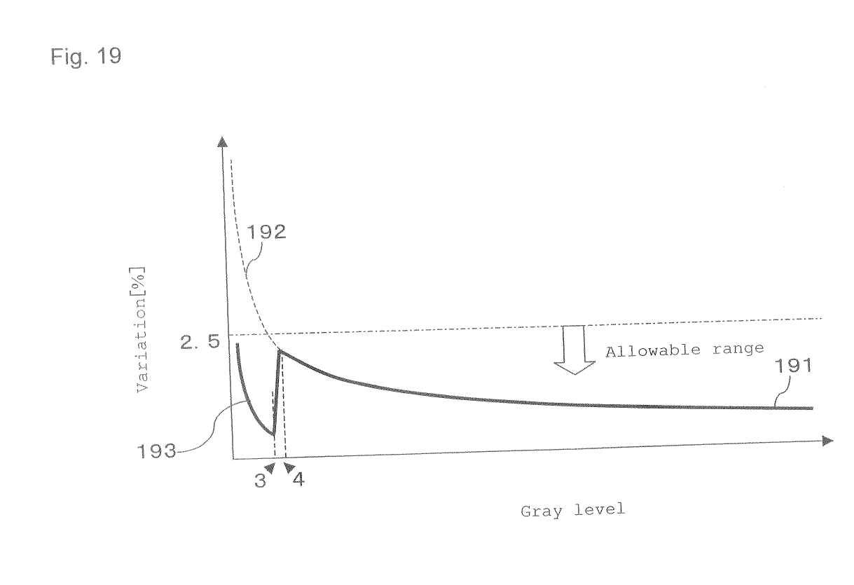

FIG. 19 shows the relationship between the gray level and the variation in current between adjacent terminals in the configuration of the output stage shown in FIG. 25. If the size of the transistor 251 for the lower 2 bits is simply reduced, then the gray level and the variation have the relationship shown by a dashed line 192. Disadvantageously, the variation exceeds 2.5% at most gray level 3. FIG. 14 (b) shows the relationship between the variation and gray level observed if the channel width is simply quartered. The variation exceeds 2.5% between gray levels 1 and 3. This is intolerable.

Thus, according to the present invention, the variation is reduced by maintaining the (transistor channel width)/(transistor channel length) values of the three transistors 251, which contribute to outputs with gray levels 1 to 3, and increasing channel width and length and thus channel area without varying the output current. FIG. 14 (a) shows an example. In this case, the variation is reduced to at most 2.5% for all gray levels by doubling both channel length and width to quadruplicate the channel area.

The present example refers to theoretical values, and the transistor groups 241a and transistor groups 241b actually have larger channel widths. Since the channel area is increased, margins are provided for the variation in output current. Accordingly, a design is first made using theoretical values and finally changed on the basis of measurements.

With this method, the chip area increases by a factor of 1.05 for 70% of the whole circuit, that is, by a factor of 1.04 for the whole circuit. Thus, the increase rate is low and display is possible which makes the variation invisible. Further, the gray level and the variation have the relationship shown by solid lines 191 and 193 in FIG. 19. The variation is 2.5% for all the gray levels.

Moreover, the transistor groups 241 and 242 have different sizes. Accordingly, a current output from the transistor group 241 may increase or decrease compared to that from the transistor group 242 owing to differences between simulation values and measurements.

If the current output from the transistor group 241 can be reduced compared to that from the transistor group 242, tone reversal does not occur because the output is not zero or because no negative current flows. Consequently, this does not pose any problems.

On the other hand, if the current output from the transistor group 241 increases compared to that from the transistor group 242, tone reversal may occur between the gray level at which the transistor group 241 contributes to the output and the adjacent gray level at which the transistor group 241 does not contribute to the output. For example, tone reversal may occur between gray levels 3 and 4 or 127 and 128.

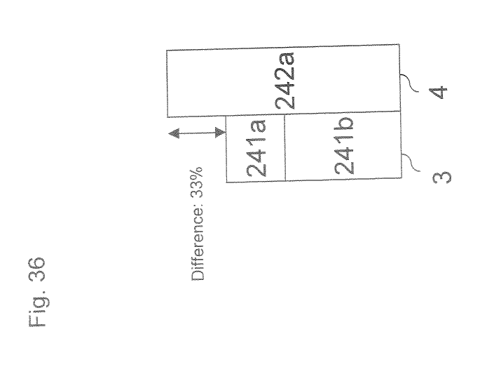

There is a luminance difference of 33% between gray levels 3 and 4 as shown in FIG. 36. Since the output variation is about 2.5% as shown in FIG. 14, the luminance difference would be 30% if the variation occurred in a direction in which a difference in gray level decreased. Therefore, no problem occurs even if the actual current output from the transistor group 241 is larger than the simulation value by 30%.

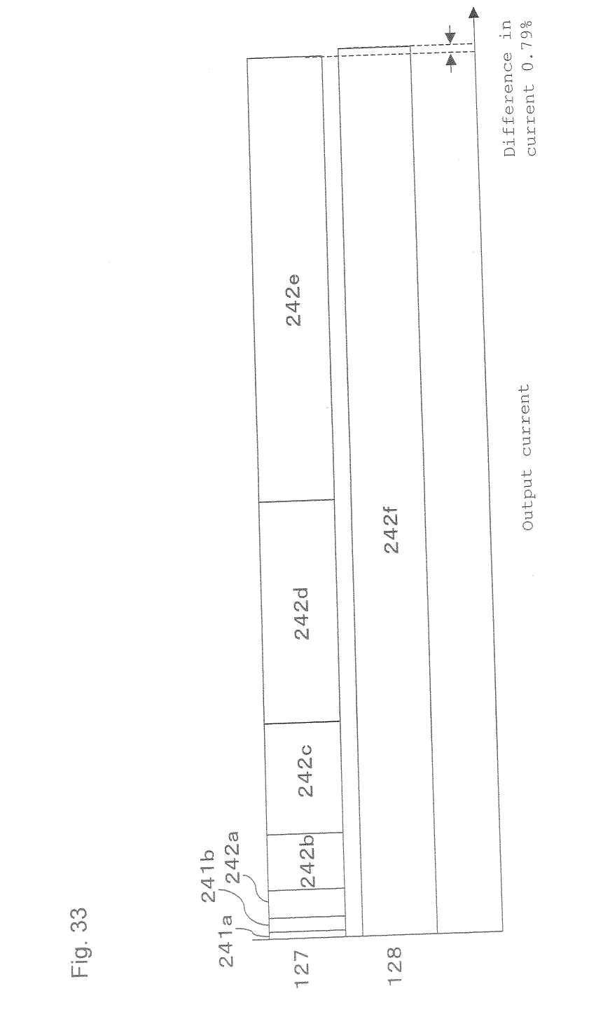

There is a gray level difference of 0.79% between gray levels 127 and 128 as shown in FIG. 33. Since 124 gray levels of gray level 127 as well as gray level 128 are output by the transistors 242 of the same size, the variation is about 0.5% similarly to the variation between adjacent terminals. Thus, the gray level difference may be at least 0.29%. Even if there is an increase in the current from the transistors of the transistor group 241, the difference as a whole has only to be reduced to at most 0.29%. Tone reversal can be prevented by maintaining the difference from the current from the transistors of the transistor group 241 at most 12.3%.

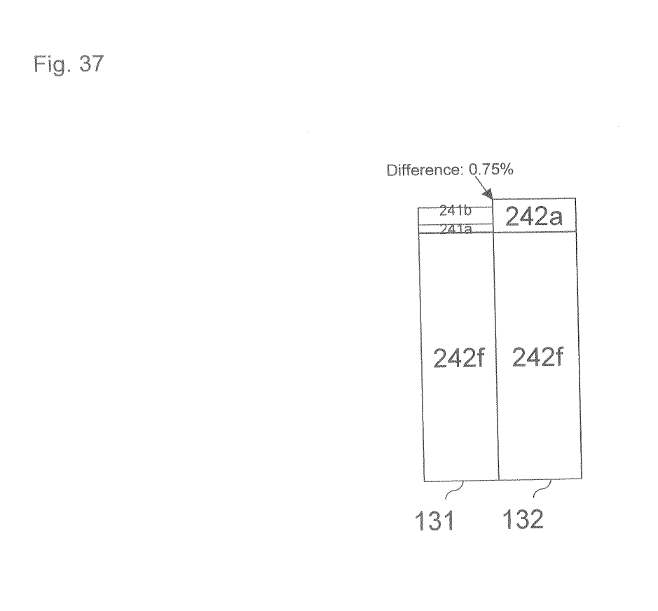

Beyond gray level 128, for example, between gray levels 131 and 132, the gray level difference is 0.75% as shown in FIG. 37. In this case, both gray levels have the current output from the transistor group 242f, and the difference corresponds to the current outputs from the transistor group 242a, transistor group 241a, and transistor group 241b. The current from the transistor group 242a is one-32ths of that from the transistor group 242f. Accordingly, a variation in current value resulting from the variation among the transistors is smaller than that at gray level 128 or lower. In this case, the variation is smaller by 0.08%, resulting in a luminance difference of 0.67% even with a variation among the transistors. Since the luminance difference is larger than that between gray levels 127 and 128 and the percentage of the total current output taken up by the transistor group 241 decreases. Consequently, no problem would occur at least if the current from the transistors of the transistor group 241 were larger than that between gray levels 127 and 128.

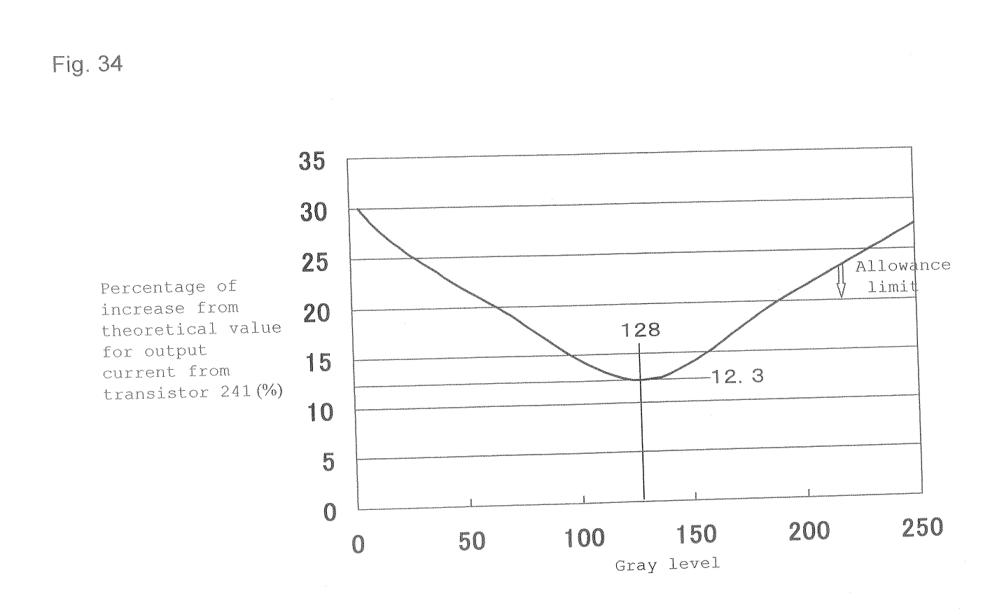

FIG. 34 shows the relationship between the display gray level and the range in which tone reversal does not occur even when the quantity of current from the transistors of the transistor group 241 is larger than the simulation value (theoretical value).

FIG. 34 shows that the tolerable difference from the theoretical value is smallest between gray levels 127 and 128; the tolerable difference is 12.3%. The current output without tone reversal can be provided at least when the difference between the theoretical value and the actual value is at most 12%.

In an 8-bit driver configured as shown in FIGS. 24 and 25, display can be accomplished without tone reversal even if the transistor size is varied between the lower 2 bits (output from the transistor group 241) and the upper 6 bits (output from the transistor group 242).

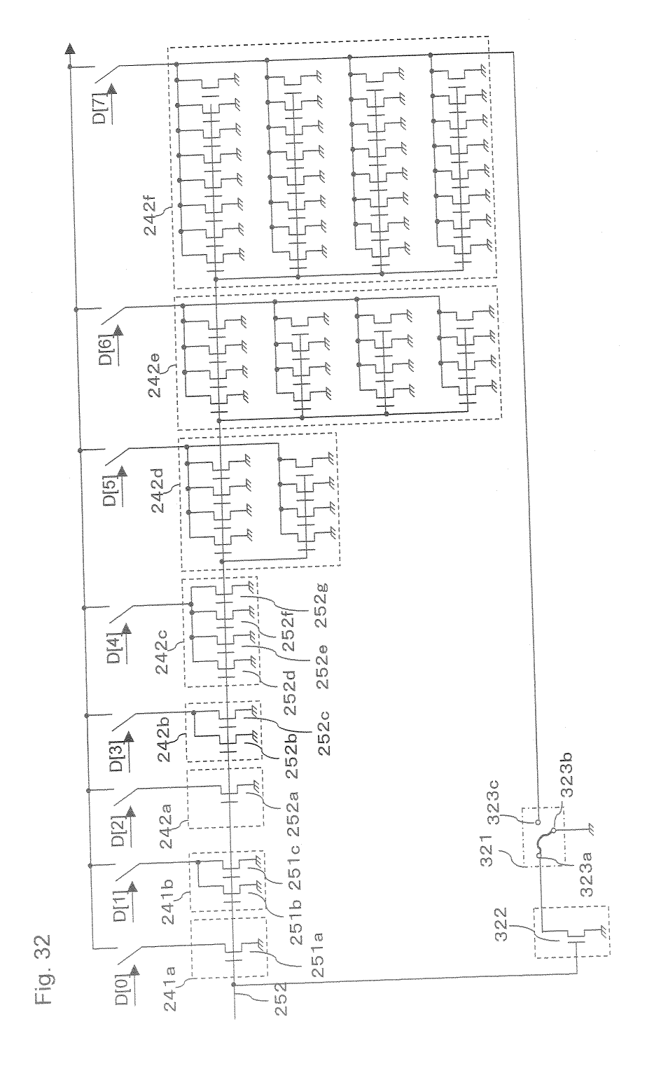

Tone reversal is most likely to occur between gray levels 127 and 128. FIG. 32 shows the circuit configuration of one output of a current output stage 23 into which a circuit is incorporated which, even if tone reversal occurs between these two gray levels, carries out repairs to eliminate the tone reversal.

This configuration is characterized by having a current increasing transistor 322 and a switching section 321 for at most 128 gray levels compared to the configuration in FIG. 25.

The switching 321 has three terminals 323 connected to the current increasing transistor 322, a ground potential, and a current source 242f, respectively.

In the switching section 321, the terminals 323a and 323b are normally connected, with the terminal 323c unconnected. Thus, the current increasing transistor 322 does not affect the current output. If tone reversal can be prevented, the circuit in this condition is shipped.

On the other hand, if the current from the transistor group 241 increases to cause tone reversal, a laser or the like is used to change the connections to the switching section 321 so that the terminals 323a and 323c are connected together, in order to increase the current for gray level 128 and higher to prevent tone reversal.

This increases the current for gray level 128 and higher to enable tone reversal to be prevented.

The current increasing transistor 322 is adapted to output a current about 10% of that from the transistor group 241a. When the current from the transistor group 241 exceeds 12.3%, reversal occurs between gray levels 127 and 128. To relieve this, the current should be set at about 10%. If the current from the transistor group 241 varies by 22%, it is impossible to prevent the tone reversal between gray levels 127 and 128. In this case, tone reversal has already occurred between gray levels 63 and 64. This circuit cannot correct the tone reversal between gray levels 63 and 64. Accordingly, the difference of 22% need not be taken into account.

Thus, the present invention is configured to prevent only the tone reversal between gray levels most likely to undergo tone reversal. Accordingly, the current from the current increasing transistor 322 may be about 10% of that from the transistor group 241a.

Since the output current from the current increasing transistor 322 is one-1,280ths of the output for the 128 gray levels, the adverse effect of the current increasing transistor 322 on the variation between adjacent terminals is 0.08% of the total effect and is thus negligible. No problems are posed even if the current increasing transistor 322 is as large as a transistor group 241a or is about one-fourth of the transistor group 241a in size.

Provision of the switching section 321 for each output provides a driver IC unlikely to undergo tone reversal. This is expected to enable to make rejected products acceptable using laser machining to increase yield.

However, laser machining for every output requires a long machining time, thus increasing the number of man-hour and thus cost. Consequently, the price of the product may not decrease compared to the increase in yield.

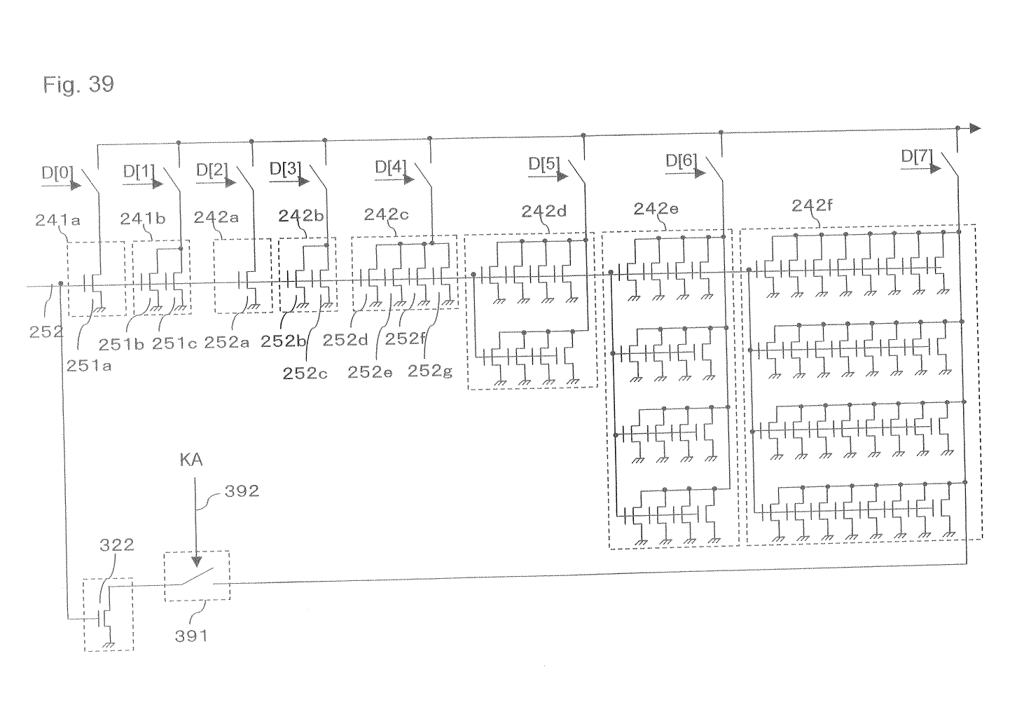

Thus, a configuration has been devised in which the current increasing transistor 322 and the current source 242f are connected together via the switching instrument 391 and in which a padding signal 392 is used to control the switching instrument 391 so that the current for gray level 128 can be easily boosted using the padding signal 392 in accordance with an external command input as shown in FIG. 39.

It is only necessary to set the padding signal 612 for every output. However, a latch is required which holds the value for the padding signal 612 for each signal line. The signal can be distributed among the latches using the 1-bit signal input 392 by employing a shift register originally used to distribute a video signal. However, since the number of latches provided is equal to that of signal lines, the circuit scale may disadvantageously increase. The number of data bits held by a latch section 22 increases by 1 bit for each source line. If an increase in circuit scale is allowable or the percentage of the total area taken up by the latch section is small owing to the use of a fine process, it is possible to determine whether or not to carry out padding by controlling the padding signal for every output. However, since tone reversal may occur if the simulation value and the measurement differ greatly, whether or not the current increasing transistor 322 is required should basically be determined for all the terminals in common.

Thus, one common padding signal line 392 is provided in one source driver so that the signal line is controlled to determine whether or not to increase the current for gray level 128 and higher for all outputs.

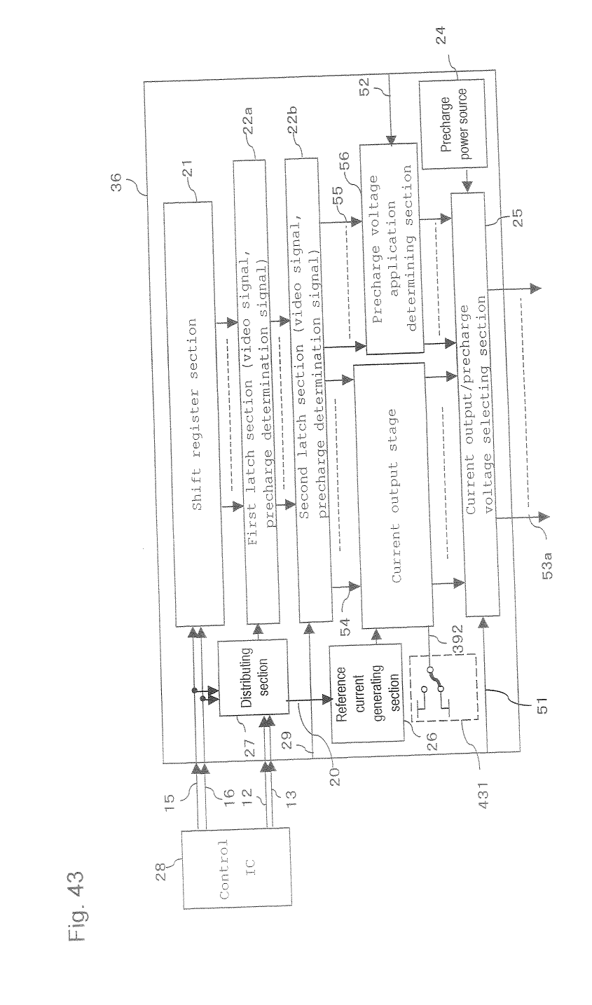

For example, this signal line is normally set to a low level to make the switching section 391 nonconductive. However, by using laser machining to switch the padding signal line 392 to a high level to control all the outputs at a time, it is possible to carry out repairs within a short period. This can be realized by forming such a circuit as shown at 431 in FIG. 43.

Moreover, if a ROM 351 can be constructed inside a source driver IC 36, values are written to the ROM 351 in accordance with external control signals so that the padding signal line 392 is set to the high level for ICs in which tone reversal has occurred and to the low level for ICs in which tone reversal has not occurred.

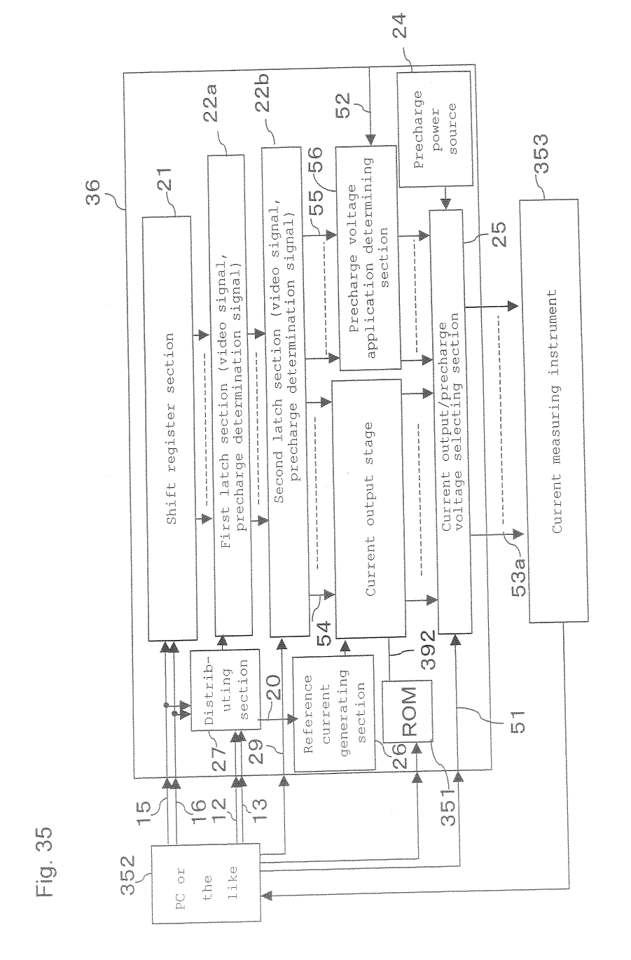

For example, as shown in FIG. 35, a PC or the like 352 can input signals to the ROM 351 during inspections. The PC or the like 352 detects whether or not tone reversal is occurring on the basis of a current value from output current measuring section 353. When tone reversal occurs, the PC or the like 352 writes a high level signal to the ROM 351. When tone reversal does not occur, the PC or the like 352 writes a low level signal to the ROM 351. This makes it possible to automatically determine whether or not to correct tone reversal. Consequently, rejected products can be rescued without the need for manual operations. Therefore, inexpensive ICs can be promptly provided.

In the above description, the source driver has 8 bits. However, the present invention can be implemented with the number of bits different from eight. Further, the present invention can be implemented with a set of bits different from the combination of lower 2 bits and upper 6 bits, for example, the combination of lower 1 bit and upper 7 bits. A current driver with (N+M) (≧3) bit outputs can be provided by using one transistor size to form lower N bits while using another transistor size to form upper M bits. In this case, it is best for the transistor for the lower N bits to output a current ½^{N} of the current output from the transistor for the upper M bits. However, in some cases, the transistor for the upper M bits may have only to output a larger current than the transistor for the lower N bits as long as gray levels can be expressed.

The preferable relationship between N and M is N≦M. The rate of the current output from the transistor corresponding to the N bits increases consistently with the value of N. This increases the adverse effect of the difference between the current value of the transistor corresponding to the N bits and the corresponding theoretical value. For example, for an 8-bit driver, the difference is tolerable up to 12.3% for N=2 and M=6, but only 5.26% for N=3 and M=5 and 2.46% for N=4 and M=4. The difference of 2.46% is at the same level as the variation between adjacent terminals. Accordingly, this is the minimum value with which the difference between the theoretical value and the measurement can be controlled.

Thus, for the 8-bit driver, N=4 is the maximum value.

In general, for an (N+N) bit driver, it is necessary that N≦M is held in order to suppress the adverse effect of the difference from the theoretical value for the lower transistor (for the N bits). Further, even when N≦M, preferably N≦4 is held in order to improve the gradation between adjacent gray levels.

By inputting an 8-bit signal subjected to gamma correction and utilizing the source driver IC 36 for display, it is possible to provide display subjected to gamma correction without using an FRC. This enables lower gray levels to be easily displayed (eliminates the adverse effect of flickers caused by the FRC) to provide a display apparatus with a high display grade.

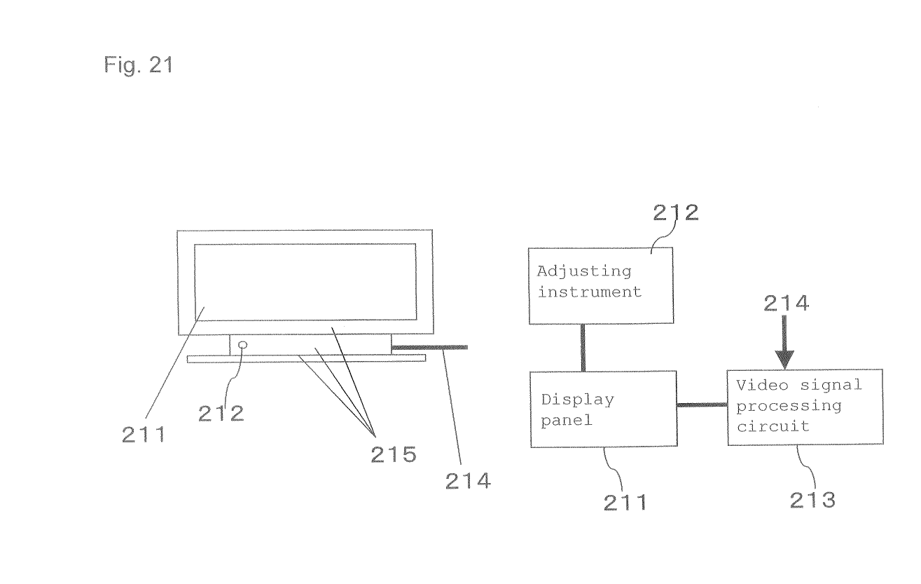

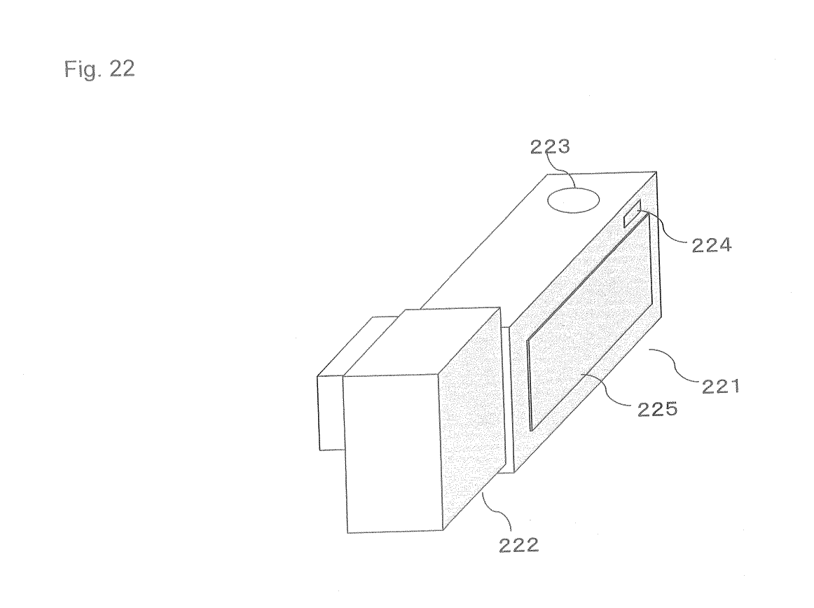

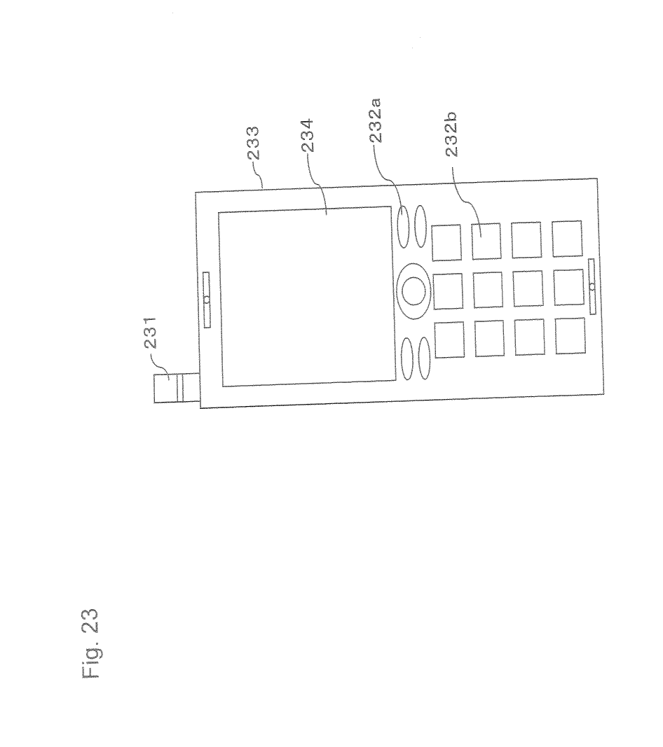

The driver IC 36 is essential for such a display apparatus as shown in FIGS. 21 to 23.

In this example, the transistor used for a pixel 67 is of a p type. However, the present invention can also be implemented using an n-type transistor.

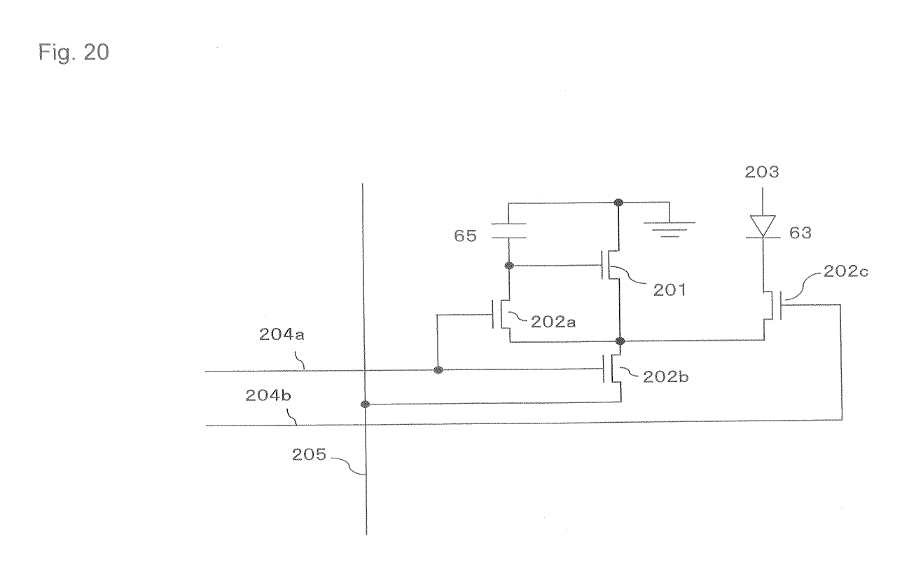

FIG. 20 shows a circuit for one pixel in which a current mirror type pixel configuration is formed of n-type transistors. The current flows in the opposite direction, with the power supply voltage correspondingly changed. Therefore, the current flowing through a source signal line 205 must flow from the source driver IC 36 toward the pixel 67. The output stage has a current mirror configuration of p-type transistors such that a current is discharged to the exterior of the driver IC. The direction of a reference current must also be reversed.

In this manner, both p- and n-type transistors may be used for pixels.

In recent years, the number of colors used in portable informational terminals has been increasing; most such terminals use 65,000 or 220,000 colors. With an RGB digital interface, an input signal to the driver IC must have 16 or 18 bits. Consequently, 16 or 18 input signal lines are required only for data transfers. Further, it is also necessary to have signal lines for signals for operations of shift registers and for setting of various registers.

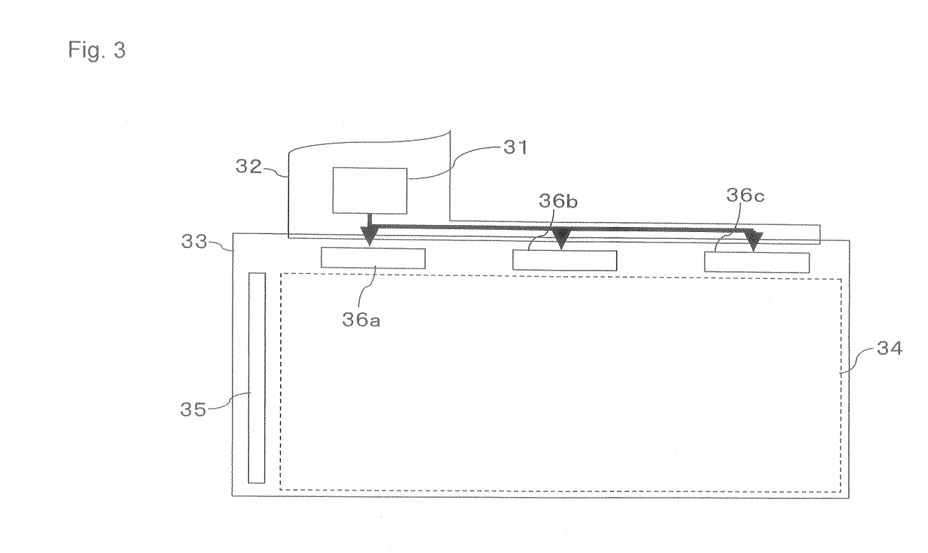

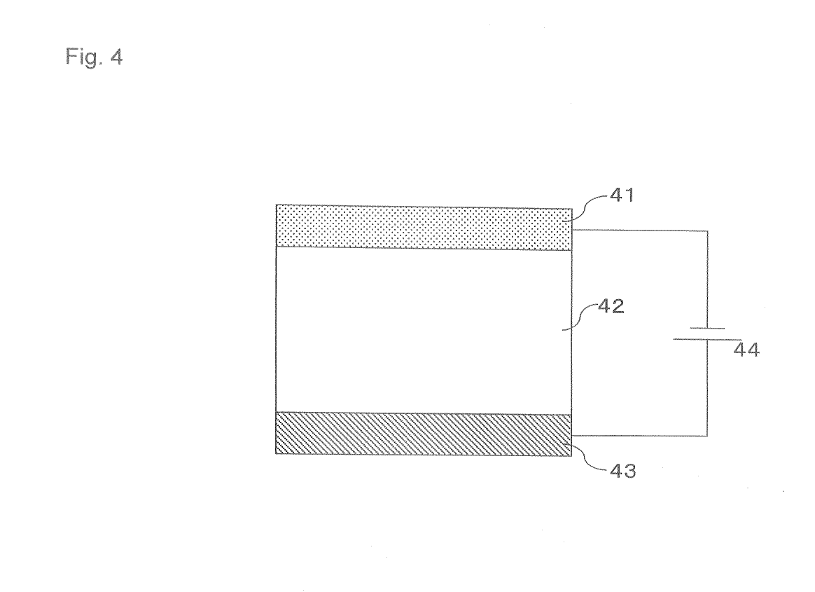

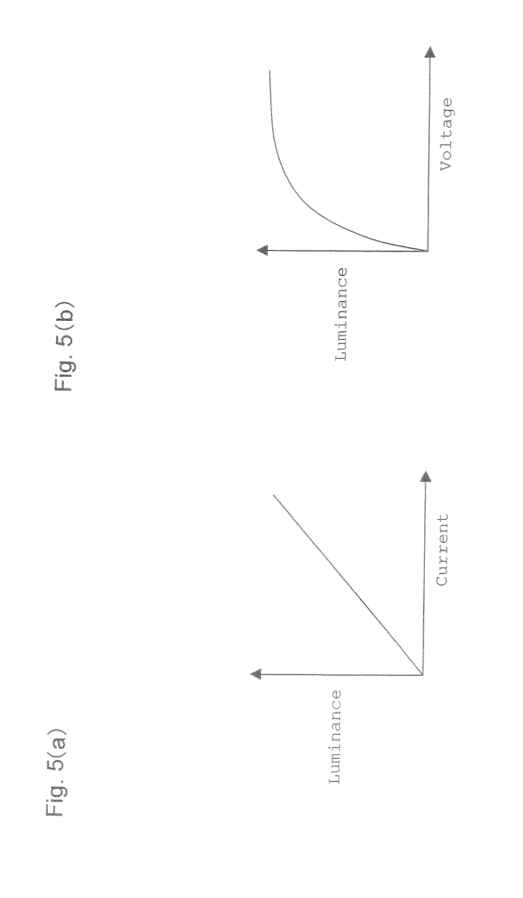

This increases the number of wires required. For example, as shown in FIG. 3, more wires are installed between a control IC 31 and the source driver IC 36 for a display panel 33. This disadvantageously increases the cost because of an increase in the size of a flexible substrate 32 or the use of a multilayer substrate.

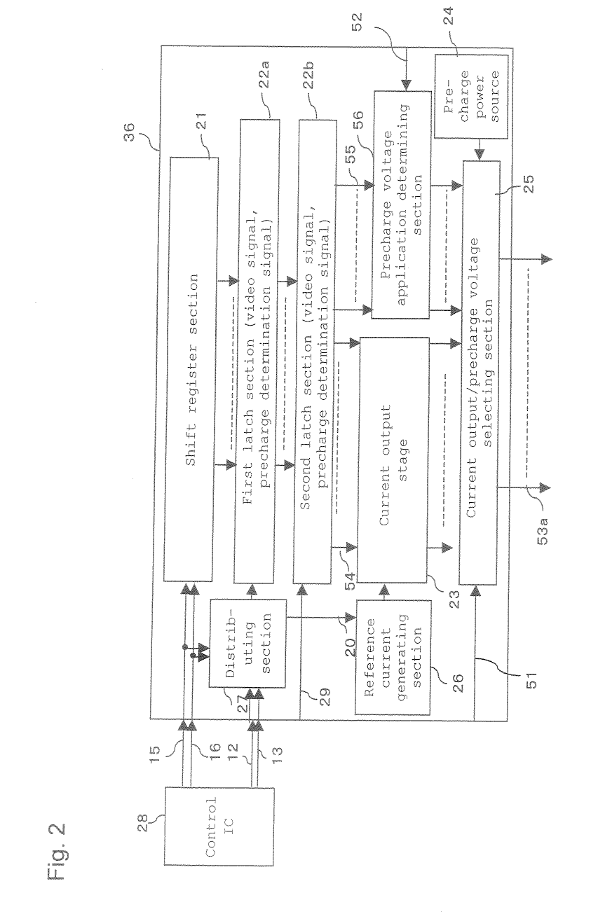

FIG. 2 shows the configuration of the current output type source driver IC 36 according to the present invention. The number of outputs can be set by increasing or reducing the numbers of shift registers 21 and latch sections 22, current output instrument 23, precharge voltage application determining sections 56, and current output/precharge voltage selecting sections 25 required for one output in response to an increase or decrease in the number of outputs. Accordingly, it is possible to accommodate an arbitrary number of outputs (however, since an increase in the number of outputs excessively increases chip size and impairs general purpose properties, the maximum number in a practical sense is about 600).

A video signal for the driver IC 36 according to the present invention is input by a control IC 28 through signal lines 12 and 13. A distributing section 27 then divides the video signal into a video signal and various setting signals and inputs only the video signal to a shift register section 21. The shift register section 21 and two latch sections 22 distribute the video signal to output terminals. The distributed video signal is input to a current output stage 23. The current output stage 23 outputs the current value corresponding to the gray level on the basis of the video signal and a reference current generated by a reference current generating section 26. The latch sections input precharge determination signal data to a precharge voltage application determining section 56. On the other hand, the precharge voltage application determining section 56 generates a signal that controls a switch determining whether or not to output a voltage supplied by a precharge power source 24 to an output 53, on the basis of the precharge determination signal latched by the latch section 22 and a precharge pulse. Thus, the current corresponding to the gray level or the voltage supplied by the precharge power source 24 is output to the exterior of the driver IC 36 via a current output/precharge voltage selecting section 25 that selects whether to provide the current or voltage to the exterior of the driver IC 36 on the basis of an output signal from the precharge voltage application determining section 56.

The voltage output by the precharge power source 24 has a value required to display black on a display panel. The method of applying a precharge voltage has a configuration characteristic of the driver IC 36 in order to display gray levels on an active matrix type display apparatus in accordance with a current output.

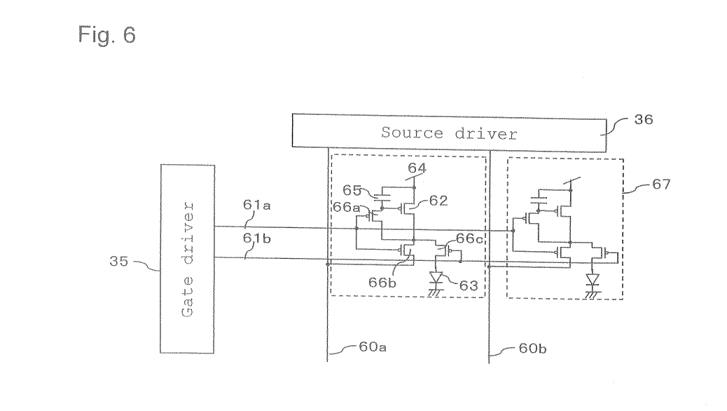

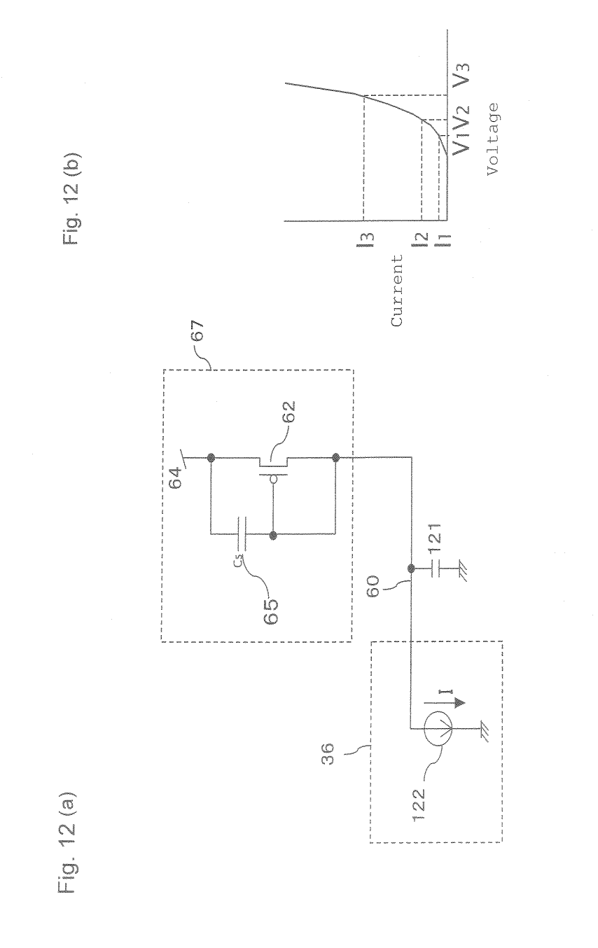

It is assumed that, for example, in an active matrix type display apparatus having the pixel configuration shown in FIG. 6, the predetermined current value from a source signal line is written to a certain pixel. If precharge is not carried out, that is, there is no precharge circuit, a circuit relating to a current path from the output stage of the source driver IC 36 to the pixel is configured as shown in FIG. 12 (a).

The current I corresponding to the gray level flows from inside the driver IC 36 in the form of a current source 122 as a lead-in current. The current is incorporated into the pixel 67 through a source signal line 60. The incorporated current flows through a driving transistor 62. That is, in the selected pixel 67, the current I flows from an EL power supply line 64 to the source driver IC 36 via the driving transistor 62 and the source signal line 60.

When the video signal and thus the current value of the current source 122 change, the current flowing through the driving transistor 62 and source signal line 60 also changes. On this occasion, the voltage across the source signal line changes depending on the current/voltage characteristic of the driving transistor 62. If the driving transistor 62 has the current/voltage characteristic shown in FIG. 12 (b), when for example, the value of a current from the current source 122 changes from I2 to I1, the voltage across the source signal line changes from V2 to V1. The change in voltage is caused by the current from the current source 122.

The source signal line 60 has a floating capacity 121. Charges for the floating capacity must be drawn out in order to change the source signal line voltage from V2 to V1. The time ΔT required to draw out the charges is ΔQ(charges for the floating capacity)=I(current flowing through the source signal line)×ΔT=C (floating capacity value)×ΔV. Here, ΔV(signal line amplitude between the point of white display and the point of black display) must be equal to ΔT=50 milliseconds for 5 [V], C=10 pF, and I=10 nA. This means the following. The signal line amplitude ΔV is longer than one horizontal scan period (75 μsec) required to drive QCIF+size (the number of pixels 176×220) with a frame frequency of 60 Hz. Accordingly, if an attempt is made to display a pixel in black which is located under a pixel displayed in white, switch transistors 66a and 66b used to write a current to a pixel are closed before the source signal line current is completely changed. Consequently, a half tone is memorized in the pixel to make the pixel shine at the luminance corresponding to the intermediate value between black and white.

The value I decreases consistently with the gray level, so that it becomes more difficult to draw out the charges for the floating capacity 121. Consequently, the following problem appears more markedly at a lower gray level: a signal not having changed enough to have a predetermined luminance is written into the pixel. To put it in an extreme way, for black display, the current source 122 provides a zero current, so that it is impossible to draw out the charges for the floating capacity 121 without passing a current through the circuit.

Thus, a voltage source is provided which has a lower impedance than the current source 122 so as to apply a voltage to the source signal line 60 as required. This voltage source corresponds to the precharge power source 24, and the mechanism 25 enables the application.

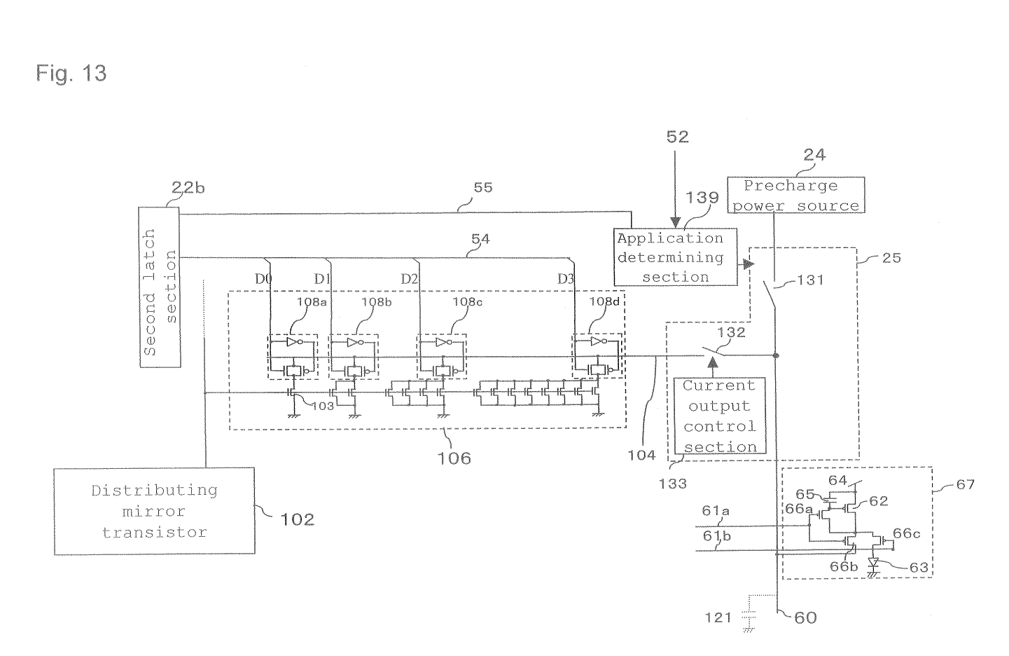

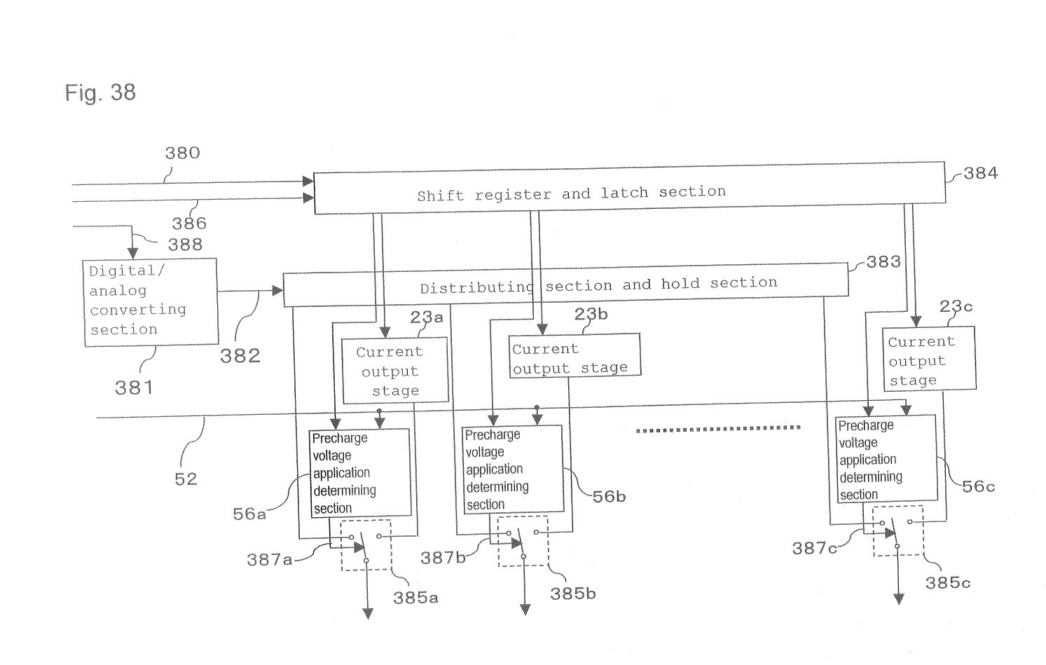

FIG. 13 shows a simplified circuit for one source signal line 60. The floating capacity 121 can be changed or discharged by applying the voltage supplied by the precharge power source 24 to the source signal line 60. The voltage supplied by the precharge power source 24 may be associated with each gray level current depending on the characteristic shown in FIG. 12 (b). However, in this case, the voltage generating circuit requires the digital/analog converting section corresponding to data 54, thus increasing the circuit scale. Since a small-sized panel (at most 9 inches) has a floating capacity 121 of 10 to 15 pF and a small number of pixels and thus allows the use of relatively long vertical scan periods, in a practical sense, it is sufficient in terms of cost (chip area) vs. effect that the precharge power source 24 generates only a voltage corresponding to a black level at which it is most difficult to write a current value (a driver IC using a digital/analog converting section may be used for a large-sized high-definition panel as shown in FIG. 38, described later).

A small-sized panel only requires that the precharge power source 24 generate one voltage. It is thus only necessary to determine whether or not to output the voltage on the basis of data to control the switch 131. That is, a 1-bit signal line (precharge determination signal) is provided which makes it possible to determine whether or not to apply the voltage source 24 before outputting the current corresponding to a certain video signal.

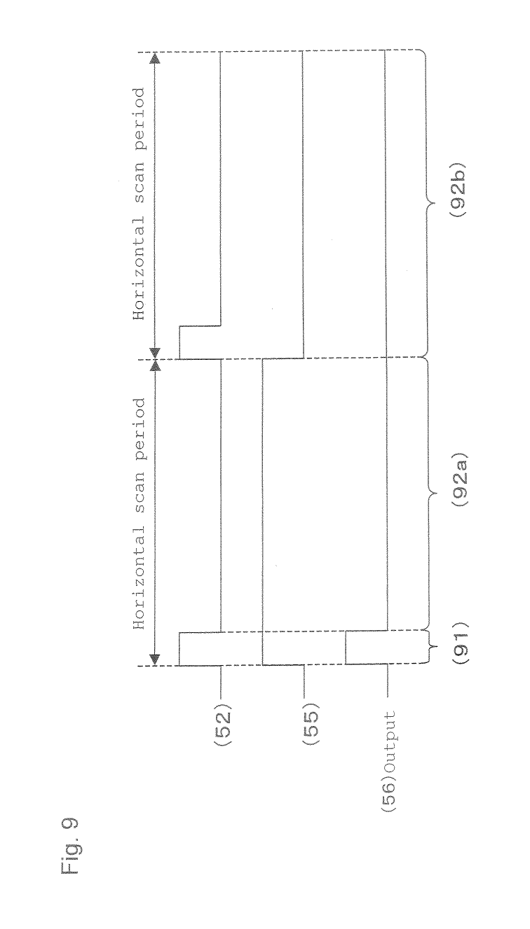

FIG. 9 shows an operation for voltage application determination performed in the circuit configuration in FIG. 13. A precharge determination signal 55 is used to determine whether or not to apply the voltage. In this example, the voltage is applied at an “H” level, whereas it is not applied at an “L” level.

A time constant expressed by the product of the wiring capacity and resistance of the source signal line 60 determines the time during which the gate voltage of the driving transistor 62 inside the pixel circuit 67 is the same as the output voltage from the precharge power source 24. The gate voltage can be changed within about 1 to 5 μs, though it may depend on the size of a buffer for outputs from the precharge power source 24 as well as the panel size.

With voltage-based gray level display, the current flowing through an EL element 63 may be varied by a variation in the current/voltage characteristic of the driving transistor 62 even if the same voltage can be supplied to the pixels. This results in an uneven luminance. Thus, to correct the variation in the current/voltage characteristic of the driving transistor 62, a current output is provided after the predetermined voltage has been obtained within 1 to 5 μs.

To accomplish this, the voltage output and the current output are switched using a precharge pulse. By allowing the precharge power source 24 to output the voltage only when the precharge pulse and the precharge determination signal 55 are simultaneously at the “H” level and otherwise carrying out current output, it is possible to provide a current output if the voltage need not be applied. Even if the voltage must be applied, a possible variation can be corrected using the current after the voltage application.

The switch 131, which controls the precharge power source 24, operates as described above. The operation of the switch 132 controlled by a current output control section 133 is such that the switch 132 must be turned on during a current output period 152, whereas it may be turned on or off during a voltage output period.

While the switch 132 is off, no problem occurs because the output from the precharge power source 24 is output from the source driver as it is. On the other hand, even while the switch 132 is on, the voltage across the source signal line 60 is the same as that of the precharge power source 24 provided that the precharge power source 24 outputs the voltage. This is because loads determine the voltage to a current output 104 from the digital/analog converting section 106. Thus, the switch 132 may be in either state.

Accordingly, the switch 132 and the current output control section 133 may be omitted. However, if an operational amplifier is used for the output of the precharge power source 24, the operational amplifier draws a current to a gray level display current source 103. This results in the need for improving the current output capability of the operational amplifier. Thus, if the capability of the operational amplifier cannot be improved, the switch 132 is often provided and operated in a manner opposite to that in which the switch 131 operates. This compensates for the insufficiency of the current output capability of the operational amplifier.

Whether or not to provide the switch 132 depends on the design of the operational amplifier associated with the design of the driver. If a small operational amplifier is provided, the switch 132 is provided so that the source driver 36 can be supplied with an external output from the operational amplifier or precharge power source 24. If the power source used has a sufficient current output capability, the switch 132 and the current output control section 133 may be omitted in order to reduce the circuit scale of the source driver.

The value of the voltage output by the precharge power source 24 is equal to only the voltage corresponding to the current for the black level (this voltage will be referred to as the black voltage below). Accordingly, if the gray level data 54 causes a white level to be displayed for a plurality of continuous horizontal scan periods, the source signal line repeats a black state and a white state in this order. If precharge is not carried out, the white state occurs continuously. That is, the precharge causes the signal line to vary more greatly, and depending on the current provided for the white display, may result in an imperfect white display, that is, an insufficient write current.

Thus, the precharge determination signal may be used to avoid precharge for gray levels at which a relatively large quantity of current flows, while utilizing the assistance of the precharge power source 24 for gray levels near the black level at which a predetermined current is difficult to reach. For example, it is most effective that the precharge voltage is applied only for gray level 0 (black), whereas the precharge voltage is not applied for the other gray levels. A reduction in luminance at the lowest gray level improves contrast to enable a more beautiful picture to be displayed.

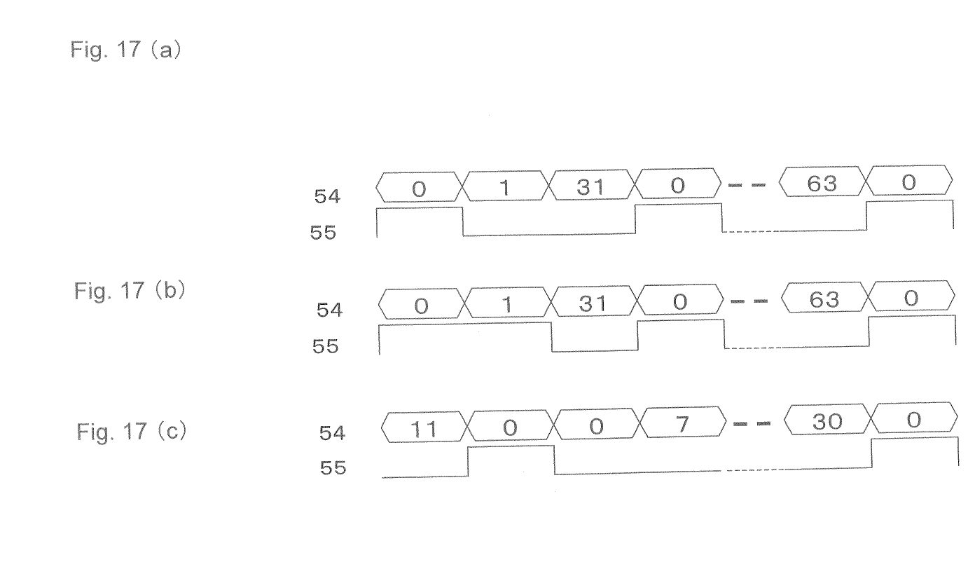

For example, as shown in FIG. 17 (a), the precharge can be carried out only on gray level 0 by setting the precharge determination signal 55 only when the gray level data 54 is 0.

Further, the precharge can be carried out on gray level 0 or 1 by setting the precharge determination signal 55 only when the gray level data 54 is 0 or 1, respectively.

For a pattern that does not involve any changes in source signal line, for example, a pattern causing black to be displayed all over the screen, the precharge voltage is applied only at the beginning of one frame, and then the gray level can sufficiently be obtained only with the black current.

That is, during the same black display, the time required to change to the predetermined current value using only current depends on a current passed through the source signal line during the last horizontal scan period. The time required to achieve this change increases consistently with the amount of the change. For example, it takes a long time to display black after white display. However, if black display follows black display, only a short time is required for the change because the change corresponds only to a variation among the driving transistors 62.

Thus, by introducing a signal (precharge determination signal 55) for each color which determines whether or not to apply the precharge voltage in synchronism with the gray level data 54, it is possible to introduce an arrangement that enables the selection as to whether or not carry out precharge at an arbitrary gray level or at the same gray level.

The precharge determination signal 55 is added to the gray level data 54. Then, the latch section 22 must latch the precharge determination signal. Accordingly, the number of video signal bits+1 (bit) latch sections must be provided.

FIG. 17 (c) shows that precharge is carried out on gray level 0 and when the gray level during the last period is not 0 (precharge is carried out on gray level 0, but if the gray level during the last period is also 0, precharge is not carried out in spite of gray level 0).

In contrast to the above method, this one has the advantage of being able to select whether or not to carry out precharge on the basis of the state of the source signal line during the last horizontal scan period, in spite of the same gray level.

The precharge determination signal is supplied by the control IC 28. Command operations by the control IC 28 enable the pattern of the precharge determination signal 55 to be changed for output as shown in FIGS. 17 (a) to 17 (c).

Precharge settings can be flexibly changed from outside the source driver IC 36 depending on the capacity of the source signal line or the length of one horizontal scan period. This advantageously improves the general purpose properties of the circuit.

Description will be given of a method of using a control IC 22 to generate a precharge determination signal 55. In response to an input video signal, the control IC 22 determines whether or not to carry out precharge. The control IC 22 then outputs the determination to the source driver as the precharge determination signal 55.

Whether or not to carry out precharge is determined on the basis of the state of the preceding row and of the display gray level of the current row in view of the effects of the precharge on the amount of change in the current flowing through the source signal line and on whether or not the value of the current flowing through the source signal line changes to the predetermined one.

When, for example, the state of the source signal line changes in order of white, black, and black, the amount of change from white state to black state is large and a long time is required for the change. However, if the same gray level is displayed over a plurality of rows as in the case of the continuous black state, only a small amount of change in source signal line current is required during the period corresponding to the rows over which the same gray level is displayed because the amount of change corresponds only to the compensation for the variation.

On the basis of this nature, with reference to the data in the preceding row, voltage output is carried out starting with the precharge voltage only if there is a large difference in gray level between the data in the preceding row and the current data. In the above example, precharge is carried out if the white state changes to the black state and is not carried out if the black state changes to the black state. The avoidance of the precharge correspondingly increases the time available for the change required for the variation correction for the change from black state to black state. Consequently, correction accuracy can further be improved. This indicates that the precharge is preferably avoided when the gray level of the preceding row is the same as that of the current row.

Moreover, only the voltage corresponding to the black state is required for the precharge. Accordingly, if the current row has a higher luminance than the preceding row, gray level display may be provided using only a predetermined current and without the need to change to the black state. This indicates that the precharge is preferably avoided when the current row has a higher gray level than the preceding row.

Moreover, if the current pixel has at least a half tone, it involves a large quantity of current. It is thus easy to change the current to a predetermined value, thus eliminating the need for the precharge regardless of the pixel in the preceding row. However, when the change is difficult to achieve because of a high resolution, a small quantity of current in spite of the half tone, or a large panel size, the precharge may be carried out if the pixel in the preceding row is at most the level of the half tone.

In general, it is more difficult to change the current value from white state to black state than from black state to white state. This is because the state of the source signal line for the preceding row must be changed to the desired one using the current corresponding to the gray level to be displayed and because the change is more difficult to achieve at a lower gray level with a smaller current value, as previously described. Moreover, with a large amount of change, the horizontal scan period is over before the change is completed. Thus, when a long time is required to complete the change, the amount of change is large, and the gray level is low, that is, the pixel in the preceding row is at least the level of the half tone, the precharge is effectively carried out if the pixel has a luminance equal to or lower than that of the half tone.

Provided that the preceding row is at most the level of the half tone, even if the pixel has a luminance equal to or lower than that of the half tone, a predetermined gray level can be displayed because the amount of change is small.

Thus, precharge is not carried out if the pixel has a luminance higher than that of a certain gray level. When the pixel has a luminance equal to or lower than that of the gray level, precharge is not carried out if the luminance is higher than that of the data in the preceding row but is carried out if the luminance is lower than that of the data in the preceding row by the preceding gray level. If the luminance is the same as that of the data in the preceding row, precharge is not carried out regardless of the gray level of the current row.

For the data in the first row, not involving the preceding row data, importance must be attached to the state of the source signal line immediately before an operation of writing data in the pixel in the first row, that is, the state of the source signal line during a vertical blanking period.

In general, there is a vertical blanking period in which none of the rows within one frame are selected. In this case, a switching transistor disconnects the source signal line from all the pixels to eliminate the path through which a current flows. If the current output stage of the source driver IC is configured as shown in FIG. 13, the current output 104 is connected only to the source signal line during the vertical blanking period. Accordingly, even if the gray level display current source 103 attempts to draw in a current flowing through the source signal line, the attempt fails because of the absence of a current path.

The gray level display current source 103 then forcibly attempts to draw in the current, thus reducing the drain voltage of a transistor constituting the current source 103. The potential across the source signal line lowers at the same time.

When the vertical blanking period is over and a current is to be supplied to the pixel in the first row, the decrease in source signal line potential increases. The source signal line potential becomes lower than that obtained during normal white display. (Here, the potential across the source signal line is lowest during white display and highest during black display in the case of the pixel configuration shown in FIG. 6). For this row, it is thus more difficult to change the potential across the source signal line to the value corresponding to the gray level than for the other rows (a large amount of change is required).

If the source signal line potential decreases markedly and if the potential becomes lower than that obtained during white display, so that a long time is required for the change even in providing white display for the first row, then the display is provided at a luminance higher than a predetermined one. For rows scanned immediately after the vertical blanking period, the precharge voltage is desirably output regardless of the display gray level.

Thus, the present invention utilizes a vertical synchronizing signal to force a precharge determination signal to determine that precharge is to be carried out on the data corresponding to the row next to the vertical blanking period. The present invention has thus solved the problem that the luminance of the first row is different from those of the other rows.

To suppress the decrease in the potential across the source signal line, it is possible to input black display data to the gray level data 54 during the vertical blanking period and to set the switch 108 in a nonconductive state. Alternatively, a switch may be provided between the current output 104 and the source signal line and set in the nonconductive state during the vertical blanking period. The switch may also be used as a current/voltage selecting section 385 and configured so that its state can have three values for a current output, voltage output, and disconnection from the source signal line. This makes it possible to reduce the number of switches.

The average luminance and illumination rate of a display pixel is affected by the phenomenon in which a predetermined gray level is difficult to write, that is, the phenomenon in which black is displayed as a half tone. With a high illumination rate, the luminance is generally high. In this case, even if a small number of black display pixels are displayed as half tones, they are invisible. On the other hand, with a low illumination rate, most pixels have their luminance set low. If this luminance cannot be displayed correctly, it may vary almost all over the surface. This results in display quite different from the original video, thus significantly affecting display grade.

Thus, the present invention enables settings such that for display with a high illumination rate that does not significantly affect the display grade, the precharge is avoided in order to give priority to uniform display based on current driving, whereas precharge is carried out for display with a low illumination rate that significantly increases the black display luminance.

The illumination rate of the panel can be calculated by summing all the luminance data for the whole frame. On the basis of the value of the illumination rate obtained by the above method, the luminance of a pixel displayed at a low gray level can be faithfully displayed by avoiding the precharge at a high illumination rate, while carrying out the precharge at a low illumination rate on the basis of previous determinations.

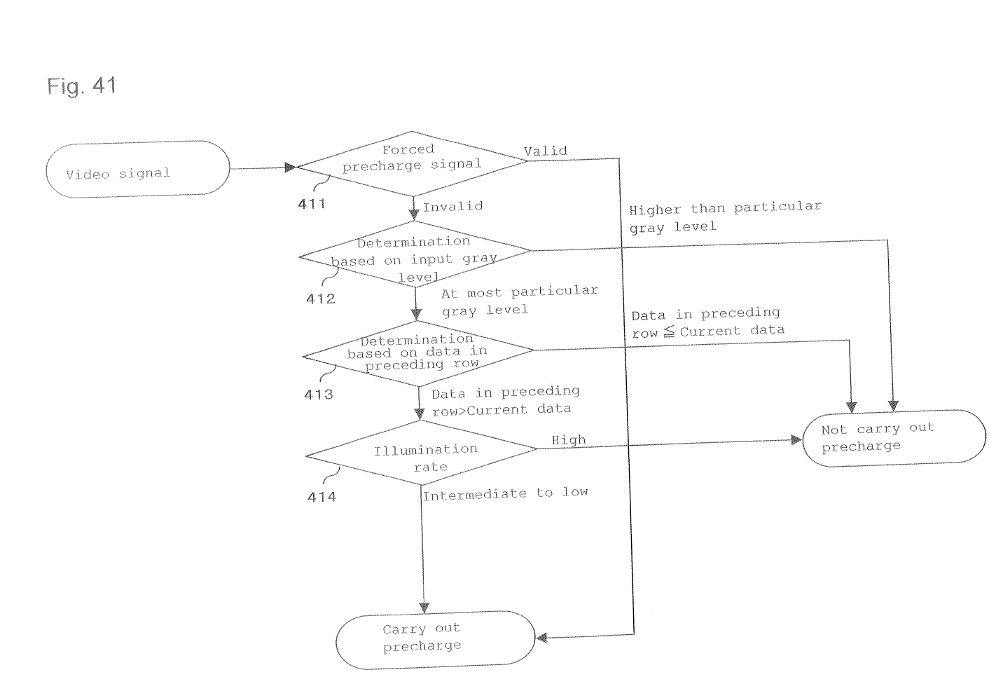

FIG. 41 shows a flowchart for executing the method for precharge shown above.

If a forced precharge signal is determined to be valid on the basis of a video signal and the forced precharge signal, the precharge voltage is output regardless of the video signal. The output voltage value may be varied depending on the video signal if there are a plurality of voltages. When the forced precharge signal is set valid only when the video signal corresponding to the first row has been input, precharge is carried out on the data in the first row regardless of the video signal. This makes it possible to avoid the phenomenon in which the current is difficult to change to the predetermined value owing to a decrease in source signal line voltage during the vertical blanking period.

If the forced precharge signal is invalid, the gray level of the input video signal is determined (412). With a small-sized panel or a panel with a low resolution, in a high gray level region having a larger current quantity than a low gray level portion, the predetermined current value can be reached during a predetermined period (one horizontal scan period) using only current. Thus, in 412, determination is made such that precharge is not carried out on gray levels that enable a predetermined current to be written, whereas precharge is carried out on gray levels that do not allow the predetermined current to be reached using only current.

Then, for a particular gray level or lower which requires the precharge, the process proceeds to 413. (The particular gray level depends on the display panel and can preferably be set using an external command). Whether or not to carry out precharge is determined on the basis of the state of the video signal in the preceding row. When the current video signal data has a high gray level than the preceding row data, precharge is not carried out because the signal line would actually change greatly if the precharge were executed to set the black level. Likewise, precharge is not carried out when the gray level is the same as that of the preceding row.

If the circuit determines that the precharge is to be carried out, then the illumination rate is referenced to avoid the precharge regardless of the determination if the illumination rate is high. Precharge is carried out as determined if the illumination rate is low.

In the present description, whether or not to carry out precharge is determined by sequentially executing all steps 411 to 414. However, not all the steps need be executed.

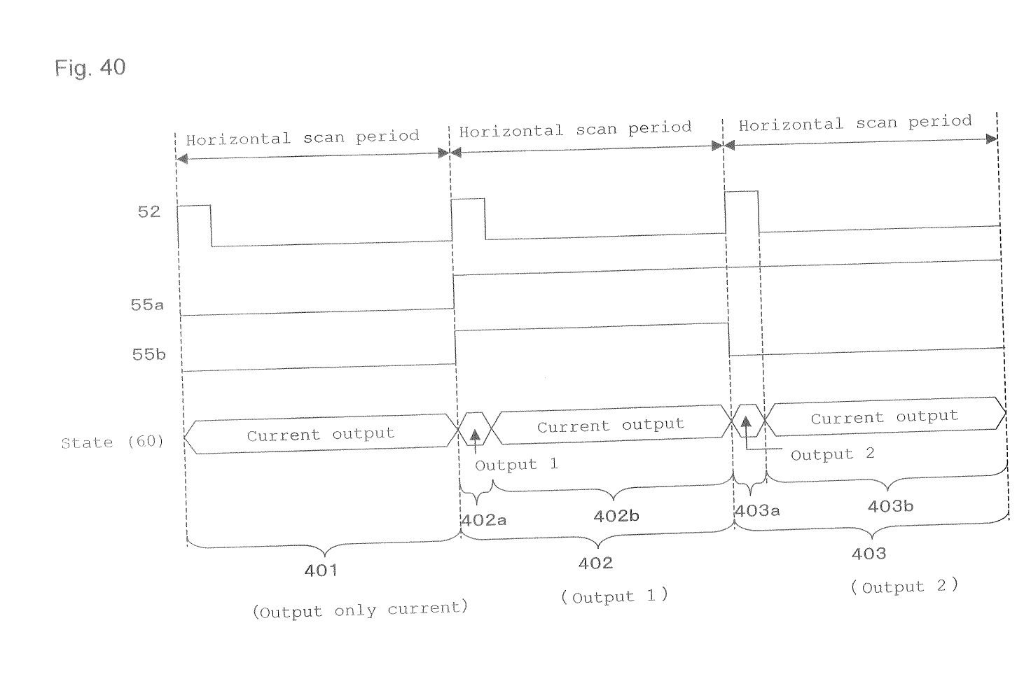

If the precharge power source 24 has a plurality of outputs, a plurality of switches 131 are present. Further, the possible number of outputs of the application determining section is the number of voltage outputs of the precharge power source 24+1. With the (the number of voltage outputs+1) outputs, the precharge determination signal 55 must have N bits (2^{N}≧(the number of voltage outputs+1); N is a natural number) instead of 1 bit. The number of bits in the latch section 22 may correspondingly be changed. FIG. 40 shows an example with a 2-bit precharge determination signal 55. In this case, the precharge power source 24 has three voltage values. Only the current is output when the both precharge determination signals are 0. When both signals are 1, a first voltage is output in a certain period. When only the signal 55a is 1, a second voltage is output in a certain period. When only the signal 55b is 1, a third voltage is output in a certain period. Then, the appropriate precharge voltage can be applied by controlling the precharge determination signal 55 in accordance with the gray level.

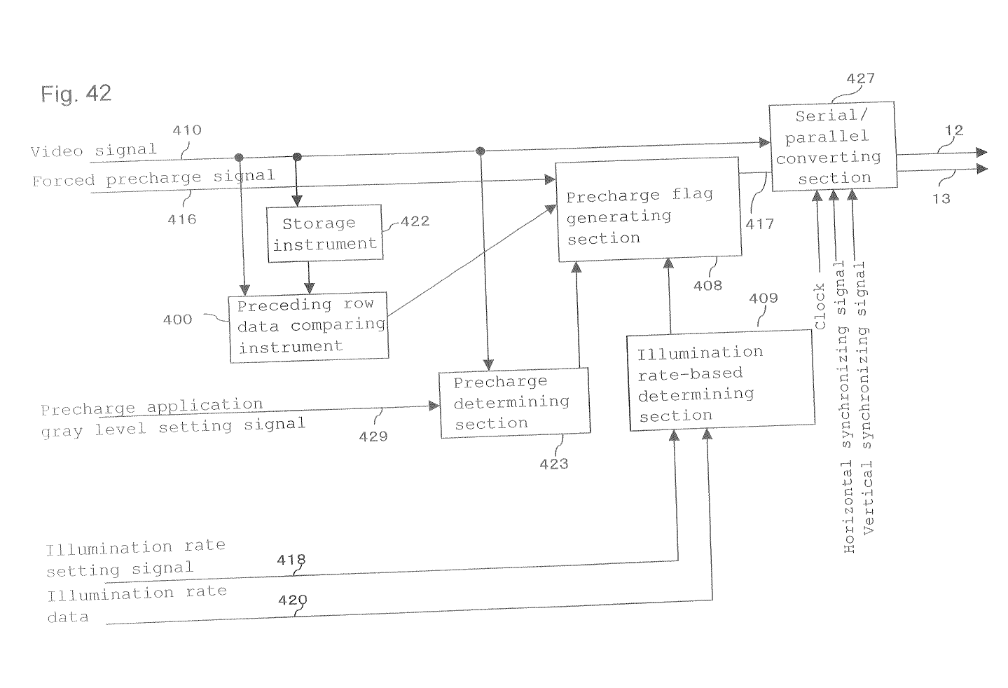

FIG. 42 shows a circuit block that implements the method for precharge according to the present invention. As a result of the determination in each block for a video signal 410, a determination signal 417 is output which determines whether or not to carry out precharge. Whether or not the source driver is to carry out precharge is determined by the determination signal 417, output at almost the same time as that at which the video signal 410 is output. A serial/parallel converting section 427 is not necessarily required; if a combination with the source driver IC 36 in FIG. 2 is implemented, the serial/parallel converting section 427 is required to adapt to an input interface of the source driver 36.

The video signal 410 is input to a precharge determining section (421) and storage instrument (422).

Forced precharge is carried out regardless of the video signal 410 when a forced precharge signal 416 is input as shown at 411 in FIG. 41. Accordingly, the forced precharge may be inserted into the final stage of each precharge determining block so as to mask the determination. Thus, in FIG. 42, a precharge flag generating section 408 is constructed in the final stage. If precharge is carried out when the precharge determination signal 417 is at the “H” level, then the block can perform desired operations when composed only of logical OR's.

If the preceding row data is at a gray level lower than that of the current data, precharge is not carried out. Accordingly, the preceding row data is compared with the current row data. A circuit for this purpose includes the storage instrument 422 and a preceding row data comparing section 400. The storage instrument 422 has a capacity sufficient to hold an amount of data corresponding to the number of outputs of the source driver 36. The storage instrument 422 holds the preceding row data by retaining the video signal for one horizontal scan period. An output from the storage instrument 422 is compared with the video signal 410 to compare the preceding row with the current row. The comparison is then input to the precharge determining section. The comparison is output as 1 bit indicating whether or not to carry out precharge.

Further, precharge is not carried out on high gray level data that can be written using only current. Accordingly, the video signal 410 is referenced to determine whether or not the gray level is higher than that set by a precharge application gray level determination signal 429. Then, a signal is output indicating whether or not to carry out precharge.

Further, a determination is made based on the illumination rate. On the basis of calculated illumination rate data 420 and a illumination rate setting signal 418, a illumination rate determining section 409 outputs a signal indicating that the precharge is to be carried out if the illumination rate is higher than that determined by the illumination rate setting signal 418.

The precharge flag generating section 408 receives outputs from the preceding row data comparing section, precharge determining section, and illumination rate determining section as well as the forced precharge signal 416. When the precharge is to be carried out by the forced precharge signal 416, the precharge flag generating section 408 outputs a signal indicating that the precharge is to be carried out, to 417 regardless of the other signals. Otherwise, the precharge flag generating section 408 provides an output such that precharge is carried out only when all the outputs from the preceding row data comparing section, precharge determining section, and illumination rate determining section indicate the execution of the precharge.

Thus, the precharge flag 417 corresponding to the video signal 410 is output in association with the determination made in accordance with the flow shown in FIG. 41.

The serial/parallel converting section 427 is required to adapt to the input interface of the source driver 36 in FIG. 3. The serial/parallel converting section 427 may be omitted if video signals for the respective colors and the precharge outputs 417 (for the respective colors) are transferred in parallel (these signals are output directly to the source driver).

FIG. 2 illustrates an example in which the control IC 28 and the source driver 36 are composed of separate chips. However, the control IC 28 and the source driver 36 may be composed of the same integral chip. In this case, the configurations shown in FIGS. 41 and 42 are built into the source driver 36.

The output voltage value from the precharge voltage 24 can preferably be controlled using an electronic regulator. This is because the precharge voltage required to provide a predetermined current is determined on the basis of the voltage across an EL power supply line 64. In FIG. 12, when a current I2 is passed through the source signal line 60, the potential across the source signal line 60 is (the voltage across the EL power supply line 64)−V2 on the basis of the relationship between the drain current and drain/gate voltage of the transistor 62 (FIG. 12 (b)).

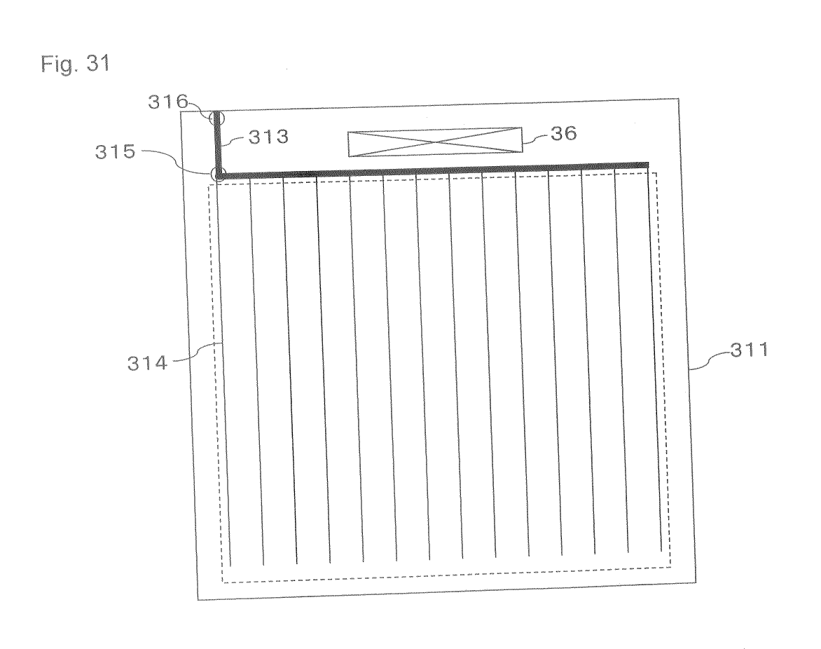

On the other hand, in the display panel shown in FIG. 31, power from the EL power supply line 64 is supplied to each pixel through wires 313 and 314. The maximum current flows through the wire 313 when all the pixels are displayed in white. The minimum current flows through the wire 313 when all the pixels are displayed in black. On this occasion, the wiring resistance of the wire 313 causes the potential at a point 315 to differ from that at a point 316 during white display. On the other hand, the potential at the point 315 is almost equal to that at the point 316 during black display. That is, the potential across the EL power supply line 64 during white display differs from that during black display owing to a decrease in the voltage across the EL power supply line 313. That is, even with the same current I2, the voltage across the source signal line 60 varies depending on the amount of decrease in the voltage across the EL power supply line 313. Thus, disadvantageously, unless the voltage value of the precharge power source 24 is varied depending on the amount of decrease in the voltage across the EL power supply line 313, the current flowing through the source signal line and thus the luminance vary. When the voltage across the EL power supply line 64 varies, the voltage applied to the source signal line 60 must be varied. The voltage may be varied using the illumination rate data for one frame. A high illumination rate increases the quantity of current flowing through the EL power supply line 313, thus increasing the amount of voltage drop. Accordingly, the electronic regulator is controlled so as to reduce the voltage value of the precharge power source 24. On the other hand, a low illumination rate reduces the amount of drop in the voltage across the EL power supply line 313. Thus, by using the electronic regulator to increase the voltage value of the precharge power source 24, it is possible to eliminate an uneven luminance caused by the wiring resistance of the EL power supply line 313.

On the other hand, with a large-sized panel, it is difficult to write a current up to a predetermined value. In particular, for lower gray levels, a voltage value must be provided for almost every gray level to improve write operations. Moreover, more precharge power sources 24 may be used to increase the number of voltage values. However, this requires a number of switches 131 corresponding to the number of voltages. In particular, a number of switches corresponding to the number of power sources are required for each source line and occupy a large area.

An N-bit precharge determination signal 55 is required for (2^{N}−1) power sources. An application determining section 39 for each source signal line requires a decode section that allow the (2^{N}−1) switches to be controlled in accordance with the N-bit signal. Thus, disadvantageously, the circuit scale of the decode section increases consistently with the value of N, resulting in an increased chip area.

Each source line converts digital data (gray level data) into an analog value (precharge voltage) and thus requires a digital-analog converting section. Accordingly, the circuit scale increases consistently with the number of output voltages.

Thus, as shown in FIG. 38, only one digital/analog converting section 381 is provided in a semiconductor circuit. The digital/analog converting section 381 converts serially transferred data into an analog voltage and then distributes the voltage to the source signal lines. To accomplish this, an output 382 from the digital/analog converting section is input to a distributing section and a hold section 383 to distribute and supply the analog voltage based on the gray level data to the source signal lines.

On the other hand, to output the current corresponding to the gray level, gray level data 386 is distributed to the source lines using a shift register and a latch section 384 so that the current output stage 23 in each source line can output the current corresponding to the gray level, as in the case of FIG. 2.

The current/voltage selecting section 385 is placed immediately before an output to the source signal line as a section that determines whether to output a current or a voltage. A precharge determination signal 380, the precharge voltage application determining section 56, and a precharge pulse 52 switch the current/voltage selecting section 385 to determine whether to output a current or to output a current after a voltage. The precharge voltage application determining section 56 determines whether or not to provide a period of voltage output. The precharge pulse 52 is used if voltage output is to be provided, to determine the period of voltage output.

Thus, provided that the digital/analog converting section 381 has a number of analog output stages corresponding to the number of gray levels, the voltage corresponding to the gray level can be output. During a period in which a certain row is selected (corresponding to a horizontal scan period), it is possible to use a voltage to change the source signal line current to a predetermined value and then use current output to correct a possible variation in current value resulting from a variation among the transistors for the respective pixels.

A time longer than the horizontal scan period is often required notably in a lower gray level part to change the source signal line current to the predetermined current value. However, the method of changing the current with voltage can complete the change in almost 1 μs and requires only a small amount of correction based on current. Consequently, the method of passing a current after voltage application has the advantage of allowing the current to change easily to the predetermined value within a horizontal scan period.

For example, in a driving semiconductor circuit that can display 256 gray levels, if the source signal line current can be sufficiently changed to the predetermined current value for the upper 128 gray levels using only current, voltages need to be output only for the lower 128 gray levels. Therefore, the digital/analog converting section 381 has only to have a resolution of 7 bits and to be able to output 128 types of voltages. The precharge determination signal 380 is input so that voltage output is not provided when the gray level data 386 is one of the upper 128 gray levels. This allows the current/voltage selecting section 385 to always output only current. An output signal from the digital/analog converting section 381 is not output to the exterior of the driving semiconductor circuit and may thus have an arbitrary value. The simplest method is to neglect the upper 1 bit of the input gray level data 386, while outputting the voltage corresponding to the value for the lower 7 bits.

If the gray level data 386 is between gray levels 0 and 127, a period is provided in which the precharge determination signal 380 controls the current/voltage selecting section 385 to output an analog voltage from the digital/analog converting section 381 to the exterior of the driving semiconductor circuit.

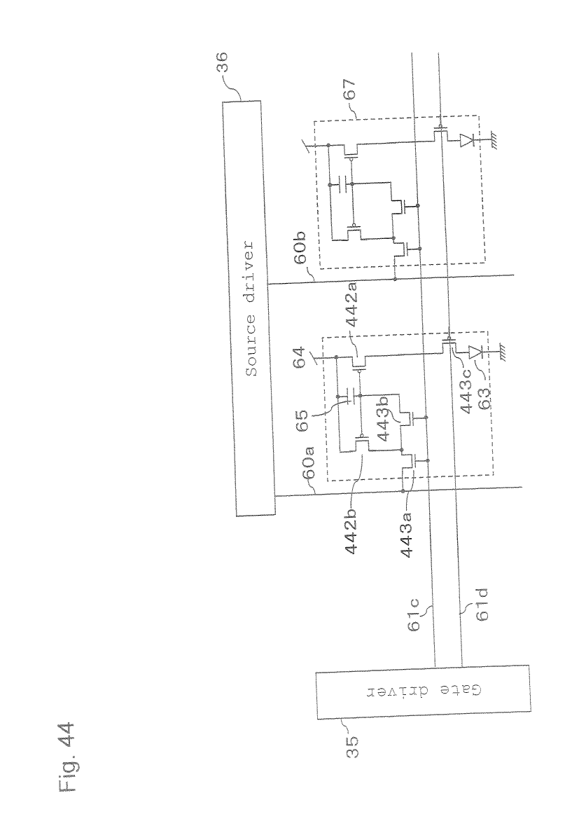

This enables the formation of a circuit in which the digital/analog converting section has a reduced resolution. Further, for a pixel configuration in a current copier using a p-type transistor as shown in FIG. 6 or in a current mirror such as the one shown in FIG. 44, the voltage across the source signal line is highest during black display and decreases as the black display changes to white display. A variation in voltage from black to half tone is smaller than that from back to white. Therefore, if voltage is output only for gray levels 0 to 127, the dynamic range of the output voltage can be reduced.

The source driver IC 36 according to the present invention outputs a current after voltage application to correct a possible variation among the driving transistors. Accordingly, the output voltage value has only to be sufficient to substantially achieve the target current value and need not be very accurate. Thus, since the value for an output deviation in the voltage output from the digital/analog converting section 381 may be large compared to that in a liquid display panel, the circuit scale may correspondingly be reduced.

In general, the easiness with which the current varies depends on the size of the panel using the source driver IC (floating capacity of the source line) or the number of pixels in a scanning direction (horizontal scan period).

The use of the driver IC configured as described above has the following advantage. When the precharge pulse 52 is input from the exterior of the source driver IC, the precharge determination signal 380 and the gray level data 386 are external signal inputs as shown in FIG. 2. Accordingly, depending on the panel, it is possible to arbitrarily set a gray level range in which gray level display is provided utilizing only current or both voltage and current. The setting of a gray level range can be controlled by a control IC externally formed as shown in FIG. 2. Further, if a command input can vary the operation of the control IC, it can be used for the adjustment. The control IC may be integrated with the source driver IC on the same chip as seen in some liquid crystal source drivers, rather than being constructed outside the source driver IC as shown in FIG. 2. In this case, the integrated ICs may be adapted to provide a command input to adjust the gray level range.

The above invention uses the precharge voltage input to solve the problem that in a lower gray level part, only a small current flows through the source signal line to preclude the current from changing to the predetermined value within the predetermined time (horizontal scan period), so that the pixel in the row following the one for white display exhibits a luminance higher than the predetermined one.

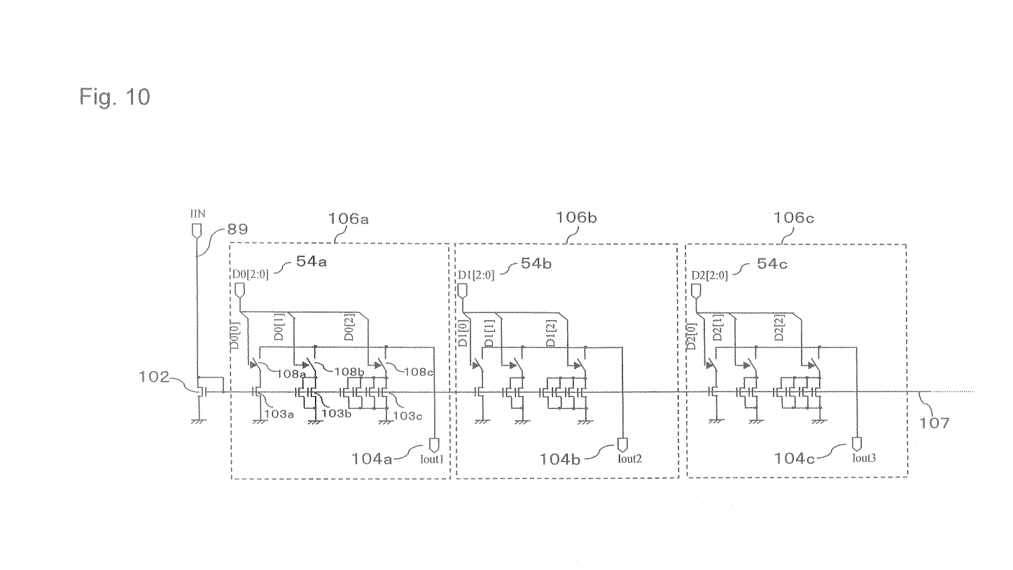

FIG. 8 is a diagram showing a reference current generating circuit. A reference voltage defines a current value (reference voltage 89) per gray level in the configuration of the output stage shown in FIG. 10.

In FIG. 8, the reference voltage 89 is determined by the potential at a node 89 and the resistance value of a resistance element 81.

Moreover, the potential at the node 80 can be varied by a voltage adjusting section 85 on the basis of the control data 88.

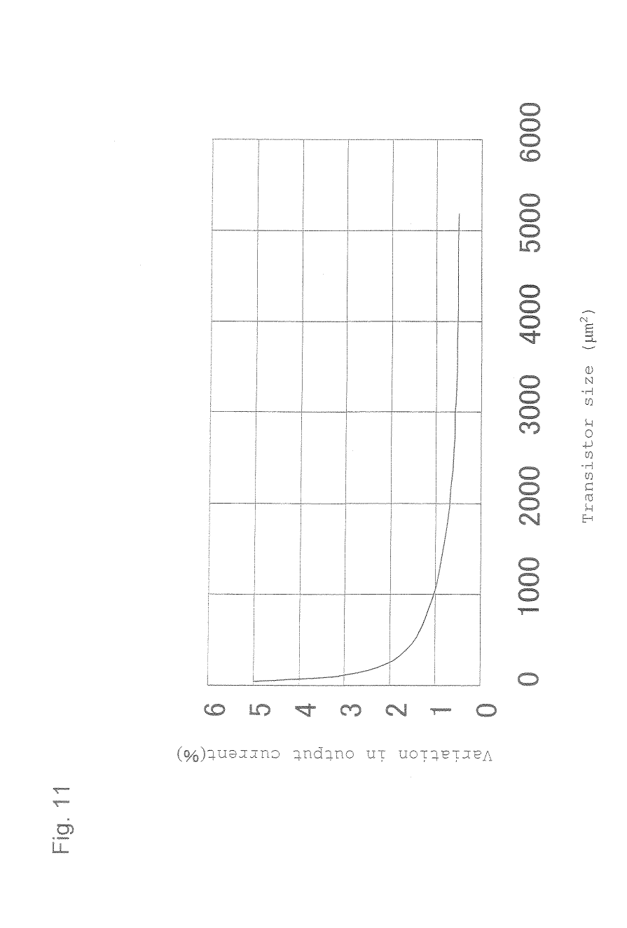

The output current may vary among the terminals depending on the transistor size of the gray level display current source 103, which provides current output. FIG. 11 shows the relationship between the transistor size (channel area) and the variation in output current. In view of a variation in reference voltage, the variations in output current between intra-chip adjacent terminals and between inter-chip adjacent terminals must be reduced to at most 2.5%. Accordingly, the variation in output current (variation in current at the output stage) in FIG. 11 is desirably reduced to at most 2.5%. The transistor size of the gray level display current source 103 should be at least 160 square microns.

In a display panel using an organic light emitting element, a current flows only through lighted pixels and not through unlighted pixels. Consequently, the maximum current flows when white is displayed all over the screen. The minimum current flows when black is displayed all over the screen.

A power supply circuit supplying a current to the display panel must have a capacity sufficient to provide the maximum current. However, there are very few opportunities to provide screen display that requires the maximum current. It is very wasteful to provide a power supply circuit with a large capacity for the maximum current, which has very few opportunities to be generated. Further, the maximum current must be minimized to reduce power consumption.

Thus, to reduce the maximum current, the luminance of each pixel is reduced by about 2 to 3% if white display pixels account for at least 60% of all the pixels. This reduces the maximum current by 2 to 3% to reduce peak power consumption.

This method can be implemented by varying the value of the reference current 89 by 2 to 3%, which is generated by the referenced current generating section 26 that determines the current per gray level.

To accomplish this, the reference current 89 is varied on the basis of the value for the control data 88 and the voltage at the node 80 depending on a display pattern.

To vary the value for the control data depending on the display pattern, it is necessary to perform control such that the display pattern is determined to vary the control data depending on the determination. Thus, the control IC 28 normally makes the determination.

Thus, the number of signal lines leading from the control IC 28 to the source driver IC 38 is equal to the total number of video signal lines and control data lines for the electronic regulator. This increases the I/O terminals of both ICs. If 6 bits are used to control the electronic regulator and 18 bits (6 bits per color) are used for the video signal lines, then 24 terminals are required.

Moreover, since the precharge power source 24 is built into the circuit, a register is present which sets an output voltage for the precharge power source 24. The precharge voltage is determined by the TFT characteristic of the display panel and a threshold voltage for the organic light emitting element. Accordingly, different voltage values must be set for the respective panels. The setting must be made at least once from the exterior of the circuit. It is inefficient to provide an external input terminal for the single setting.

A reduction in the number of I/O signal lines is effective in reducing the area of the chip and simplifying the routing of external wiring.

Thus, the present invention connects data lines and address lines to be connected between the control IC and the source driver IC so that a video signal and various setting signals can be serially transferred at high speed. This reduces the number of signal lines. For video signals, the three primary colors, red, green, and blue are serially transferred.

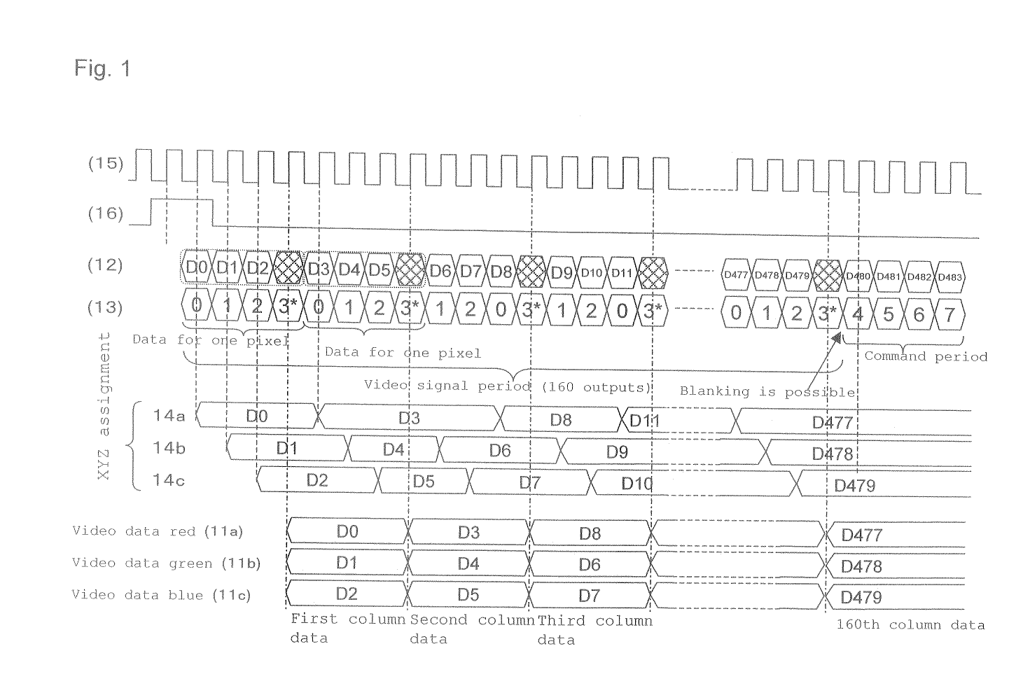

FIG. 1 shows a timing chart for the data and address lines. After a start pulse 16 is input, pixel data for one row is transferred through a data line 12. Subsequently, control data, for example, set values for the electronic regulator, are transferred. An address 13 is transferred in synchronism with the data flowing through the data line 12 in order to determine what data is flowing through the data line 12. In this example, when the data on the address line 13 has a value of 0, 1, or 2, it indicates red data, green data, or blue data, respectively. A value of 4 or more indicates command data.

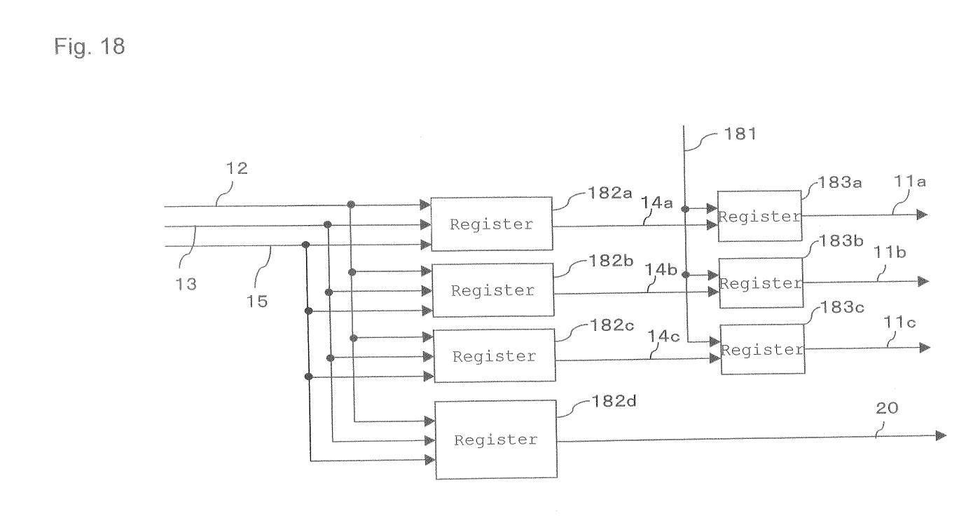

FIG. 18 shows a block diagram of the distributing section 27, which distributes the serially transferred data. The distributing section is composed of two registers or latch circuits for video signals or of one register or latch circuit for other command data.

A first register or latch circuit 182 loads only required data. For a video signal 11, timings for three color signals are adjusted so that the next shift register section 21 can provide a long carry pulse. This allows such video data 11 as shown in FIG. 1 to be extracted. The shift register section 21 distributes the data to each output.

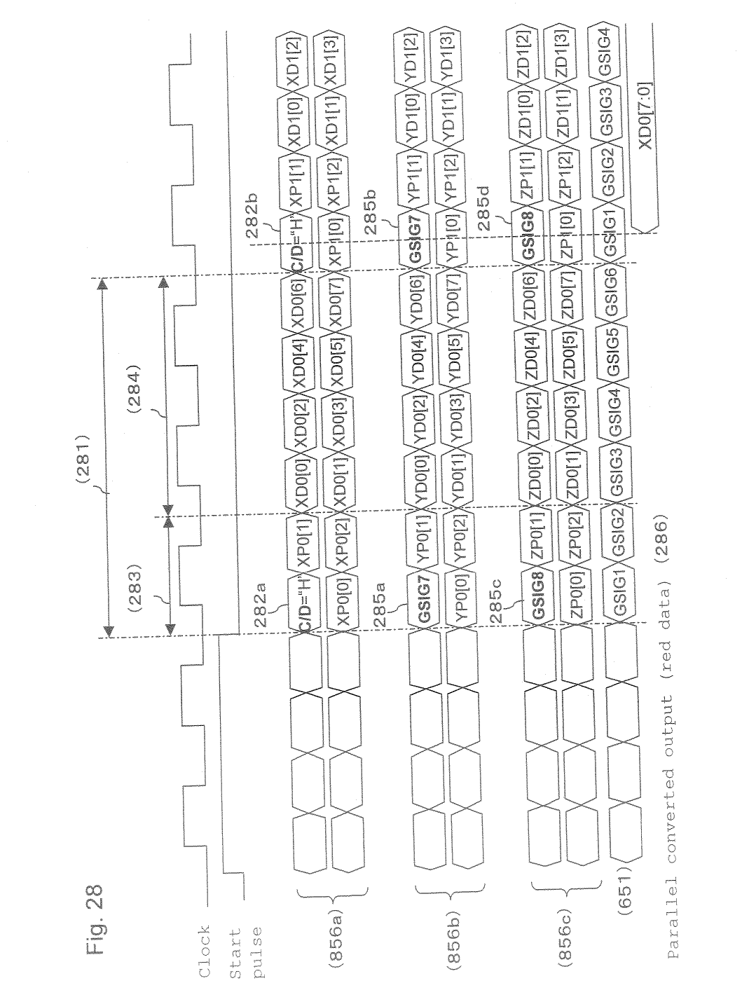

FIGS. 28 to 30 show a second example in which the number of signal lines is reduced.

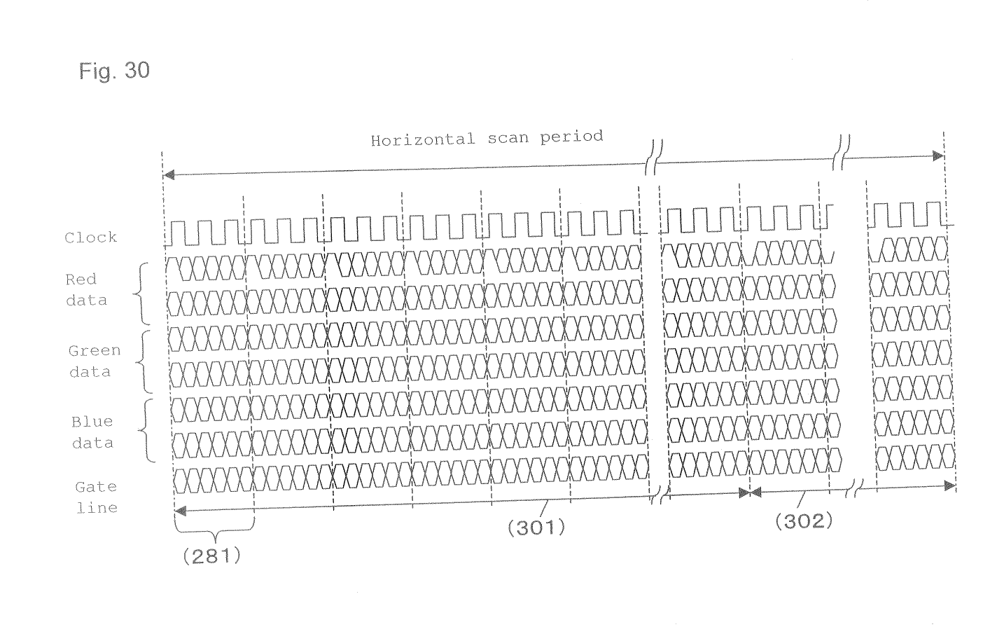

In this example, signal lines are provided for the respective colors so that data for the respective colors are serially transferred. The video signals corresponding to respective dots are sequentially transferred. Command signals are sent during blanking periods. FIG. 30 shows the relationship between transfers during one horizontal scan period. A data command flag 282 is used to distinguish a video signal transfer period 301 from a command transfer period 302. One leading data of one-pixel data 281 is assigned to the data command flag 282 (in this example, one of the red data). A high level indicates that the data is a video signal. A low level indicates that the data is a command. The data command flag 282 may be located at an arbitrary position in the one-pixel data 281. However, the data command flag 282 located at the leading end enables an early determination as to whether or not input data is a command. This facilitates processing.

In this example, the one-pixel data 281 consists of six data transfers. An 11-bit signal composed of 3 bits of precharge determination signal 55 and 8 bits of video signal is transferred at six-times speed using two signal lines. FIG. 28 shows this in detail. First, a group 283 of precharge determination signals 55 and then a video signal group 284 are transmitted. The order of transfers is not limited. The precharge determination signals 55 and the video signal group 284 are preferably transferred after a blanking period corresponding to 1-bit data in order to provide the same circuit configuration for red data, green data, and blue data. The video signals are serially transferred and thus input to the shift register after a parallel conversion by a serial/parallel converting section. An output timing for the red data after a parallel conversion is shown at 286.

A period denoted by 285 may be blank data. In this example, the gate signal line by serial transmission is input to the source driver, in which the data are subjected to a parallel conversion. Then, the corresponding signal is supplied to a gate driver. Thus, the signal on the gate signal line is placed in the period 285 (in a display apparatus using an organic light emitting element, the gate driver must include a pixel selecting gate driver with which a predetermined current is passed through a predetermined pixel and an EL illumination gate driver that allows the continuous flow of a current stored in the pixel. Each of the gate drives requires a clock terminal, a start pulse terminal, a scan direction control terminal, and an output enable terminal, that is, eight signal lines in total. By sending signals in six sections on one gate signal line and in two sections 285, it is possible to control the waveform of the gate driver using one pixel timing. This enables more precise control to be performed. To accomplish this, 285 sections are required in addition to those for gate signal line serial transfers).

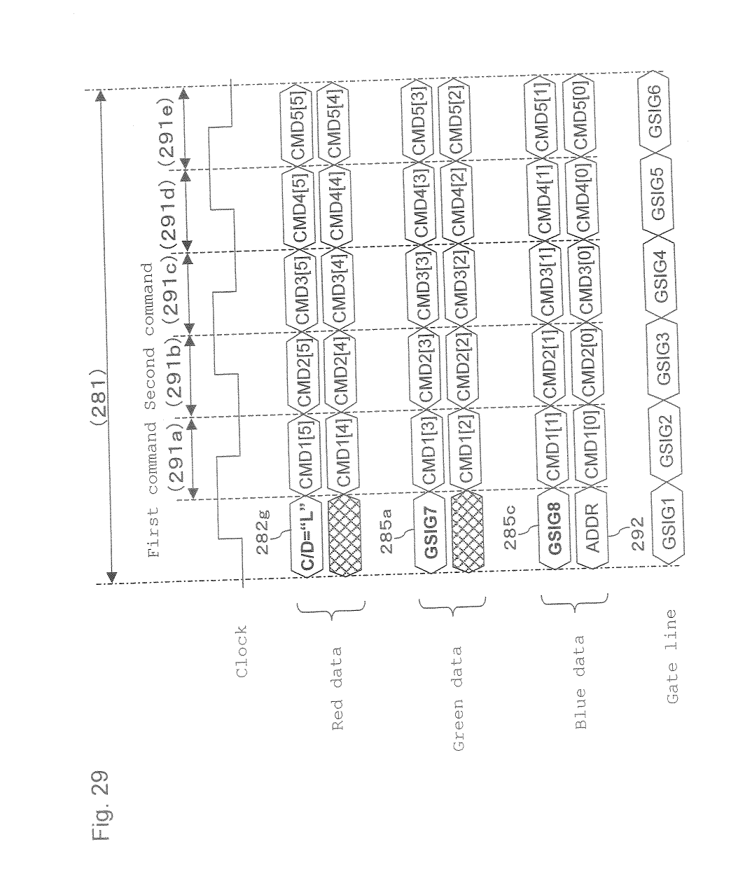

On the other hand, FIG. 29 shows an example of data transfers during a command transmission. About 6 bits per command are often sufficient. Accordingly, in this example, red, green, and blue data as a whole are considered to be a 6-bit signal. Five data following a data command identification signal 282 are loaded as a command. Since the gate driver must operate even during blanking periods, signals for the gate driver are input in the sections on the gate line and in the sections at 285 regardless of the value for the flag 282.

There are free data for 3 bits in addition to sections in which those of the signals using the same timings as that for the data command flag 292 which are intended for the gate driver are input. This part may be assigned to a command with a small bit length but is used as a command address when at least five commands must be set. FIG. 29 shows, as an example, a source driver that accepts at most 10 commands and in which a 1-bit command address shown at 292 is provided. An updated command register is varied depending on the values 282 and 292. Since all the data can be transferred during a single transmission, the serial/parallel converting section is not required. Internal register inputs (for example, an electronic regulator input that determines the precharge power source 24) may be directly updated.

The input interface shown in FIGS. 28 to 30 transmits the video signal and the precharge determination signal in a multiplexed manner and inputs commands during video signal non-transmission periods. If 10 commands are used and the command bit length is 6 bits, this configuration enables the number of signal lines to be reduced to 6 compared to 93 input lines used in the prior art.

The number of signal lines and transfer rate can be arbitrarily set. The number of signal lines can be set at various values ranging from a minimum value of 1 bit for each color to a maximum value of the number of signal bits required for one pixel in each color/2. A decrease in the number of signal lines increases clock frequency to make it difficult to route external wiring. Accordingly, in a practical sense, the number of signal lines preferably corresponds to a data transfer rate of at most 100 MHz. To reduce EMI, the present invention allows only a clock to have a half frequency to load data at the opposite edges.

The input signal need not be a CMOS level signal but may be sent by differential transmission. The differential transmission is generally effective in reducing signal line amplitude and thus EMI.

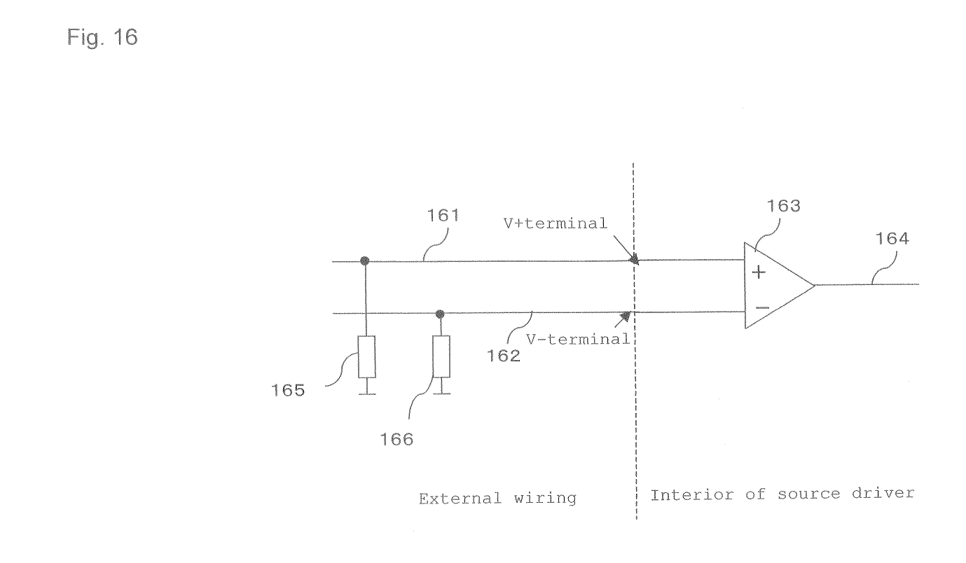

For a clock and data lines through which data is transferred at high speed, such an input form as shown in FIG. 16 may be used so that transmissions can be carried out using an RSDS form in which a logic signal 164 is obtained from the difference between two input signal lines (161 and 162). Reference numerals 165 and 166 denote resistance elements that convert a current-transmitted signal into a voltage value. The values for the resistance elements are determined in accordance with specifications for a transmitter. These input terminals are incorporated into all the signal lines in FIGS. 1 and 28 to allow the differential transmission form to be used. As a result, a driver with reduced EMI has been provided.

Thus, the source driver IC 36 with a reduced number of input signal lines has been provided.

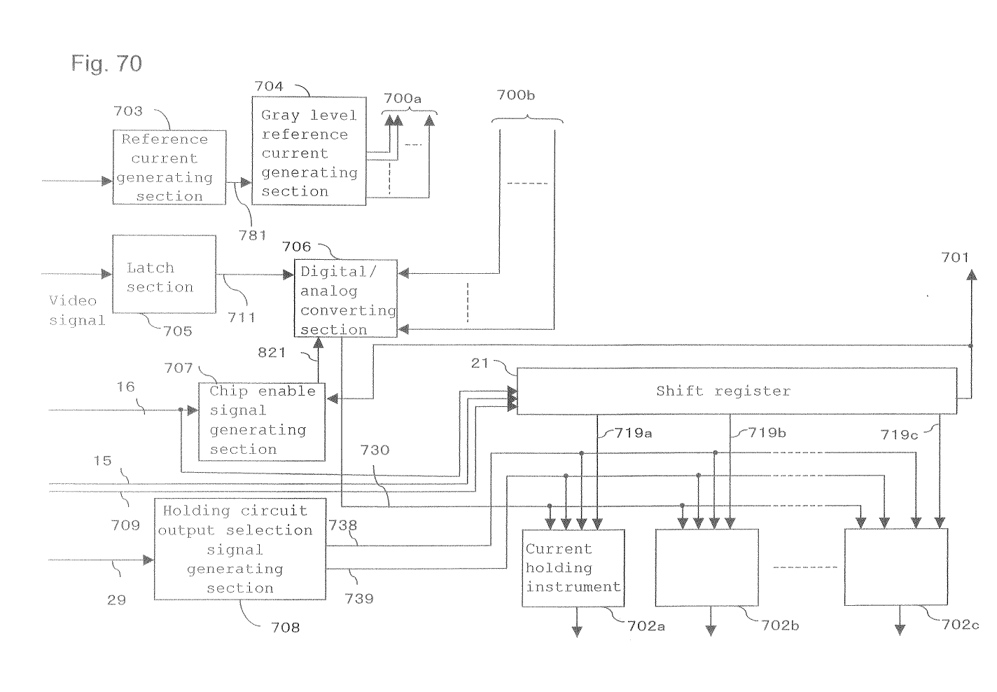

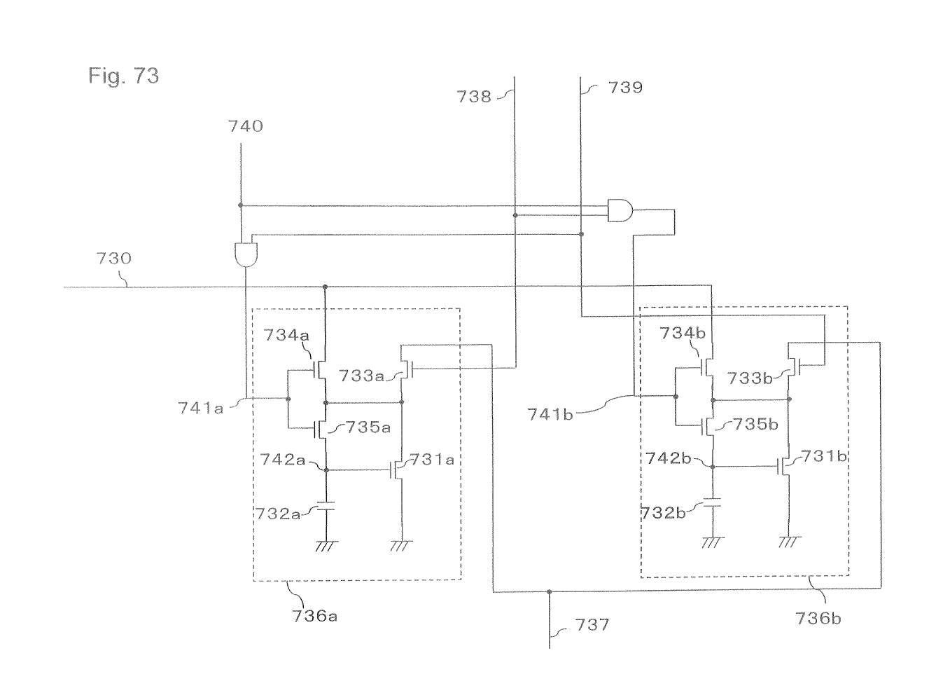

FIG. 70 shows the general configuration of a driver IC in which a current output stage is formed of a current copier arrangement such as the one shown at 736 in FIG. 73.

In a current copier circuit, an input current is passed to a driving transistor 731 via switches 734 and 735. The voltage at a node 742 is determined by the quantity of current flowing to the driving transistor 731. A storage capacity 732 is provided to store charges to hold a voltage. After an input current is memorized, the switches 734 and 735 are set in a nonconductive state to hold the input current. To output a current, the transistor 733 is set in a conductive state to cause the current corresponding to the quantity of charges to flow to the driving transistor 731 for output, the charges being stored in the storage capacity 732. Since the input current is memorized and output using the drain current/gate voltage characteristic of the same driving transistor 731, the circuit has the advantage of being able to output the same current as the input one regardless of characteristic variation of the transistor.

Moreover, the current copier circuit has a memory function in order to memorize the input current in the storage capacity 732 before output. Thus, the current copier circuit can be provided with the function of a latch section for allowing the input data distributed to output terminals to be output at the same time. Consequently, in the configuration shown in FIG. 70, serially transferred video signals can be distributed to each output without using any latch section.

The current copier circuit can hold an analog current. Accordingly, a digital/analog converting circuit 706 converts a video signal into a gray level current signal 730 that is the analog current corresponding to the gray level and then distributes the gray level current signal 730 to each output in accordance with an output signal from the shift register 21. The current copier circuit is formed in current holding instrument 702 for holding the distributed current.

The current copier circuit performs the operation of holding an input current and then outputting the current corresponding to the input current as previously described. Consequently, the current copier circuit cannot provide current output while the input current is memorized. Further, while current output is being provided, the gray level current signal 730 cannot be loaded.

In connection with current output to the display section, it disadvantageously takes for a pixel circuit a long time to change the current to a predetermined value. Accordingly, during a horizontal scan period, current is desirably continuously output for as long a period as possible. Thus, preferably, current is always output by the source driver IC.

Thus, in order that the output stage of the current copier circuit arrangement may continuously output current, two current copier circuits are provided at the same output terminal so that while the gray level current signal 730 is memorized in one of the current copier circuits, the other circuit outputs current to the exterior of the driver IC.

FIG. 73 shows circuits in the output stage. Two holding circuits 736a and 736b have a current copier configuration. A select signal 738 determines which of the two holding circuits is used for outputs or to store the gray level current signal 730. The select signal 738 changes after every horizontal scan period. The current output corresponding to a video signal can be provided by changing the holding circuit 736 after every horizontal scan period. The holding circuit used for outputs can be determined by varying the state of the current output transistor 733 in accordance with the select signal 738.

Both the select signal 738 and the inverted output 739 of the select signal are set to the low level in order to preclude both holding circuits 736 from providing output. The signals 738 and 739 need not have opposite phases but not both of them must be set to the high level. Alternatively, similar operations may be performed by always setting the signals 738 and 739 so that they have opposite phases, separately providing an enable signal, and inputting the logical AND of the signals 738 and 739 to a signal controlling the switch 733.

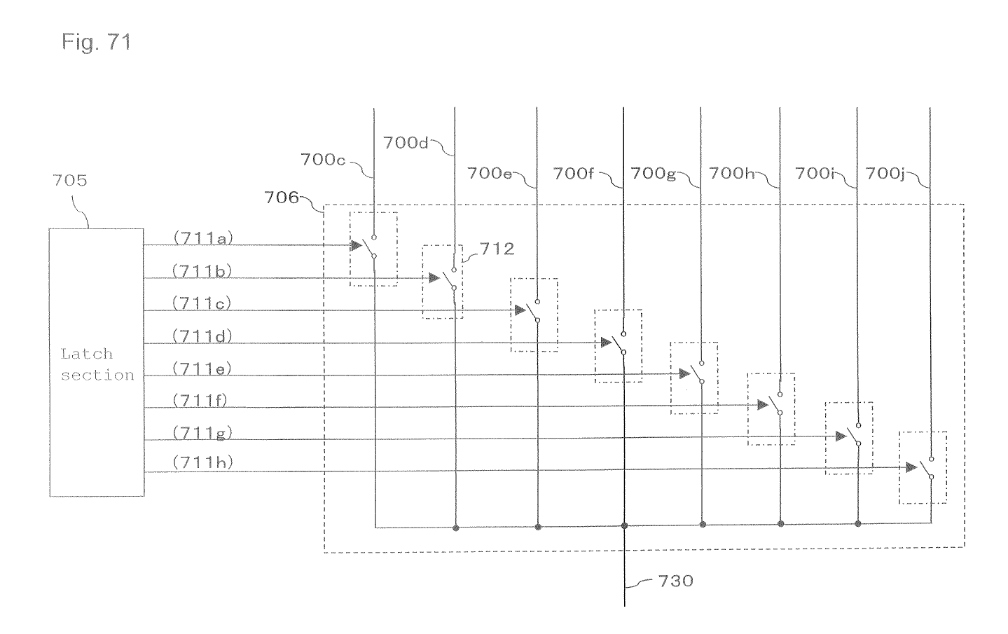

The shift register 21 and the current holding instrument 702 enables the gray level current signal 730 to be distributed to each output. Now, description will be given of a circuit that generates a gray level current signal 730. The digital/analog converting section 706 is provided to convert a video signal that is a logic signal into a gray level current signal 730 that is an analog signal, in order to output the current corresponding to the video signal. FIG. 71 shows an example of a circuit in the digital/analog converting section 706.

The currents corresponding to the bits of a video signal are input from the exterior of the circuit. For the corresponding currents (gray level reference currents 1 to 8), a switch 712 is controlled in association with the current values in accordance with a gray level signal 711. Then, the gray level current signal 730 corresponding to the gray level signal 711 is output. If the gray level signals 1 (711a) to 8 (711h) are sequentially associated with the respective bits starting from the lowermost bit and going to the uppermost bit, the current value is set and input so that double the gray level reference current 1 (700c) is equal to the gray level reference current 2 (700d) and that in general, double the gray level reference current n is equal to the gray level reference current (n+1) (here, n is an integer equal to and larger than 1 and smaller than the number of bits).

Thus, the sum of the gray level reference currents 700 for which the switch 712 is in the conductive state is output as the gray level current signal 730.

Now, description will be given of a method of creating and inputting a gray level reference current 700 to the digital/analog converting section 706.

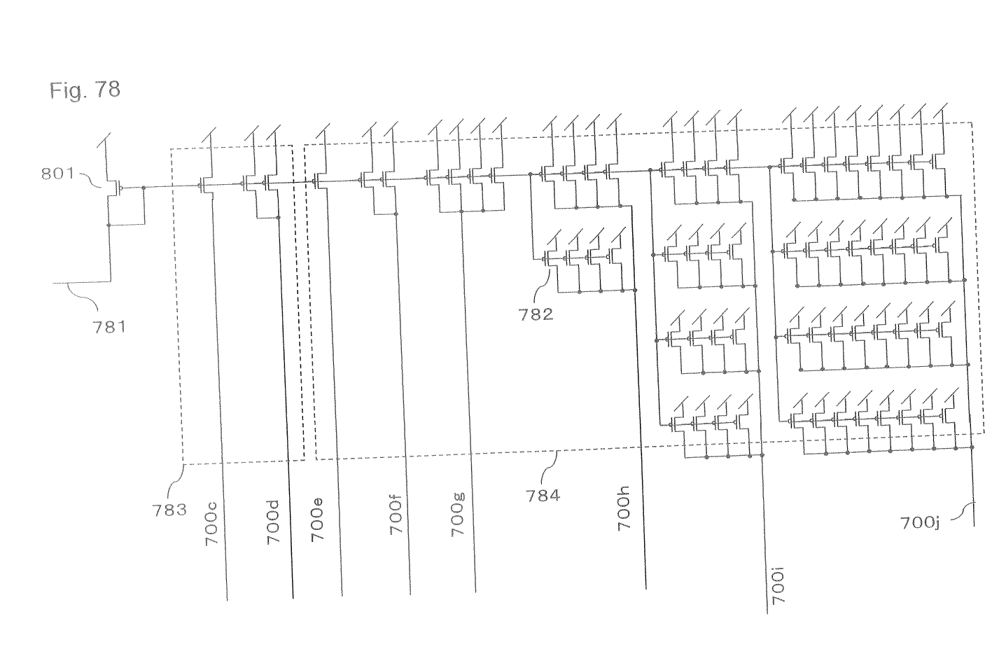

As shown in FIG. 78, a gray level reference current generating section 704 generates a gray level reference current 700. On the basis of a reference current 781 that sets the quantity of current per gray level, the gray level reference current 700 corresponding to the bits of a video signal is output using a current mirror configuration or the like. Here, 8-bit output is used, and thus eight outputs of gray level reference currents 700 are present. Since it is necessary to precisely output a current characterized in that (current value of a gray level reference current n)×2=(current value of a gray level reference current (n+1)), the output current is preferably varied on the basis of the number of transistors 782 for mirroring. The method exhibits a high gradation characteristic but is disadvantageous in that the circuit has a large area. On the other hand, one transistor 782 generating each gray level reference current 700 is provided for the reference current so that the gray level reference current can be varied from 1 to 8 on the basis of the channel width. However, since the currents do not coincide precisely with the channel width, the channel width must be varied depending on the process on the basis of simulations. Thus, this method may degrade the gradation characteristic compared to the method of arranging a number of reference currents corresponding to the number of bits. Thus, as shown in FIG. 78, the gray level reference currents are grouped into a lower gray level part and a higher gray level part. Between the low gray level part and the high gray level part, the current value is varied on the basis of the channel width. Within lower gray level part or the high gray level part, the current is varied on the basis of the number of transistors.

In FIG. 78, the lower gray level part corresponds to the lower 2 bits, while the upper gray level part corresponds to the upper 6 bits. The transistor enclosed by the dotted line shown at 783 is formed with a channel width one-fourths (this value may vary depending on the process; at least −10% and less than +50%) of that of the transistor enclosed by the dotted line shown at 784. This makes it possible to provide a gray level reference current generating section 704 that can maintain a high gradation characteristic and which has a small circuit scale.

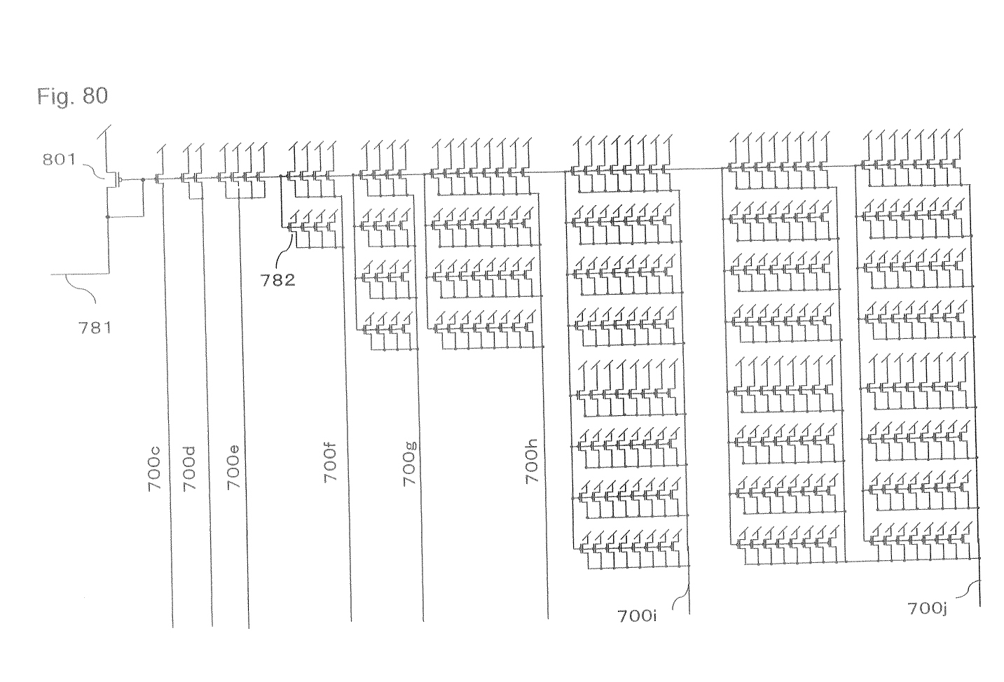

Since the driver IC is composed of one circuit, the current may be varied on the basis of the number of transistors as shown in FIG. 80, in order to improve the gradation characteristic (the percentage of the entire area taken up by the area of the circuit is at most 10%).

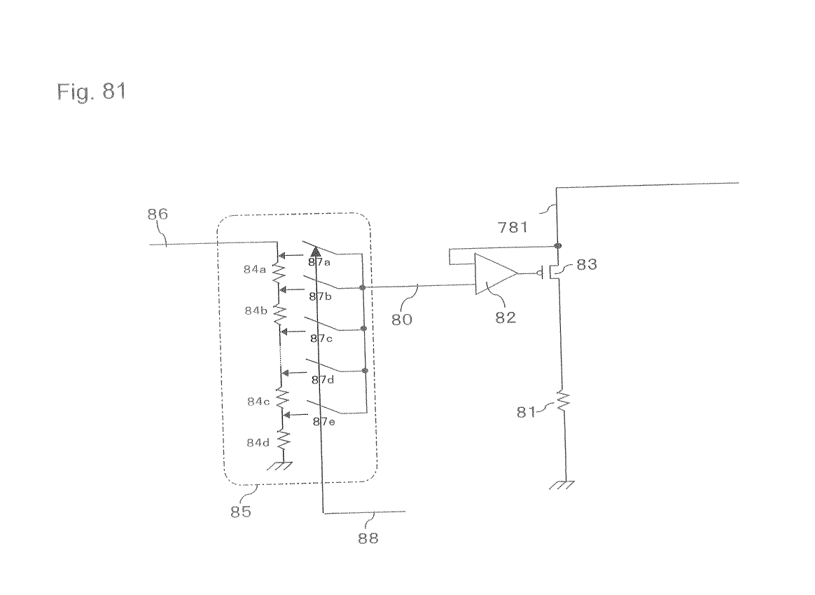

The reference current 781 can be realized by using a resistor and an operational amplifier to construct a constant current source as shown in FIG. 81. The current value of the reference current 781 can also be varied using the control data 88. Controlling the reference current 781 is useful in reducing power consumption, preventing seizure, and improving contrast.

The gray level reference current 700 thus formed may be input to the digital/analog converting section 706. However, if the gray level reference current 700 is connected directly to the digital/analog converting section 706, when a plurality of source driver ICs 36 are connected together, it is difficult to supply the gray level reference current 700 to all the chips within at most 1% of difference.

When a reference current generating section 703 and a gray level reference current generating section 704 are provided on each chip, the gray level reference current 700 undergoes the root mean square of a variation among the reference current generating sections 703, shown in FIG. 81, and a variation among the current mirrors, shown in FIG. 78 or 80. Consequently, the current value of a certain gray level may vary depending on the chips. As a result, uneven luminance may occur on each chip. It is possible to reduce a variation resulting from a deviation from the mirror ratio of the current mirrors by increasing the size of the transistors 782 and 801. However, a channel size of at least 10,000 square microns is required to reduce the variation to at most 1%.

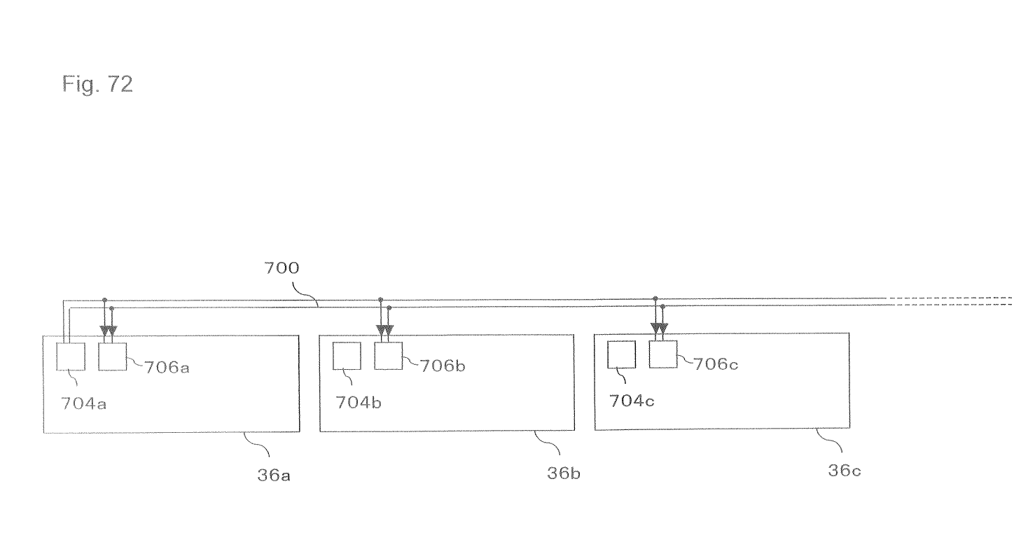

To supply each small-sized chip with the gray level reference current 700 without causing any variation, one reference current generating section 703 and one gray level reference current generating section 704 are used for one display section to generate and distribute a gray level reference current 700 to the chips. This concept is shown in FIG. 72.

Each chip is supplied with a current without causing any variation by providing all the chips including 36a, with a gray level reference current 704 generated by the source driver 36a. Here, it is necessary to prevent the gray level reference current 700 from being simultaneously supplied to at least two source driver ICs 36. In contrast to the voltage, when the current is connected to a plurality of drivers, it is separated into pieces, so that each driver IC has a reduced gray level reference current value. Thus, to prevent a plurality of driver ICs 36 from simultaneously loading the gray level reference current 700, the switch 712 of the digital/analog converting section 706 is utilized to set, when one of the ICs is generating a gray level current signal 730 corresponding to a video signal, all the switches 712 in the other ICs in the nonconductive state.

The gray level current signal 730 is required when the current holding instrument 702 is supplied with current and when a signal requiring that one of the outputs from the shift registers 21 be loaded is being provided. That is, the gray level current signal 730 is required after the start pulse 16 is input and before a carry output 701 provides a pulse to the next cascaded IC 36.

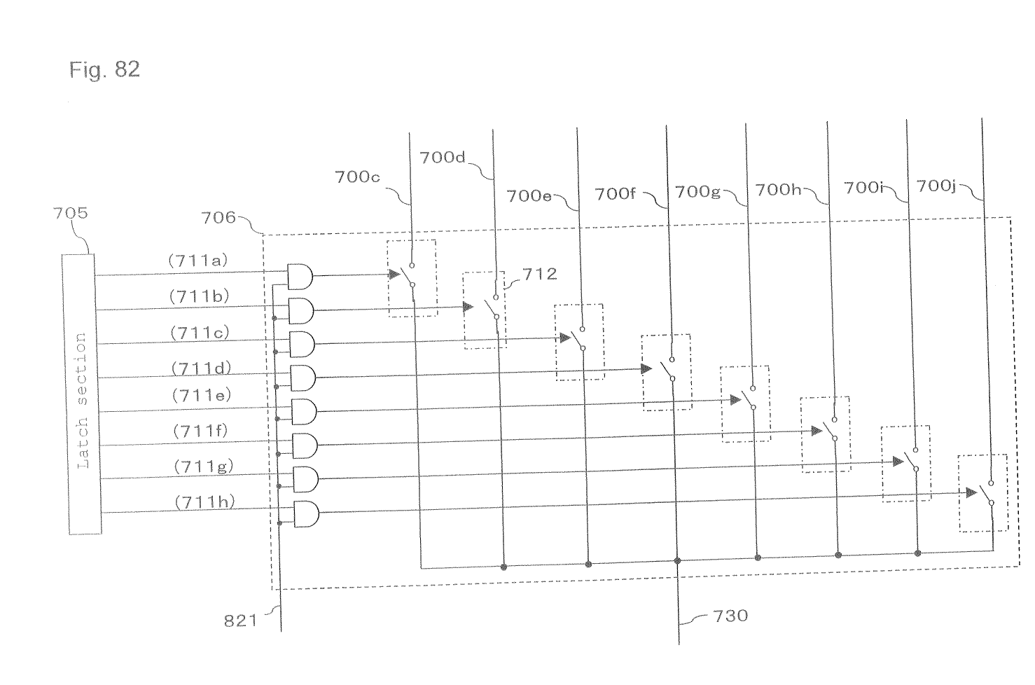

Thus, the switch 712 of the digital/analog converting section 706 is always in the nonconductive state regardless of the gray level signal 711 except while the shift register 21 is providing output. To accomplish this, a chip enable signal generating section 707 is provided so that the switch 712 is always in the nonconductive state except during a shift register operation. The chip enable signal generating section 707 outputs a pulse to permit a video signal to be converted into an analog current only after the start pulse 16 is input and before the carry output 701 is provided. Exactly speaking, this corresponds to a period when a shift register output 719 is provided within the same chip. The relationship between the start pulse 16 and the shift register output 719 and between the carry output 701 and the shift register output 719 may be varied by the relationship between input data and the start pulse 16 or the configuration 21 of the shift register. Accordingly, the period is adjusted on the basis of the start pulse 16 and the carry output 701 to output an enable signal 821. FIG. 82 shows a circuit diagram of the digital/analog converting section 706 corresponding to the enable signal. The chip enable signal 821 is at the high level after the start pulse 16 is input and before the carry output 710 is provided. The gray level reference current 700 is output to the gray level current signal 730 in accordance with the gray level signal 711. During the other periods, the chip enable signal 821 is at the low level. Consequently, the switch 12 is always in the nonconductive state, with no current supplied.

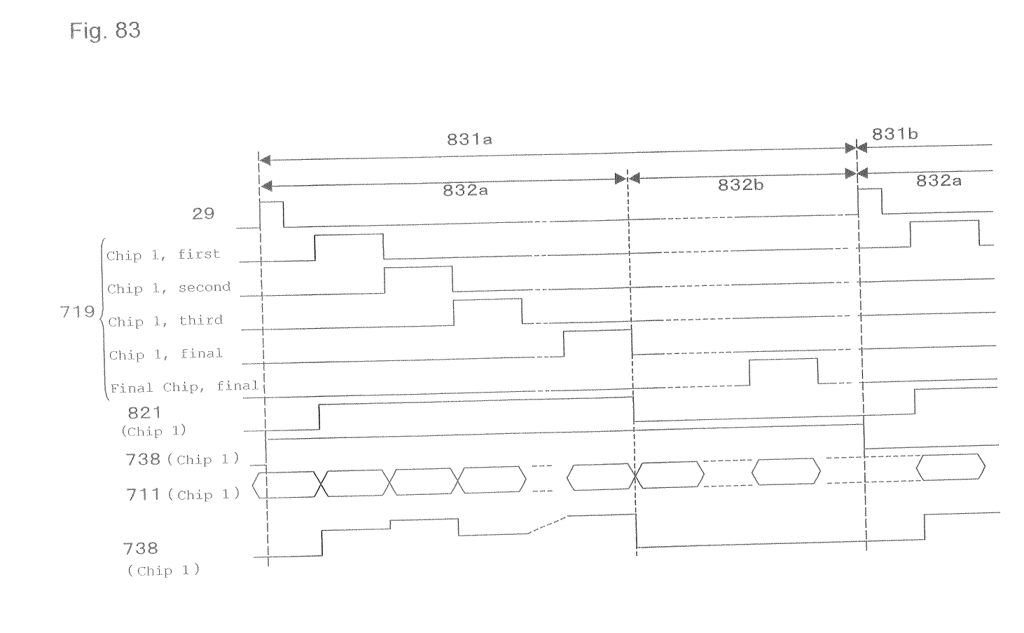

FIG. 83 shows a timing chart of the chip enable signal 821, select signal 738, gray level current signal 738, and gray level signal 711 for a certain driver IC (chip 1) during one horizontal scan period.

The select signal 738 is varied by the timing pulse 29 after every horizontal scan period to determine which of the two holding circuits 736, provided for one output, memorizes the gray level current signal 738 with the other outputting the memorized current. During a period 831a, the holding circuit A (736a) outputs a current, whereas the holding circuit B (736b) memorizes the gray level current signal 730.

The gray level current signal 730 is sequentially memorized in each output. A shift register output 719 determines the output in which the particular gray level current signal 730 is stored. Moreover, the wiring is configured so that the reference current can be distributed among a plurality of driver ICs. Accordingly, to prevent the current from being separated from one another, the chip enable signal 821 operates the digital/analog converting section 706 to allow the flow of the gray level current signal 738 only while the shift register is in operation. The chip enable signal 821 for the chip 1 is at the high level only during a period 832a when the shift register operates in the chip 1, thus allowing the flow of the gray level current signal 738. During a period 832b (the shift registers in all the chips other than the chip 1 are in operation), the chip enable signal 821 is at the low level, thus precluding the flow of the gray level current signal 738. Thus, since the gray level reference current signal 700 is always input to one driver IC, it can be diverted to a plurality of driver ICs as shown in FIG. 72. Compared to the distribution based on current mirrors or the like, the distribution based on temporal divisions enables the precise supply of the same current.

With the method of providing each output with a current copier so that the gray level current can be distributed to the outputs, the same current as that memorized can be output regardless of a variation in characteristics among the driving transistors 731. This makes the outputs unlikely to vary. However, a phenomenon called “punch-through” may vary the output currents.

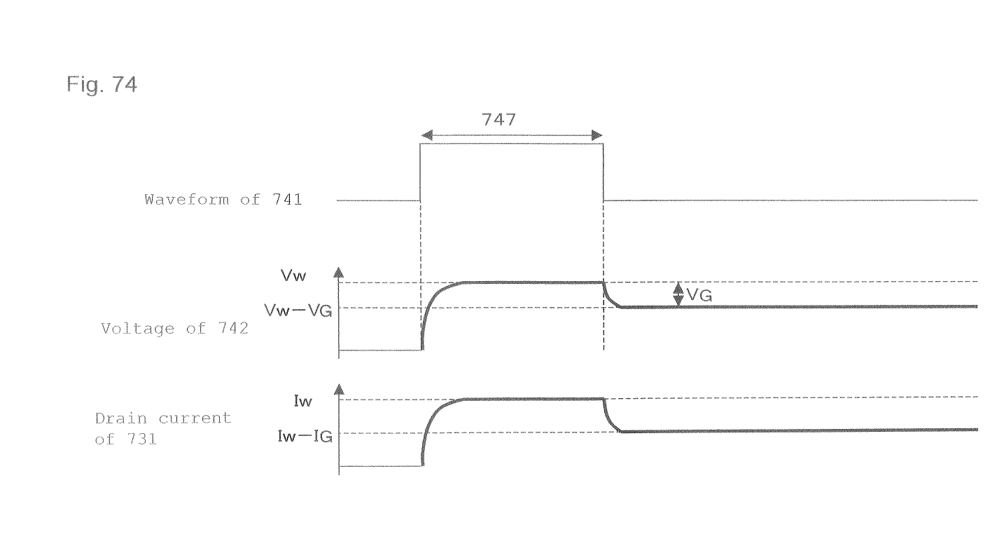

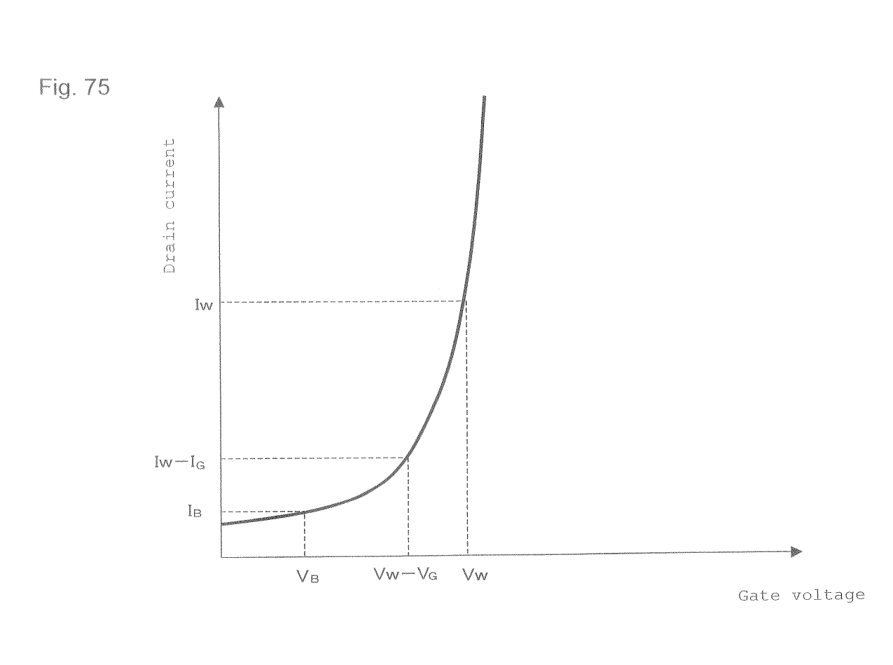

In the holding circuit in FIG. 73, when the signal on the gate signal line 741 is set at the high level, the gray level current is memorized. As shown in FIG. 74, the drain current from the driving transistor 731 is a white level current (referred to as Iw in the specification) if, for example, a white level current is memorized. In this case, the voltage at the node 742 is Vw on the basis of the current/voltage characteristic (FIG. 75) of the driving transistor 731 (period 747).

The period 747 is over, and the holding circuit 736 ends memorizing the current. Consequently, the gate signal line 741 changes to the low level. On this occasion, a drop in the voltage across the gate signal line 741 reduces the voltage at the node 742 by a value VG via the gate capacity of the transistor 735a through capacitive coupling. This also reduces the drain current from the driving transistor 731 from Iw to IG.

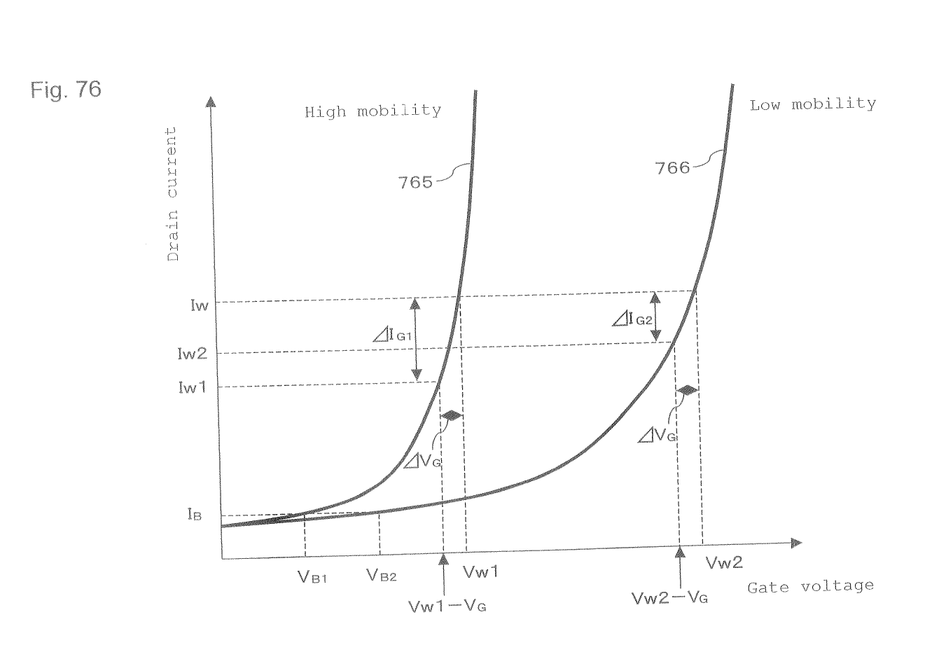

This “punch-through” may vary the output current among the terminals. For example, it is assumed that the driving transistor 731 has such current/voltage characteristics as shown at 765 and 766 in FIG. 76. When the voltage at the node 742, that is, the gate voltage of the driving transistor 731, changes by the value VG owing to punch-through, the driving transistor has a driving drain current Iw1 at 765 and a drain current Iw2 at 766. This current flows to the exterior via the output signal line 737, causing a variation in output current. When the difference between Iw2 and Iw1 is at least 1% of the average of two currents, the luminance becomes uneven to affect the display grade.

Let Cgs, Cs, and VGa be the gate capacity of the transistor 735, the magnitude of the storage capacity 732, and the amplitude of the gate signal line 741, respectively. Then, the variation VG in the voltage at the node 742 is expressed by VG=Vga×Cgs/(Cgs+Cs).

To reduce VG, Cgs or Vga is reduced or Cs is increased. Increasing Cs is difficult in a practical sense because it increases the chip size. Further, Vga basically has the amplitude corresponding to the voltage of the analog power source. Lowering this voltage reduces the voltage amplitude of the output terminal and thus the dynamic range of a current that can be output. Further, lowering the high level voltage only of the gate signal line 741 requires a power source for the gate signal line 741, thus increasing the number of power sources. The increase in the number of power sources increases the number of power supply circuits. Accordingly, this method is also difficult to implement.

Thus, the present invention contemplates that the gate capacity Cgs of the transistor 735 may be reduced. A simple reduction in the size of the transistor 735 increases leakage current in an off period. This causes charges held in the storage capacity 732 to migrate via the transistor 735. Thus, disadvantageously, the voltage at the node 742 changes to preclude the flow of a predetermined current.

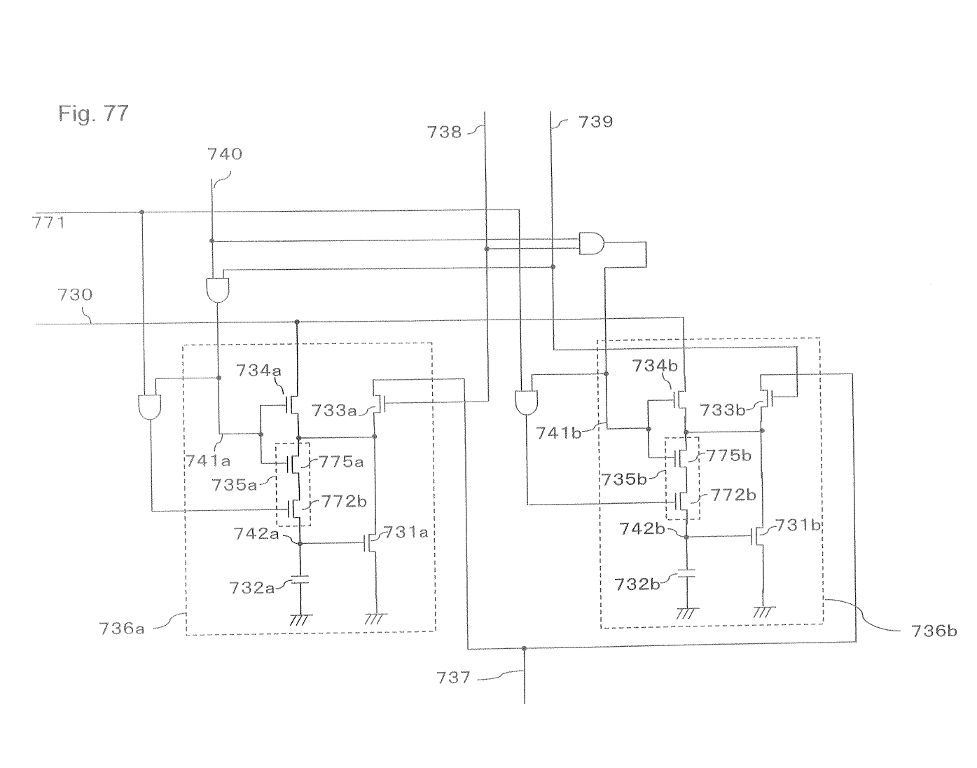

The present invention contemplates that the transistor 735 may be divided into at least two smaller transistors and that the size of one of the smaller transistors which is closest to the storage capacity 732 may be reduced. FIG. 77 shows the circuit in the current holding instrument with the transistor divided into two.

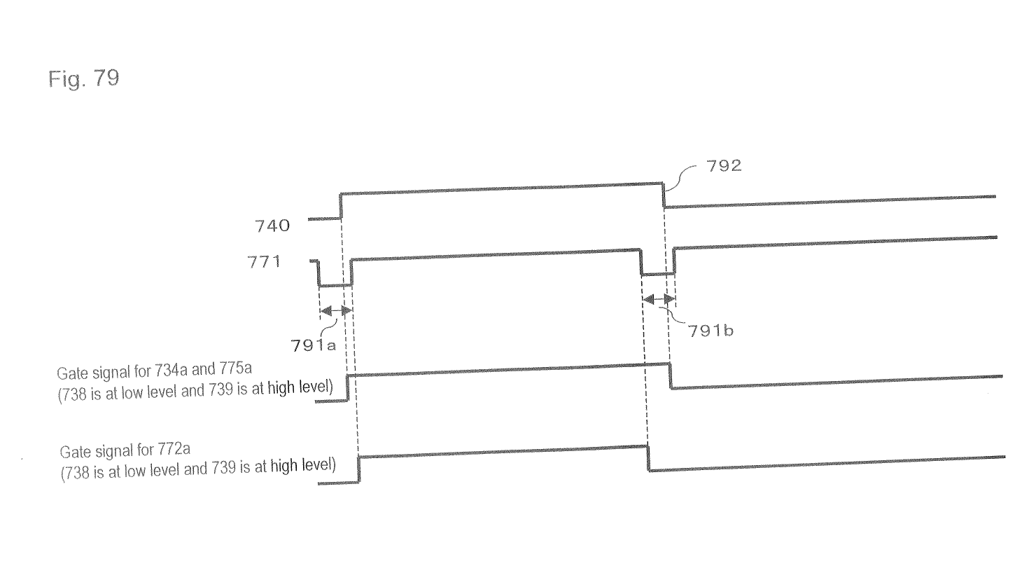

The transistor 735 is divided into two smaller transistors 775 and 772. The transistor 772 has a smaller channel size than the transistor 775. Further, different signal lines are connected to the respective gate electrodes. A gate enable signal 771 performs control such that the transistor 772 enters the nonconductive state earlier than the transistor 775. FIG. 79 shows a timing chart.

The plurality of transistors have the following advantages. The waveforms of signals from the gate signal lines of the two transistors are varied, the transistor 772 closer to the storage capacity 732 is set in the nonconductive state, and then the transistor 775 is set in the nonconductive state. Then, the “punch-through” depends on the gate capacity Cg1, storage capacity Cs, and gate amplitude Vgate of the transistor 772, resulting in Cgs>Cg1. As a result, the VG itself can be reduced. Moreover, the following operation is performed in order to hold the charges in the storage capacity 732: after the transistor 722 is completely set in the nonconductive state, the gate signal line 741 is changed to the low level in order to set the transistor 775 in the nonconductive state. The transistor 775 is designed to have a large channel width/channel length value so as to reduce the leakage current. The two transistors connected in series have the advantage of reducing the leakage current. Moreover, the transistor 772 in the nonconductive state is inserted between the transistor 775 and the storage capacitance 732. This advantageously prevents a gate signal from the transistor 775a from “punch-through” through the node 742.

In this manner, the transistor connected between the gate and drain electrodes of the driving transistor 731 is divided into the plurality of smaller transistors. One of the smaller transistors which is closest to the storage capacity 732 has a smaller channel size and is set in the nonconductive state earlier than the other transistors. This solves problems such as the leakage of charges and reduces the amount of punch-through.

Moreover, the (channel width)/(channel length) (referred to as W/L below) of the driving transistor 731 preferably has a smaller value.

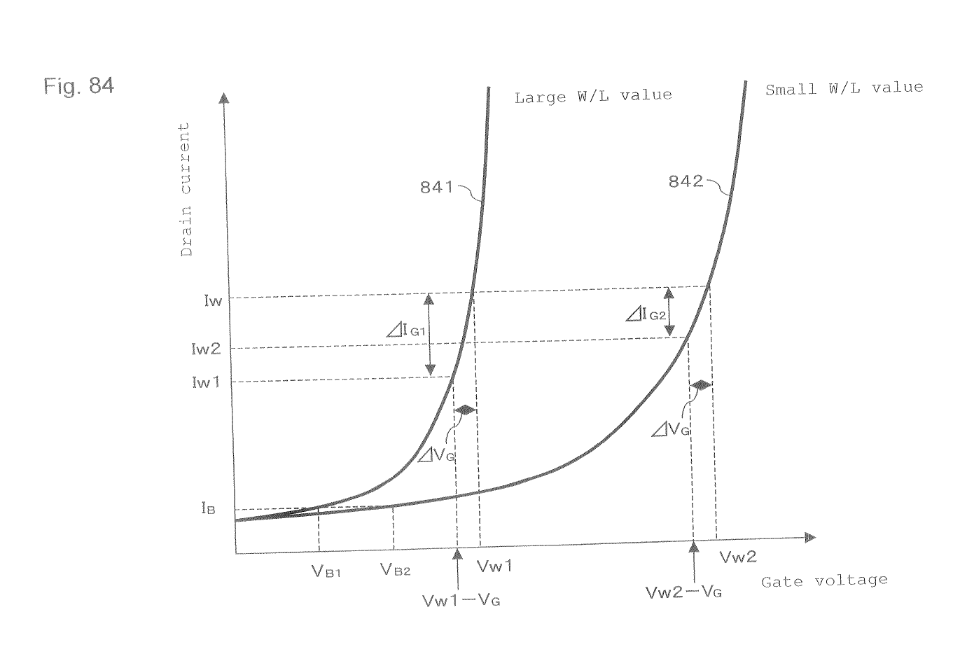

FIG. 84 shows a current-voltage characteristic. The inclination in the figure decreases consistently with the value of W/L. For a decrease in current quantity occurring when the gate voltage of the driving transistor 731 lowers by the value VG owing to “punch-through” after the gray level current signal 730 has been memorized, a curve 841 exhibits a larger values than a curve 842. Thus, the W/L of the driving transistor is preferably at most 0.5 in order to suppress a decrease in drain current because of “punch-through”. In this case, the decrease amount is at most 1% of the set current (Iw). The lower limit value must be at least 0.002 taking into account the adverse effect of an increase in chip area resulting from increases in the minimum production value of the channel width and in channel length.

An output stage using a current copier circuit has been formed as described above to provide a driver IC with a small variation in output.

In a source driver for a large screen panel, a video signal must be transferred at high-speed. This increases signal line frequency, thus disadvantageously causing electromagnetic noise to be emitted. Further, a source driver adapted for televisions has an increased number of signal line bits to be input, thus disadvantageously requiring a large number of signal lines.

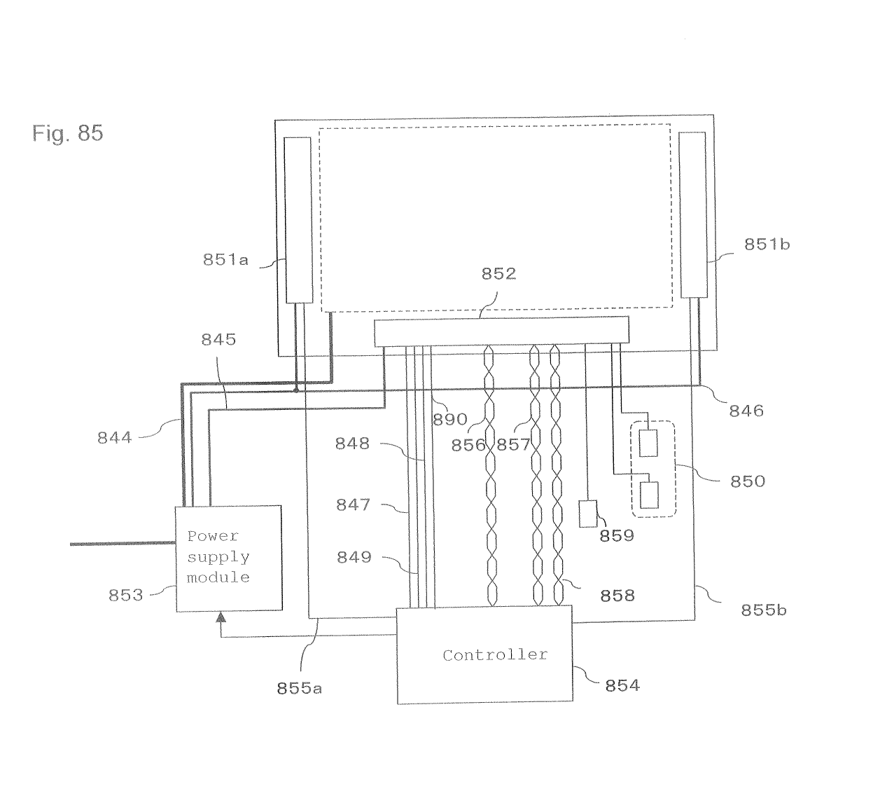

Thus, a video signal is transmitted so as to have a smaller amplitude. FIG. 85 shows how to connect a source driver 852, a gate driver 851, a controller 854, and a power supply module 853 together in this case. A clock 858, a synchronizing signal 857, and a video signal line 856 which have high signal line frequencies are transmitted so as to have smaller amplitudes.

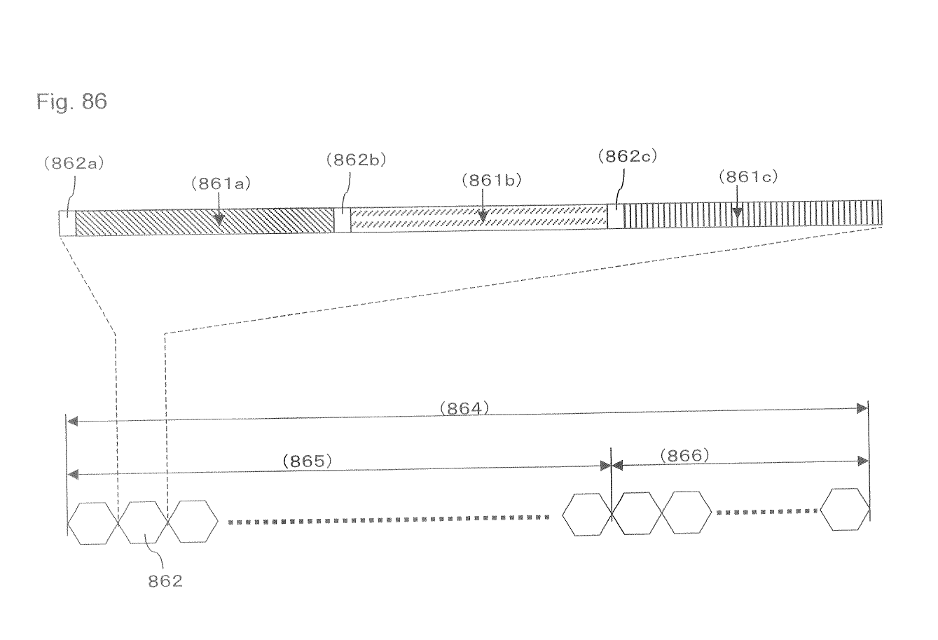

FIG. 86 shows a transmission form of the video signal line 856. A period in which data output to a pixel is transferred (data transfer period 865) and a blanking period (866) are formed in one horizontal scan period 864. The blanking period need not necessarily be present.

The data transfer period 865 is divided into a number of shorter periods corresponding to the number of source signal lines in the panel (for a color panel, the number of signal lines/the number of colors (in general, three)). Periods 862 result from the division. During the period 862, each color data (861) and a 1-bit precharge flag (862) are transferred via the video signal line 856; the precharge flag determines whether or not to insert the voltage application corresponding to the gray level, into the beginning of a horizontal period. The video signal data 861 and the precharge flag 862 can be transferred using an arbitrary method regardless of whether all the bits are transferred in parallel or serially bit by bit under constraints for transfer signal rate or the number of signal lines.

For a current driver for a large-sized panel, the large panel size increases the floating capacity of the source signal line and the number of pixels to reduce the horizontal scan period. Consequently, the following problem appears markedly: the current cannot change to a predetermined value within one horizontal scan period. Thus, it is essential that before a predetermined gray level is displayed using current, the state of the source signal line is changed to the vicinity of the predetermined gray level using voltage and then to the predetermined gray level using current.

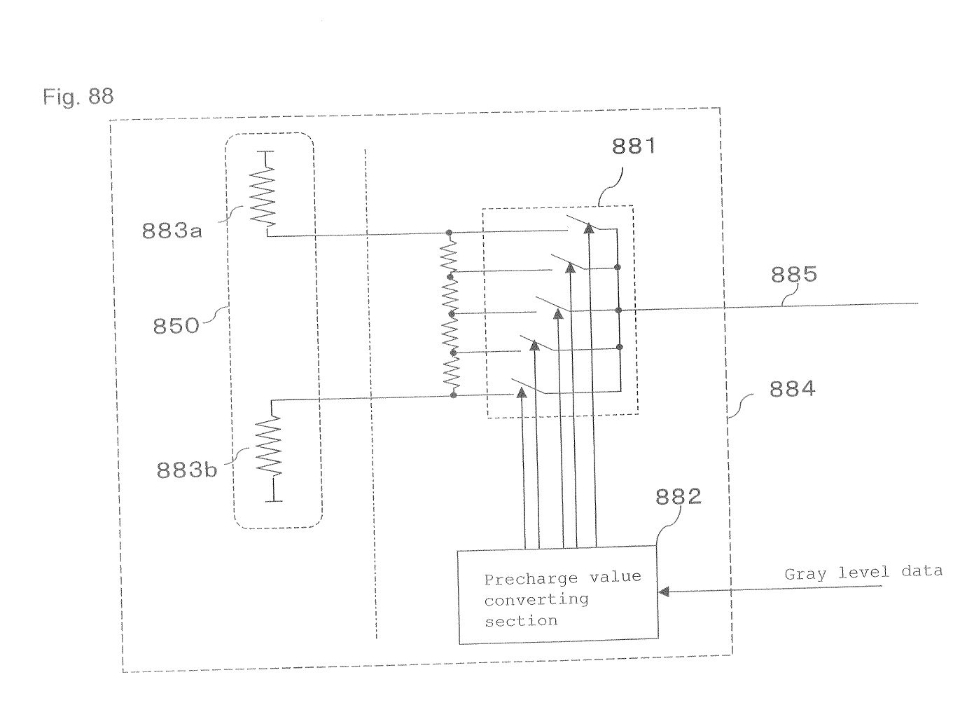

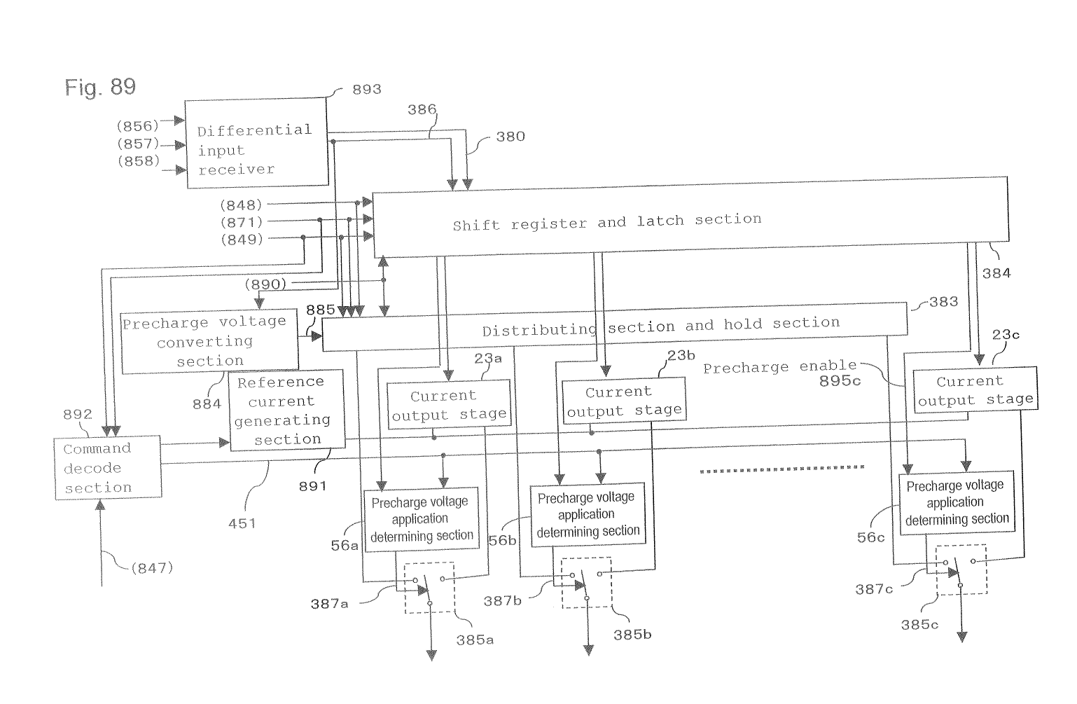

FIG. 89 shows an example of the configuration of a source driver. This figure shows a source driver 852 in FIG. 85. A video signal is transmitted so as to have a smaller amplitude together with a clock and a synchronizing signal. Thus, the video signal is input to a differential input receiver 893 that allows the source driver to execute a level conversion. The video signal is converted into gray level data 386 at a CMOS or TTL level. The gray level data 386 is input to the shift register and latch section 384 and to a precharge voltage converting section 884. The shift register and the latch section 384 distribute the gray level data 386 to each output. The current output stage 23 then converts the distributed gray level data into the current quantity corresponding to the gray level. This makes it possible to provide the current output corresponding to the gray level. On the other hand, the gray level data is simultaneously input to the precharge voltage converting section 884. The precharge voltage converting section 884 has such a circuit configuration as shown in FIG. 88, to output a voltage corresponding to gray level data as a signal 885. The output voltage can be varied using a conversion matrix of a precharge value converting section 882 and a value for a resistance element 883.

FIG. 12 (a) shows an equivalent circuit for a pixel and a source driver during a period of current write. In this case, when a current used for white display is defined as I3 and a current used for black display is defined as I1, the precharge voltage output ranges from V3 to V1 as shown in FIG. 12 (b). The values V3 and V1 vary depending on the channel size of the driving transistor 62. For example, the difference between V3 and V1 increases with decreasing channel width. According to the present invention, to allow different panels (pixel transistor configurations) to output respective voltage values, two resistance elements one of which is shown at 883 in FIG. 88 are externally arranged so as to arbitrarily set a resistance value. This enables voltage outputs for various panels. In general, the current/luminance characteristic of the organic light emitting element varies between red and green and blue. Accordingly, the values I1 and I3 and thus the values V1 and V3 vary depending on the colors. Therefore, three of the precharge voltage converting section 884, shown in FIG. 88, are required for the source driver. The external resistance value varies with the colors. FIGS. 85 and 89 each show one circuit but there are actually three circuits for red, green, and blue.

As described above, the voltage output depending on the gray level is distributed by the distributing section and hold section 383 to each output. Thus, the current and voltage both corresponding to the gray level are distributed to each output. The current/voltage selecting section 385 selects whether to output the current or voltage.

The precharge voltage application determining section 56 determines whether to select the current or voltage. The precharge voltage application determining section 56 makes the determination on the basis of a precharge pulse 451 and a precharge enable 895. A voltage is applied only when the precharge enable 895 outputs a signal indicating precharge after the precharge pulse 451 has been input to the precharge voltage application determining section 56.

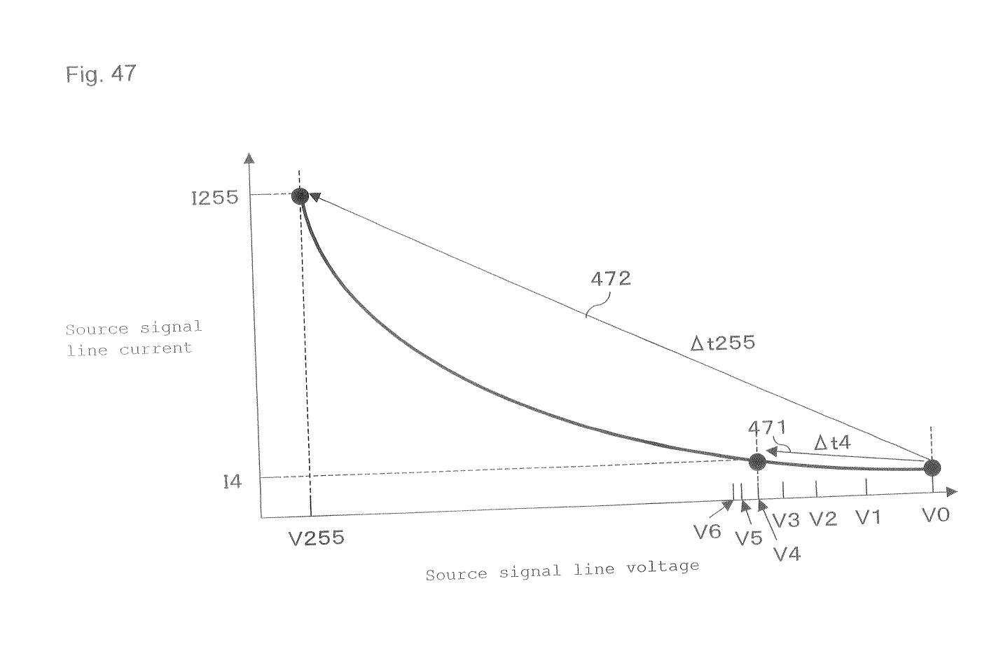

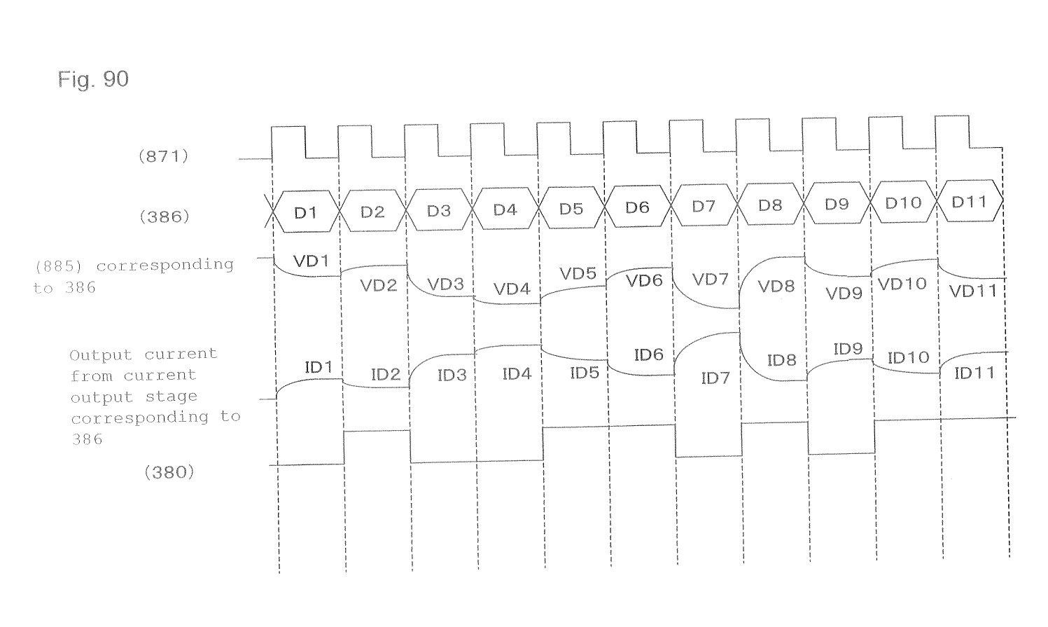

As shown at an output 901 in FIG. 90, the voltage and current corresponding to gray level data Dn (n is a natural number) are defined as VDn and IDn. Then, when the precharge determination signal 383 changes to the high level, indicating precharge, the voltage VDn and the current IDn are output within one horizontal scan period. (The period during which the voltage VDn is applied depends on the pulse width of the precharge pulse 451). On the other hand, when the precharge determination signal 383 is at the low level, the voltage VDn is not output and only the IDn is output for one horizontal scan period. (FIG. 47 shows a time chart roughly showing whether the current or voltage is output). With the use of the precharge determination signal 383, for the lower gray level part, in which the current is unlikely to change to the value corresponding to a predetermined gray level value, the state of the source signal line is first roughly changed using voltage. Then, the source signal line is changed to the predetermined current value using current. On the other hand, for the higher gray level part or the second and subsequent rows in which the same gray level is continuously displayed over a plurality of rows, it is unnecessary to change the current to the value corresponding to a predetermined gray level value using voltage. This is because in the higher gray level part, the source signal line can change easily to the predetermined current value and because for the continuous gray level over a plurality of rows, the state of the source signal line remains unchanged. Consequently, the precharge determination signal 383 can perform control such that precharge is avoided. (In this state, if the source signal line was changed using voltage, an uneven luminance might result from a possible variation in characteristics among the driving transistors 62 in the pixel circuits. Accordingly, the application of voltage should be avoided). The precharge determination signal 383 thus has the advantage of making it possible to determine whether or not to carry out precharge depending on the status of the source signal line. Thus, even if the amount of data sent over the video signal line 856 increases by 1 bit for each color, the data must be transferred.

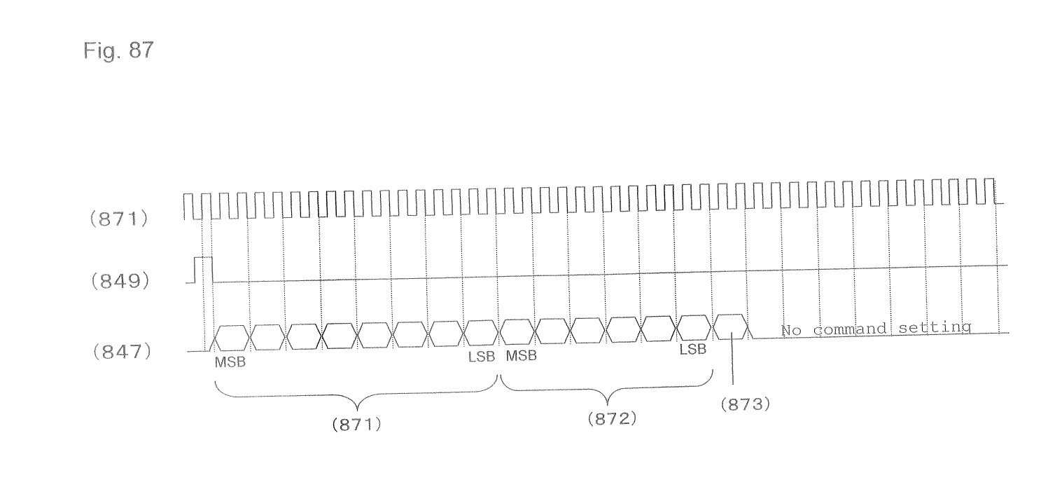

The precharge pulse 451 inputs a precharge period to the source driver through a command line 847. The pulse width of the precharge pulse 451 can be varied depending on the set value for the precharge period. Thus, voltage output is provided in the minimum time required for precharge in connection with the screen size to maximize the current output period required to obtain a predetermined luminance. This allows the easy correction of an uneven luminance resulting from a variation in characteristics among the driving transistors 62 which variation is associated with the voltage-based setting. To reduce the number of signal lines for the command line 847, the source driver sends 1-bit data through serial transfer as shown in FIG. 87. Only the commands required for the source driver are a precharge period setting 872, a reference current setting 871 used to vary the reference current value, and a driver output enable signal. These signals are not frequently rewritten; even if the operation is frequently performed, these signals have only to be rewritten once during one horizontal scan period. In the example shown in FIG. 87, these signals contain 15 bits in total. A clock 871 for the shift register for the source driver may be slow compared to the time varying during one horizontal scan period. Consequently, signal transmissions can be carried out without suffering electromagnetic noise. Thus, only one signal line is required. Further, for determinations for the data flowing through the command line 847, the need for a command determination line (address setting) is eliminated by, for example, arranging the reference current setting 871, precharge period setting 872, and output enable signal in this order in the 8 bits succeeding the clock next to a timing pulse 849, from upper to lower bits. The source driver can be set using fewer signal lines. A reference current generating section 891 can vary the reference current using the electronic regulator; the reference current signal is input to the reference current generating section 891. The reference current generating section 891 uses the setting signal to vary the electronic regulator value and thus the reference current (FIG. 8 shows an example of the configuration of the reference current generating section 891).

If a video signal is composed of an even number of bits for each color (for example, 30 bits including 10 bits for each color), the total number of bits is always odd (in the example, 33 bits) because 1 bit of precharge flag 862 is added to each color. Twisted pairs are normally used for low amplitude signal transmissions. If a 33-bit signal line is sent, 66 signal lines are required when transfer rate is the same as that of the driver. This number of wires is too large. Accordingly, the transfer rate is normally a specified number of times as high as that of the clock for the driver, thus correspondingly reducing the number of wires. For example, with a double transfer rate, when 17 bits are transferred during one transfer, 34 bits can be transferred. By containing data in 33 of the 34 bits, it is possible to transfer the data at the double transfer rate. However, in this case, since 34 bits can actually be transferred, 1 bit of blank data is transferred. This reduces the efficiency of the signal lines. Likewise, if transfers are carried out at a speed even-number times as high as the original one, then for data of an odd number of bits, 1 bit of blank data is always transferred. That is, an increase in the amount of data by 1 bit does not affect the transfer rate (double the clock rate) or the number of signal lines.

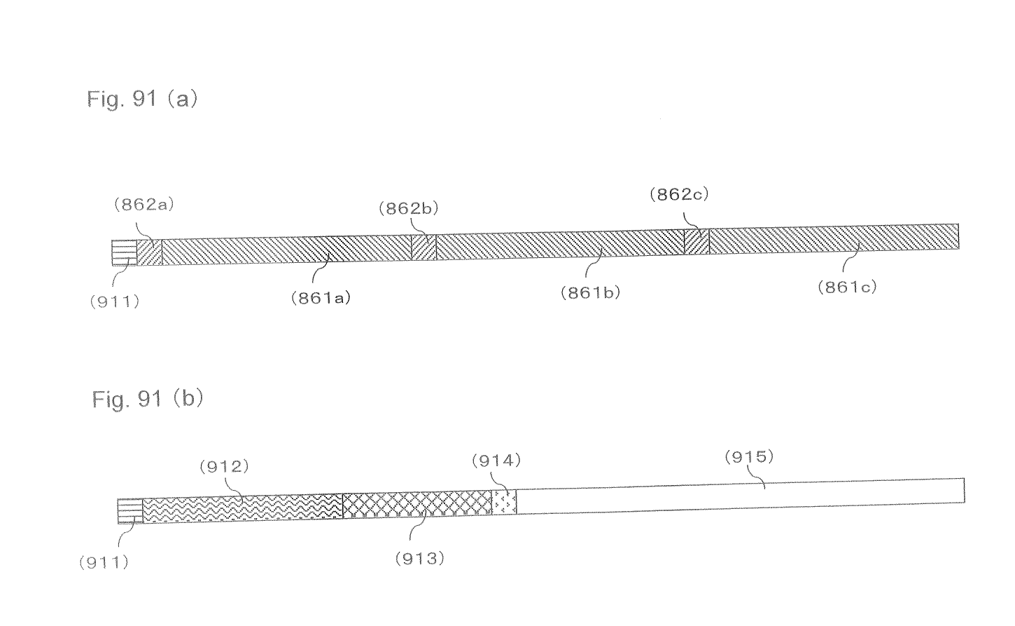

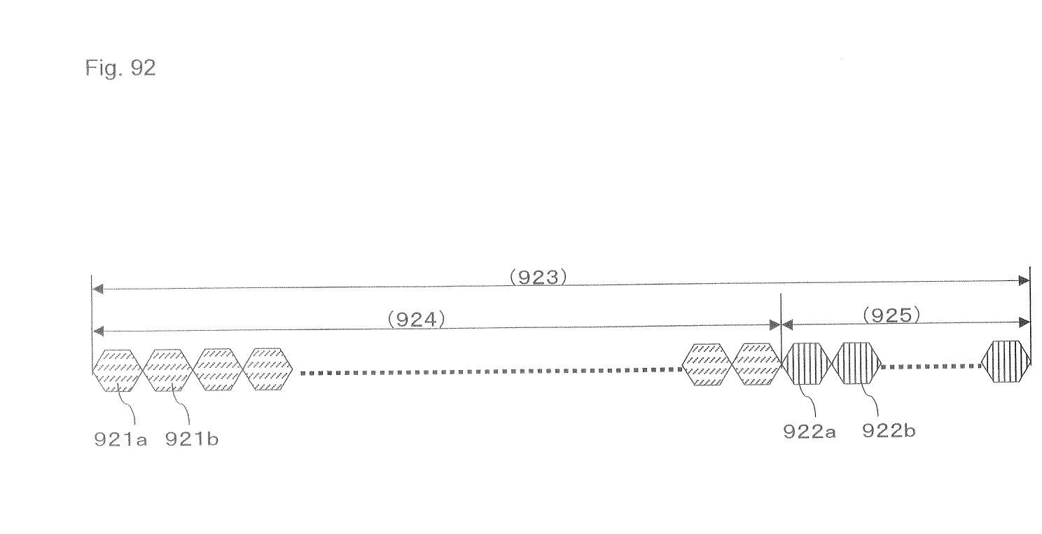

Thus, the present invention adds a data/command flag 911 to each of the video signals for red, green, and blue and to the precharge flag to enable the following process. When the data/command flag 911 has a value of, for example, 1, the video signal and the precharge flag are transferred. When the data/command flag 911 has a value of 0, various registers for the source driver are set. FIG. 91 (a) shows data transfers. FIG. 91 (b) shows the configuration of bits used when the various registers are set. FIG. 92 shows transfer timings for data transfers and the setting of the various registers. After the video signal for each color and the precharge flag are all transferred, the next blanking period is utilized to set the various registers for the source driver on the basis of the data/command flag 911 in one horizontal scanning period. In this case, as shown in FIG. 91 (b), the reference current and the period during which the precharge voltage is applied are set.

This configuration eliminates the need for the command line 847 in FIG. 85 to enable a reduction in the number of signal lines.

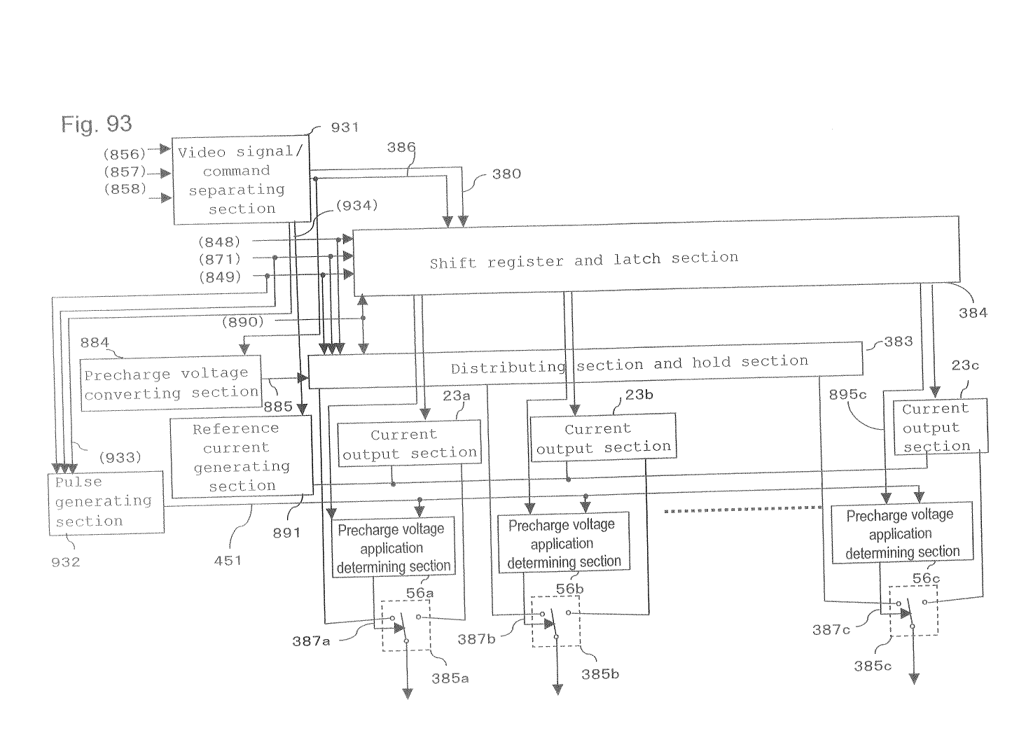

FIG. 93 shows a block diagram of the source driver. This source driver is different from the configuration in FIG. 89 in that it includes a video signal/command separating section 931 that is a circuit for converting a low amplitude signal into a CMOS level in order to separate command data and a video signal from the video signal line 856. With this configuration, in a source driver IC that must transfer the precharge flag in synchronism with the video signal line and set the various registers, the video signal and precharge flag or the video signal line, precharge flag, and various register setting can be transferred at high speed over the same signal line using low amplitude signals. This enables a reduction in the numbers of wires required for the precharge flag and of wires required to set the various registers. Further, electromagnetic noise can be reduced during high-speed transfers.

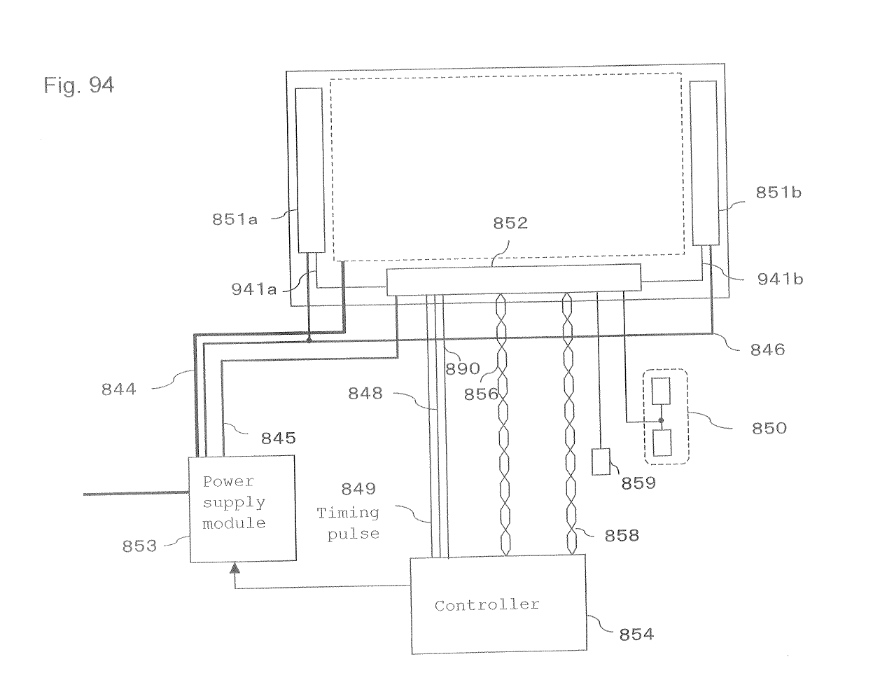

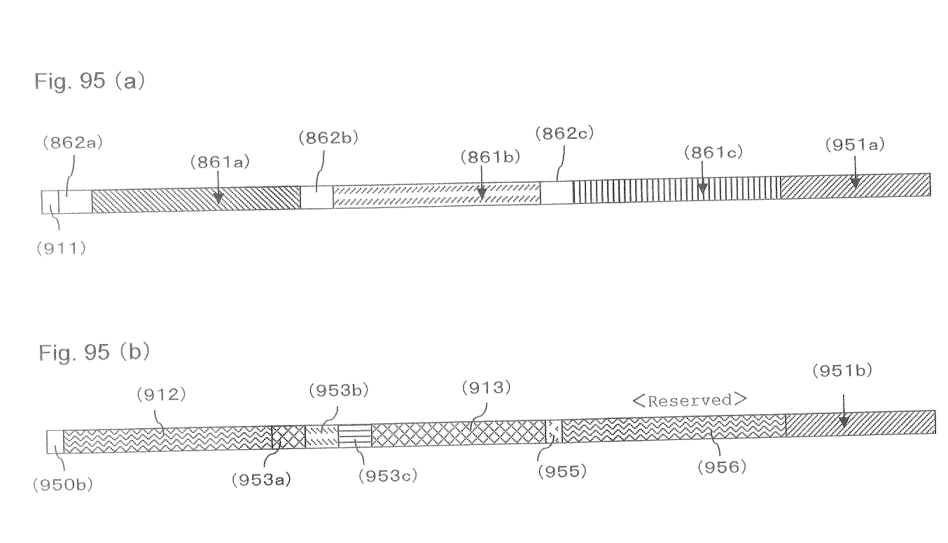

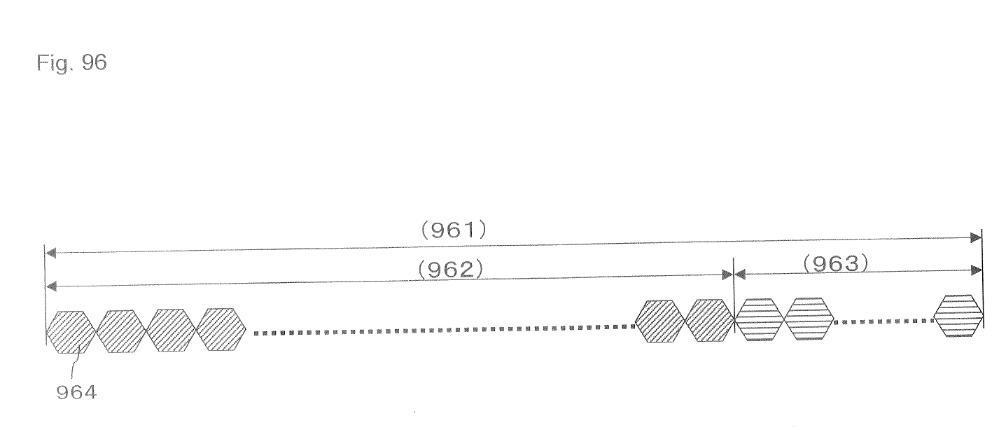

For a display panel for small-sized applications, module arrangement is spatially restricted, resulting in the need to minimize the number of signal lines drawn out of the panel. Since the number of dots displayed is smaller than in large-sized panels, the video signal line has a lower transfer rate. Thus, as shown in FIGS. 94 and 95, transmission of gate driver control data 951 is carried out in addition to the multiplexing of gray level display data (color data for red, green, and blue; referred to as R data, G data, and B data below) with the precharge flag 862 the precharge flag 862 determining whether or not to carry out precharge. Signal lines are transmitted which are required to control both gate drivers A (851a) and B (851b). The transmitted signals are a clock for shift register operations, a start pulse, an output enable signal, and a signal determining shift direction. The output enable signal may change the state of a signal line at a unit of several μs. Accordingly, the gate driver control data 951 is transmitted not only during a data transfer period 962 but also during a blanking period 963 in FIG. 96. Thus, as shown in FIG. 95 (b), the gate driver control data 951 is transferred in addition to the source driver setting signals. As a result, the signal lines drawn out of the panel may be limited to the power source line, the minimum two twisted pairs, and three signal lines.

A reduction in the number of signal line increases the transfer rate and thus the power consumption of the clock generating section of the transmitting controller 854. In general, most of the power used for small amplitude transmissions is consumed by the clock generating section. Thus, apparatuses required to reduce power consumption has an increased number of twisted pairs used for the video signal line 856 to reduce the transfer rate and thus the power consumption. (The power consumed by the signal lines is about one-tents to one-twentieths of the power consumed by the clock generating section). The data sequence in FIG. 95 (a) sent during the period shown at 964 in FIG. 96 may be serially sent or may be partly or totally transferred in parallel depending on the number of video signal lines 856.

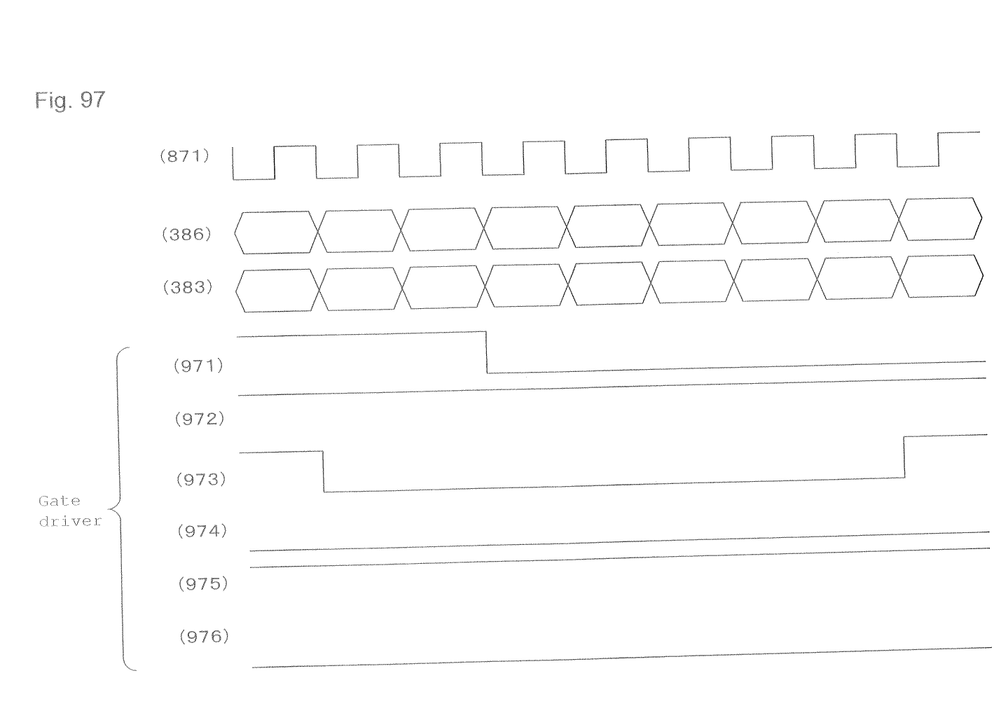

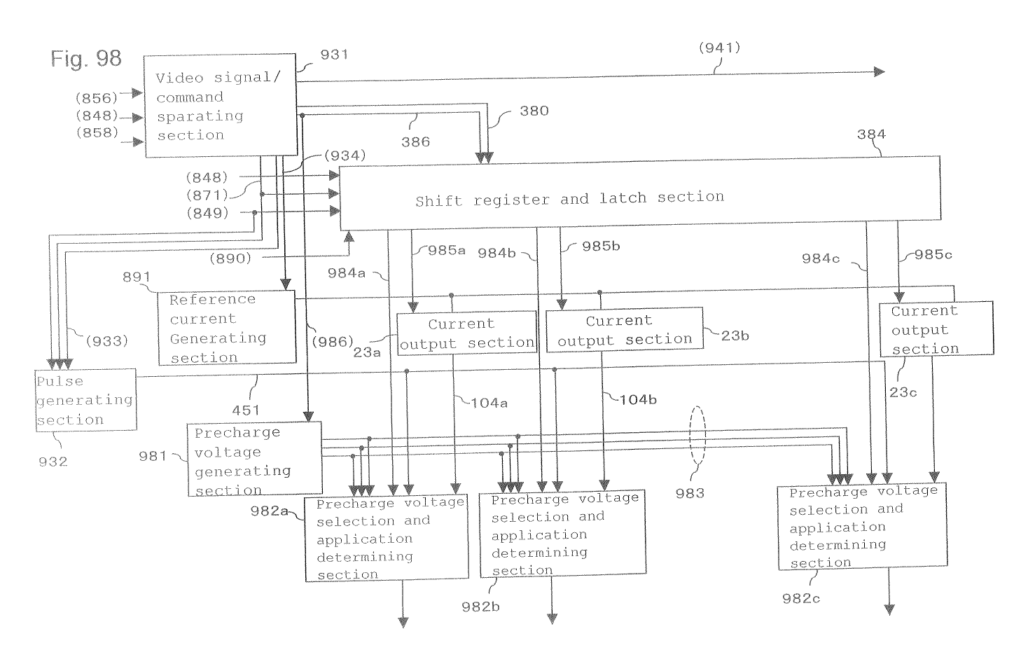

In this manner, the source driver 852 separates, into pieces, the data transmitted through the video signal line 856 so as to have a smaller amplitude. FIG. 98 shows the internal block of the source driver 852. The source driver 852 is characterized by having the video signal/command separating section 931, which allows the output, from the clock 858, video signal line 856, and start pulse 848, of the gray level data 386, precharge determination signal 383 and gate driver control line 941 operating in synchronism with the source driver clock 871 created from the clock 858. The gate driver control signal is always transmitted in association with a video signal and a command as shown in FIG. 95. Accordingly, the gate driver control signal must be demodulated so as to synchronize with the source driver clock 871 as shown in FIG. 97. This eliminates the need to draw the gate signal line out of the panel, thus providing a display panel with a reduced number of signal lines. Further, the output in synchronism with the source driver clock 871 has the advantage of more easily matching timings for the source and gate drivers with each other. Furthermore, since the control line from the controller 854 to the gate driver 851 is unnecessary, the number of output terminals in the controller 854 decreases to enable the production of a controller 851 using a smaller package.

The configuration in FIG. 98 differs from that in FIG. 93 in a block that generates and outputs a precharge voltage. In FIG. 93, the voltage corresponding to a video signal is generated and distributed to each output using analog latch. In FIG. 98, a plurality of voltage outputs from a precharge voltage generating section 981 determined by a voltage setting line 986 are distributed to the output stages. Then, a precharge voltage selection and application determining section 982 determines which of the plurality of voltages is to be output or whether or not to provide output using only current. This eliminates the need for the distributing section and hold section 383. Unlike a large-sized panel, in a small-sized panel, each horizontal scan period is long and the source signal line has a smaller floating capacity. Accordingly, the predetermined current value is easier to write. Thus, the present source driver has a reduced number of voltage values and thus a reduced circuit scale on condition that no voltage is applied in the higher gray level part, in which a writing operation can be performed using only current. In this example, three voltage values are output. The number of voltage values may be varied from 1 to about 7 as required.

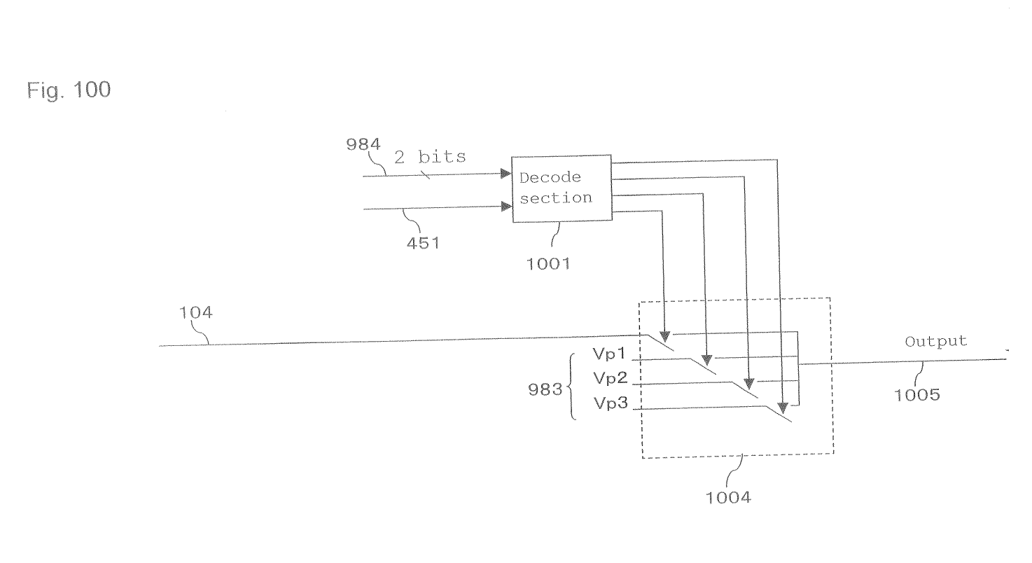

Description will be given of a method of outputting the precharge voltage corresponding to the data in a video signal. A video signal and a precharge flag are transmitted in a pair through the video signal line 856 in accordance with the method shown in FIG. 95 (a). For a color panel, a red, green, and blue video signals are each paired with the precharge flag for transmission. Precharge is carried out using the same method in each case. Thus, description will be given below in connection with the red signal. An R precharge flag 862a and R data 861a transmitted in a pair are input to the video signal/command separating section 931. Then, the R precharge flag 862a and the R data 861a are converted into the CMOS level to obtain a precharge determination signal 383 and gray level data 386. The signal, sequentially sent pixel by pixel, is input to the shift register and latch section 384 in order to be distributed to each output. After the distribution, the gray level data 386 is input to the current output stage 23 via the gray level data line 985. Then, the current corresponding to the gray level is obtained as the output 104. On the other hand, the precharge determination signal 383 is output to the precharge determination line 984. As shown in FIG. 100, the precharge voltage selection and application determining section 982 uses the precharge determination line 984 and the precharge pulse 451 to control a decode section 1001 and a selecting section 1004. The precharge voltage selection and application determining section 982 thus determines whether to output the gray level current 104 or any one of the precharge voltages 983. In this case, one of the four signals is selected. Accordingly, the precharge determination line 984 must have a 2-bit width. In general, when the number of bits in the precharge determination line 984 is defined as N (natural number), a value 2^{N} must be at least (the number of precharge voltages+1).

The precharge pulse 451 is a signal used to determine a voltage output period during one horizontal scan period as shown at 473 in FIG. 47. Thus, voltage is output only while the precharge pulse 451 is input even when the precharge determination line 984 outputs any of the precharge voltages 983.

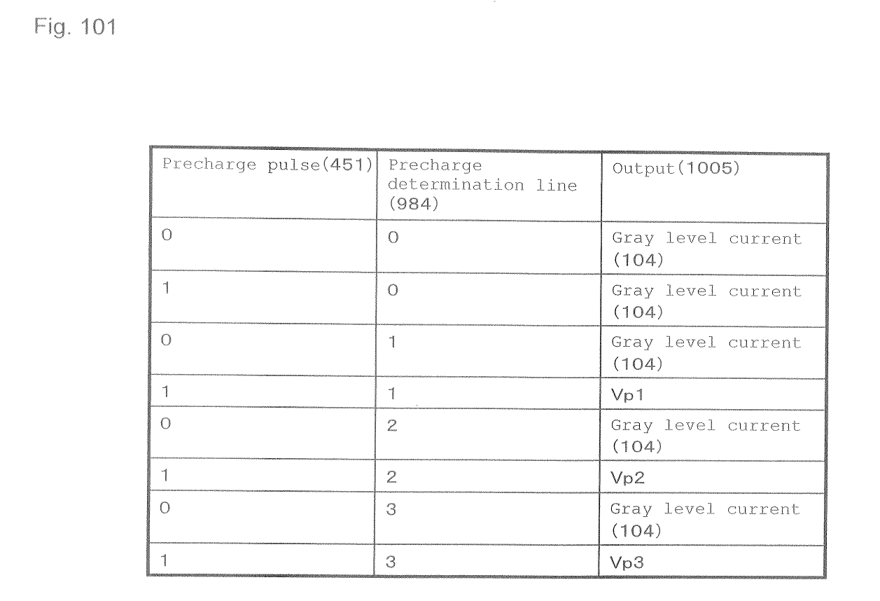

FIG. 101 shows the relationship between the precharge pulse 451 and the precharge determination line 984 and an output 1005. The controller controls signals input to the precharge determination line 984 to enable the provision of a period during which the precharge voltage corresponding to the video signal is output.

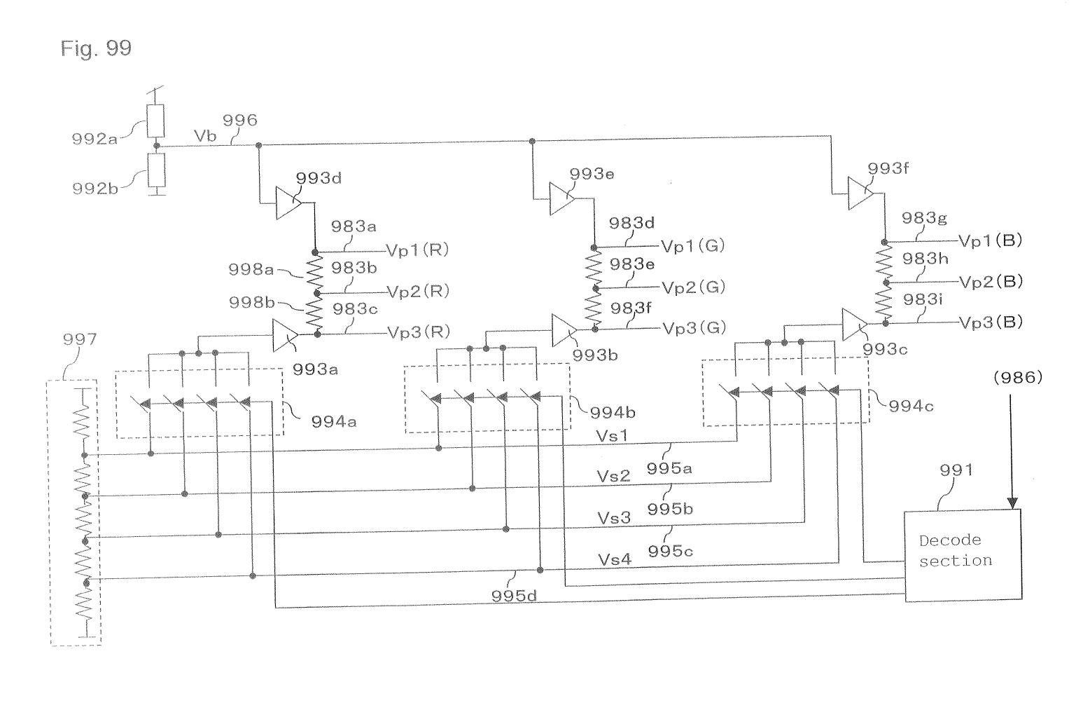

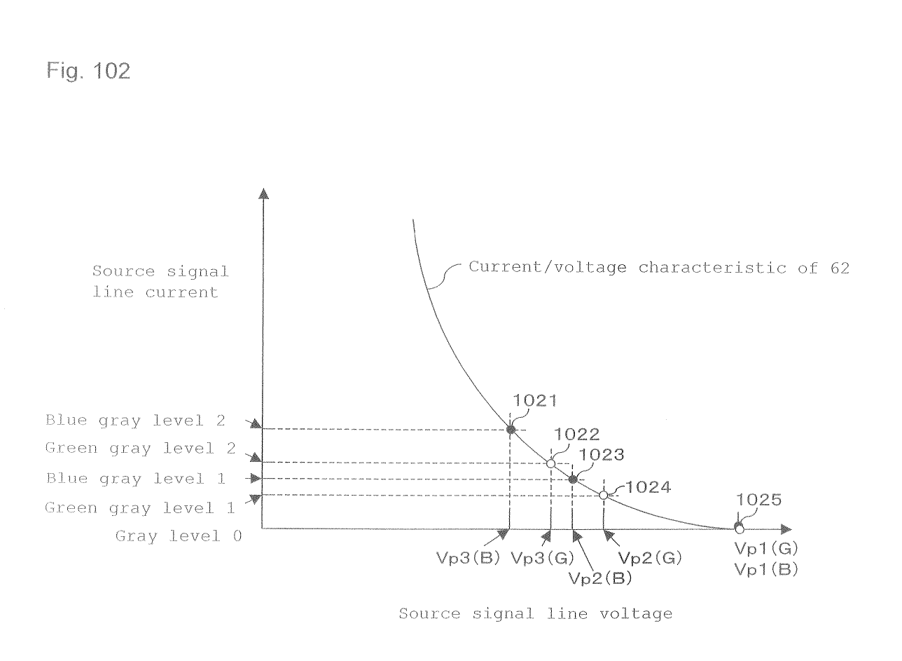

The precharge voltage is generated by the precharge voltage generating section 981. FIG. 99 shows an example of the configuration of the internal circuit of the precharge voltage generating section 981. Each voltage is generated by resistance division. (An operational amplifier is connected to the output 983). A voltage Vp1 is determined by resistance elements 992a and 992b. On the other hand, a voltage Vp3 can be varied with the colors because the required current value varies with the luminescent colors. Any of voltages Vs1 to Vs4 can be selected using a resistance element 997 and a voltage selecting section 994. In a display apparatus having such a pixel circuit as shown in FIG. 6, the relationship between the source signal line voltage (=the current flowing through the EL element 63) and the voltage across the source signal line 60 agrees with the current/voltage characteristic of the driving transistor 62 in FIG. 102. Accordingly, a deviation in current per gray level appears as a difference in source signal line voltage; the deviation in current is caused by a difference in EL element luminous efficiency between green and blue. For gray levels 0 to 2, which require the precharge voltage, blue needs a larger quantity of current than green because of its lower luminous efficiency. Even for the same gray level 2, blue requires the voltage shown by a point 1021, while green requires the voltage shown by a point 1022. This results in a difference in voltage value. The precharge voltage value can be varied using such colors as shown in FIG. 102, by using the voltage setting line 986 to control the voltage selecting section 994 so that, for example, the voltage selecting section 994c selects Vs4 (995c) and that the voltage selecting section 994b selects Vs1 (995a). A predetermined voltage can be generated by determining such resistance values for 997 and 998 as match the characteristics of the driving transistor 62. The voltage setting line 986 can be externally directly set. The precharge voltage setting 953 is input during a command period as shown in FIG. 95 (b). Then, the video signal/command separating section 931 separates and extracts the voltage setting line 986 from the video signal. This eliminates the need to increase the number of external signal lines in setting different voltages for the respective colors. FIG. 98 shows only three precharge voltages 983. However, this is a monochromatic example, and for a multicolor application, three precharge voltages 983 are required for each color; nine precharge voltages 983 are required in total. The precharge voltage selection and application determining section 982 has three voltage inputs. This is because each output has a specified display color, so that three voltages corresponding to the output colors may be input.

If at least eight voltage values are required, the decode section 1001 and selecting section 1004, shown in FIG. 100, have larger circuit scales. Accordingly, the circuit configuration in FIG. 89 is more preferable.

Any of the configurations shown in FIG. 95, FIG. 98 or 91, and FIG. 93 may be selected on the basis of the panel size and the number of pixels.

This provides a source driver IC that can output current or voltage, using a reduced number of signal lines.

A major problem with current driver ICs is that in the lower gray level part, the floating capacity of the source signal line is insufficiently charged and discharged owing to a smaller output current value, thus delaying the change in current written into pixels. The time Δt required to change the current is expressed as Δt=C×ΔV/I (where C is source line capacity, ΔV is the amount of change in source line voltage, and I is a current flowing through the source signal line). This indicates that a longer time is required for the change at a lower gray level. Further, it has been found that a change from black to white takes a longer time than that from white to black.

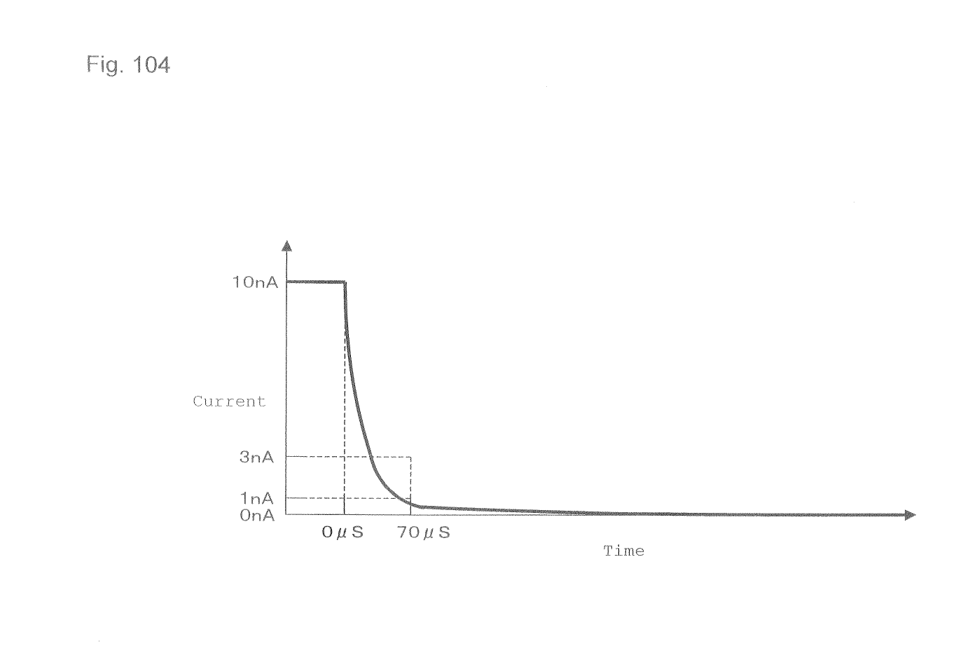

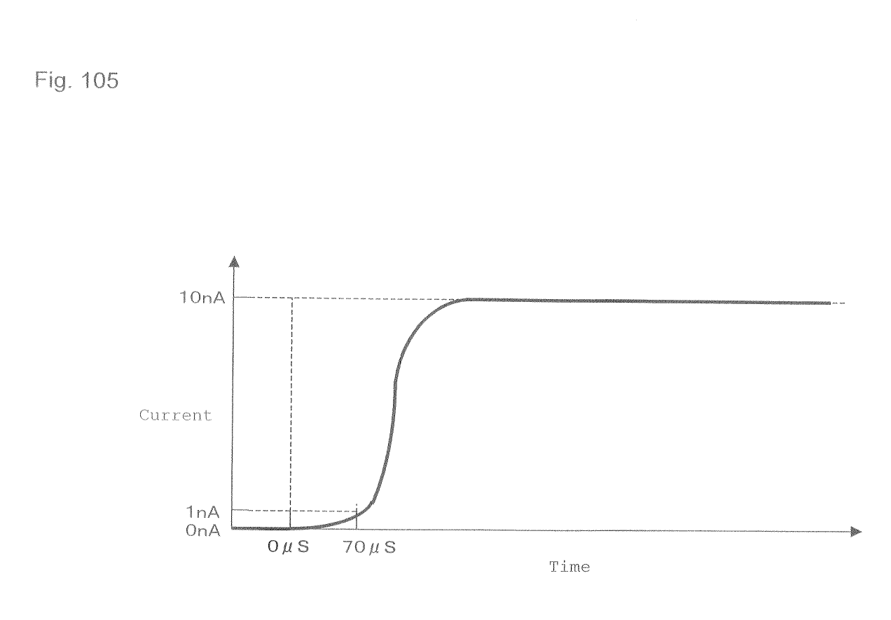

If for example, a source signal line current of 10 nA is provided during white display and a source signal line current of 0 nA is provided during black display, a change in source signal line current from white to black occurs as shown by the waveform in FIG. 104. A change in source signal line current from black to white occurs as shown by the waveform in FIG. 105.

If one frame is scanned at 60 Hz in a panel of QCIF+(176×220 pixels), one horizontal scan period is about 70 μs. By 70 μs after an initial state, for a change from white to black, the value has reached 94% of the target as shown in FIG. 104. In contrast, for a change from black to white, the value has reached only 5% of the target.

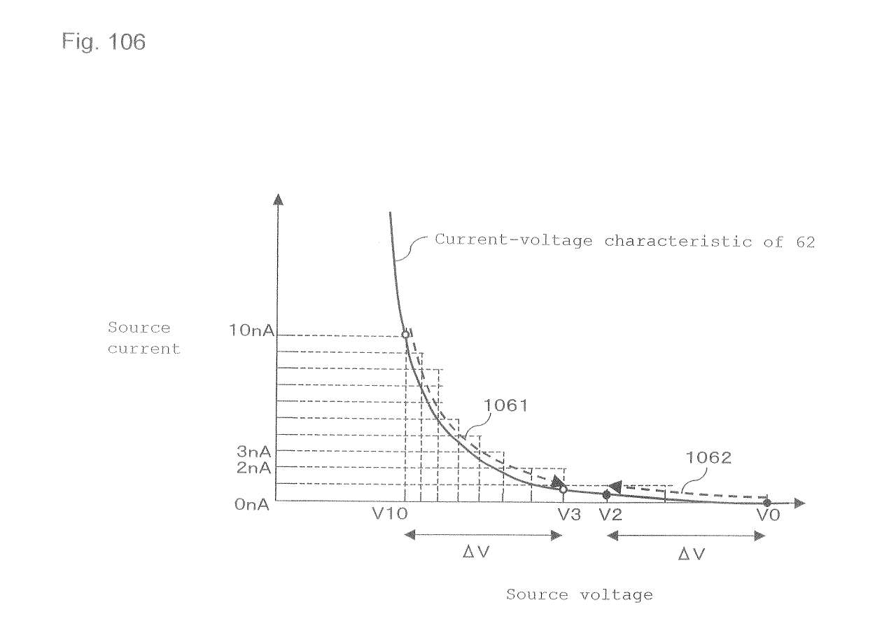

Such a large difference in change within the range from 10 nA to 0 nA is due to the nonlinearity of the source signal line voltage with respect to the source signal line current. FIG. 106 shows the relationship between the source signal line current and the source signal line voltage. The relationship between the current and the voltage is determined by the current/voltage characteristic (1063) of the driving transistor 62. The value of the source signal line voltage corresponds to a curve 1063 with respect to the current on the source signal line. On the basis of the equation Δt=C×ΔV/I, which indicates the time required to change current, I=10 nA during a change from black to white. Further, the current flowing through the source driver is zero during a change from white to black. However, since the driving transistor attempts to supply a current of 10 nA, I is also 10 mA in the initial state. This indicates that when Δt is 70 μs, ΔV necessarily remains the same. Because of the characteristic indicated by the curve 1063, the amount of change in current varies greatly between the case where the source potential rises from 10 nA by ΔV and the case where the source potential lowers from 0 nA by ΔV. When the potential rises, it changes from 10 nA to 0.6 nA as shown at 1061. In contrast, when the potential lowers, it changes from 0 nA only to 0.5 nA as shown at 1061. This results in current changes such as those shown in FIGS. 104 and 105.

Description has been given of changes between 10 nA and 0 nA as an example. For any combinations of gray levels, a change from higher gray level to lower gray level is similarly faster than that from lower gray level to higher gray level.

Thus, the present invention has devised a method of increasing the speed of the change from lower gray level to higher gray level, which is slower.

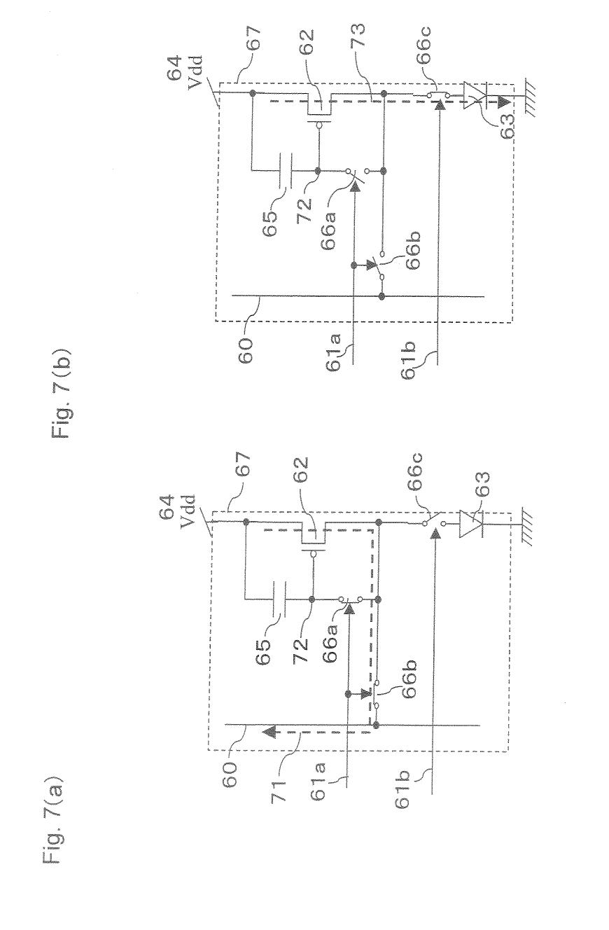

It is necessary to reduce the source signal line capacity or voltage change amount or to increase the current in order to increase the speed of the change. The source signal line capacity is determined by the panel size and cannot be changed. Further, changing the current/voltage characteristic of the driving transistor is the only way to reduce the voltage change amount. Specifically, the only way is to increase the channel width of the transistor or to reduce its channel length. An increase in channel width increases the transistor size, which is not accommodated by a small-sized high-definition panel with a small area per pixel. On the other hand, a decrease in channel length disadvantageously results in a marked early effect. Further, when the drain current from the driving transistor 62 during a write operation differs from that during EL emission (period shown in FIGS. 7 (a) and 7 (B)), the early effect varies the drain current value in each case. This precludes a reduction in channel length. Thus, the present invention contemplates that the source signal line current may be increased.

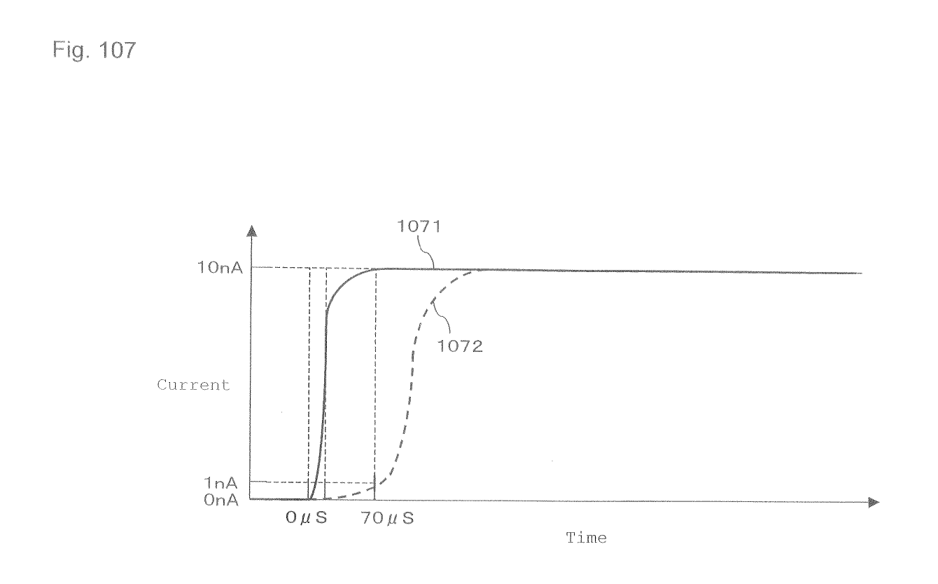

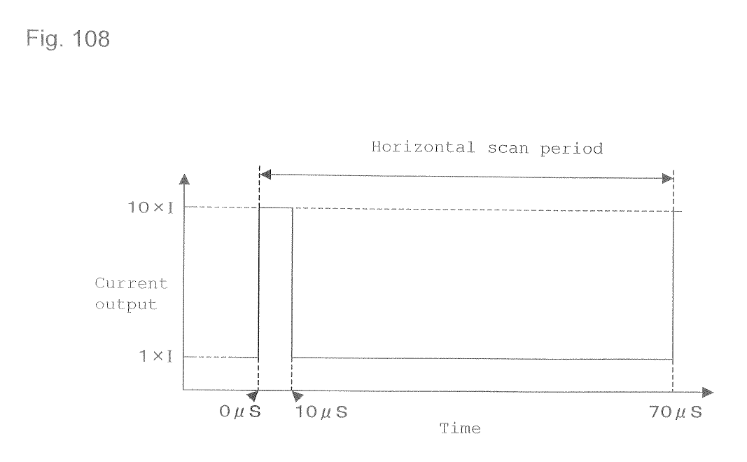

FIG. 108 shows the waveform of a source driver current output according to the present invention which waveform is obtained when the current I is written to a certain pixel. This method is characterized by a 10-μs period at the beginning of a horizontal scan period during which a current 10 times as large as a predetermined one is applied. The application of the tenfold current results in such a current change as shown by a curve 1071 in FIG. 107 instead of a curve 1072 indicating the conventional technique. This enables the predetermined current to be written in 70 μs. Thus, the speed of a change in current value is increased to enable the predetermined current to be written, by providing a period at the beginning of one horizontal scan period during which the current flowing through the source signal line is increased.

When a current 10 times as large the predetermined one is output, the value of the current 10 times as large the predetermined one must be calculated. Further, the source driver must be provided with a function for providing a tenfold current. This disadvantageously requires an arithmetic circuit or a tenfold current source in the current output stage of the source driver, thus increasing the circuit scale. Further, if the current value per gray level varies with the display colors, scale factor must be varied with the gray levels. This complicates processing.

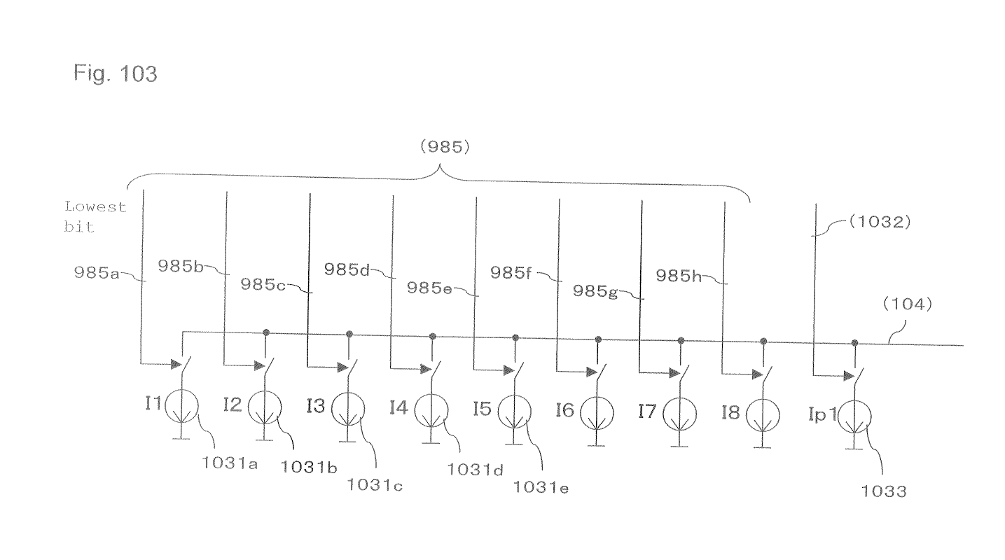

Thus, the present invention adopts the following configuration. Since the change from lower gray level to higher gray level is slow and slowest at gray level 0, examinations are made to determine how much current is required to change gray level 0 to the next higher level within one horizontal scan period. Then, the current value obtained (referred to as Ip1 below) is applied during a period at the beginning of one horizontal scan period, that is, an example of a third period according to the present invention, and then a predetermined current is applied. This enables the predetermined current value to be reached within one horizontal scan period. If the predetermined gray level value is larger than Ip1, the current for gray level 0 to the predetermined gray level can be written within one horizontal scan period for all the gray level regions by applying the predetermined gray level current even during a period in which the current Ip1 is otherwise provided. In this case, the period into which Ip1 is inserted may be provided only if the video signal has less than a certain gray level. This eliminates the need for a multiplier. Further, in the output, each output may have only one current source that outputs the current Ip1. This concept is shown in FIG. 103. The concept can be realized by providing the current output 104 with a precharge current source Ip1 (1033) in addition to the gray level display current source. The current Ip1 is used only to increase the speed at which the gray level changes to a predetermined value. Accordingly, there may be a variation between adjacent terminals. Thus, in outputting the same current, the transistor requires a smaller total area than one constituting a current source used to display gray levels.

Further, the current Ip1 has its optimum value determined by the source line capacity and the current/voltage characteristic of the pixel transistor and does not depend on the luminous efficiency of the EL element 63. This enables a common current value to be used for each color and eliminates the need for individual adjustment for each color. Therefore, size of the required circuit can be reduced.

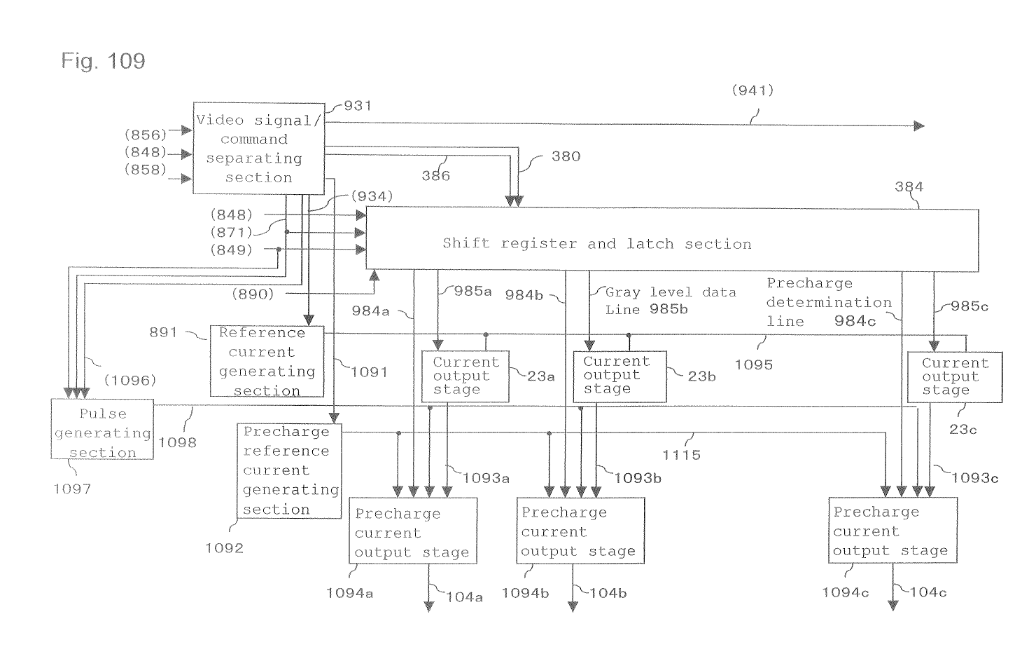

FIG. 109 shows the configuration of a source driver IC corresponding to a current output type driving circuit for the self-luminescent display apparatus according to the present invention; the source driver has a function for outputting the current Ip1 at the beginning of a horizontal scan period. Here, the current Ip1 output at the beginning of a horizontal scan period is called a precharge current. This source driver is characterized by a precharge reference current generating section 1092 that generates a precharge current, a precharge current output stage 1094 that determines whether or not to provide output to the source signal line on the basis of a predetermined first condition according to the present invention, and a pulse generating section 1097 that sets a period of precharge current. The precharge reference current generating section 1092 and the precharge current output stage 1094 constitute precharge current applying instrument according to the present invention. The precharge reference current generating section 1092 and the precharge current output stage 1094 constitute a display control device for the self-luminescent display apparatus according to the present invention, together with a controller (not shown in FIG. 109) that controls the source driver IC. The pulse generating section 1097 corresponds to third period generating instrument according to the present invention. The controller section not shown in FIG. 109 may be packaged into the source driver or may be a separate device serving as a controller. The controller section packaged into one chip is particularly effective on a relatively small-sized display apparatus including about one or two source drivers.

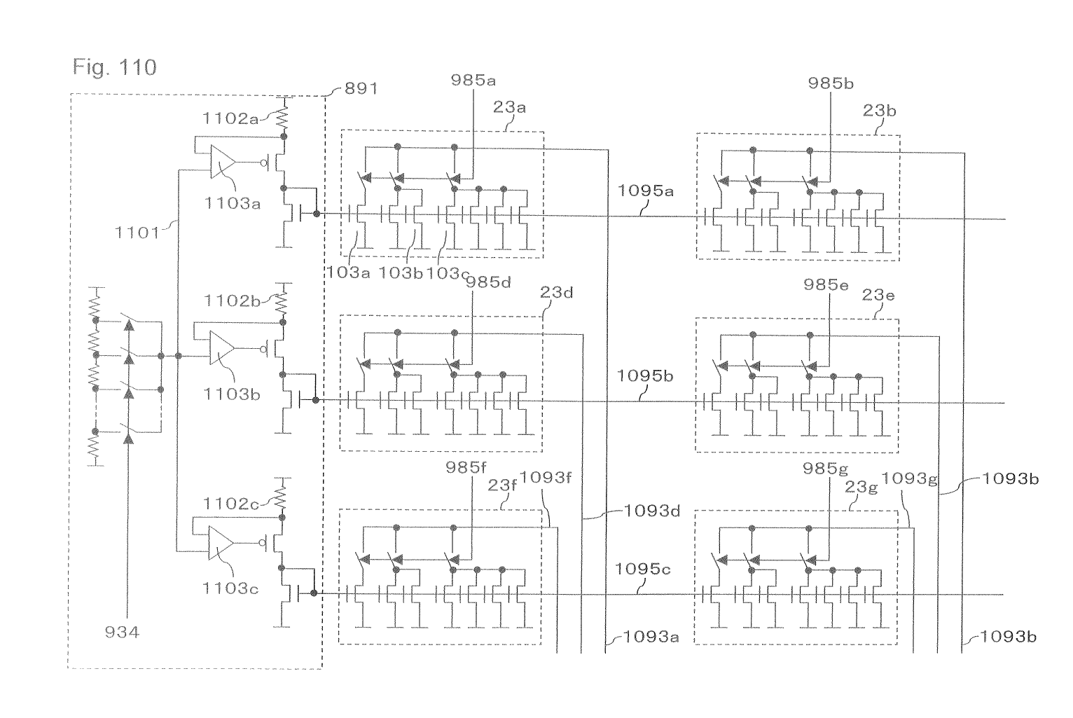

The precharge determination signal 383 determines whether or not to output a precharge current. The precharge determination signal 383 is transmitted in synchronism with the gray level data 386. It is thus possible to set whether or not to provide a period in which the precharge current is output for each pixel, or if a plurality of precharge currents are provided, which of the precharge currents is selected. The shift register and latch section 384 distribute the precharge determination signal 383 to each output together with the gray level data 386. The gray level data is input to the current output stage 23, provided at each output, as a gray level data line 985. The current output stage 23 outputs, to 1093, the current quantity corresponding to a reference current value created by the gray level data line 985 and reference current generating section 891. FIG. 110 shows the configuration of the reference current generating section 891 and current output stage 23 for a multicolor-based driver; in this example, the gray level data line 985 contains 3 bits. The reference current setting line 934 varies the potential across a signal line 1101 and thus the current value of a constant current circuit consisting of an operational amplifier 1103, a resistor 1102, and a transistor. This indicates that the current varies depending on the value for the reference current setting line 934. The gray level data line 985 varies the output current 1093 because the value for the gray level data line 985 varies the number of current source transistors 103 connected to the output. In general, the organic EL element has a luminous efficiency varying with the luminescent colors. Accordingly, the current per gray level must be varied with the luminescent colors. According to the present invention, the resistor 1102 is configured as an element outside the IC to facilitate the adjustment of the resistor 1102. The resistance value is used to vary the current value per gray level, thus maintaining white balance. On the other hand, the precharge determination line 984 distributed to each output is input to a precharge current output stage. Moreover, the precharge reference current generating section 1092 and a precharge pulse 1098 also input signals to the precharge current output stage 1094.

The pulse width of the precharge pulse 1098 is determined by a pulse generating section 1097. The pulse generating section 1097 obtains the value for a current precharge period setting line 1096, a timing pulse, and a clock. The pulse generating section 1097 thus uses a counter circuit to output the precharge pulse 1098 from the timing pulse output on the basis of the value for the precharge period setting line 1096.

The precharge reference current generating section 1092, which determines the value for the precharge current, varies the precharge current on the basis of an input from a precharge current setting line 1091.

For these two external set values (current precharge period setting line 1096 and precharge current setting line 1091), setting signals are sent to the video signal line 856 during a blanking period for video signals in order to reduce the number of input signal lines for the source driver. To accomplish this, the current precharge period setting line 1096 and precharge current setting line 1091 are extracted from the video signal line 856 via the video signal/command separating section 931.

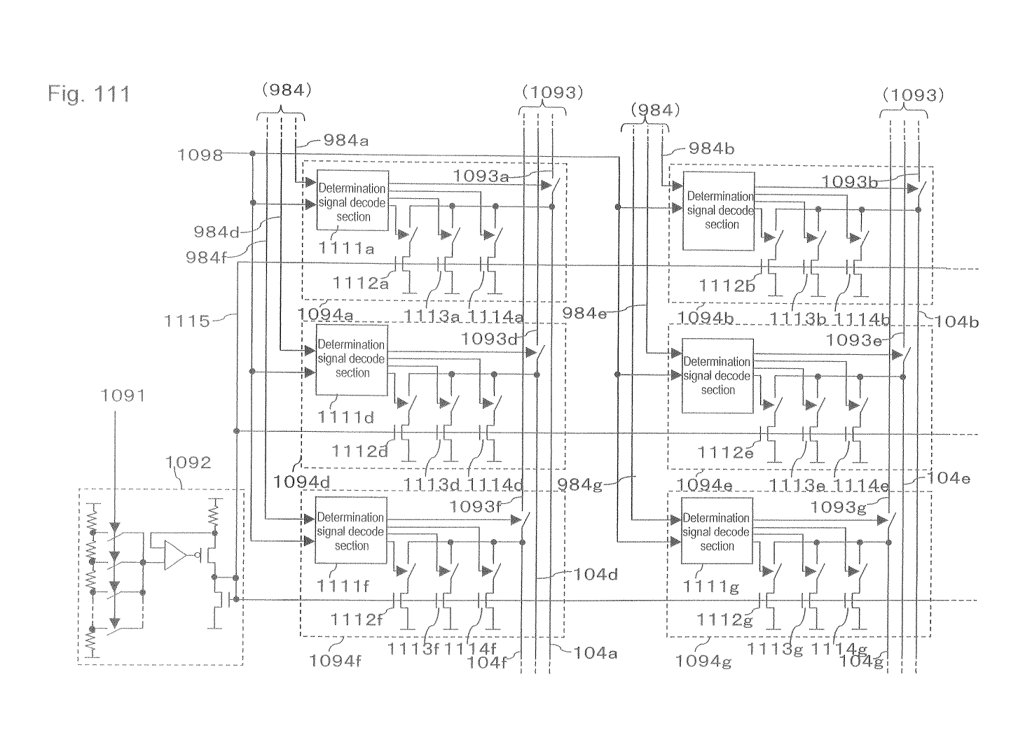

FIG. 111 shows the circuit configuration of the precharge current output stage 1094 and precharge reference current generating section 1092. (This example uses two sets each of three colors).

In the precharge current output stage 1094, a determination signal decode section 1111 connects one of precharge current source transistors 1112 to 1114 and the gray level current 1093 to the output 104 to select whether or not to output the precharge current; the precharge determination line 984 and the precharge pulse 1098 are input to the determination signal decode section 1111.

Thus, when the precharge pulse 1098 is at the high level, it is possible to determine on the basis of the value for the precharge determination line 984 which of the precharge current sources is used for output or whether or not to output a gray level current without using the precharge current.

The precharge current may have only one value. However, since the required current value varies depending on the panel size, that is, the capacity value, when the IC driver is used for a general purpose with an arbitrary size, the general purpose properties of the IC driver can be improved by adjusting the current so that it has a plurality of values for a large- and small-sized applications.

The pulse width of the precharge pulse 1098 is preferably at least 5 μs and at most 50% of the horizontal scan period, though it depends on the panel size and the length of the horizontal scan period. If a predetermined gray level cannot be written within this range, the precharge current is increased. In connection with the value for the gray level data 386 indicating the period into which the precharge current is inserted, the precharge determination signal 383 may be controlled so that the precharge current is applied if the current output by the current output stage 23 on the basis of the gray level data 386 is less than the precharge current. The precharge determination signal 383 may be subjected to small-amplitude differential input in such as form as shown in FIG. 95 in order to reduce the number of input signal lines and to avoid electromagnetic waves.

Thus, the desired current can be written by inputting the precharge current even if the current row data is at a higher gray level than the preceding row data.

When a high gray level changes to a lower one, the target current value can substantially be written as shown in FIG. 104. Accordingly, the above configuration meets the requirements. However, for gray level 0 (black), by allowing black to be appropriately displayed, it is possible to emphasize the advantages of improving the contrast and being able to display black, which is characteristic of self-luminescent elements.

Thus, when a gray level different from zero changes to gray level 0, adequate black is realized by applying a voltage required to display black using voltage, during a period at the beginning of a horizontal scan period which corresponds to a fourth period according to the present invention. If the voltage corresponding to the black current is applied to the source signal line, then with particular applied voltages and particular pixels, a phenomenon in which black appears to stand out against the image owing to a variation in the current/voltage characteristic of the driving transistor 62. A variation in luminance associated with the variation among the driving transistors can be prevented by applying a voltage (precharge voltage) that prevents current from flowing through even the driving transistor 62 through which current tends to flow most favorably, taking the variation in the current/voltage characteristic into account. The fourth period is set at a period at the beginning of the first period if the third period is set at 0. The fourth period is set at a period at the beginning of the third period if the third period is set at a value different from 0.

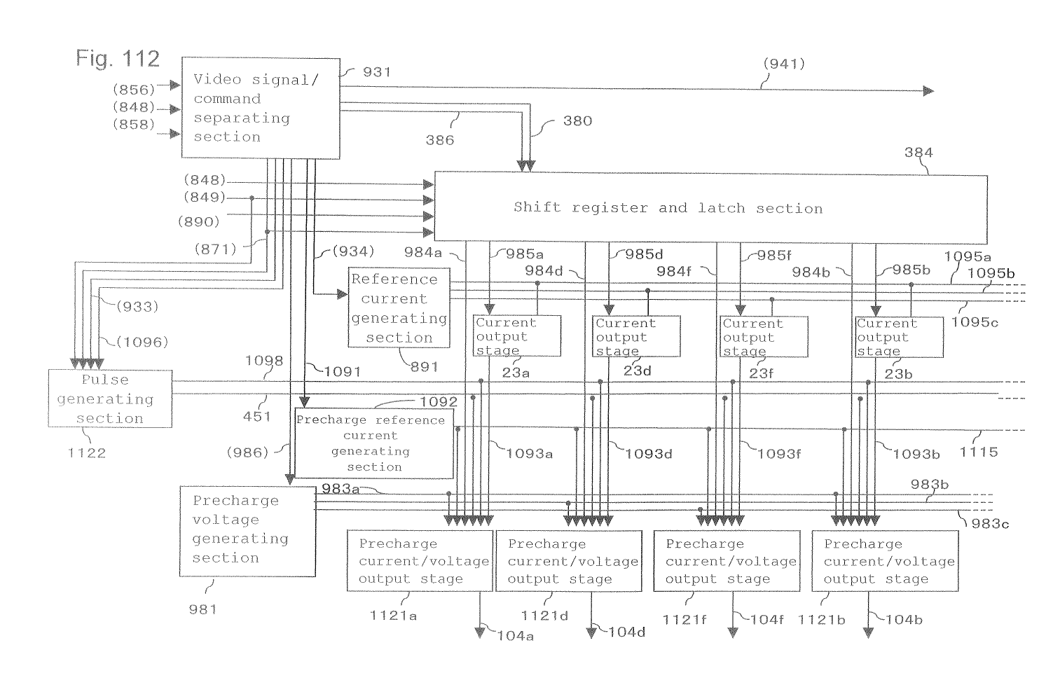

FIG. 112 shows the configuration of a source driver that can apply the precharge current or precharge voltage during a horizontal scan period. This source driver is characterized by including the precharge voltage generating section 981 and the voltage precharge pulse 451 that specifies the period during which voltage precharge is carried out, so as to enable the supply of the precharge voltage.

If precharge is carried out using voltage, the source signal line can be sufficiently precharged with a voltage application period of at least 0.8 μs and at most 3 μs. Thus, the precharge voltage is applied only for a shorter period than the precharge current. Accordingly, the signal line voltage precharge pulse 451, which is different from the current precharge pulse 1098, is input. The voltage precharge may use the same period as that used by the current precharge. In this case, however, the period during which the current corresponding to the gray level is provided is reduced to prevent a possible variation among the driving transistors from being sufficiently corrected using current. This may lead to an uneven luminance if the voltage value for black display changes. Thus, the voltage application period is minimized to increase the period of gray level current output (In each panel, the precharge voltage can be adjusted depending on a variation among the driving transistors 62. However, actually, the characteristics of the driving transistor 62 may vary greatly among panels or lots. In contrast, the adjustment of the precharge voltage allows the same period to be shared but requires an additional adjusting process. Consequently, the adjustment of the precharge voltage is not practical. To provide this adjusting function using current, it is favorable to increase the period of gray level current output. In a small-sized panel, the source line capacity is relatively small and the horizontal scan period is long. Accordingly, sufficient corrections can be made in spite of the sharing of the same period. Therefore, the two precharge pulses share the same period with the chip size given top priority).

The two precharge pulses 1098 and 451 have the same start position (beginning of a horizontal scan period) and differ only in pulse width. Accordingly, these precharge pulses can be created using a counter produced by the source driver clock 871 and timing pulse 849. The pulse widths are defined by the current precharge period setting line 1096 and a voltage precharge period setting line 933, respectively. As in the case of the configuration in FIG. 109, the precharge pulses are transmitted using blanking periods of the video signal lines 856, in order to reduce the number of I/O signal lines in the source driver. The two pulses are output at a time during one horizontal scan period. Consequently, settings are rewritten at most once during one horizontal scan period. Therefore, signals to be set may be inserted into blanking periods in the above manner.

The precharge voltage generating section 981 generates an applied precharge voltage value. If there are a plurality of voltages for each color which are output to a precharge current/voltage output stage 112, a configuration similar to that shown in FIG. 99 may be used. However, if the voltage corresponding to gray level 0 is used for each color, then the electronic regulator and the operational amplifier may form the three voltages. Then, the electronic regulator may adjust the voltage values. With either of these configurations, the precharge voltage setting line 986 adjusts the voltage values. As in the case of the precharge pulses, settings are made during blanking periods of the video signal line 856.

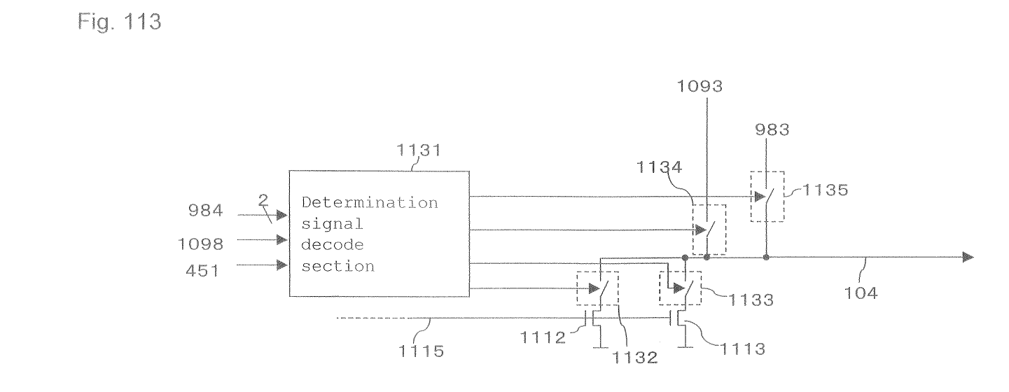

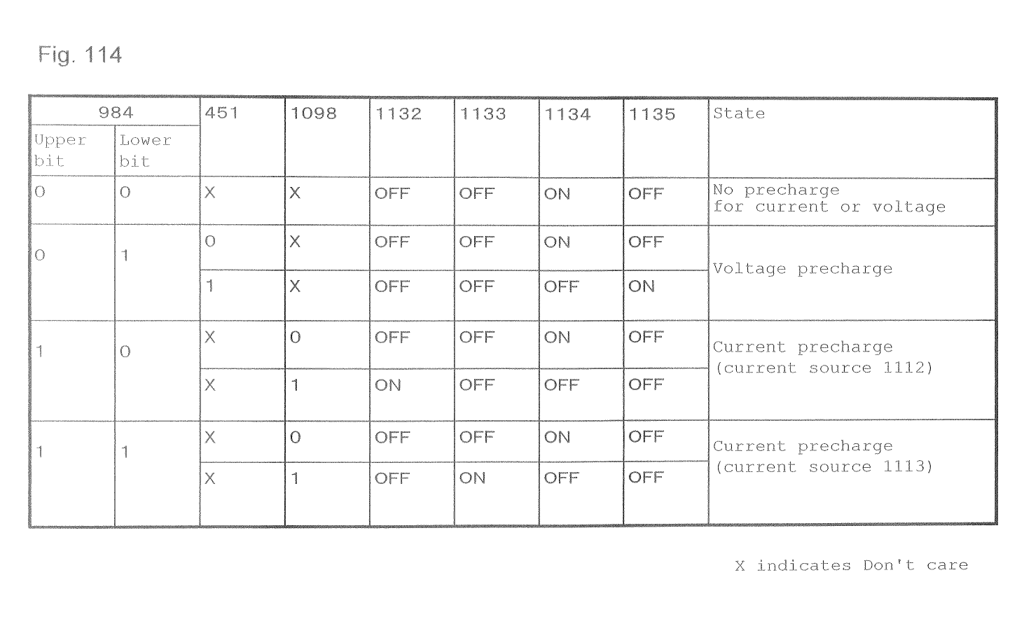

The precharge current/voltage output instrument 1121 selects which of the precharge voltage, precharge current, and gray level current is to be output on the basis of a predetermined first and second conditions of the present invention. FIG. 113 shows the circuit configuration of the precharge current/voltage output instrument 1121. In this example, selection is made from the two precharge current sources 1112 and 1113 and the one precharge voltage line 983, that is, three items in total, as well as the gray level current 1093. Accordingly, the precharge determination line 984 contains 2 bits. A determination signal decode section 1131 performs a decode operation to determine which of the four items is to be output on the basis of the determination line 984 and precharge pulses 1098 and 451. FIG. 114 shows the relationship of the states of switching sections 1132, 1133, 1134, and 1135 and an input signal. The precharge determination line 984 determines whether or not to carry out precharge, and if precharge is to be carried out, whether it is to be carried out using current or voltage. Moreover, if precharge is to be carried out, it is executed only during the current or voltage precharge pulse and the gray level current is output during the other periods. This has provided a source driver IC having a current or voltage precharge function. FIGS. 112 to 114 show the predetermined first and second conditions according to the present invention. In the description of these figured, one voltage for voltage precharge is used for each color, and two currents for current precharge are used for each color. However, the present invention can be implemented with arbitrary types of voltages and currents.

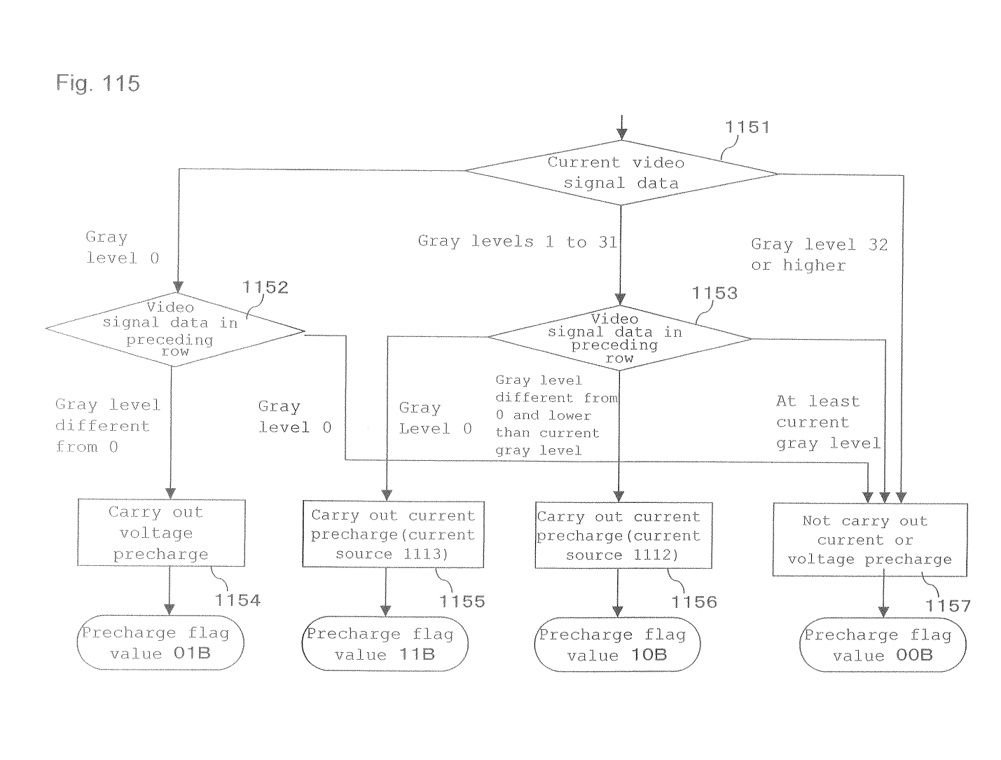

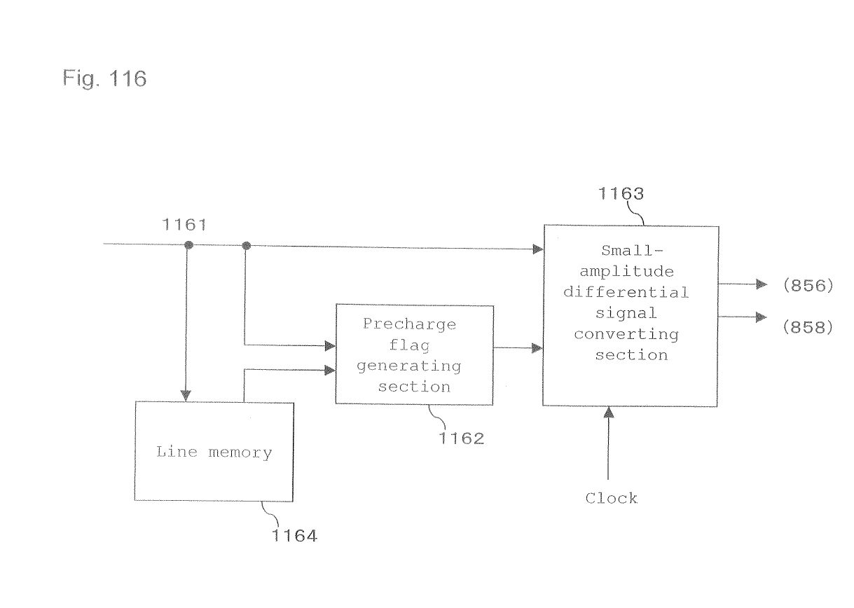

FIG. 115 is a flowchart showing generation of a precharge flag, on which the precharge determination line is based.

Conditions for precharge will be discussed. The predetermined second condition of the present invention is that voltage precharge is carried out only on gray level 0. Moreover, when the preceding row is also at gray level 0, the signal line remains unchanged during these two horizontal scan periods. Accordingly, voltage precharge need not be carried out and thus is not executed. Then, for current precharge, at a specified gray level or higher, a writing operation can be sufficiently performed using the gray level current regardless of the data in the preceding row. Consequently, current precharge is not required. In general, current precharge is unnecessary for gray levels at which a gray level current larger than the current value Ip of the current precharge current source is output. FIG. 115 is a flowchart for an example of a 3.5 type QVGA panel. In this example, current precharge is not required for gray level 32 or higher because the gray level can be changed to a predetermined one. Current precharge is required for display rows with gray level 1 to 31 if the preceding row data is at a gray level higher than the display gray level. Current precharge is unnecessary if the current row data is at a gray level equal to or lower than that of the preceding row data. If the preceding row data is at gray level 0, the precharge voltage has often been applied. Thus, a voltage higher than that for the predetermined gray level is applied to prevent a variation in luminance associated with voltage. This increases the amount of change in the potential across the source signal line to make it difficult to write the predetermined gray level. Thus, when the preceding row data is at gray level 0, it is possible to provide a current Ip0, which has a larger precharge current value than Ip, and output this current after gray level 0.

To carry out such precharge, as shown in FIG. 115, video signal data is checked in accordance with the flow shown at 1151 and is branched to one of three flows for gray level 32 or higher, which requires no precharge, for gray level 0, on which voltage precharge is carried out, and for the other gray levels. For gray level 32 or higher, precharge is not required. Accordingly, on the basis of a determination at 1157, the precharge flag value is set to 0 (the truth table for the determination signal decode section 1131, shown in FIG. 114, is used). For gray level 0, the preceding row data is referenced in accordance with flow 1152. Since precharge is unnecessary for gray level 0, different determinations are made for gray level 0 and for the other gray levels. For gray level 0, the circuit does not determine that precharge is to be carried out as shown at 1157 and the flag is set to 0. For the other gray levels, the circuit determines that precharge is to be carried out as shown at 1154 and the flag is set to 1.

For remaining gray levels 1 to 31, if the preceding row data is at a gray level higher than that of the current row data, precharge is not required. Accordingly, precharge is not carried out as shown at 1157 and the flag is set to 0. For gray level 0, the current Ip0 is required as a precharge current, so that current precharge (current source 1113) is carried out as shown at 1155. Thus, the flag value is set to 3. Otherwise, normal current precharge (current value Ip) is used, so that current precharge (current source 1112) is carried out as shown at 1156. The precharge flag outputs 2 (it is assumed that the current source 1112 is for Ip and that the current source 1113 is for IP0).

Some panels have increased Ip values and a correspondingly increased number of gray levels requiring precharge. To allow for this, the branching command at 1151 may have branching conditions that can be changed in accordance with external commands or the like. Further, when for example, the number of precharge current sources and voltage sources increases, a flowchart can be appropriately created and implemented in the circuit.

A precharge flag generating section 1162 implementing this flowchart is normally placed in the controller 854 to receive a video signal 1161 and an output from a line memory 1164 that stores the preceding row data. An output from the precharge flag generating section 1162 is input to a small-amplitude differential signal converting section 1163 in synchronism with the video signal 1161. In the small-amplitude differential signal converting section 1163, the input data is converted into a small-amplitude differential signal in order to reduce the number of signal lines and to avoid electromagnetic noise. Moreover, during a blanking period, a source driver control signal is inserted into the data. As a result, the small-amplitude differential signal converting section 1163 outputs the video signal line 856 and the clock 858 to the source driver. If the controller and source driver are composed of one IC, the small-amplitude differential signal converting section 1163 is not required. Thus, the output from the line memory 1164 and the video signal 1161 are input directly to the shift register and latch section 384.

In FIGS. 109 and 112, the gate driver control line 941 is output. However, this signal is used to reduce the number of controller output signal lines and is not required if the number of controller output signal lines is not restricted.

It has been found that the current quantity of required current precharge varies depending on the display gray level of the preceding row even if display is provided at the same gray level. If for example, gray level 16 is displayed, when the preceding row is at gray level 0, the precharge current corresponding to gray level 64 is required. When the preceding row is at gray level 1 or 2, the precharge current corresponding to gray level 26 or 16 (this may be omitted) is required. Thus, in determining the precharge current, it is necessary to reference the preceding row data and set the optimum precharge current on the basis of the values for the preceding row data and current row data.

The precharge current may be controlled by providing a matrix table indicating the relationship between the preceding row data and the current row data and the precharge voltage value. However, disadvantageously, the size of the table increases consistently with the number of gray levels, thus increasing the circuit scale in the IC design.

The matrix table must be provided to determine the precharge current because the time of change varies greatly depending on the original state of the source signal line. The time required for a current change is expressed by (capacity of the source signal line)×(difference in source signal line potential between the preceding row and the current row)/(source signal line current). As shown in FIG. 106, the relationship between the current and voltage of the source signal line conforms to the characteristics of the driving transistor 62. The relationship is thus expressed as a nonlinear curve. The difference in potential per gray level is larger at a lower display gray level. Thus, the time required to change to a predetermined current varies significantly even with the same gray level difference. For example, the potential difference between gray levels 2 and 4 is half that between gray levels 0 and 2. Further, the source signal line current is doubled, so that the write time is quartered. Consequently, (if the gray level difference remains unchanged and is 2), it is necessary not only to detect the gray level difference but also to determine precharge on the basis of the gray level difference and display gray level. At least the data in the preceding and the data in current rows must thus be referenced.

Provided that the gray level difference is in proportion to the source potential difference, the source potential difference and thus the required current are uniquely determined for a gray level difference of 1. On the basis of these values, the required current quantity can be calculated for an arbitrary gray level difference. That is, the required current value is determined from the results of calculation of the gray level difference. Therefore, the precharge current can be determined using instrument which memorizes the data in the preceding row and even the required current for a gray level difference of 1.

However, in the self-luminescent display apparatus according to the present invention, the gray level difference is not in proportion to the source potential difference. The source potential difference may vary even with the same gray level difference. Accordingly, the precharge potential value is determined by first calculating the potential difference in the source signal line referring the data in the preceding and current rows. That is, the precharge current must be determined on the basis of the potential difference in the source signal line. It is impossible to calculate the relationship between the data in the preceding row and the data in the current row and the source signal line potential difference; this operation is actually impossible because it involves calculations that require the circuit scale to be sharply increased. It is thus necessary to provide a table in advance and memorize precharge current values for all gray level combinations so that the current value can be found on the basis of the data in the preceding and current rows.

For 256 gray levels, precharge current values must be memorized for all of more than 65,000 combinations. In this case, it is also quite difficult to actually produce a circuit (For actual production, the circuit scale is reduced by avoiding memorizing combinations of gray levels that do not require current precharge. This enables the calculation to be achieved with a memory amount corresponding to about 10,000 combinations).

Thus, to further reduce the circuit scale that determines the precharge current value, the present invention applies a voltage corresponding to gray level 0 at the beginning of a horizontal scan period using voltage. The state of the source signal line can be changed to gray level 0 in about 1 to 3 μs using voltage. That is, the change is completed during a period equal to 10% of a horizontal scan period. This enables the state of the source signal line to change to gray level 0 without sacrificing much of the time required for the write operation.

Since the period is provided during which the voltage corresponding to gray level 0 is applied (voltage reset period), the change in the state of the source signal line always starts from gray level 0. This eliminates the need to memorize the state of the preceding row. Since (the change always starts from gray level 0 and thus) it is only necessary to memorize the precharge current corresponding to the display gray level, the memory amount decrease drastically. At most about 70 combinations need to be memorized.

Even a lower gray level region with a lower current change speed can have its state quickly changed by providing a precharge current output period after the voltage reset period in order to quickly change the current to a predetermined value, changing the current to the vicinity of a predetermined gray level, and then outputting the current corresponding to the predetermined gray level.

With a method of adjusting the precharge current to an optimum value for output on the basis of the display gray level, each output requires a number of current sources corresponding to the optimum precharge current value and to required types of current values. The installation of the current precharge current source in addition to the gray level display current source 241 increases the size of the source driver circuit and thus the chip size. Further, the time required to change current varies depending on the capacity of the source signal line. Accordingly, panels of different sizes may have different current precharge current values. The precharge current cannot be changed in a driver IC having a circuit already formed. For example, selection patterns for the current value corresponding to the gray level may be changed by creating current values the number of which is smaller or larger than that required. However, this disadvantageously increases the circuit scale. To allow the optimum current precharge corresponding to any of a plurality of panel sizes to be carried out in accordance with external command operations or the like, the present invention thus changes the period of precharge current application instead of changing the current value depending on the gray level.

Specifically, the precharge current corresponds to the current for the maximum gray level display. When the time of precharge current application changes and decreases, the precharge current makes a small amount of change to provide a current for a lower gray level. If the time increases, the precharge current makes a large amount of change to provide a current for a higher gray level.

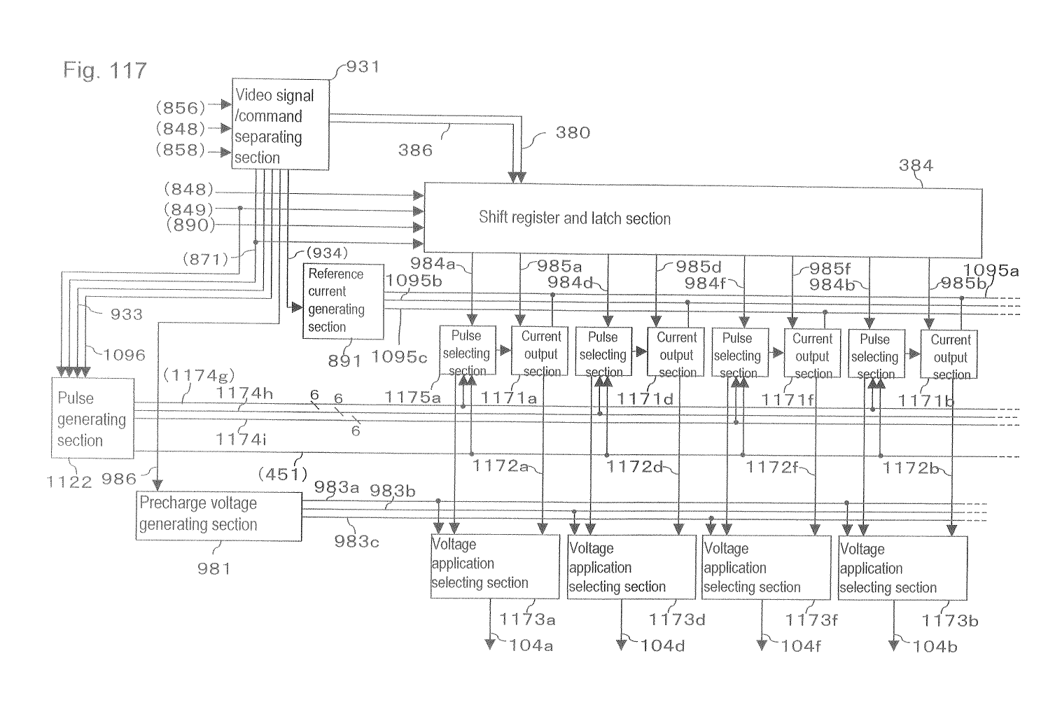

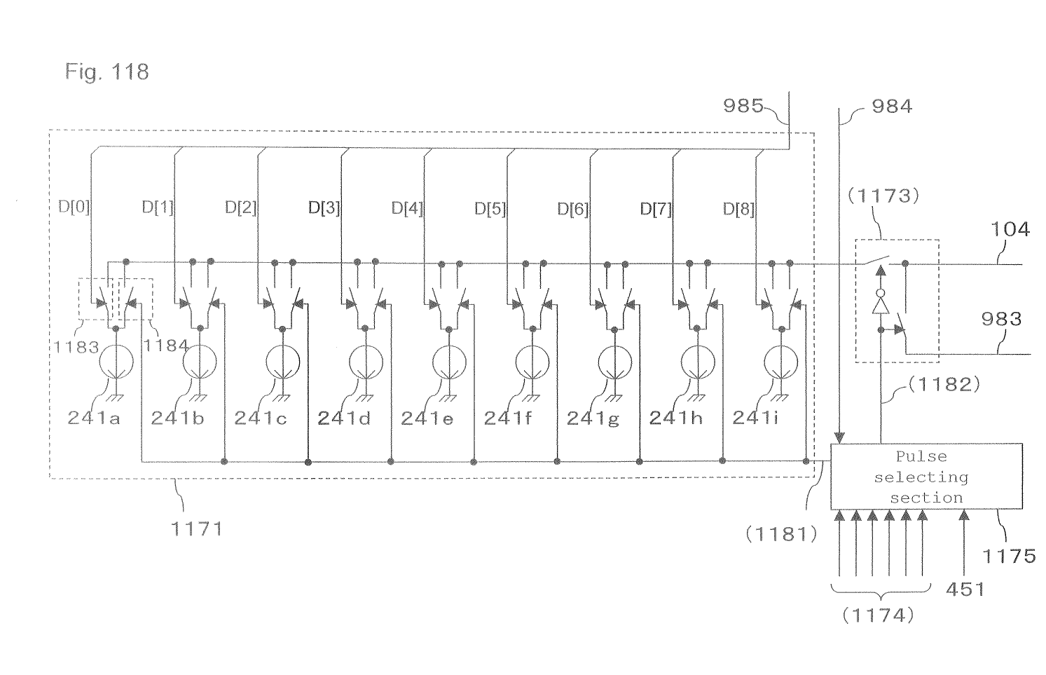

FIG. 117 shows the configuration of a source driver that realizes the above operations. Further, FIG. 118 shows an example of the configuration of a circuit in a current output section 1171 that outputs the precharge current and the current corresponding to the gray level.

In FIG. 118, switching instrument 1183 controlled by the gray level data line 985 determines whether or not to connect the gray level display current source 241 to the output 104. This current source is designed to have a current quantity varying according to the weights of the bits on the gray level data line 985. Specifically, current can be precisely output by forming current sources using transistors as shown in FIG. 25 and weighting the current on the basis of the number of current sources.

The circuit scale of the current source section is reduced by enabling the precharge current to be output by the same current source. To accomplish this, switching instrument 1184 is connected in parallel with the switching instrument 1183 to determine whether or not connect the current source 241 to the output 104. Further, a current precharge control line 1181 controls the switching instrument 1184 to allow the current source to be shared. This reduces the circuit scale. The single current source 241 can be provided simply by arranging the switching instrument 1183 and 1184 in parallel because the precharge current is a maximum current (white display current). The switching instrument are connected in parallel, but when one of them is set in the conductive state, the connected current source outputs current. Accordingly, these two switches provide a logical OR circuit. If the current precharge control line 1181 is at the high level during a current precharge output period, whereas the control line 1181 is at the low level when no output is provided, then when no output is provided, the gray level data 985 causes current output, whereas when output is provided, all the current source 241 is output by the current precharge control line 241. Consequently, the precharge current can be output regardless of the gray level data 985. The use of the maximum current value advantageously increases the speed of current change to enable the minimization of a precharge current output period 1203. Therefore, it is possible to increase a gray level current output period 1204 used to allow precise gray level display.

The switching instrument 1183 and 1184 connected in parallel eliminate the need for elements for logical calculations. This enables the circuit scale to be reduced.

To allow the precharge current output period to be controlled using the gray level, it is possible to use the gray level to vary the period during which the current precharge control line 1181 is at the high level. Thus, according to the present invention, a pulse selecting section 1175 and a plurality of current precharge pulses are provided to select a current precharge pulse from a group of current precharge pulses 1174 according to the value for the precharge determination line 984. Further, command settings are used to preset the current precharge pulses 1174 so that they have different high level periods, thus enabling the precharge period to be varied.

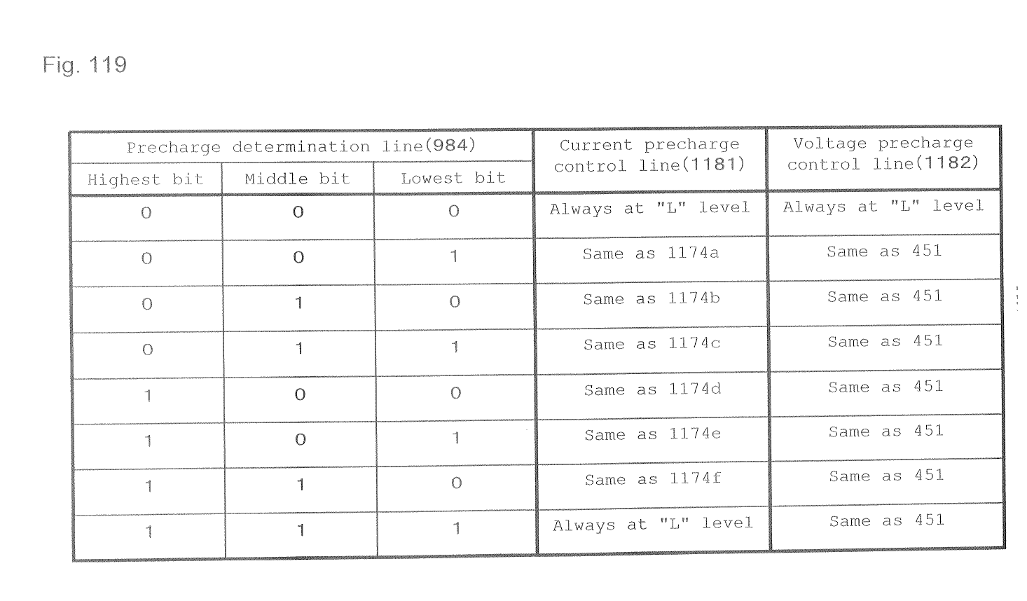

FIG. 119 shows the I/O relationship in the pulse selecting section 1175. The value for the precharge determination line 984 varies the states of the current precharge control line 1181 and a voltage precharge control line 1182. If the state of the source signal line remains unchanged, for example, the same gray level is continuously displayed over a number of rows, voltage and current precharge is not required. Accordingly, in this example, when the precharge determination line 984 is at gray level 0, only the current output corresponding to the gray level is carried out. Further, for gray level 0, voltage precharge causes this gray level 0 to be displayed, thus eliminating the need for current precharge. Therefore, a mode is provided in which whenever the precharge determination line 984 exhibits 7, only the current precharge control line is at the low level. For any other determination value, one of a plurality of current precharge pulses having different pulse widths can be selected.

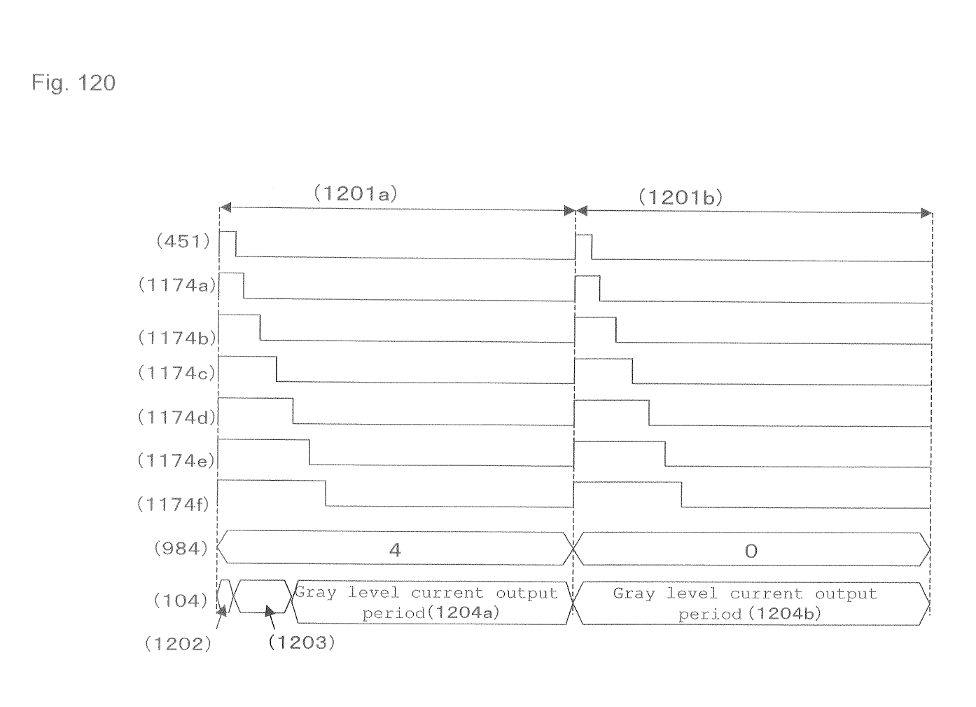

Thus, as shown in FIG. 120, a signal output to the output 104 is determined on the basis of the precharge determination line 984, the voltage precharge pulse 451, and the current precharge pulse 1174. According to the relationship shown in FIG. 119, the output is subjected to voltage precharge during the first horizontal scan period, followed by the precharge current output period 1203 corresponding to a current precharge pulse 1174d. The process finally enters the gray level current output period 1204. Only the gray level current output period 1204 is present during the next one horizontal scan period. This enables the period of current precharge to be varied using the precharge determination line 984. Further, the circuit is designed so that the high level period of each current precharge pulse 1174 can be varied using an external input. Then, the optimum current precharge can be carried out according to the panel size and the horizontal scan period. A source driver can thus be provided which corresponds to an arbitrary panel size and pixel number.

According to the present invention, a pulse generating section 1122 generates a group of current precharge pulses 1174 and a voltage precharge pulse 451 as shown in FIG. 117. The current precharge period setting line 1096 and the voltage precharge period setting 933 are externally input to the pulse generating section 1122 via the video signal/command separating section 931. Thus, a precharge pulse with an arbitrary pulse width can be realized using an external command.

Further, in a display apparatus using an organic light emitting device, since the display colors have different luminous efficiencies, the current value per gray level disadvantageously varies with the colors, thus varying the precharge current value. The most efficient display color has such a small white display current value that the current cannot be changed enough to obtain a predetermined gray level. Thus, the present invention solves this problem by providing current precharge pulses 1174g, 1174h, and 1174i for the respective colors to adjust the period of current application. Specifically, for the most efficient color, the width of the precharge pulse is generally increased to compensate for the small current quantity.

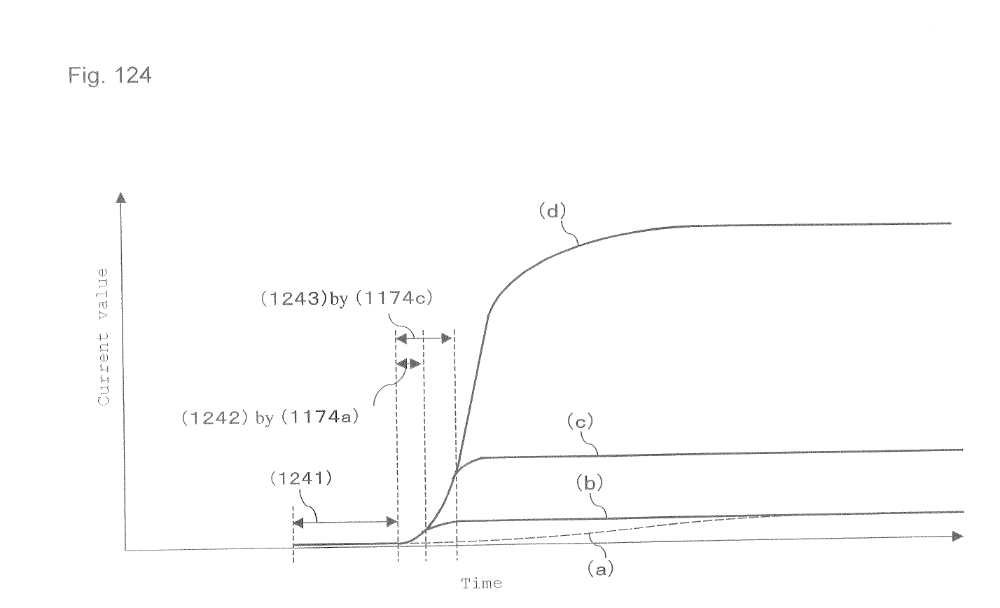

With reference to the current change shown in FIG. 124, description will be given of the capability of setting a predetermined current by varying the length of the precharge pulse 1174 depending on a gray level. (In the description below, it is assumed that the driver provides 8 bit outputs and can output 256 gray levels. The description can be similarly applied to a driver with an arbitrary number of bits by assuming the number of gray levels corresponding to the number of bits used).

When the period of the current precharge pulse is shown, for example, by 1174a, a precharge current output period 1242 causes current to change quickly before the predetermined current is output. Consequently, the current changes slowly as shown by such a curve as shown in FIG. 124 (b).

On the other hand, if current precharge is output for an extended period, for example, a period 1174c, the current changes quickly during a period 1243. Subsequently, the predetermined current causes a slow variation until gray level 30 is reached (curve 124 (c)).

Moreover, if the current precharge pulse is always applied, such a variation as shown in FIG. 124 (d) occurs.

The current change curve in FIG. 124 (d) indicates that the current can be changed most quickly by carrying out current precharge until the gray level comes close to the predetermined value and then outputting the predetermined gray level current. Thus, the precharge current output period is increased for a higher gray level, while it is reduced for a lower gray level. Then, the gray level can be changed to the predetermined value using only the application period without the need to vary the precharge voltage value itself.

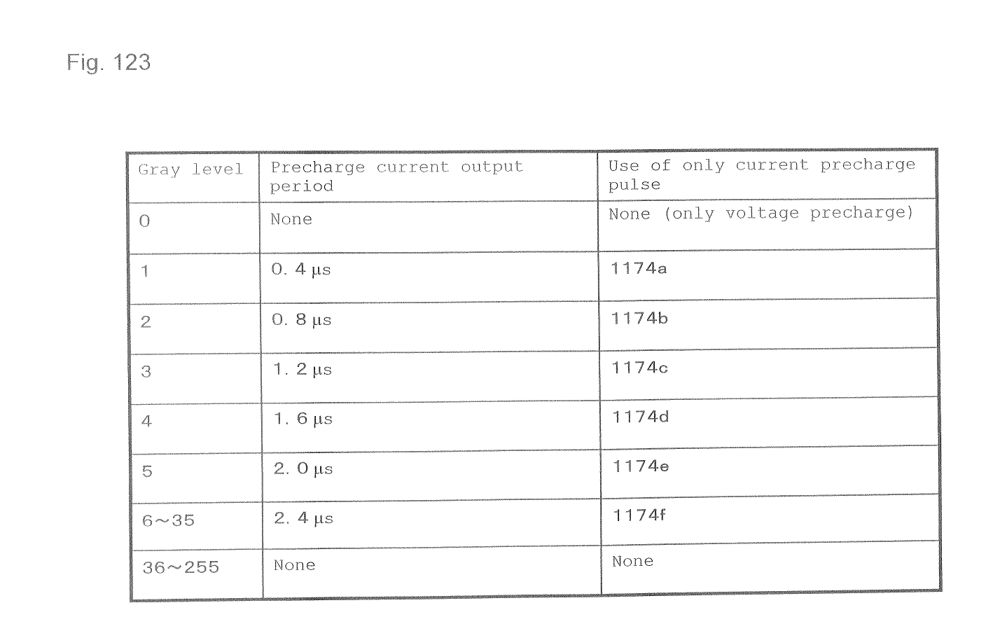

FIG. 123 shows the relationship between the required precharge current period and gray level in a 3.5 type QVGA panel. A higher gray level requires a longer precharge current period. It has also been found that the precharge current period is not required for gray level 36 or higher. Thus, the required current periods are associated with the required current precharge pulses as shown in FIG. 123. Further, an external command is used to specify the high level period of each current precharge pulse as shown in FIG. 123. Then, for all the gray level changes, the predetermined gray level can be appropriately displayed even in the succeeding row using one precharge current source and external command operations.

The correspondence between the gray level and the current precharge pulse can be replaced with the correspondence between the precharge determination line 984 and the current precharge pulse. The gray level can be associated with the current precharge pulse by using the control IC or the like to generate and supply the precharge determination signal corresponding to gray level data so that the desired precharge pulse is selected for the display gray level.

This is advantageous in that when the correspondence between the gray level and the current precharge pulse changes, the control IC can controllably change the current precharge pulse in association with the gray level.

For a large current value per gray level, the predetermined gray level can be displayed without current precharge even at a lower gray level. If for example, the current is doubled per gray level compared to that shown in FIG. 123, theoretically the data can be written without current precharge at gray level 18 or higher. This can be dealt with by changing processing by the control IC, which controls the relationship between the gray level and the precharge determination line 984, to rewrite the relationship.

Thus, the precharge determination line is provided separately from the gray level signal and used to select the current precharge pulse. This has enabled the same source driver to be used for display even when the luminous efficiency of the organic light emitting device changes.

In the method of selecting one of the precharge pulses 1174 with the respective pulse widths according to the value for the precharge determination line 984, signals defining a large number of pulse widths is required to enable all the pulse widths of the plurality of precharge pulses 1174 to be controlled using external commands. A large number of input pins are required to directly receive all these signals input by a circuit outside the driver IC 36. This is not practical. Thus, the present invention utilizes blanking periods of a video signal to serially transfer all set values over the video signal line 856 during the blanking periods. This makes it possible to set the precharge pulse width without the need to increase the number of external signal lines.

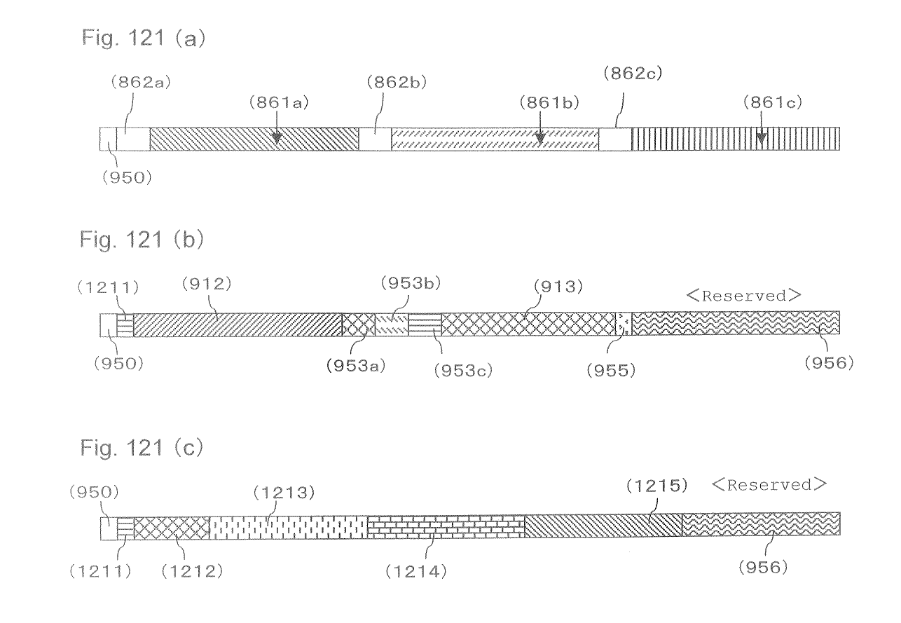

FIG. 121 shows a signal input method of inputting commands utilizing the video signal line 856. While a video signal is being transmitted, each display color data 861 (In this case, red, green, and blue are assumed. However, it is possible to use data on arbitrary colors other than these three, for example, three colors including cyan, yellow, and magenta) and the precharge flag 862 are input in association with each other, as shown in FIG. 121 (a); the precharge flag 862 is a signal used to determine whether or not to carry out precharge on each data 861. A data/command flag 950 is also transmitted which is used to determine whether or not the signal is a video signal. For example, when the flag is set to 1 for data and to 0 for a command, referencing this bit makes it possible to determine whether the sent signal is a video signal or a command.

Then, commands are transmitted during blanking periods. The data/command flag 950 is set to 0 to make it possible to determine that the signal is a command. This determination is unwanted if all command settings can be achieved during one transfer. However, since the present invention involves a large number of commands, a number of bits are used as an address so as to make it possible to determine the command corresponding to the data on the basis of the value of the address. In the example shown in FIG. 121, an address A1211 is used to determine whether or not the data corresponds to a current precharge setting signal. In FIG. 121 (b), not only the current precharge period but also other required signals are set; the following signals are transmitted: a precharge voltage value, a voltage precharge period, and a reference current setting signal 912 defining a current per gray level. In FIG. 121 (c), current precharge output periods must be set for each color. Accordingly, an address B1212 is further provided so that which current precharge pulse is to have its pulse width set can be determined on the basis of the value of the address B1212.

The pulse width of the current precharge pulse is in about 0.4 μs increments as shown in FIG. 123. Accordingly, an arbitrary panel can be adjusted by setting the increments at 0.2 or 0.4 μs and the variable range at about 6.4 μs. It is only necessary to set 32 or 16 levels. Since the pulses 1174a to 1174f need not have the same pulse width, it is advisable to be able to set their pulse widths at different values. Moreover, the following configuration is possible. Different tasks are allotted to the pulses in such a way that the pulse 1174a has the minimum pulse width, while the pulse 1174f has the maximum pulse width. Then, a pulse width ranging from 0.2 μs to 8.4 μs can be set in such a way that, for example, the adjustment range of the pulse 1174a is 0.2 to 6.6 μs (32-level adjustment), while the adjustment range of the pulse 1174f is 2.0 to 8.4 μs (32-level adjustment). In this manner, the variable range can be reduced by setting slightly different variable ranges for the pulse widths of the respective pulses. Therefore, setting signal line width can be reduced, providing a small circuit scale.

A source driver IC36 has been provided by thus allowing the externally input command to set various values; the source driver IC36 can quickly output the current corresponding to the gray level of a display apparatus with an arbitrary panel size and an arbitrary resolution.

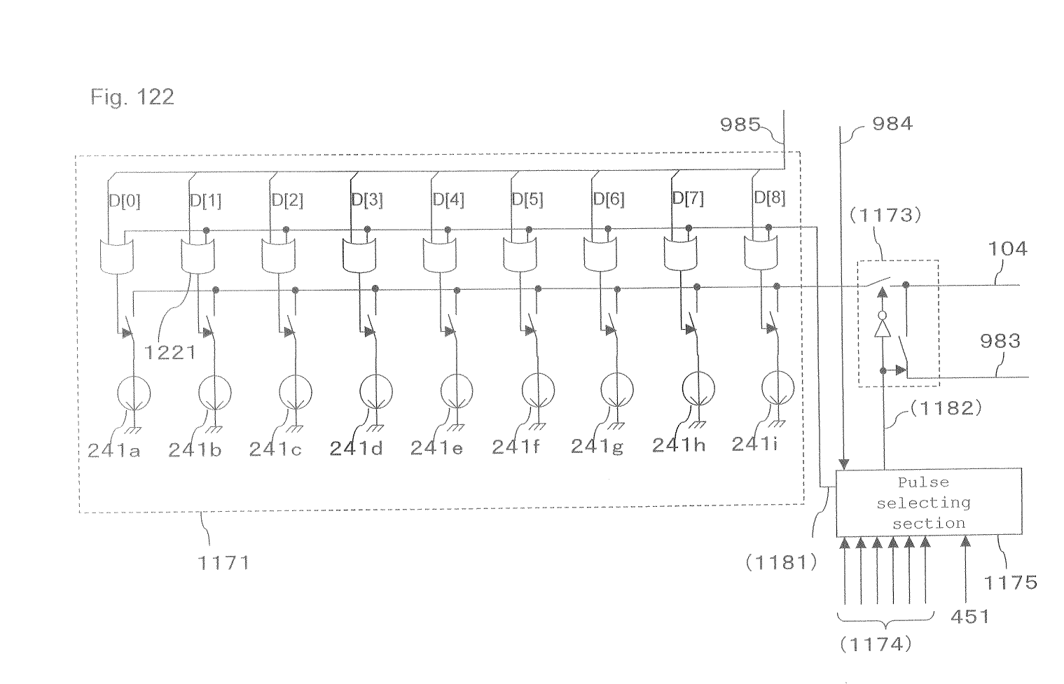

A current output section 1171 according to the present invention is composed of a plurality of switching sections connected in parallel with one current source 241 as shown in FIG. 118. Alternatively, the current output section 1171 may be implemented by using the logical OR of each bit of the gray level data line 985 and the current precharge control line 1181 to control a switching section 1221 connected to the current source 241, as shown in FIG. 122. With a process allowing the formation of smaller switching sections 1183 and 1184, the current switching section 1171 shown in FIG. 118 has a smaller scale. However, if this process fails to enable the size reduction, a logical OR circuit may be added which can be created on the basis of a logic signal rule.

The smaller of these two circuits may be adopted taking a process rule into account.

In this example, the voltage precharge pulse 451 is input with the same pulse regardless of the display color. The reason is as follows. When the state of the source signal line is changed using voltage, the speed of the change in state is determined by the driving capability of the operational amplifier for outputs. The change in state is not affected by different signals for the respective display colors such as different currents for the respective gray levels. Thus, only one voltage precharge pulse 451 is used to reduce the circuit scale. If the circuit scale has no particular limitations, three pulses may be used to allow the respective colors to be individually specified.

The source driver IC36 with the output stage shown in FIG. 118 or 122 can provide outputs with the precharge current output period 1243 on the basis of the relationship between the gray level and the precharge pulse such as the one shown in FIG. 123. When the precharge current output period 1243 is simply determined for the gray level on the basis of the relationship shown in FIG. 123, precharge is carried out even if, for example, the same gray level is continuously output with the source signal line remaining unchanged.

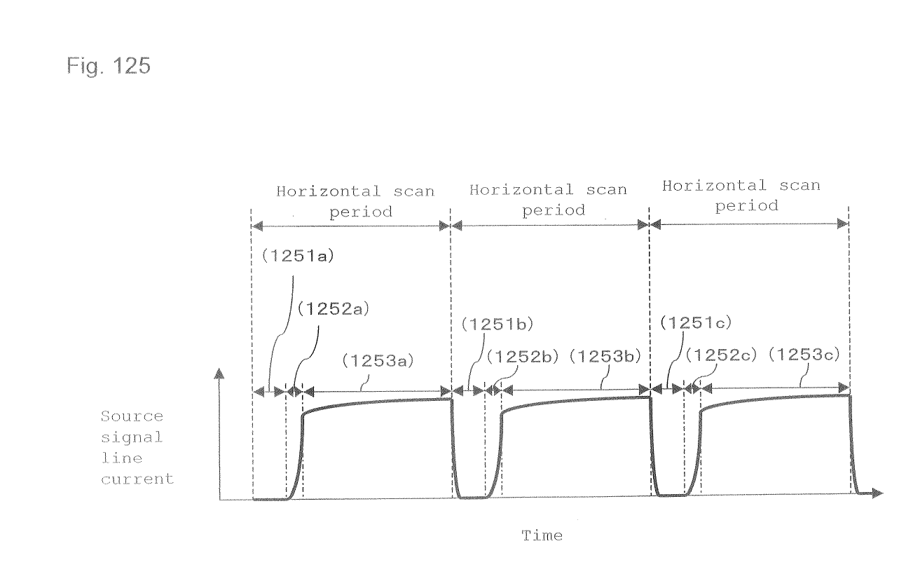

As shown in FIG. 125, at the beginning of a horizontal scan period, the signal line changes to a black display state during a precharge voltage application period 1251. Then, the state of the source signal line changes to a current value close to a predetermined one during a precharge current output period 1252. Then, during the final gray level current output period 1253, the current changes to the predetermined current value. In this manner, the source signal line current changes to the black state at the beginning of the horizontal scan period. Consequently, the change in the signal line is more marked than in the case in which precharge current output is not provided. This may increase the possibility of an insufficient write operation.

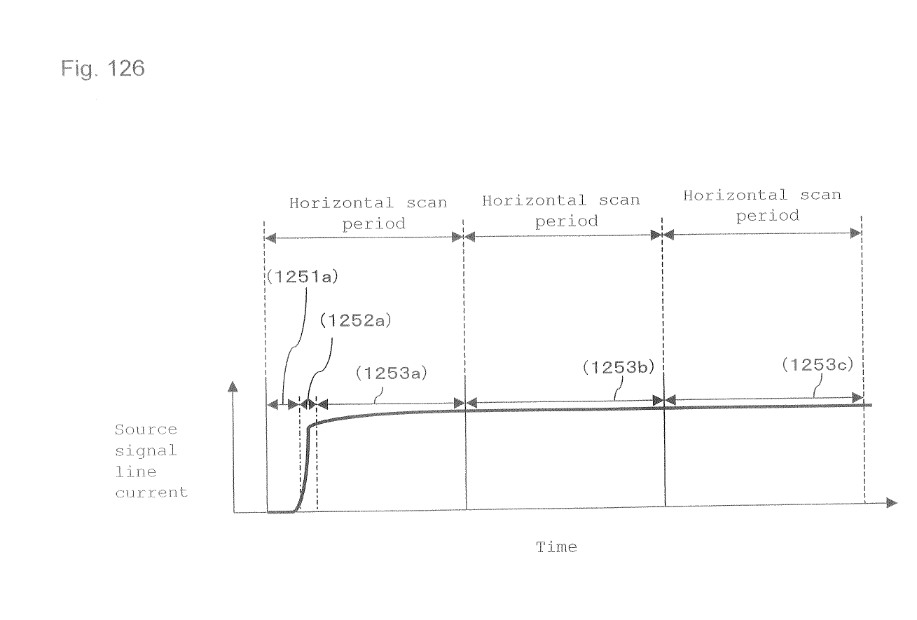

Thus, according to the present invention, as shown in FIG. 126, if the same gray level current is continuously output, the precharge current output period 12152 is not provided but only the gray level current output period 1253 is provided for the subsequent rows. This makes the change in the state of the source signal line insignificant to reduce the possibility of an insufficient write operation.

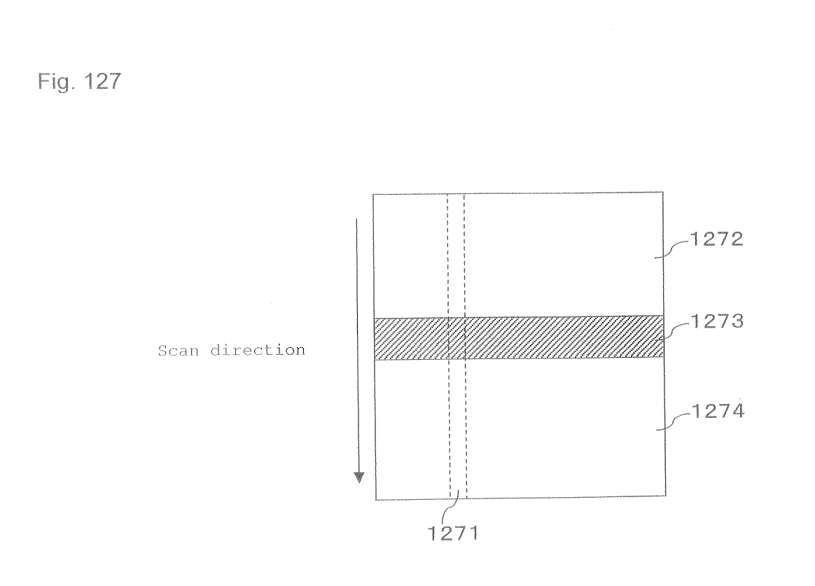

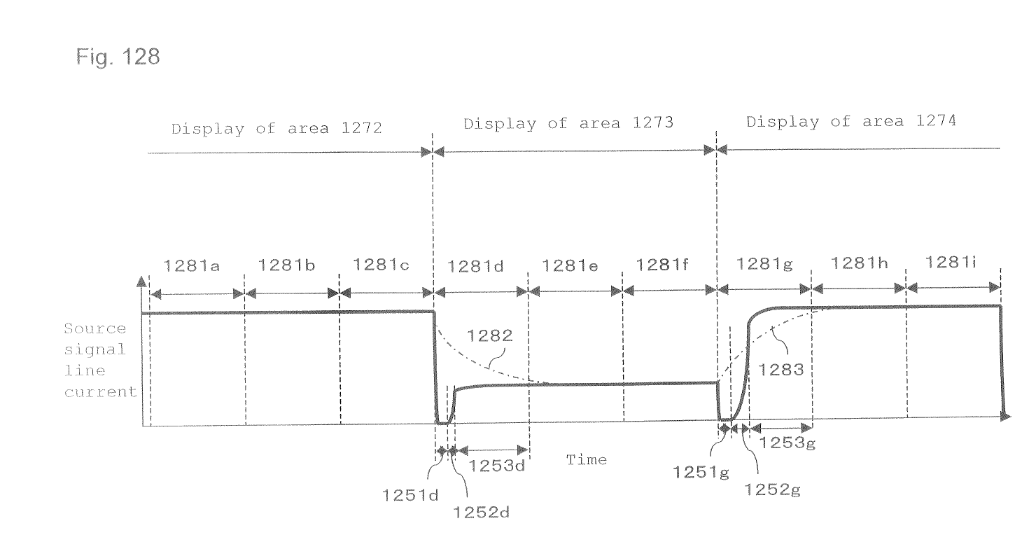

With the display pattern shown in FIG. 127 (the pattern in which the regions 1272 and 1274 offer the same luminance and in which a region 1273 offers a lower luminance than the regions 1272 and 1274), current precharge is carried out on the first row corresponding to the region 1273 and for the first row corresponding to the region 1274. FIG. 128 shows the output current waveform of the source signal line corresponding to a column 1271. During the period corresponding to a region 1272, the output current does not change. Accordingly, a horizontal scan period 1281 is composed only of gray level current output periods.

The source signal line current changes during the first horizontal scan period 1281d after a shift to the region 1273. Accordingly, a precharge voltage application period 1251d and a precharge current output period 1252d are provided in order to quickly change the current. This enables the current corresponding to the region 1273 to be output more quickly than when precharge current is not output as in the prior art (1282). Even if the region 1273 display continues, the period in which the precharge current or precharge voltage is output is not provided but only gray level current output is provided. This minimizes the change in the source signal line current.

Moreover, if the source signal line provides the output corresponding to the area 1274 display, voltage and current precharges are carried out only during the first horizontal scan period 1281g. A precharge current output period 1252g is longer than a precharge current output period 1252d. This corresponds to the fact that the precharge current output period increases consistently with gray level, that is, current on the basis of the relationship between the gray level and the current precharge output period shown in FIG. 123. If the area 1274 offers gray level 0, a gray level current output period 1253g follows the precharge voltage application period 1251g. This eliminates the precharge current output period 1251g. (The presence of the precharge current output period 1251 depends on the gray level and thus this period 1251 is not always present). This precharge has enabled the current flowing through the source signal line to be changed to the predetermined current value more quickly than when the output current value is changed using only the gray level current output without carrying out precharge as in the prior art (1283).

To allow voltage and/or current precharge to be carried out only when the state of the source signal line changes, it is necessary to execute precharge on the basis of the relationship with the gray level shown in FIG. 123 only when a comparison with the gray level of the preceding row indicates a change in the video signal.

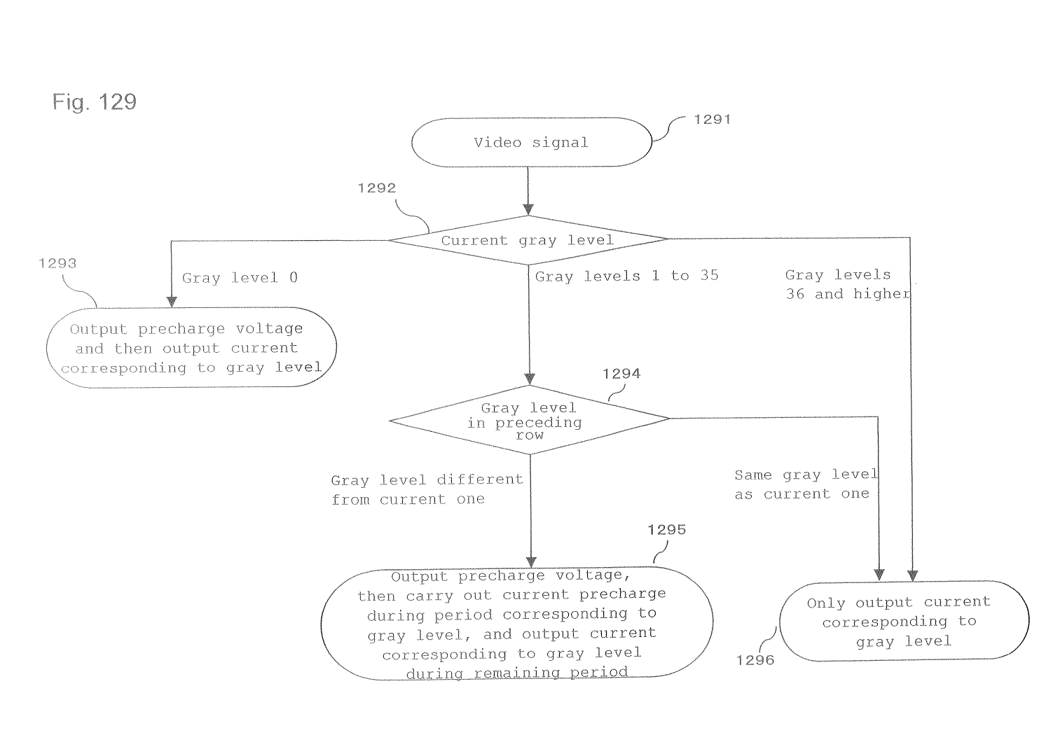

FIG. 129 show a flow used to determine whether or not to carry out precharge. The current gray level value is detected in a video signal 1291. If the gray level is 0 (1292), only voltage precharge is carried out as in FIG. 123 and then the current corresponding to the gray level is output (1293).

For gray level 36 or higher, the current varies up to the predetermined gray level without the need for precharge. Accordingly, only the current corresponding to the gray level is output (1296).

For at least gray level 1 and at most gray level 35, the process depends on the gray level of the preceding row (1294). For the same gray level as the current one, only the current corresponding to the gray level is output (1296). This is carried out in order to reduce the change in waveform when the same gray level is continuously displayed as shown in FIG. 126.

On the other hand, in the processing in 1294, when the current gray level differs from that of the preceding row, the precharge voltage is output. Then, current precharge is carried out during the period corresponding to the gray level. The current corresponding to the gray level is output during the remaining period (1295). This corresponds to the operation performed during horizontal scan periods 1281d and 1281g in FIG. 128.

The precharge determination line 984 provides a signal such that the relationship between the gray level and the precharge current output period shown in FIG. 123 is established if the states 1294 and 1295 result from the determination in FIG. 129. Then, the signal allows the source driver IC to provide such an output as shown in FIG. 126. If the state 1296 results from the determination, the relationship shown in FIG. 123 is not used. Instead, the value for the precharge determination line 984 may be determined so as to always output the gray level current.

Thus, by enabling the current to be rapidly changed at change points while minimizing the change in the source signal line, it has become possible to appropriately show the boundary between regions even for such a display as shown in FIG. 127.

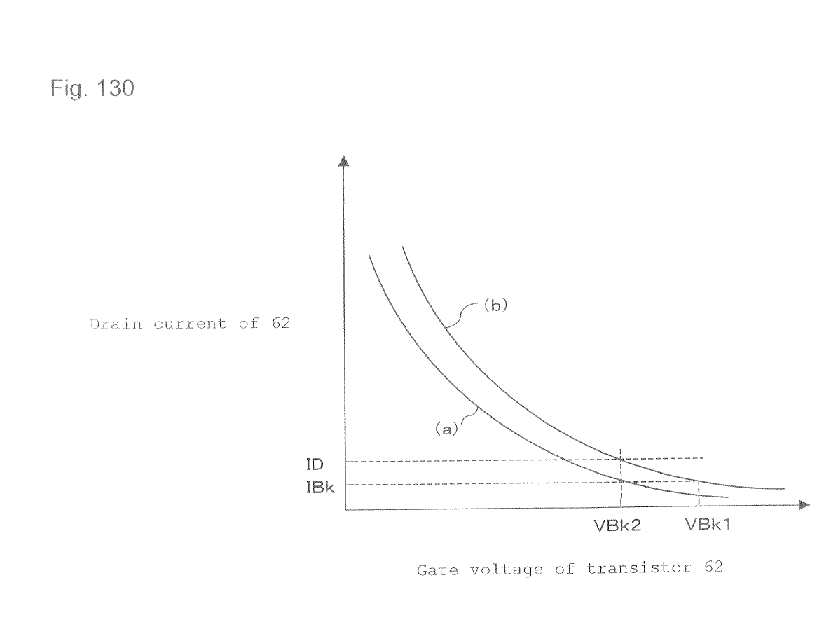

For gray level 0 display, the precharge voltage is applied to the gate electrode of the driving transistor 62 in the pixel circuit through the source signal line to provide the current (at most 1.3 nA) corresponding to black display. However, in this case, the driving transistor 62 converts the voltage into a current, so that the drain current corresponding to the input voltage varies depending on temperature. For example, as shown in FIG. 130, if the driving transistor 62 is formed of low-temperature polysilicon, current flows more smoothly at higher temperature (FIG. 130 (a)) than at lower temperature (FIG. 130 (b)). This disadvantageously increases the current for black display, causing black to appear to stand out against the image (With such a circuit configuration as shown in FIG. 6, the drain current from the driving transistor 62 flows through the EL element. Thus, an increase in the current flowing through the EL element causes the EL element to be faintly lighted, causing black to appear to stand out against the image).

For example, if the precharge voltage is adjusted to VBk2 at a lower temperature (a), a drain current IBk from the transistor 62 flows. This current is at most the level (1.3 nA) at which black does not appear to stand out against the image. In this state, if the temperature rises to change the characteristics of the transistor 62 as shown by the curve in FIG. 130 (b), a current ID flows which is at a level at which black appears to stand out against the image. The gate voltage must be raised to VBk1 in order to prevent black from appearing to stand out against the image at higher temperature.

If the channel in the pixel transistor is designed so as to have a width of 25 microns and a length of 15 microns, provided that (a) and (b) correspond to −20° C. and +50° C., respectively, the voltage VBk2 is equal to the (voltage value of the line 64)−1[V] and the voltage VBk1 is equal to the (voltage value of the line 64)−3[V]. At this value, the voltages at the sources and drains of the pixel transistor 62 are 1 V and 3 V, respectively.

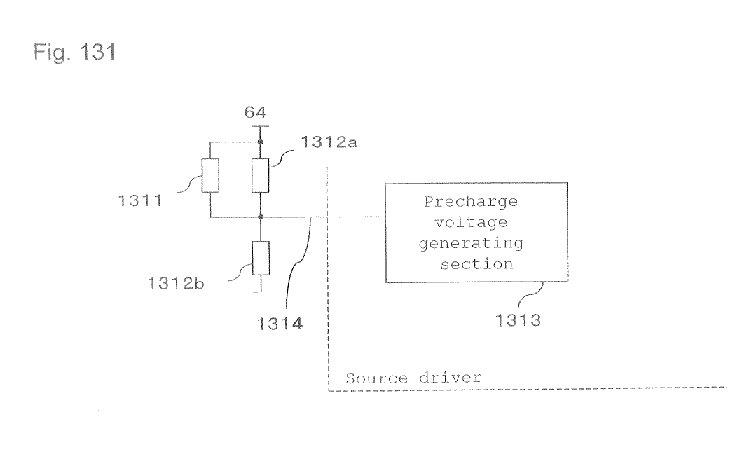

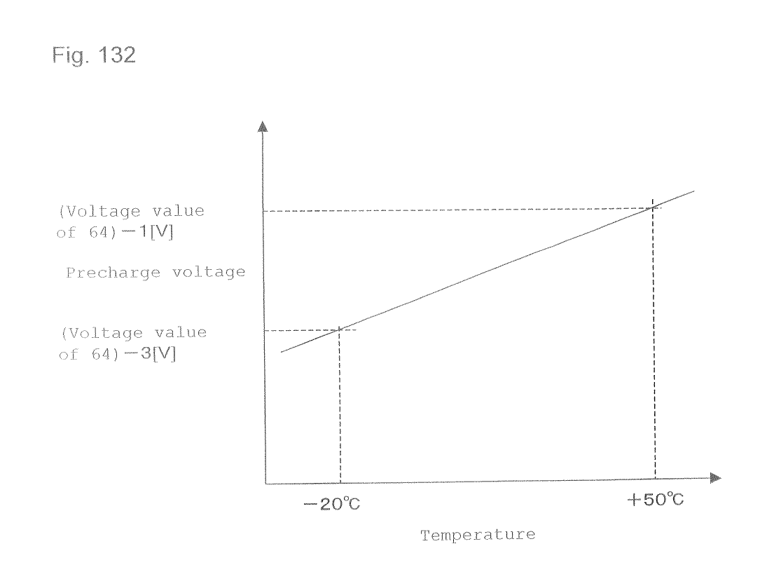

If the required source/drain voltage varies depending on temperature, the precharge voltage applied to the transistor 62 may be varied depending on temperature. When a reference voltage used to generate a precharge voltage is generated by resistance division, the voltage at a division point 1314 is varied with temperature by connecting a temperature compensating element 1311 such as a thermistor in parallel with one of the resistance elements 1312 as shown in FIG. 131. Since the thermistor has a resistance value decreasing with increasing temperature, the temperature compensating element 1311 is connected in parallel with one 1312a of the two resistance elements 1312 which is connected to the power supply side of the line 64. Such a setting as shown in FIG. 132 can be made by adjusting the value for each resistance element, the resistance value of the thermistor, and temperature coefficient; this setting allows the precharge voltage to increase consistently with temperature.

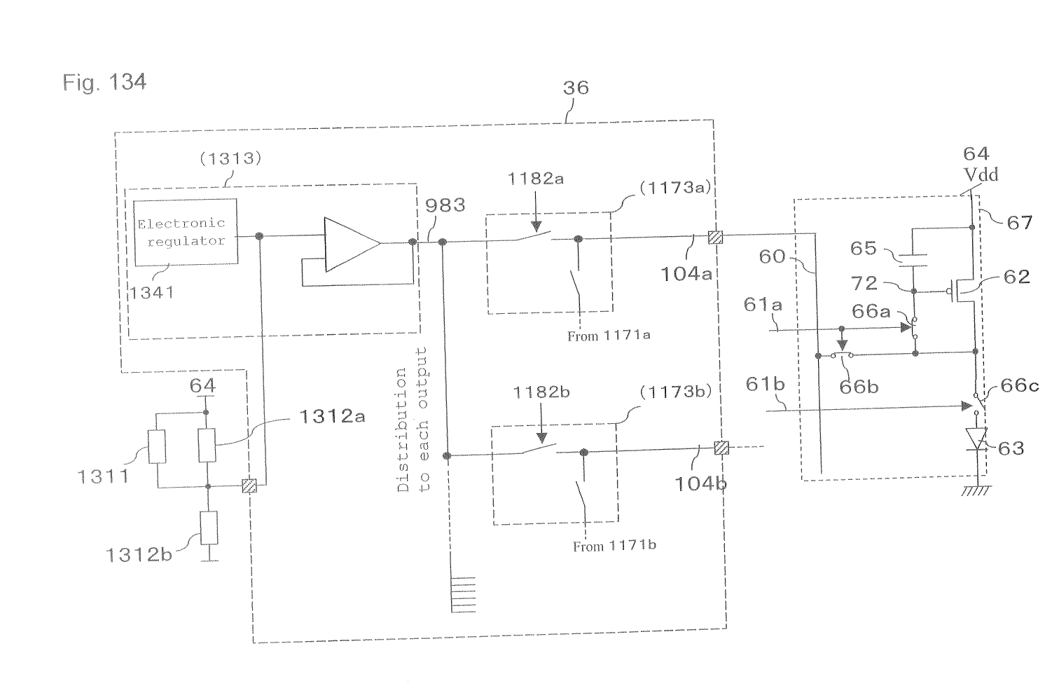

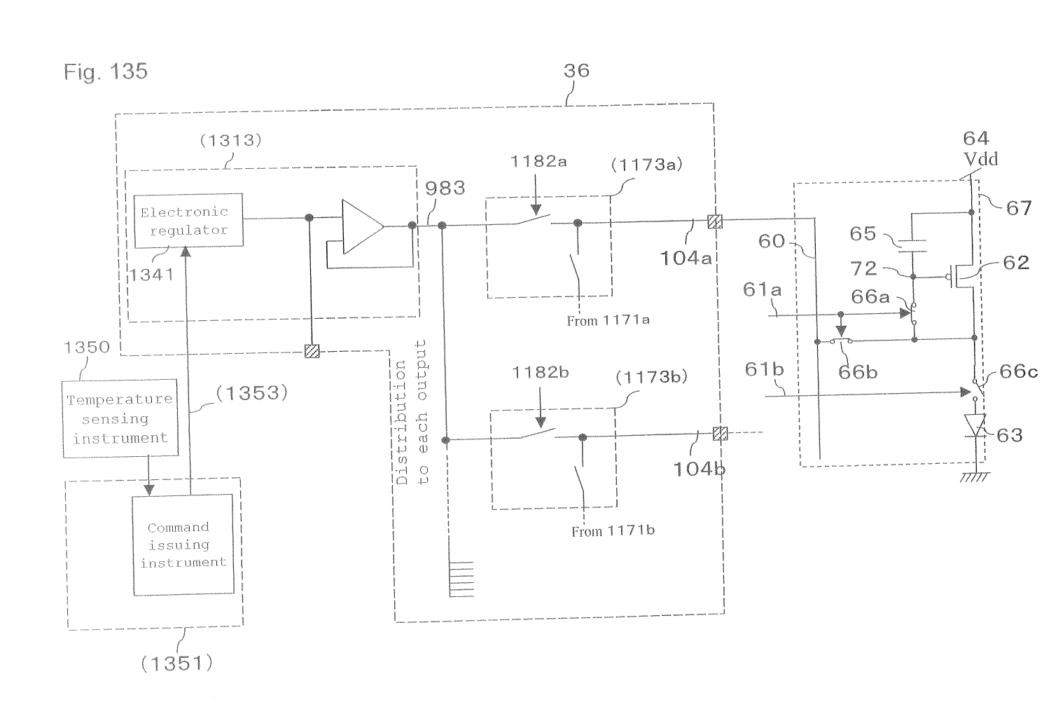

FIG. 134 shows a specific circuit configuration. Description will be given of the source driver 36 and a pixel circuit for one pixel. For the circuit in the source driver 36, only the analog output section that carries out voltage precharge is shown. The entire circuit configuration is, for example, as shown in FIG. 117. To carry out voltage precharge, the voltage precharge control line 1182 applies a voltage generated by a precharge voltage generating section 1313, to the current output line 104.

The output voltage is applied to the node 72 through the source signal line 60; the node 72 is located inside the pixel circuit 67, selected by the gate signal line 61.

When a pixel selection period is over, the switches 66a and 66b are in the nonconductive state, while the switch 66c is in the conductive state. A current flows through the EL element 63 on the basis of the relationship between the gate voltage and drain current of the transistor 62. On this occasion, the relationship between the gate voltage and the drain current is as shown in FIG. 130. Accordingly, when a fixed value is output by the precharge voltage regardless of temperature, the node 72 (=the gate voltage of the transistor 62) is also fixed. A change in temperature changes the current flowing through the EL element on the basis of the relationship shown in FIG. 130.

Thus, according to the present invention, in the precharge voltage generating section 1313, the voltage not having buffered by the operational amplifier yet is generated via an external connection terminal using the resistance elements 1312 and temperature compensating element 1311 rather than being generated by an electronic regulator 1341. This allows the precharge voltage, that is, the voltage at the node 74, to be varied depending on temperature. Consequently, the current flowing through the EL element is fixed regardless of temperature.

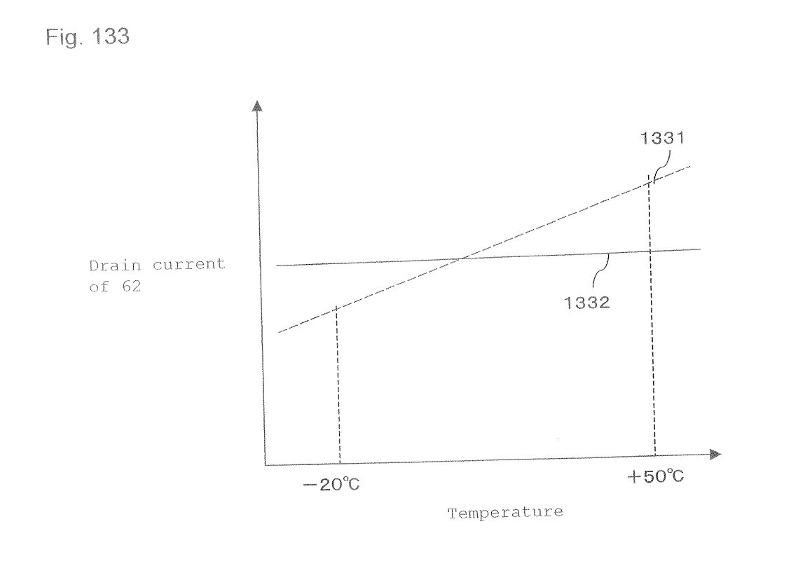

A wavy line 1311 in FIG. 133 shows the relationship between the drain current (=current following through the EL element 63) from the transistor 62 and temperature for a fixed precharge voltage.

A solid line 1332 in FIG. 133 shows a variation in current value resulting from a variation in precharge voltage. The solid line 1332 indicates that the drain current from the transistor 62 is fixed regardless of temperature. By selecting the resistance elements 1312 and temperature compensating element 1311 so that the current value is at most 1.3 nA, it has become possible to provide display in which black does not appear to stand out against the image.

In the configuration shown in FIG. 134, the temperature compensating element is used to compensate for a variation in current on the basis of the temperature characteristic. However, if the electronic regulator 1341 is provided, the value for the electronic regulator 1341 may be varied depending on temperature.

A controller 1351 is generally used to control the electronic regulator 1341. Accordingly, the controller may vary an electronic regulator control command depending on temperature. For this purpose, a signal from temperature sensing instrument 1350 is input to the controller 1351.

In this figure, the electronic regulator is set by using an electronic regulator control signal 1353 to cause the controller 1351 to control the source driver 36. However, such a source driver as shown in FIG. 117 receives the voltage value of the precharge voltage generating section 981 from the video signal line 856 via the video signal/command separating section 931. In this manner, the signal may be separated after being serially transferred by the controller to the source driver utilizing a different signal line. Thus, the electronic regulator control signal 1353 is not always required. A controllable signal line has only to be connected between the source driver and the controller so as to simply control the electronic regulator or to be shared by other signals.

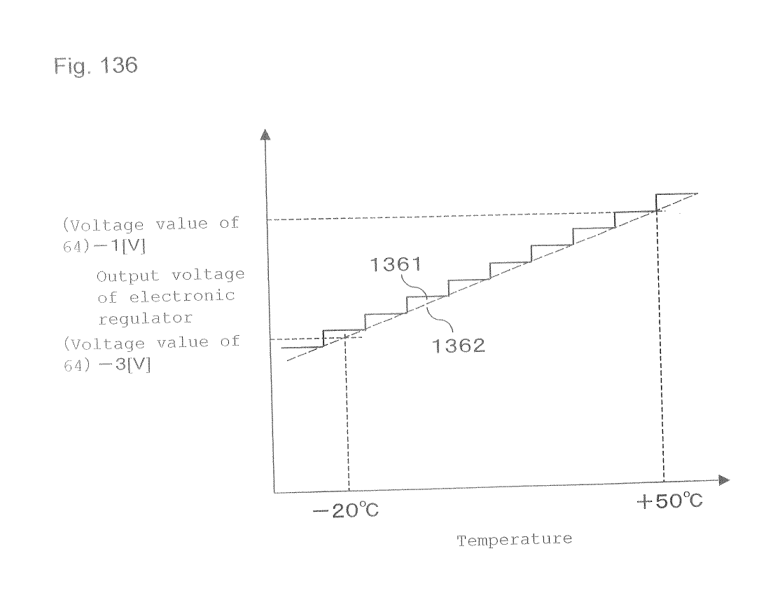

If the electronic regulator 1341 is used to control the voltage value, since digital signals are input, the voltage value cannot be increased in proportion to temperature. Consequently, the output voltage (that is, precharge voltage) of the electronic regulator varies step by step as shown by the solid line in FIG. 136.

Also in this case, the current flowing through the EL element 63 is adjusted to at most 1.3 nA all over the temperature range. Accordingly, the output voltage from the electronic regulator may be varied with temperature as shown by a solid line 1361 showing the value for the electronic regulator varied so that the value does not decrease below the voltage value varied by the temperature compensating element and shown by a dashed line 1362.

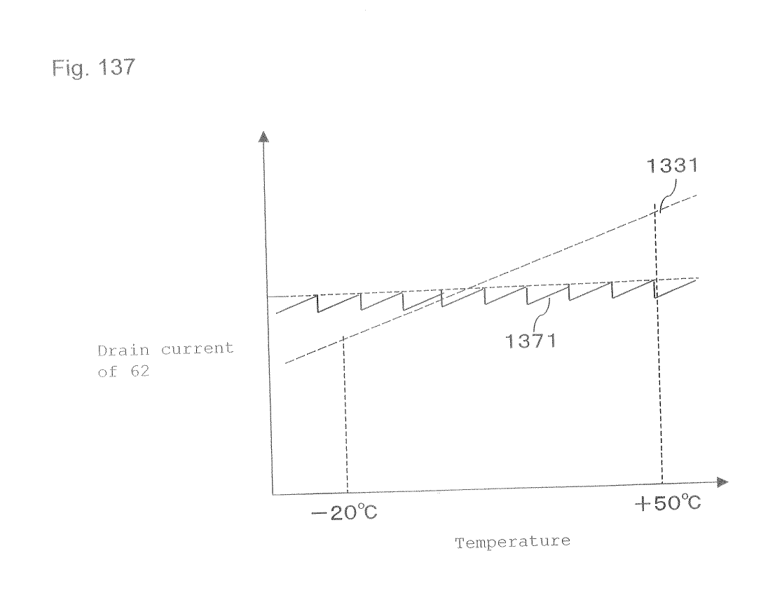

This allows the drain current from the transistor 62 to vary with temperature as shown at 1371 in FIG. 137. It is thus possible to set the current flowing through the EL element 63 at most 1.3 nA regardless of temperature. This has realized display in which black does not appear to stand out against the image even at higher temperature, in contrast to the conventional technique for avoiding varying the precharge voltage depending on temperature as shown at 1331.

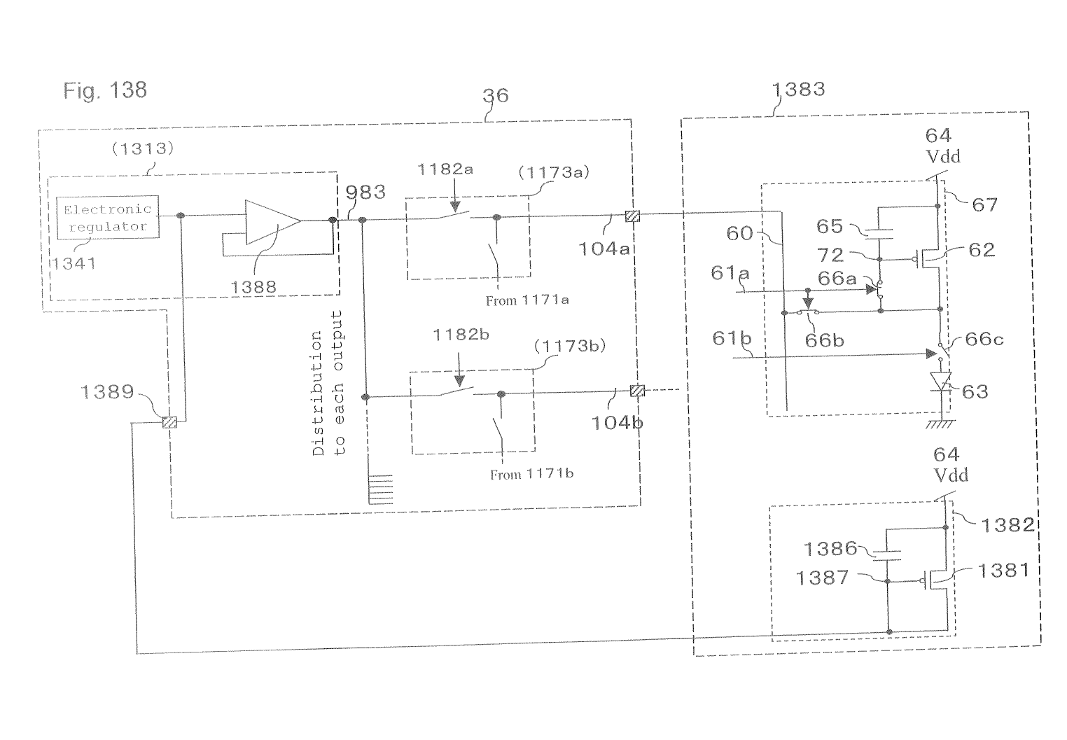

FIG. 138 shows a method of varying the precharge voltage value without using the temperature compensating element 1311 such as a thermistor.

The present invention is characterized in that a precharge voltage generating circuit 1382 is formed on the same array surface of an array 1883 in which the pixel circuit 67 is formed, to output a voltage using a transistor 1381 having the same characteristics as those of the driving transistor 62.

The precharge voltage generating circuit 1382 consists of the transistor 1381 and a capacity 1386. The precharge voltage generating circuit 1382 has the same circuit as that of the pixel circuit 67 in the pixel selected state. When the voltage at the node 1387 is input to the operational amplifier of the precharge voltage generating section 1313 of the source driver 36, the precharge voltage generating section 1313 outputs a voltage obtained when no current flows through the transistor 1381. This makes it possible to output the precharge voltage corresponding to a black display state established by this array. (The output from the electronic regulator 1341 is not used). Here, to prevent current from flowing through the transistor 1381, it is necessary to design an operational amplifier 1388 so that the amplifier 1388 offers a sufficiently high input impedance.

The transistor 1381 and the driving transistor 62 are present on the same array surface. The relationship between the drain current and the gate voltage can be significantly weakened between two transistors. This is because a variation within a sheet surface is smaller than a variation among lots or sheets.

Raising the potential at the node 72 is the only way to reduce the luminance (current) during black display. The voltage at the node 72 can be raised only by increasing the voltage at a node 1387 in the precharge voltage generating circuit 1382. For this purpose, the drain current from the transistor 1381 may be reduced. However, increasing the input impedance of the operational amplifier 1388 is the only way to reduce the drain current from the transistor 1381. This method is likely to be affected by a variation in characteristics among the operational amplifiers 1388.

Thus, the present invention increases the channel width of the transistor 1381 so as to raise the voltage at the node 1387 in accordance with the characteristics of the transistor 1381 even with the same drain current (even with the source driver configuration remaining unchanged).

In this case, the precharge voltage and the voltage required for the driving transistor 62 to provide black display are determined only by the two transistors formed on the same array surface 1383. Accordingly, reducing a variation within the array surface makes it possible to provide fixed black display regardless of the type of an external circuit.

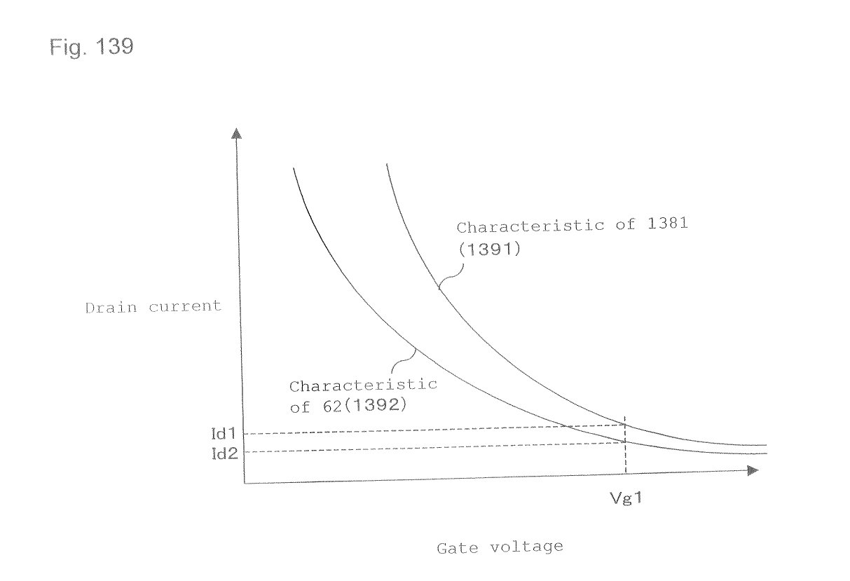

Increasing the channel width or reducing the channel length of the transistor 1381 varies the relationship between the drain current and the gate voltage to realize curves 1391 and 1392 shown in FIG. 139.

When the two transistors are formed so as to have such a relationship as shown in FIG. 139. Then, if a current Id1 flows through the transistor 1381 owing to leakage current or the like, the potential at the node 1387 becomes Vg1. As a result, the output precharge voltage is Vg1. On this occasion, the same voltage Vg1 is applied to the node 72 in the pixel circuit 67 to cause a current Id2 smaller than Id1 to flow through the driving transistor 62. This allows the flow, through the pixel, of the current Id2, which is smaller than the current Id1, which may cause a leakage current. It has thus become possible to provide black display with a reduced luminance. The relationship between Id1 and Id2 is determined by the relationship between the characteristics of the transistor 1381 and those of the transistor 62, that is, the ratio of the channel widths of the transistors and their lengths. Accordingly, the channel width of the transistor 1381 can be increased in order to reduce the current required for black display. The two transistors may have the same size but the transistor 1381 preferably has a channel width about three times as large as that of the transistor 62.

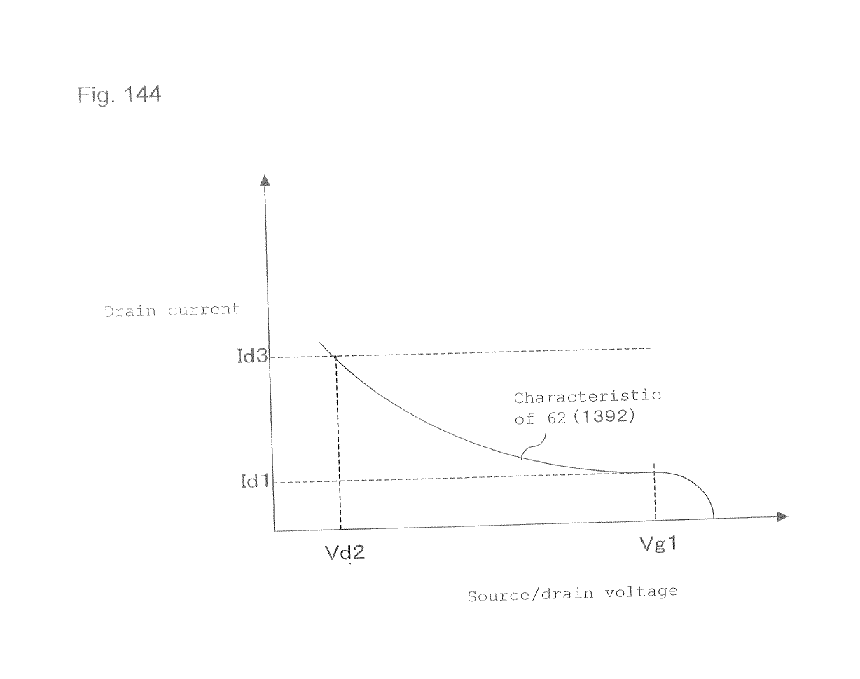

The channel width of the transistor 1381 is increased in order to deal with the following problem: a current of about 3.5 nA may flow through the EL element 63 even when a zero current is passed through the transistor 62 via the source signal line 60. Because of the early effect of the driving transistor 62 such as the relationship between the drain current and the source/drain voltage shown in FIG. 144, the source/drain voltage obtained if a zero current is written through the source signal line 60 is entirely different from that obtained when a current is passed through the EL element 63. Thus, disadvantageously, a current written at Id1 may increase up to Id3. The current Id3 is 3.5 nA, which is nearly three times as large as a current of at most 1.3 nA, which provides appropriate black display under subjective evaluations. Thus, the channel width of the transistor 1381 is tripled to reduce the current to one-third. Since the current must be reduced to at most 1.3 nA, the channel width may be increased by a factor larger than three. However, this increases the area on the array in which the transistors are formed, so that the factor is set at about three.

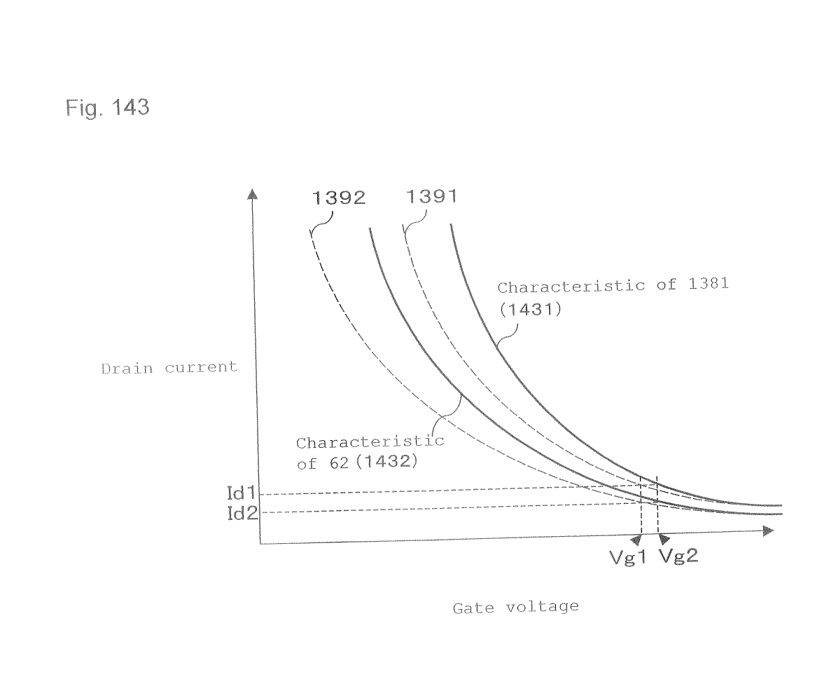

Moreover, since the transistors are formed on the same array surface, a variation in temperature dependence is small. As shown in FIG. 143, if characteristics observed at room temperature are as shown by 1391 and 1392, then at higher temperature, they are equally shifted to 1431 and 1432. Thus, display can be provided with only the supplied precharge voltage changed from Vg1 to Vg2 and with the drain current from the driving transistor 62 remaining at Id2. This indicates that the temperature characteristic can be compensated for without the need for adjustments. Thus, temperature compensation can be carried out by forming a precharge generating transistor in the array surface and without using temperature control instrument.

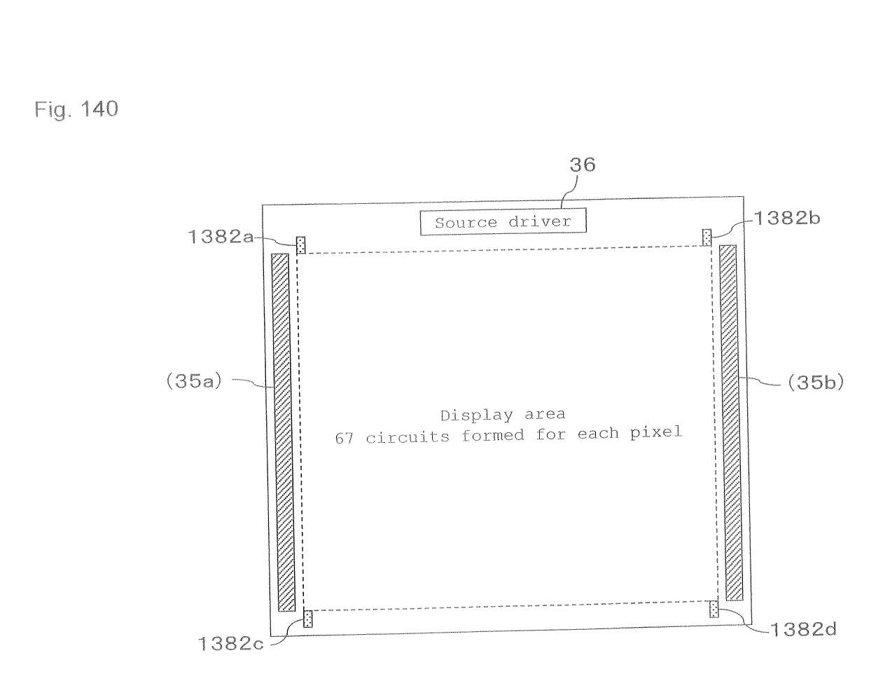

FIG. 140 shows an example of the position where the precharge voltage generating circuit 1382 is placed. The precharge voltage generating circuit 1382 cannot be placed in the display area because the pixel circuits are formed in it. Thus, the circuit 1382 is formed around the pixels. If there is a space around the gate driver 35, the circuit 1382 can be placed in this space.

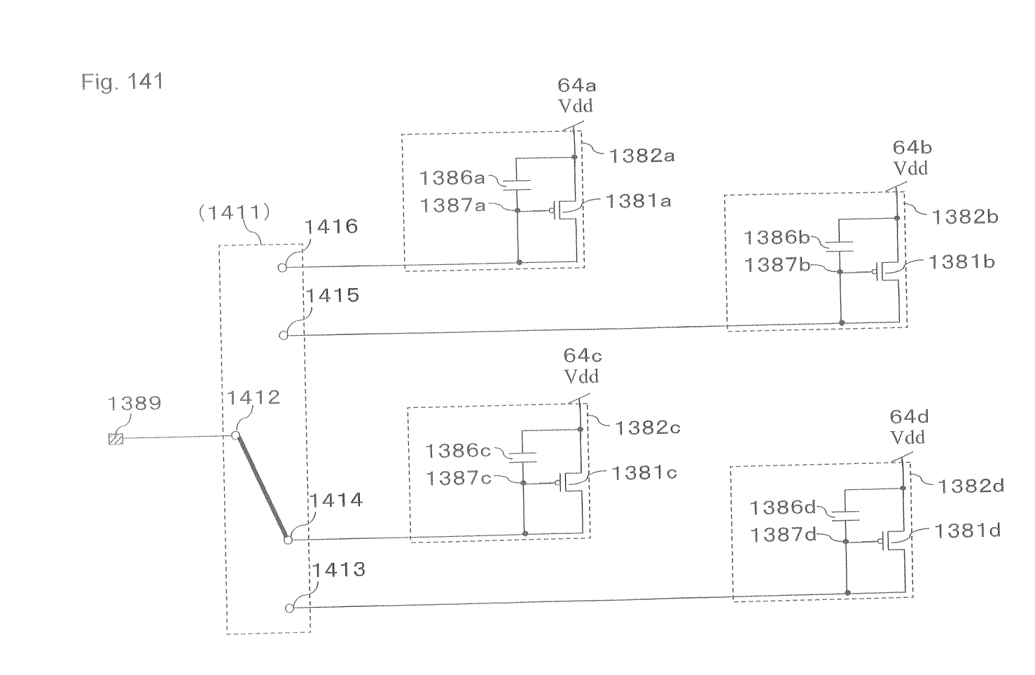

Alternatively, all the circuits 1382, one of which is shown in FIG. 140, may be formed and then an output from one of these circuits may be input to the precharge voltage generating section 1313 via a connection changing section 1411. Wiring for the connection changing section can be externally changed easily by laser machining or the like. Thus, even if a transistor 1381a becomes defective during an array manufacturing process, the wiring is changed by laser repairs so that outputs can be provided using a normal transistor. This is expected to improve yield. FIG. 141 shows an example of wiring in which a transistor 1381c operates correctly.

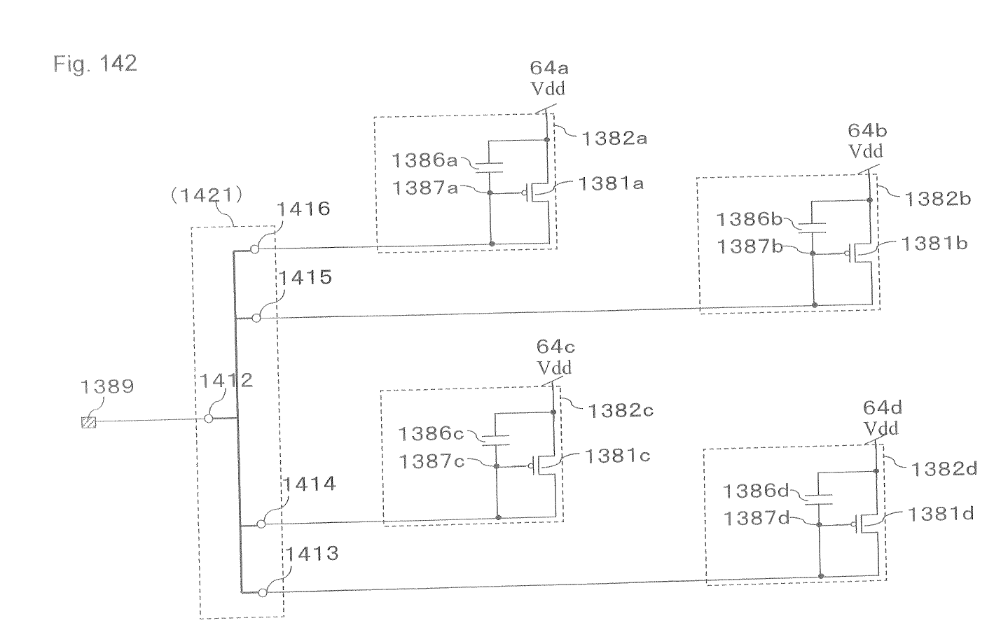

In FIG. 142, all the transistors 1381 are further connected to a source driver input terminal 1389. Since the current flowing through the terminal 1389 is fixed, the current flowing through one transistor 1381 decreases to about one-fourth. This makes it possible to provide a circuit that enables improved black display. Further, the transistors are arranged at the four corners of the display area as shown in FIG. 140 so that a black display voltage can be generated using the transistors with various characteristics in the array surface. This advantageously enables the absorption of a variation among the transistors 1381 to output a voltage closer to the average value for them. If one of the transistors allows an abnormally large quantity of current to pass through, the voltage is determined on the basis of the characteristics of that transistor. Since the current flowing through the terminal 1389 has a fixed value, the voltage is determined on the basis of the characteristics of a transistor allowing a larger quantity of current to pass through. Accordingly, even the transistor with the best characteristics outputs a voltage that enables black display. Therefore, even in the worst case, black can advantageously be prevented from standing out against the image.

If the transistor 1381 is defective, it is only necessary to cut the wire connected to the transistor using a laser. Consequently, repairs are easy.

The wire to the node 1387, including the connection changing section 1421, offers a high resistance and is thus not resistant to noise. To suppress variations caused by noise, the capacity 1386 is preferably increased compared to the capacity value of the pixel circuit. Since numerical aperture is not required in contrast to the display section, a sufficiently large capacitor can be formed. This enables the supply of a voltage with a reduced variation.

If the precharge voltage is applied by an array external circuit including a source driver IC, the precharge voltage value at which black luminance is at at most a specified level (0.1 candela/m²) varies with panels.

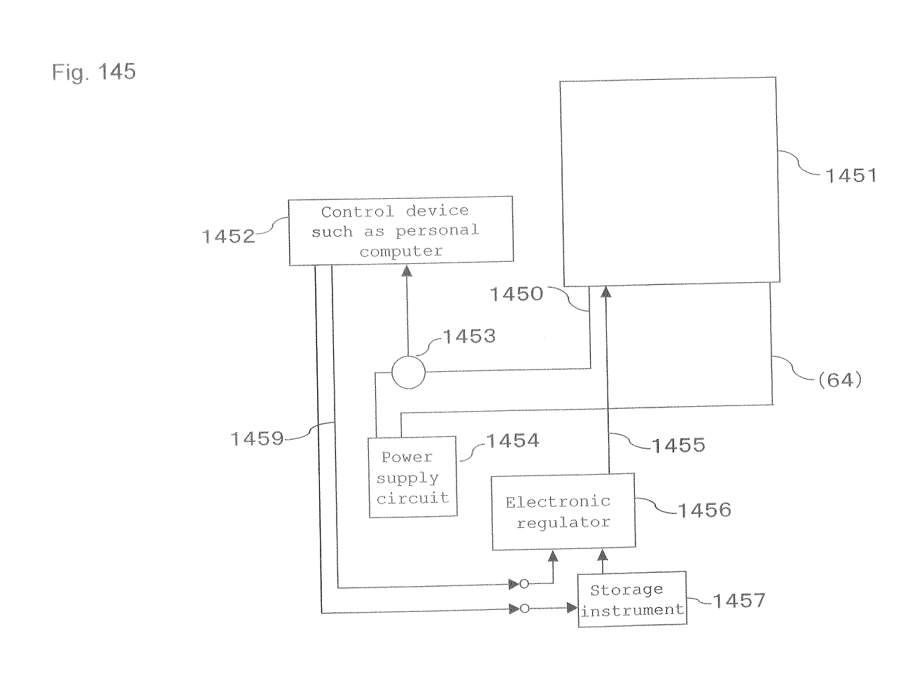

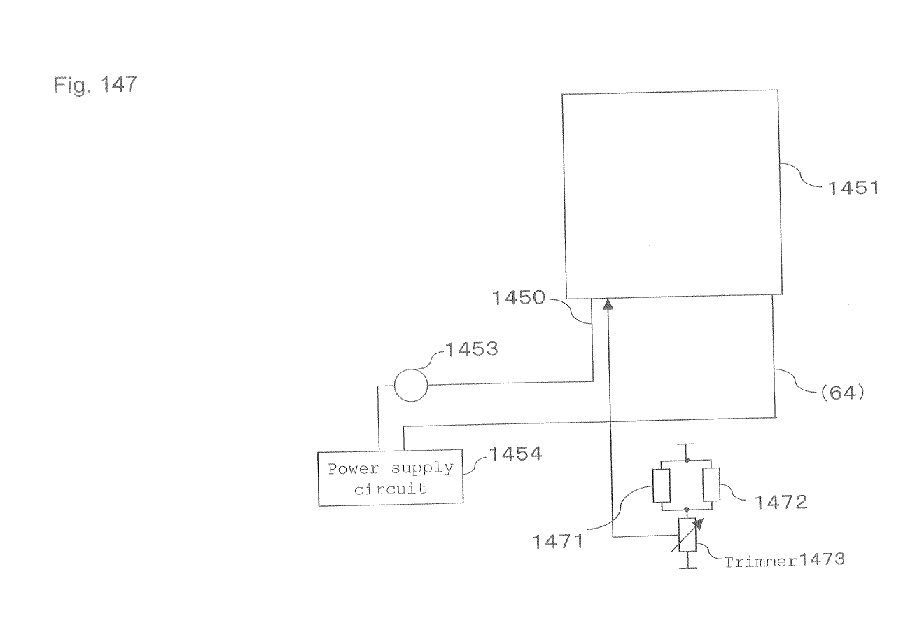

FIGS. 145 and 147 show examples of a method of adjusting the precharge voltage. The two figures differ from each other in that when externally supplied, the precharge voltage is changed using the electronic regulator on the basis of a program or adjusted using hardware such as a cermet trimmer.

The present invention is characterized in that an ammeter 1453 is used to measure a current flowing through an EL cathode power source 1450 to which all the cathodes of EL elements in an EL panel are connected, so as to vary the precharge voltage depending on the current value.

For the EL elements, luminance is in proportion to current. Given the current value at which the luminance is at most 0.1 candela/m², simply measuring the current makes it possible to determine whether or not a sufficient black level can be obtained.

Compared to the measurement of luminance, the measurement of current advantageously eliminates the need for a dark room and enables adjustments using an ammeter, which is more inexpensive and easier to use than a luminance meter.

In FIG. 145, an electronic regulator 1456 is used to adjust the voltage value of a precharge voltage line 1455. Accordingly, a cathode current can be automatically adjusted by using a control device 1452 in a personal computer or the like to allow an input logic in the electronic regulator 1456 to load a value from the ammeter 1453 and to automatically vary the value for an electronic regulator control line 1459 depending on the value from the ammeter 1453. This eliminates the need for manual operations to enable inexpensive adjustments.

FIG. 147 shows an example in which the precharge voltage can be adjusted using a resistance element 1472 and a trimmer 1472 in place of the electronic regulator 1456 and storage instrument 1457. In this figure, a temperature compensating element 1471 is simultaneously used in order to compensate for the temperature characteristic. In this case, black display can be provided by adjusting the trimmer 1473 so as to obtain the predetermined current value while observing the value in the ammeter 1453.

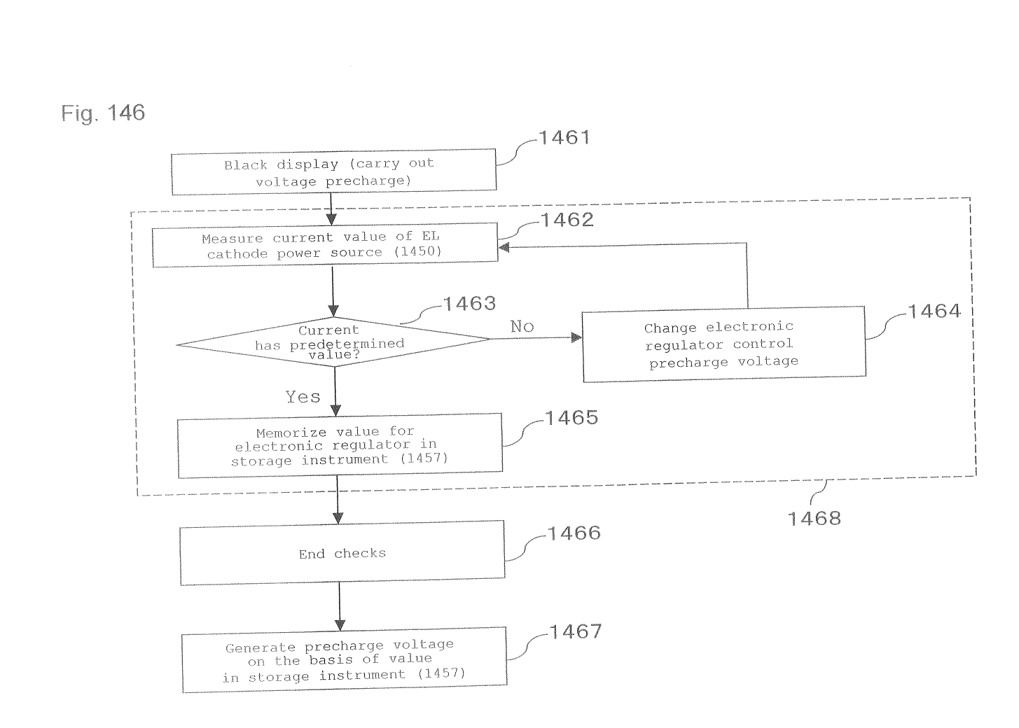

FIG. 146 shows a flow used to optimally adjust the precharge voltage. Black display is provided while carrying out voltage precharge. (1461) On this occasion, the current value of the EL cathode power source (1450) is measured (1462). Since the current value corresponding to 0.1 candela/m² is known, determination is made as to whether or not the ammeter indicates that current value (1463).

If the ammeter does not indicate the predetermined value, the electronic regulator is controlled to change the precharge voltage. (1464) The value after the change is measured to determine again whether or not it is equal to the predetermined value. This operation is repeated until the predetermined value is obtained.

Once the predetermined value is obtained, the value for a signal to be supplied to the electronic regulator is stored in the storage instrument 1457. (1465) If the electronic regulator does not internally have the storage instrument, when it is shipped after voltage adjustments according to the present invention, the value for the electronic regulator cannot be retained. Thus, separate storage instrument is provided so as to retain the value for the electronic regulator. After checks are finished, a precharge voltage is generated on the basis of the value in the storage instrument 1457. (1467) First, before checks have been finished, the control instrument in the personal computer or the like writes a value to the storage instrument 1457.

This has enabled the supply of a precharge voltage that serves to provide optimum black display for each panel even if the power supply is cut.

The present invention described above fixes the luminance for black display regardless of the panel used. As a result, black display has successfully been provided by adjusting the luminance so as to prevent black from standing out against the image.

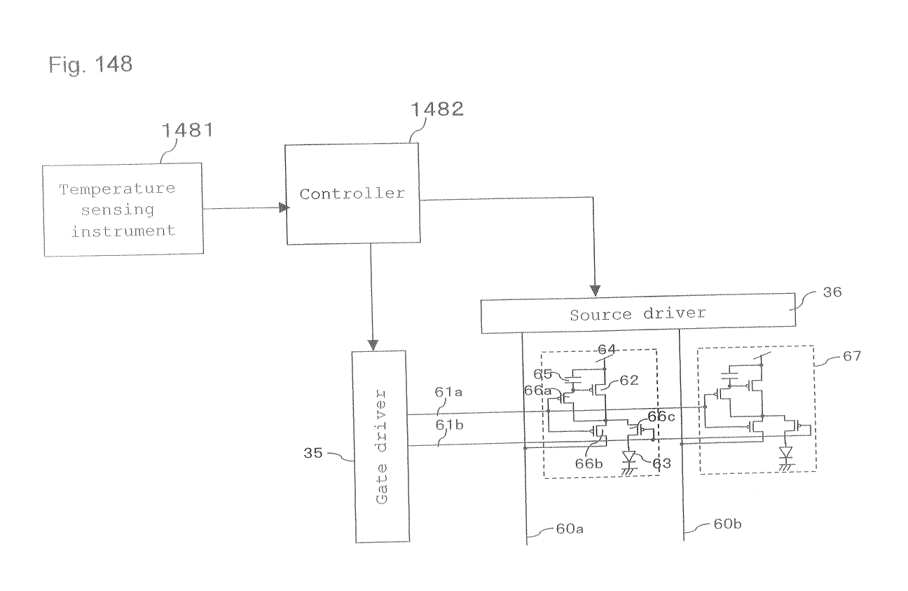

Additionally, it is possible to provide a method of reducing the luminance for black display without using voltage precharge; the luminance can be reduced by changing the on/off control of the gate signal line (61b), shown in FIG. 148, to reduce the time for which current flows through the organic EL element 63.

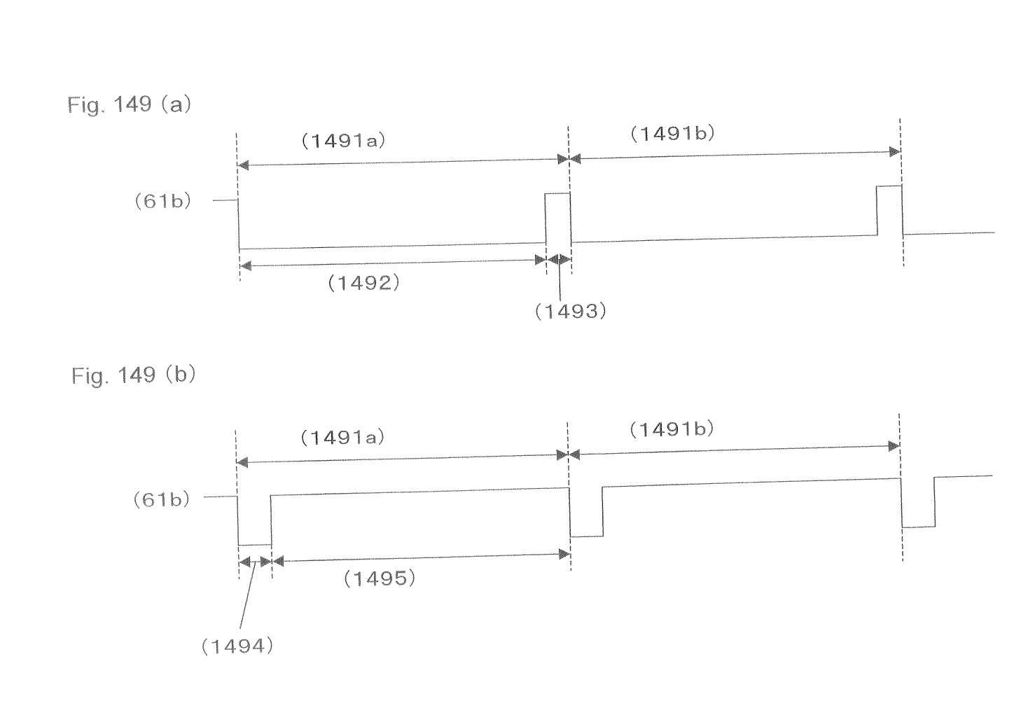

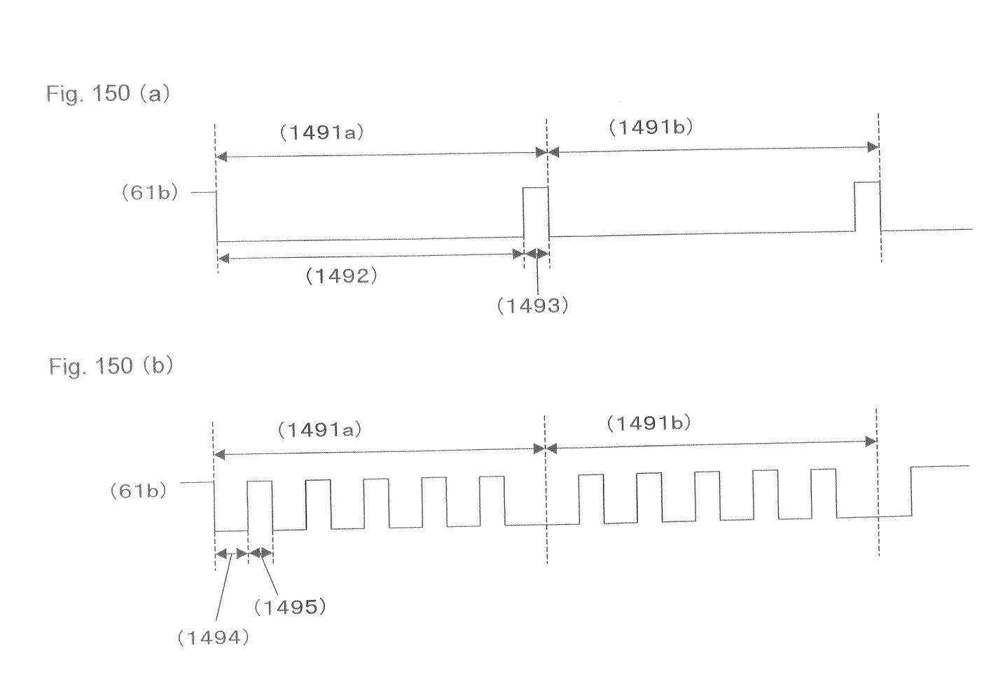

FIG. 149 shows the waveform of the gate signal line 2 (61b). FIG. 149 (a) shows a conventional waveform in which non-illuminated period (1493) corresponds to only one horizontal scan period in one frame during which a current from the source signal line is loaded into the pixel. During the other periods, the organic EL element 63 is lighted in order to pass a current through the organic EL element 63.

According to the present invention, as shown in FIG. 149 (b), the switch is made conductive during a period corresponding to a part (for example, one-tenths) of one frame to pass a current through the organic EL element 63. To fix the display luminance, the current flowing from the source signal line is increased by a factor of 10 because an illuminated period 1494 is one-tenths of that according to the prior art. The same luminance as that according to the prior art is maintained by allowing ten times as large current to flow through the organic EL element 63 during the one-tenths period.

During black display, a zero current is output by the source driver. Zero multiplied by 10 results in a zero current again. The zero current is increased by a certain value only by the early effect of the driving transistor 62. However, this current value is the same as that according to the prior art. On the other hand, since a current flows through the organic EL element 63 during the one-tenths period, the luminance can be reduced to one-tenths.

The non-illuminated period 1495 increases with decreasing illuminated period 1494. The period during which a current flows through the organic EL element 63 is reliably shortened. However, the period is preferably reduced but held at least at about one-tenths because during white display, an instantaneous current flowing through the organic EL element 63 may increase to generate heat and increase the quantity of current, thus degrading the organic EL element. On the other hand, since the current for black display of about 3.5 nA must be reduced to 1.3 nA, the non-illuminated period must be increased by a factor of at least one-third. However, if a large number of pixels and a short horizontal scan period prevent a predetermined current from being written as in the case of a large-sized television and if write operations are performed by using instrument similar to that described above to increase the current for each gray level, a current ten times as large as that current scale factor is considered to be largest.

If a method of providing black display using voltage precharge or the like is used in addition to the present invention, the illuminated period 1494 may be reduced to half compared to that according to the prior art by, for example, allowing the black display current to decrease to about 2 nA if the circuit is driven according to the conventional example shown in FIG. 149 (a). The twice as large current has the advantages of allowing mathematic operations such as a 1-bit right shift to be easily executed, thus reducing the burden on the logic circuit. Thus, the illuminated period can be reduced to half by combining at least two of the methods according to the present invention.

The illuminated period 1494 for the gate signal line 2 (61b) can be varied by, for example, controlling the length of a start pulse for the gate driver 35. The variation can be carried out by using a command to vary the logic inside the controller 1482.

The controller 1482 can vary the illuminated period 1494. Similarly, for the current flowing through the source driver 36, by providing a reference current generating section as shown in FIG. 8, it is possible to allow the controller to vary the reference current using the electronic regulator. Doubling the reference current increases the current for each gray level by a factor of two.

For example, under the control of the controller 1482, the reference current for the source driver 36 is doubled, and the length of the start pulse for the gate driver is changed so as to reduce the illuminated period 1494 for the gate signal line 2 (36b) to half. Then, the luminance for black display is reduced to half.

By simultaneously controlling the source driver and gate driver so that they use the same scale factor, it is possible to realize an arbitrary illuminated period 1482 and to reduce the black display luminance.

The luminance for black display increases with temperature because of the temperature characteristic of early effect of the driving transistor 62. Thus, the present invention inputs a result signal from temperature sensing instrument 1481 to the controller 1482 to vary the illuminated period 1482 depending on temperature. The illuminated period is increased at lower temperature and reduced at higher temperature. Thus, the current flowing through the source driver decreases at lower temperature and increases at higher temperature.

A display apparatus unlikely to be degraded can be provided by increasing the current only as required to prevent an unnecessary increase in the current flowing through the organic EL element.

The scale factor that can be set can be arbitrarily set using values which are not consecutive but discrete and which correspond to the number of scan signal lines in the display apparatus. The scale factor can be increased and reduced at the rate of 1/(the number of scan lines).

In order to prevent black from standing out against the image, the illuminated period is reduced to one-tenth to one-third for the following reason. Limit values are set for each panel, and thus the scale factor may not exactly be 1/10. Accordingly, the value N/(the number of scan lines) has only to be between 1/10 and ⅓ (N is a natural number less than the number of scan lines).

An arbitrary non-illuminated period 1495 can be provided by controlling the start pulse width and using an output enable signal for the gate driver. This method alternately mixes the illuminated period 1494 with the non-illuminated period 1495 to suppress flickers.

FIG. 149 (b) shows the waveform of the gate signal line 2 (61b) obtained if the output enable signal is used. This is the result of the application, at the final output, of output enable to the gate signal line waveform shown in FIG. 149 (a). This uniform illumination during one frame suppresses flickers. The reference current for the source driver 36 may be set by the controller by controlling the electronic regulator on the basis of the rate of the non-illuminated period 1495 so that a predetermined luminance is obtained at a gray level different from black.

The above configuration has provided display in which black is prevented from standing out against the image without using voltage precharge.

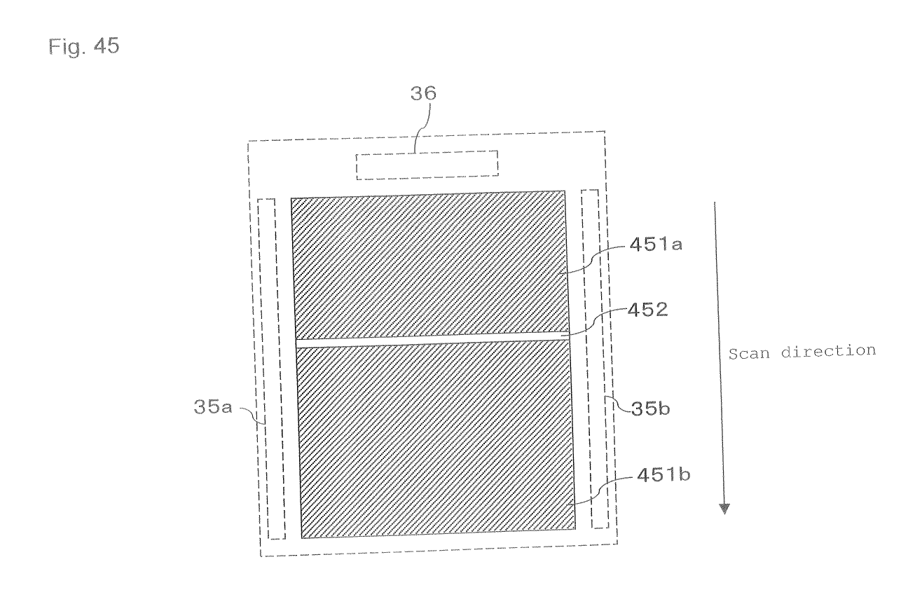

FIG. 45 shows a display pattern in which an area 451 is displayed at gray level 0, while an area 452 is displayed at gray level 4. In this case, when the area 452 contains only a small number of rows, for example, one row, its luminance may decrease extremely.

That is, gray level 4 requires only a small quantity of current (at most 20 nA). Since it is difficult to store and emit charges in and from the floating capacity of the source signal line 60 and the source signal line voltage per gray level varies greatly at lower gray level, the gray levels between 0 to 4 are displayed, disadvantageously reducing the luminance.

If the area 452 spans a plurality of rows, the luminance increases gradually from the first row, and a predetermined gray level is displayed starting from the third or fourth row. Consequently, the display obtained may be partly missing. If the area 452 is composed of one row, then in the worst case, none of the lines in the area 452 may be displayed. Thus, disadvantageously, small characters and horizontal stripe images may not be displayed against black display. On the other hand, even if the area 452 has a high gray level, even one row can be appropriately displayed.

FIG. 47 shows the relationship between the source signal line current and the source signal line voltage at each gray level. Let Δt4 be the time required to change from the area 451a to the area 452 at gray level 4, and let Δt25 denote the time required to change from the area 451a to the area 452 at gray level 255. Then, Δt4=C×ΔV4/I4 and Δt255=C×ΔV255/I255. I255≦64×I4, but ΔV255≦3.5×ΔV4. Thus, Δt4 is about 18 times as long as Δt255.

This is because an increase in source signal line current is not in proportion to an increase in source signal line voltage. A variation in voltage vs. a variation in current is more marked at lower gray level. The curve shown in FIG. 47 is determined by the relationship between the drain current and gate voltage of the transistor 62 as also shown by the equivalent circuit in FIG. 12 (a) Thus, the relationship is nonlinear, and when the same display gray level changes to a brighter one, it is more difficult to change to a lower gray level.

It has been found that when a QVGA display panel is driven at a frame number fraction of 60 Hz, the luminance of the area 451 lowers, in the area 452, at the gray level corresponding to a source signal line current of at most 40 nA, and in the area 452, at the gray level corresponding to a source signal line current of at most 300 nA.

A predetermined amount of charge is not successfully written in the capacity 65 in the pixel. This phenomenon is called an “insufficient write operation”.

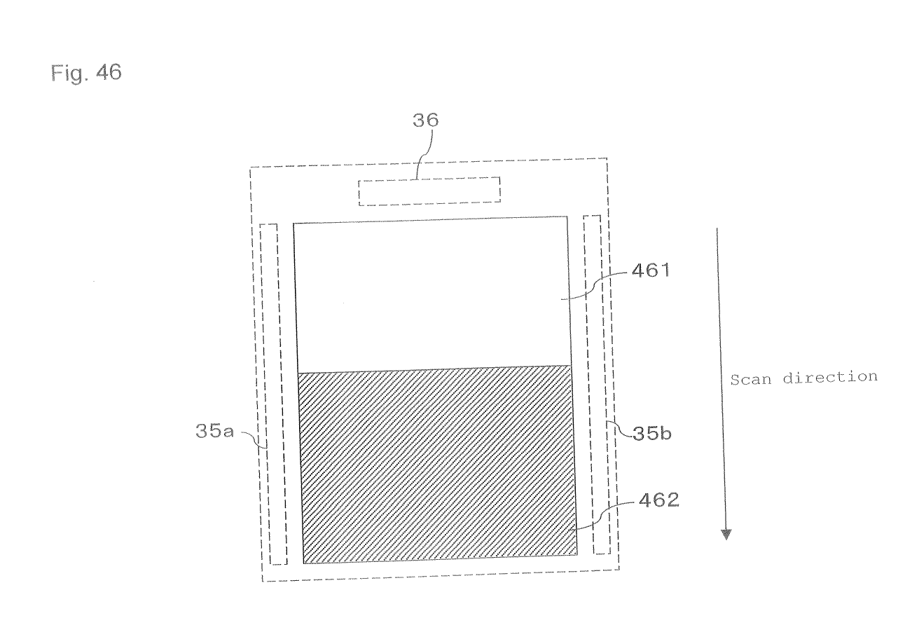

Further, with the display pattern shown in FIG. 46, when the area 461 is displayed at gray level 255 and the area 462 is displayed at gray level 0 or 4, the luminance may increase over lower several rows in the area 461. The luminance is highest at the first row in the area 462 and decreases gradually as the row shifts downward. The luminance of the area 462 is displayed in one of about the third to fifth rows.

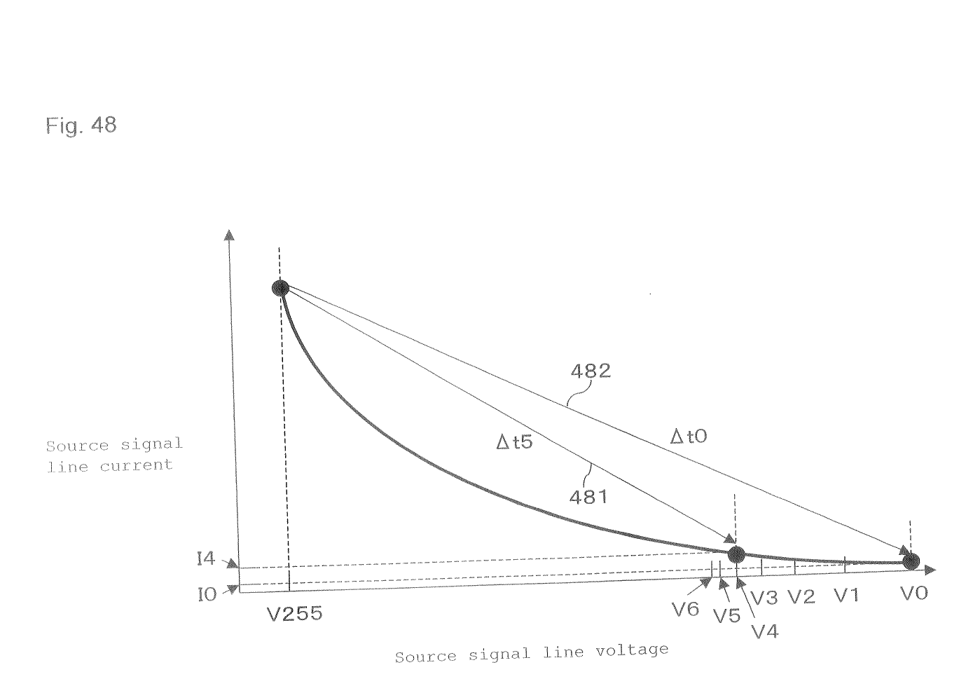

As shown in FIG. 48, to write a current in the final row of the area 461 and then write the gray level corresponding to the area 462, charges must be stored for the floating capacity using the current flowing through the source signal line. This charging requires a long time because of a small current quantity. For example, a change to gray level 4 requires a current I4, and a change to gray level 0 requires a current I0. Accordingly, a longer time is required at a lower gray level. Moreover, a larger amount of change in voltage is required for a change to a lower gray level. Thus, a change to gray level 0 is most difficult. A predetermined value can be more easily written at a higher gray level.

If a panel with a QVGA pixel number is driven so as to display one frame at 60 Hz and the source signal line current is at most 40 nA in the area 462, then the first to fifth rows exhibit a luminance higher than a predetermined one.

This phenomenon is called “tailing”.

Both “insufficient write operation” and “tailing” are caused by the small current flowing through the source signal line. Thus, the present invention sets a period during which the current for the maximum gray level is temporarily passed. Thus, the current is first changed to the vicinity of a predetermined value. Then, the current of the predetermined value is passed through the source signal line. This allows the state of the source signal line to change quickly to the predetermined gray level.

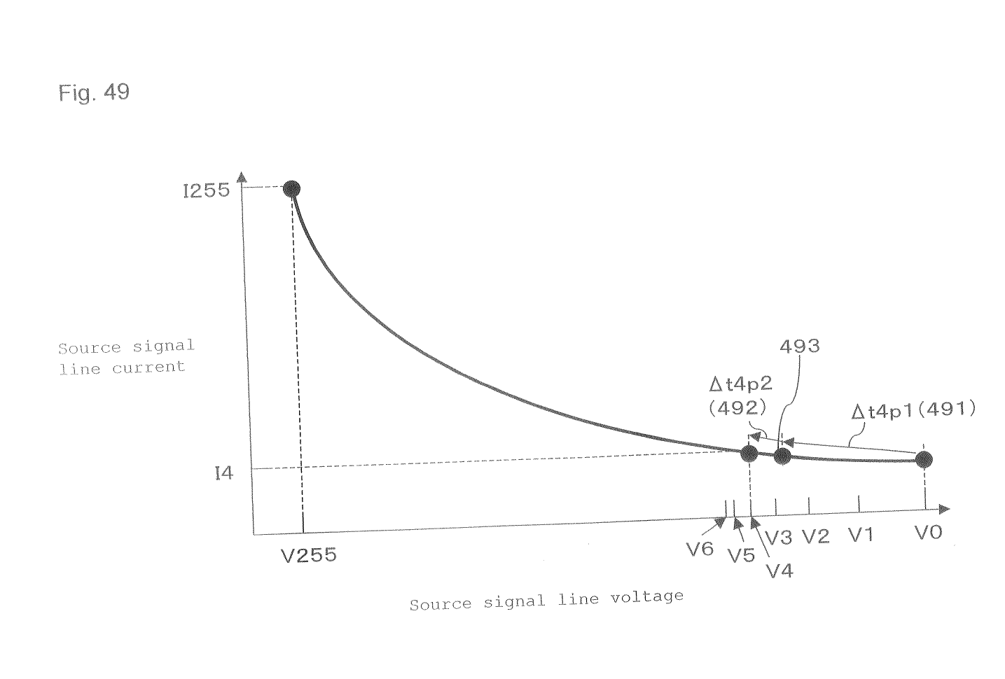

In the example shown in FIG. 47, when the gray level changes 0 to 4, a current of the maximum current value (in this case, the current for gray level 255) is passed during a period Δt4p1 (491) and a predetermined gray level current (I4) is passed during the remaining Δt4p2 (492) as shown in FIG. 49. Let Vip be the voltage during 493. The time Δt4p (=Δt4p1+Δt4p2) required to change gray level 0 to gray level 4 is C×(V0−Vip)/I255+C×(Vip−V4)/I4. When I255=(255/4)×I4 and Δt4=C×(V0−V4) are utilized, Δt4p=Δt4+((251×C)/(255×I4))×(Vip−V0). Since V0>Vip, Δt4p<Δt4. This makes it possible to reduce the time required to change the gray level from 0 to 4 using current.

Tailing cannot be dealt with simply by increasing current. Thus, the source driver supplies the voltage (V0) corresponding to the black gray level to set the source signal line in a gray level 0 display state. Then, gray level 4 is displayed as described above for FIG. 49. A change from gray level 0 to gray level 4 differs from a change from gray level 255 to gray level 4 only in the potential difference before and after the change. The potential difference is larger in the change from gray level 255 to gray level 4. The method shown in FIG. 49 effects a change in a time shorter than that required for a simple change from gray level 0 to gray level 4. Accordingly, the change from gray level 255 to gray level 4 can be effected most quickly by setting gray level 0 using voltage (the time required for this change is short, specifically 1 to 2 μs because of the use of voltage), then passing the current for gray level 255 before reaching the vicinity of gray level 4, and subsequently displaying the predetermined gray level using the current for gray level 4.

Thus passing the maximum current before changing the current to the predetermined value is defined as current precharge.

A current precharge operation is performed by applying the voltage corresponding to gray level b, then outputting the maximum current value until the gray level reaches the vicinity of a predetermined value, and finally passing the predetermined current.

Also for “insufficient write operation”, the gray level may be changed to gray level 0 using voltage before the predetermined current is applied. Since the time required for the current change is reduced by at least 100 μs by using the maximum current instead of gray level 0, the voltage is applied in spite of an increase in the voltage application period and current precharge period of about 2 μs (this value may vary depending on the gray level).

This enables current precharge of the same operation to be carried out for both “insufficient write operation” and “tailing”. A circuit for current precharge is thus simplified.

Without the voltage application period for gray level 0, even for the same display gray level, the period of current precharge must be changed when the preceding row has a different gray level. A change from gray level 3 to gray level 9 differs from a change from gray level 6 to gray level 9 in the amount of change in voltage. As a result, the time required for the change varies between these changes. Thus, without the period for gray level 0, the period during which the maximum gray level is output must be changed depending on the values of the gray levels of the preceding and current rows. This complicates control, for example, requires calculations for gray level differences.

When the voltage application period for gray level 0 is set, a variation in gray level based on current precharge always starts from gray level 0. This allows the period of current precharge to be set in accordance with the display gray level.

Such current precharge enables appropriate display using the display patterns shown in FIGS. 47 and 48 even during display at a lower gray level.

When current precharge is carried out on all display gray levels, a period during which the optimum precharge current is applied must be specified for all of the 255 gray levels. Consequently, about 10 to 20 types of application patterns are required.

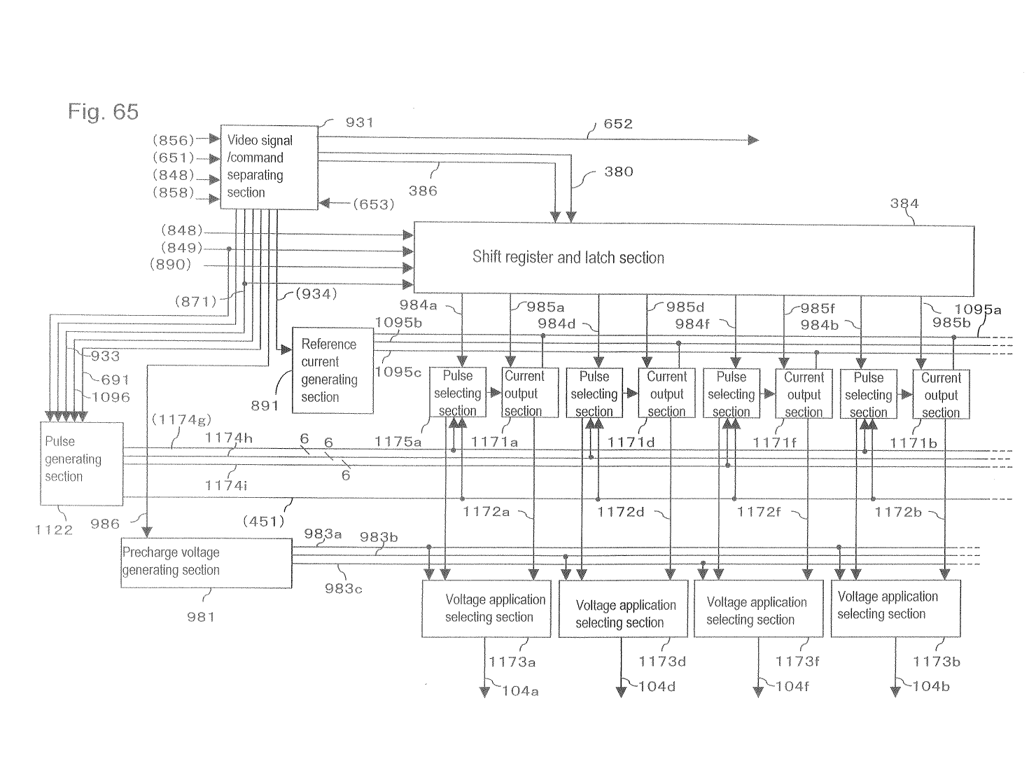

The control of the current precharge application period is performed inside the source driver shown in FIG. 65. As shown in FIG. 120, for example, the seven current precharge pulses 1174 and the voltage precharge pulse 451 are provided. The control is performed by the pulse selecting section 1175 and current output section 1171, shown in FIGS. 118 and 119. The precharge determination line 984 determines whether current precharge is carried out using one of the current precharge pulses or current precharge is not carried out but only the voltage precharge is carried out (only the voltage for gray level 0 is output). The precharge determination line 984 is transmitted in a pair with a video signal. If selecting the precharge determination line 984 for a video signal results in the choice of, for example, the current precharge pulse 1174b, the voltage precharge pulse 451 causes the precharge voltage generating section 981 to output the voltage corresponding to gray level 0. Then, while the current precharge pulse 1174b is at the high level, the current corresponding to the maximum gray level flows. At the low level, the current corresponding to the gray level is output. The optimum current precharge pulse 1174 must be selected in accordance with a video signal for one pixel. Consequently, it is necessary to have a number of pulse selecting sections 115 and current output sections 1171 corresponding to the number of outputs of the source driver.

Six precharge pulses and a precharge voltage, together with the case of no precharge, provide eight choices. Thus, the precharge determination line requires at least 3 bits. The pulse generating section 1175 requires a decode section that converts 3 bits into 7 bits (the decode section operates in accordance with, for example, the truth table shown in FIG. 119).

Executing current precharge on all the gray levels requires 20 to 30 precharge pulses 1174. This increases the circuit scale of the pulse selecting section 1175. Since the number of pulse selecting sections 1175 is equal to that of source drivers, an increase in circuit scale sharply increases the chip area. Further, the number of bits in the latch section is also increased by the transmission of the precharge determination line 984 in a pair with the video signal. Accordingly, in view of the costs of the source driver, about six precharge currents are preferably used.

The number of precharge current types is limited to six owing to constraints on the scale of the source driver hardware. Accordingly, current precharge cannot be carried out on all the gray levels and is thus executed only on required lower gray level areas.

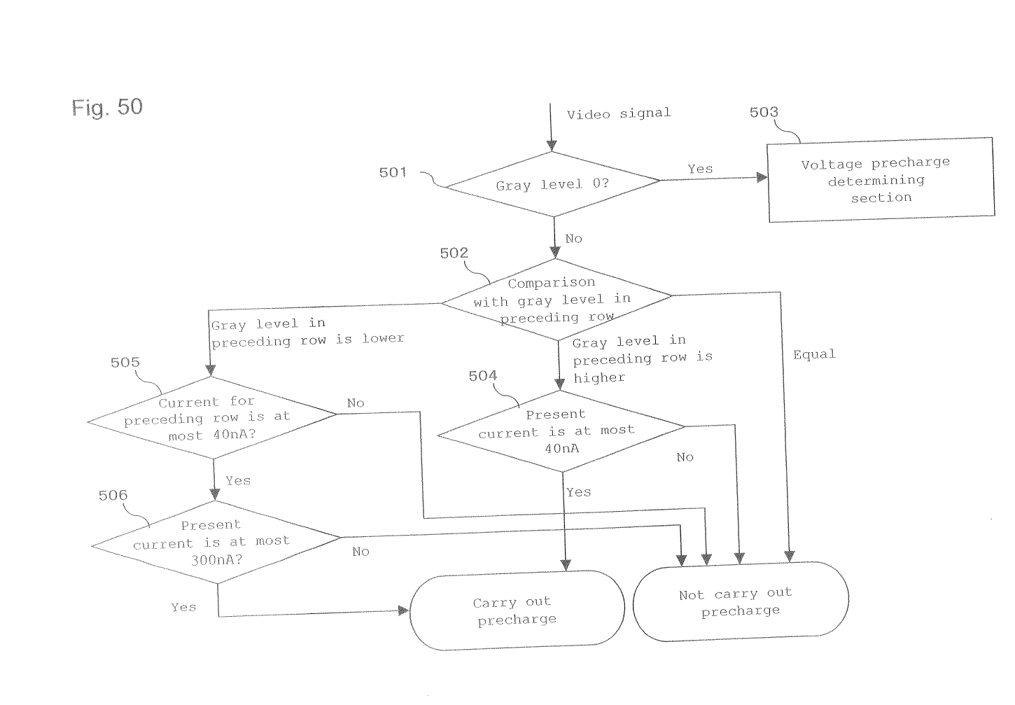

FIG. 50 shows a flowchart used to determine whether or not to carry out precharge. Determination is made as to whether or not a video signal input has a gray level 0. Gray level 0 does not require current precharge but only the voltage precharge. Accordingly, the process advances to the voltage precharge determining section to determine whether or not to carry out voltage precharge.

If the gray level of the input is not 0, it is compared with the gray level of the preceding row. The two states, the “tailing” and “insufficient write operation”, differ in the number of gray levels requiring current precharge. Accordingly, whether or not to carry out current precharge is determined depending on the problems with these states. If the gray levels of the preceding and current rows are the same, the predetermined gray level can be sufficiently displayed without current precharge. Therefore, the circuit determines that current precharge is not to be carried out.

If the gray level of the preceding row is determined to be lower (as shown in the example in FIG. 45), current precharge is carried out only if the following confirmed condition is met: the luminance lowers, in the area 451, at the gray level corresponding to a source signal line current of at most 40 nA, and in the area 452, at the gray level corresponding to a source signal line current of at most 300 nA. If this condition is not met, the area 452 is displayed at a predetermined luminance. This eliminates the need for current precharge.

If the gray level of the preceding row is determined to be higher (as shown in the example in FIG. 46), the first to fifth rows exhibit a luminance higher than a predetermined one if the source signal line current is at most 40 nA in the area 462. Accordingly, current precharge is carried out only if the current source signal line current is at most 40 nA.

This process is shown in the flowchart in FIG. 50.

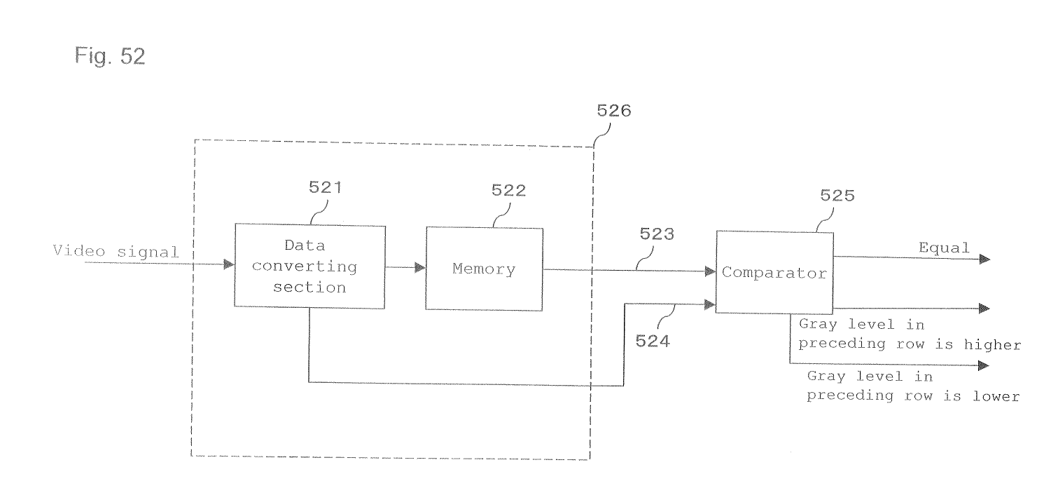

FIG. 52 shows a comparing arrangement 502 that makes comparison with the gray level of the preceding row. The comparison with the gray level of the preceding row requires one row of line memory. Storing one horizontal scan period in the memory 522 enables the current data to be compared with that stored in the memory 522 in order to compare the gray levels.

An 8-bit video signal input requires an 8-bit line memory and a comparator that compares 8-bit numerical values with each other. This increases the sizes of circuits in the line memory and comparator. Thus, according to the present invention, since current precharge is not required if both the gray levels of the current and preceding rows correspond to a current value exceeding 40 nA as shown in FIG. 50, gray level 15 or higher requires, for an 8-bit signal, a current exceeding 40 nA, though the current value depends on the efficiency of the organic light emitting device used. That is, precharge is not required if a signal with gray level 15 or higher appears in two consecutive rows.

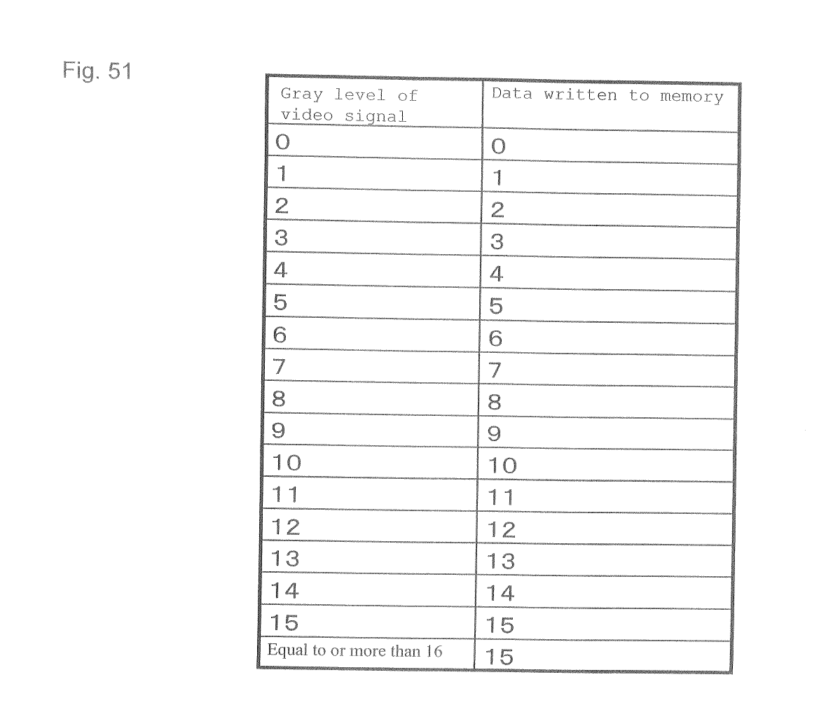

Thus, the data converting section 521 executes a data conversion on an input video signal and then writes the result to the memory 522. In this case, the memory 522 requires only 4 bits. (The area of the memory is reduced to half. The memory 522 accounts for about half of the entire area of a control IC into which the memory is built. Accordingly, the area of the control IC is expected to decrease by at least 20%). In accordance with FIG. 51, the comparator 525 compares 4 bits with 4 bits. If data at gray level 15 or higher is compared with data at gray level 15 or higher, the gray levels match. It is thus possible to determine that current precharge is not to be carried out. If either data is at lower than gray level 15, determination can be made as to which gray level is higher. Consequently, either “tailing” or “insufficient write operation” measures will be taken.

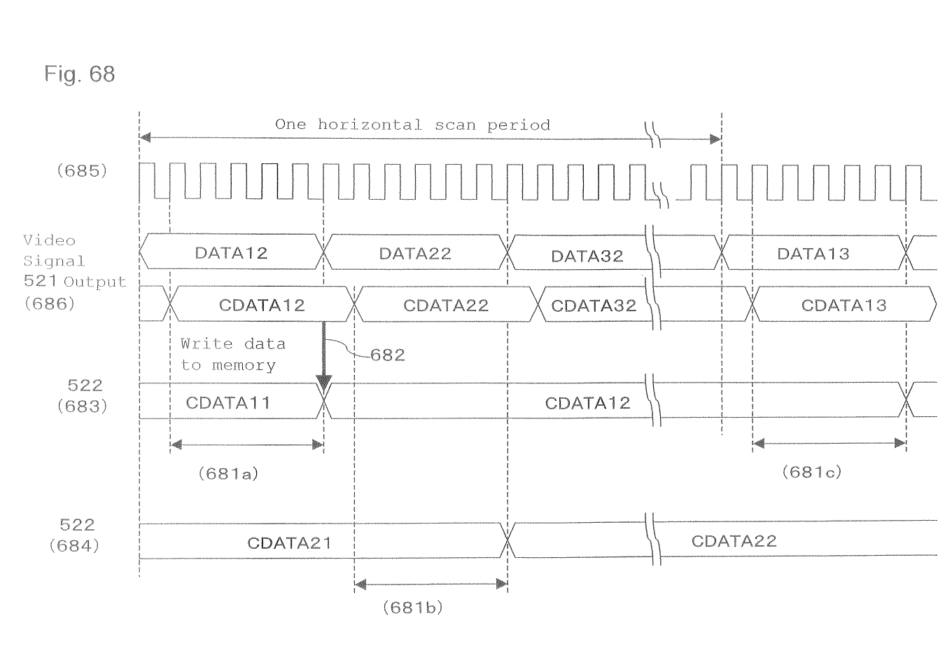

The memory further has only to be able to hold data for one row. If data is transferred at six times as high a speed as the original one as shown in FIG. 28, the clock operates six times as high a speed as the original one. That is, six clocks are input while one data is being transferred. FIG. 68 shows the relationship between a clock 685 and a video signal. The two digits next to DATA in the video signal represent a column and a row. DATA12 refers to the data in the first column and the second row. The data converting section 521 has a latch or a flip-flop and can thus store video signals. Converted data is written to the memory during the fifth clock. Associating the addresses in the memory with the number of columns allows the contents of the data at the same address to be held during one frame. Since the data in the memory 522 is updated during the fifth clock, the gray levels of the preceding row and current rows can be compared with each other by comparing the memory 522 with an output (686) from the data converting section 521 during at least the third to fifth clocks. The data in the first and second rows in the first column may be compared with each other using a period 681a. Similarly, the data can be compared using an address 2 in the memory 522 and a period 681b.

Thus, the amount of memory required is equal to the number of outputs of the source driver×4 bits.

According to this determination, even if the change amounts to, for example, one gray level, provided that it occurs at a lower gray level, current precharge is carried out. Because of the small amount of the change, display is possible regardless of whether or not current precharge is carried out. When current precharge is carried out, a voltage is applied which has been generated by the precharge voltage generating section 981 and which corresponds to gray level 0 display. This voltage is applied to the gate voltage of the transistor 62. Therefore, if a variation occurs in the relationship between the gate voltage and drain current of the transistor 62, the voltage may be higher or lower than the voltage for gray level 0, which is optimum for each pixel. Current precharge is used to change this voltage value to the one corresponding to the predetermined gray level. Since there is only a small variation in precharge current value, source signal line capacity, and precharge time, the voltage value after current precharge may still be higher or lower than the optimum value. Consequently, because of the small amount of current in the area of the low gray level, this variation cannot be compensated for using the period during which the predetermined gray level current is being passed. Thus, an uneven display corresponding to the uneven of the transistor 62 may occur. Thus, according to the present invention, current precharge is not carried out for a difference of one gray level, which corresponds to a small change. This prevents display from being uneven. However, when gray level 0 changes to gray level 1, gray level 0 is intrinsically displayed by voltage precharge in order to bring the luminance of black display as close to 0 as possible. Accordingly, display is not affected even when current precharge is carried out by inputting the same voltage. Further, the voltage may change greatly between gray levels 0 and 1 and may not be changed easily by using only the current. Thus, current precharge can preferably be carried out even on a difference of one gray level. Moreover, if the current value per gray level is large, display may be provided without current precharge even with a difference of two gray levels. Even in this case, for gray level 0, a higher voltage may be applied in order to reduce the black luminance. Alternatively, since the amount of change from gray level 0 to gray level 1 or from gray level 0 to gray level 2 is large, current precharge may be carried out only on the changes from 0 to 1 and from 0 to 2.

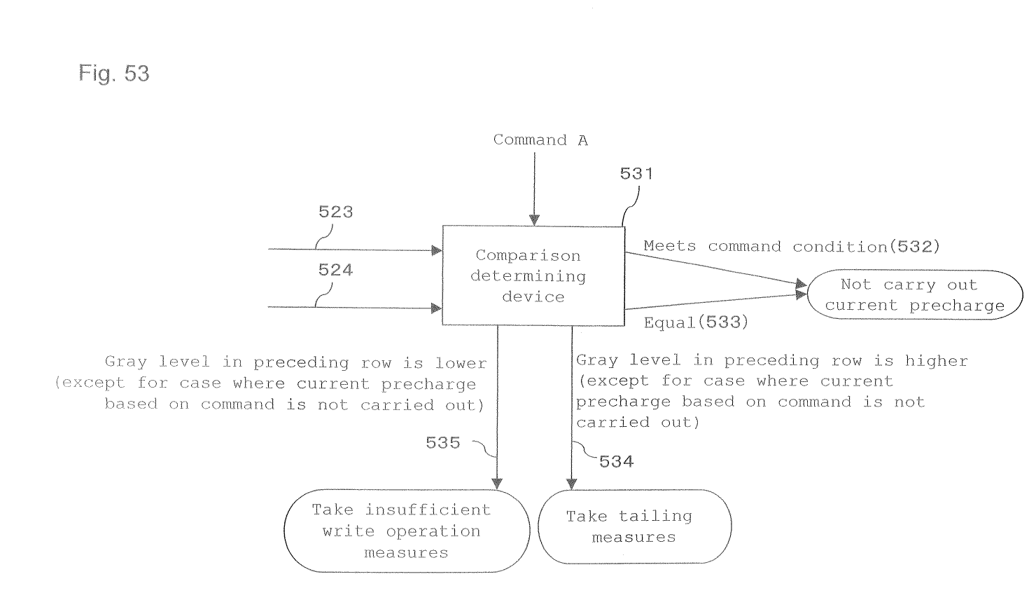

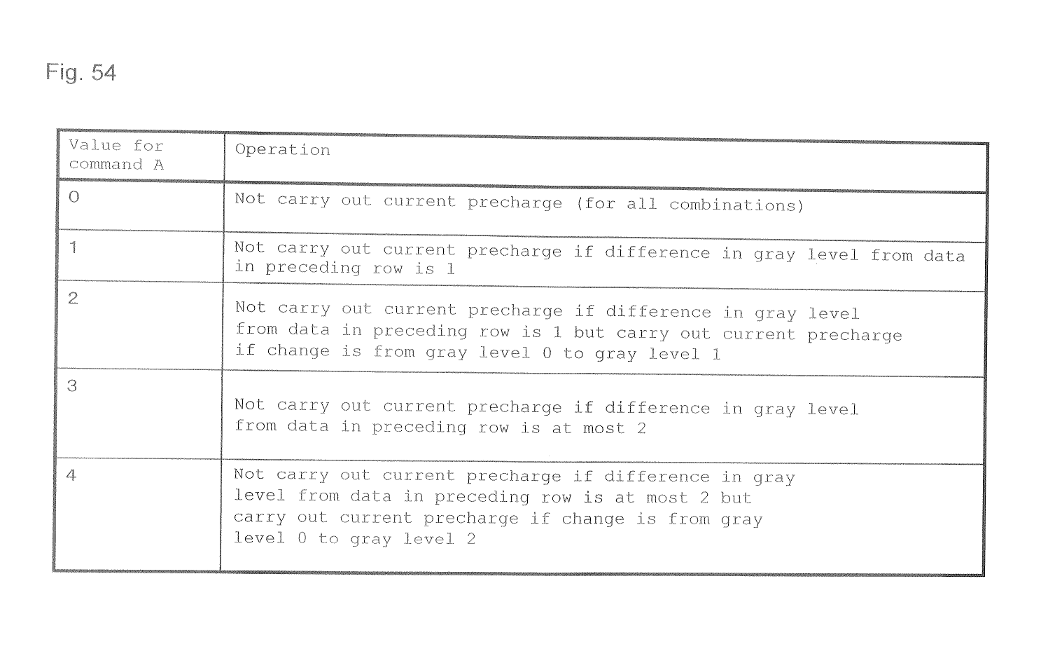

Thus, the present invention uses the circuit configuration shown in FIG. 53 in place of that shown in FIG. 52. A comparison determining device 531 is provided which makes it possible to avoid current precharge under conditions specified by a command A, for example, a difference of one or two gray levels. FIG. 54 shows the contents of the command A. When the command A has a value of 0, no current precharge is carried out (current precharge is not used). When the command A has a value of 1, current precharge is not carried out on a difference of one gray level. When the command A has a value of 2, current precharge is not carried out on a difference of one gray level except for a change from 0 to 1. When the command A has a value of 3, current precharge is not carried out on a difference of at most two gray levels. When the command A has a value of 3, current precharge is not carried out on a difference of at most two gray levels except for changes from 0 to 1 and from 0 to 2. Thus, the optimum value is selected using the value for the command A in association with the efficiency of the organic light emitting element and a variation in the luminance of the panel (since the current for gray level 255 changes, the predetermined gray level is more easily displayed at a higher luminance). This allows the minimum required current precharge. The number of pixels displayed in one screen using current precharge decreases with increasing number of times that the comparison determining device 531 determines that current precharge is not to be carried out. This makes it possible to provide display that suppresses the adverse effect of uneven display caused by the application of voltage.

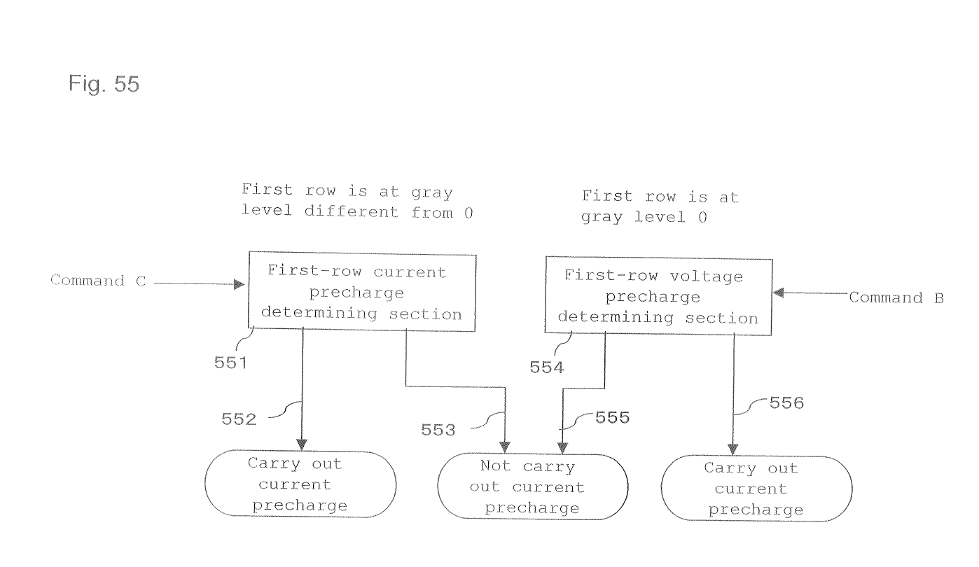

Instead of the configuration shown in FIG. 53, the configuration shown in FIG. 55 is used for the display of the first row, which cannot be compared with the state of the preceding row. The first row with gray level 0 is distinguished from that with a different gray level. For gray level 0, the data is input to a first-row voltage precharge determining section 554 in order to determine whether or not to carry out voltage precharge. Then, a command B is used to determine whether or not to carry out voltage precharge. The avoidance of voltage precharge can be selected for, for example, display apparatuses used for applications in which black can be displayed without voltage precharge or in which a high black luminance (low contrast) is tolerable.

If the first row is at a gray level different from 0, the first-row current precharge determining section 551 determines whether or not to carry out current precharge. A command C can be used to determine whether or not to carry out precharge. The avoidance of current precharge can be determined in the following case: the panel has a high maximum luminance or a large quantity of current is passed because of the low efficiency of the organic light emitting device, and the predetermined gray level can be sufficiently displayed even at a lower gray level.

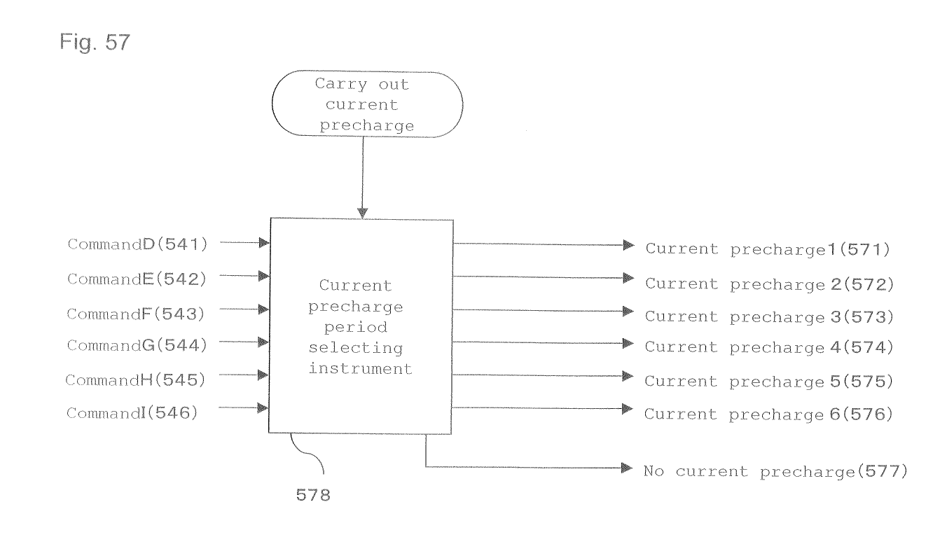

When the first-row current determining section 551 determines that current precharge is to be carried out, the period of current precharge must be determined on the basis of the gray level. FIG. 57 shows a circuit block that selects the period of current precharge on the basis of the gray level. The circuit block in FIG. 57 determines, on the basis of the values for commands D to I, whether one of six current precharge operations 1 to 6 is to be carried out or no current precharge is to be carried out. The source driver 36 is assumed to have set periods for the current precharge operations 1 to 6 as shown in FIG. 120. Current precharge is carried out while a current precharge pulse 1174 is at the high level. Which of the six current precharge pulse 1174 is to be selected is determined on the basis of the truth table shown in FIG. 119. Accordingly, to vary the current precharge period depending on the gray level, the value for the precharge determination line 984 may be varied depending on the gray level.

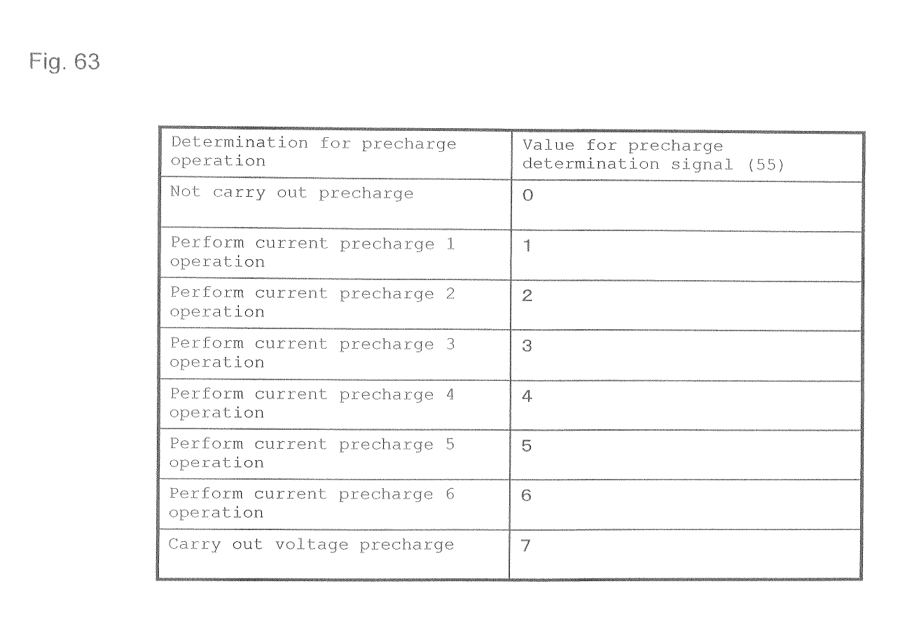

In FIG. 57, depending on whether the input is a video signal or a command, the precharge determination signal 55 for one of the results 571 to 577 may be output as shown in FIG. 63 on the basis of a concept similar to that shown in FIG. 119. Thus, the source driver 36 can determine how long current precharge is to be carried out on the basis of the precharge determination signal 55, transmitted in a pair with a video signal (it is similarly possible to determine that only voltage precharge is to be carried out or that precharge is not to be carried out).

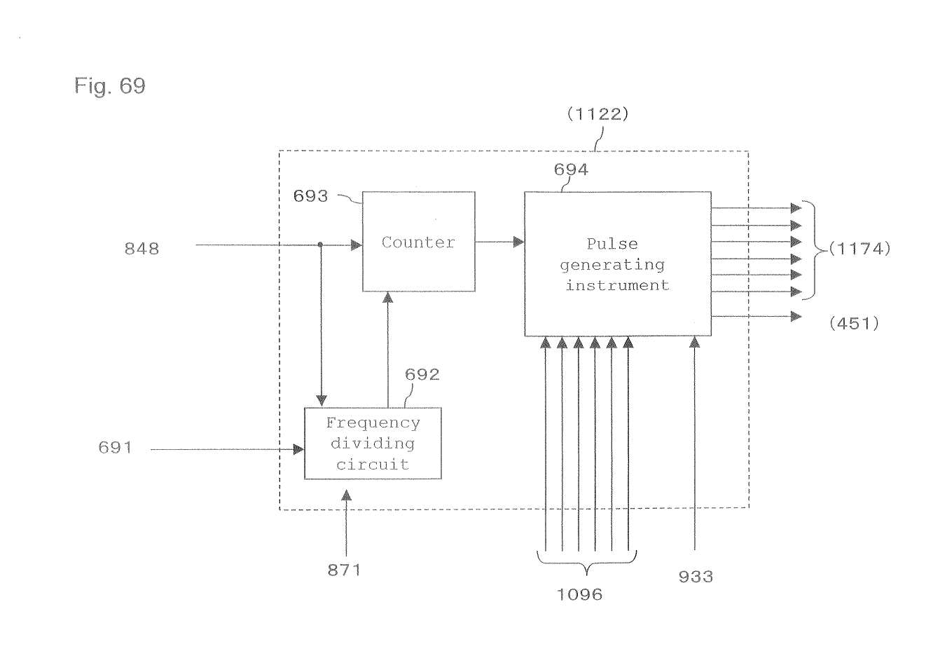

The source driver sets the length of the current precharge pulse. The pulse generating section 1122 determines each pulse length as shown in FIG. 65. The pulse generating section 1122 is composed of a counter 693, pulse generating instrument 694, and a frequency dividing circuit 692, as shown in FIG. 69. The pulse generating section 1122 compares a value counted by the counter 693 with the current precharge period setting line 1096 to output a current precharge pulse 1174 that is at the high level for a period corresponding to a set value. Voltage precharge is carried out at the beginning of the output of gray levels to the source signal line. Then, current precharge is carried out to output a gray level current. Consequently, the high level of the current precharge pulse 1174 is started after the timing pulse 848 has been output. Thus, the counter 693 is reset to 0 by the input of the timing pulse 848, so that pulses are generated on the basis of the timing pulse 848. A similar arrangement is used for the voltage precharge period setting line 933 and the voltage precharge pulse 451. Since the current output section 1171 and the voltage application selecting section 1173 are composed of the circuit shown in FIG. 118, the current precharge pulse 1174 and the voltage precharge pulse 451 may change to the high level at the same time. To simplify the pulse generating instrument 694, such a waveform as shown in FIG. 120 is used. Consequently, the length of the high level period of the current precharge pulse 1174 is equal to the sum of the values for the voltage precharge period setting line 933 and current precharge period setting line 1096. Since the six current precharge pulses 1174 are used, six current precharge period setting lines 1096 can be set. Even if a change in the number pixels or the like changes the source driver clock 871 by one, the frequency dividing circuit 692 deals with this by making the adjustment range of pulse width as uniform as possible. Further, even if an improvement in EL efficiency rapidly changes the required pulse width, the frequency driving circuit 692 deals with this by changing the number of frequencies resulting from frequency division. Accordingly, the same source driver can be advantageously used regardless of the number of arbitrary pixels or the emission efficiency of the EL element.

Thus, the optimum current precharge can be realized by using the six commands, the commands D to I, to specify the gray level ranges within which the six current precharge operations are performed and specifying the length of each current precharge period using the current precharge period setting line 1096 of the source driver 36. The current precharge operation 1 is performed within the gray level range from gray level 1 through the gray level specified by the command D. The current precharge operation 2 is performed within the gray level range from the gray level specified by the command D through the gray level specified by the command E. The current precharge operation 3 is performed within the gray level range from the gray level specified by the command E through the gray level specified by the command F. The current precharge operation 4 is performed within the gray level range from the gray level specified by the command F through the gray level specified by the command G. The current precharge operation 5 is performed within the gray level range from the gray level specified by the command g through the gray level specified by the command H. The current precharge operation 6 is performed within the gray level range from the gray level specified by the command H through the gray level specified by the command I. No current precharge is carried out if the gray level exceeds the one specified by the command I (57).

For the rows except the first one, even when current precharge is carried out as shown in FIG. 53, measures must be taken for the “insufficient write operation” and “tailing” on the basis of the result of comparison by a comparison determining device 531. This corresponds to the flow from 504 to 506 shown in FIG. 50.

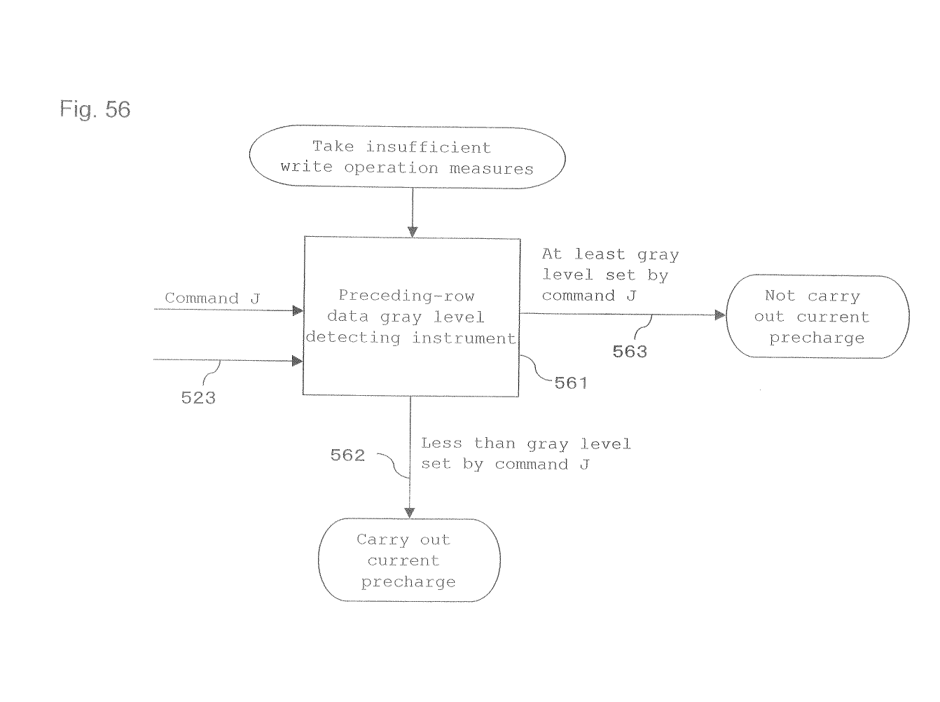

For the insufficient write operation measures, when the preceding row is at a gray level higher than that corresponding to a current of 40 nA, current precharge is not required. Accordingly, first, preceding-row data gray level detecting instrument is provided as shown in FIG. 56. Current precharge is carried out only if the preceding row is at a gray level lower than that specified by the command J. Here, by way of precaution, the command input is provided for the gray level corresponding to a current of 40 nA because this gray level varies depending on the application or is affected by the display color or the emission efficiency of the organic material. If these conditions are already set, determination may be made, without the command input, depending on whether the gray level is at most or less than the specified value. If the gray level is less than the specified value, then the current precharge determining function corresponding to the determination in 506 is required. This function can be provided utilizing the arrangement shown in FIG. 57 again. The flow shown in FIG. 50 can be realized by setting the gray level in the command I so that it corresponds to a current exceeding 300 nA.

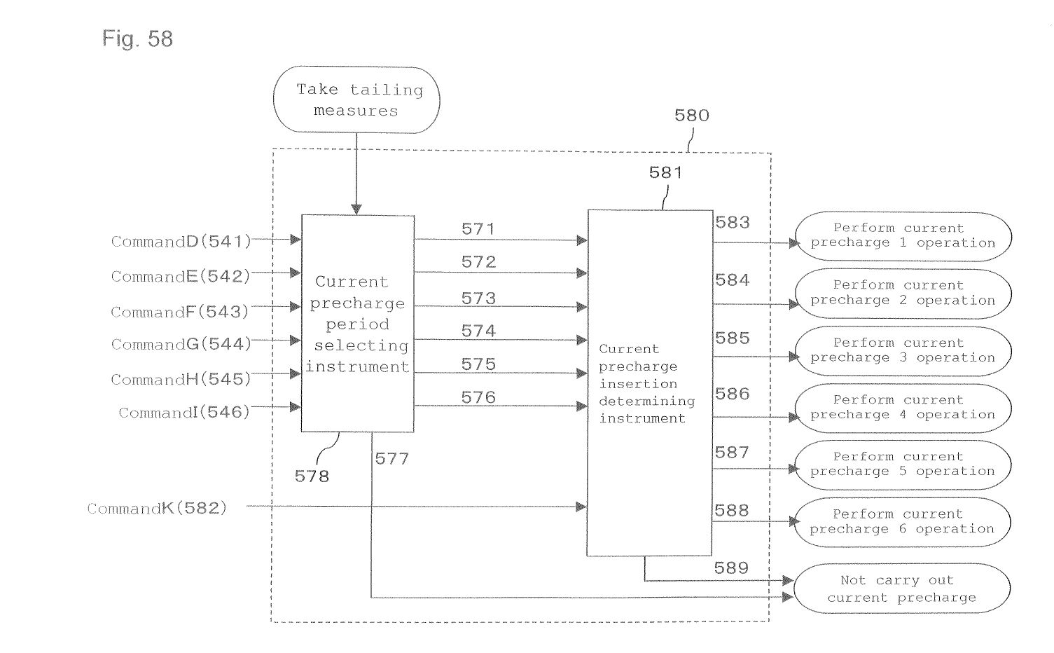

Then, for the “tailing” measures, the determination in 504 may be made. As shown in FIG. 58, the current precharge period selecting instrument 578 is used for the determination as in the case of FIG. 57. This prevents the “tailing”, but a variation in characteristics among the transistors 62 in the intra-pixel circuits may cause the application, to some pixels, of a voltage that makes display more blackish than required during voltage precharge. In this case, since there is no variation in current precharge, the display more blackish than required may reduce the luminance below the predetermined level. (This does not mean that the reduction always occurs but means that there is a possibility that it will occur in the worst case because a period is surely present during which the current corresponding to the predetermined gray level is output). For the “insufficient write operation”, even if the display becomes more blackish than required, this appears to be a gradual change and is unnoticeable. However, for the “tailing”, if the area 461 is at gray level 48 and the area 462 is at gray level 40, gray level 30 may be displayed only in the uppermost row of the area 462. If this occurs between gray levels 48 and 40, it is unnoticeable owing to halation caused by gray level 48. However, if a gray level lower than these two occurs, a dark horizontal line appears at the boundary.

The dark horizontal line affects image quality and the halation makes the “tailing” more unnoticeable than the “insufficient write operation”. In view of this, it is less necessary for the “tailing” measures than for the “insufficient write operation” measures to set a definite gray level using current precharge.

Experiments with a 3.5 sized QVGA indicate that the “insufficient write operation” occurs if the gray level of the preceding row is between gray levels 0 and 7 and if the gray level of the current row is between gray levels 1 and 74. On the other hand, the “tailing” occurs when the gray level of the current row is between gray levels 0 and 9 regardless of the gray level of the preceding row. The number of gray levels requiring current precharge is smaller in the case of the “tailing” than in the case of the “incorrect write operation”.

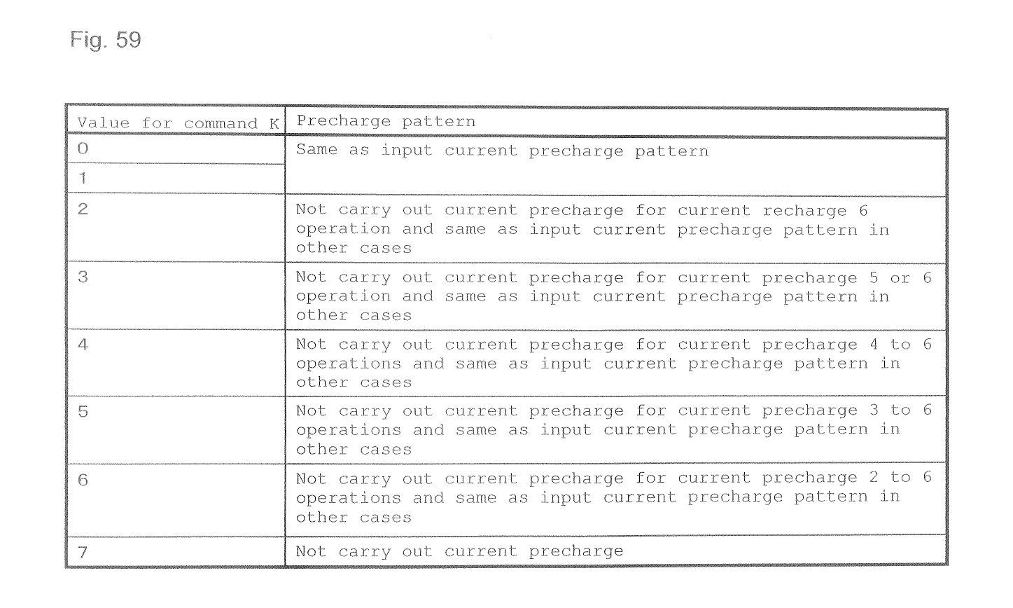

Thus, according to the present invention, an output from the current precharge period selecting instrument 578 is further input to the current precharge insertion determining instrument 581 so as to further limit the range of current precharge using a command K. The command K serves to vary the output from the precharge insertion determining instrument 581 as shown in FIG. 59. For example, the command K is assumed to have a value of 6. Then, the operation shown in FIG. 59 determines whether to avoid current precharge or to perform the current precharge operation 1. Since the command D has already determined the range of the current precharge operation 1, the current precharge operation 1 is performed when the gray level is equal to or lower than that set by the command D. The gray levels requiring current precharge are thus limited. The tailing removing instrument 580 is thus composed of two stages in order to reduce the number of commands. Provision of two types of commands for the tailing and the insufficient write operation” requires a total of 12 commands. However, the form according to the present invention requires only seven commands, thus advantageously reducing the number of command registers required. The concept of the present invention is that the determination for current precharge is made as in the case of the prior art but that the command K is used to eliminate the need for only those commands unnecessary for the “tailing”.

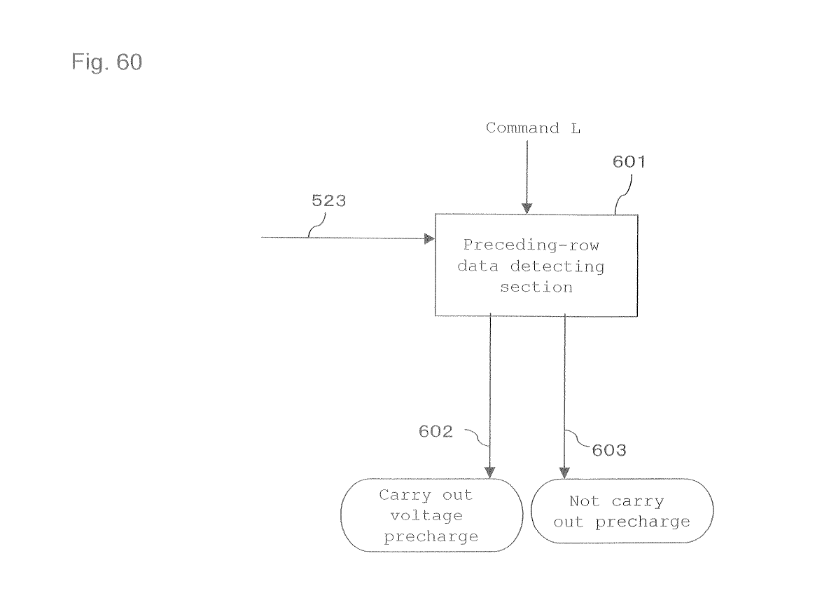

If the current gray level is 0, the current is 0 and current precharge is not required. Thus, determination is made as to whether or not to carry out voltage precharge to apply the voltage corresponding to gray level 0. In FIG. 50, this determination is made by the voltage precharge determining section 503, which is configured as shown in FIG. 60. The preceding-row data detecting section 601 is provided because if gray level 0 is continuously displayed over at least two rows, a change in the state of the source signal line need not be started in the preceding row, so that current precharge is not required even for gray level 0. Control only with current enables the suppression of the adverse effect of a variation in luminance caused by a variation among the transistors 62. Thus, the preceding-row data detecting section 601 only determines whether or not the data in the preceding row is at gray level 0. (In this case, the data in the preceding row is a data-converted preceding-row video signal 523. Since the conversion is carried out in accordance with FIG. 51, the converted data does not present any problem in determining whether or not the data is at gray level 0). Determination may be performed on the data in the preceding row output by the memory 522, shown in FIG. 52.

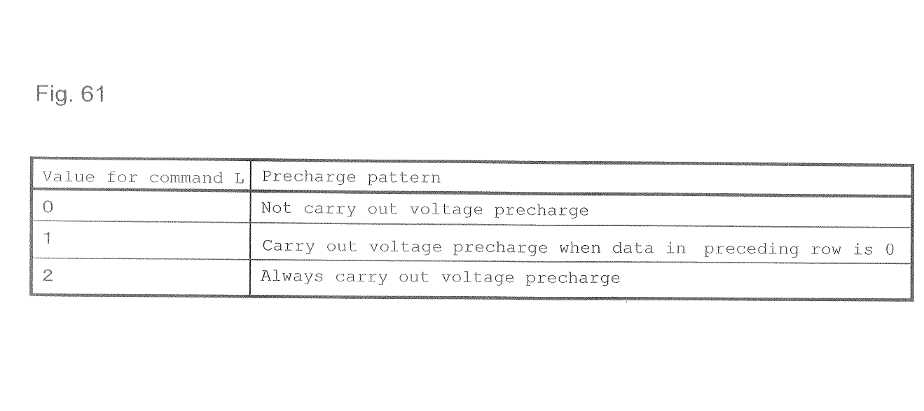

If the black luminance is sufficiently low even at gray level 0 or a high black luminance does not preset any problems, voltage precharge may be avoided. Accordingly, in this case, it is possible to determine that voltage precharge is to be avoided. A command L is used for this control; the value for the command L determines whether or not to carry out voltage precharge as shown in FIG. 61. Voltage precharge is essential for extremely reducing the black luminance. This makes it possible to prevent black from standing out against the image owing to leakage current.

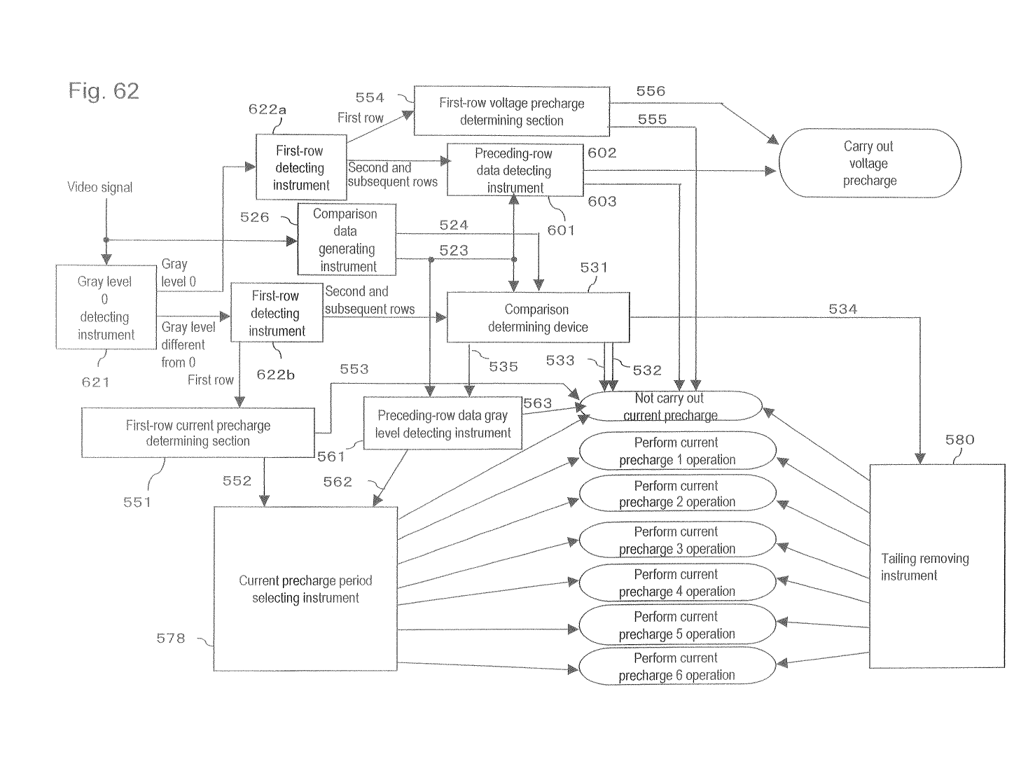

The above precharge determination is shown in FIG. 62. First, determination is made as to whether or not the video signal is at gray level 0 (621). The process to be executed depends on whether or not the video signal is at gray level 0. For gray level 0, determination is made as to whether or not to carry out voltage precharge. The determination whether or not to carry out voltage precharge is made on the basis of the data in the preceding row (601). However, since the first row has no comparative data, whether or not to carry out precharge is determined on the basis of the gray level of the first row (554).

For a gray level different from 0, determination is made as to whether or not to carry out current precharge. Moreover, if current precharge is to be carried out, determination is made as to which of the six precharge periods is to be selected. Because of the “tailing” and “insufficient write operation” measures, the process to be executed depends on whether the gray level of the current row is higher or lower than that of the preceding row. The determination differs between the first row, which cannot be compared, and the second and subsequent rows. For the first row, blocks 551 and 552 make the determination. For the second and subsequent rows, the tailing removing instrument 580 makes determination for the “tailing” measures. Blocks 561 and 578 make determination for the “insufficient write operation” measures. For the same gray level or a difference of one gray level for which precharge should be avoided, the block 531 determines that current precharge is to be avoided.

For the 3.5 QVGA panel, the command A, B, and C specify outputs of 2, 556, and 552, respectively. The commands D, E, and F specify gray levels 1, 2, and 4, respectively. The commands G, H, and I specify gray levels 10, 30, and 80, respectively. The commands J and K, and L specify gray levels 11, 4, and 1, respectively. This realizes the display of lower gray levels that preclude a predetermined gray level from being displayed easily.

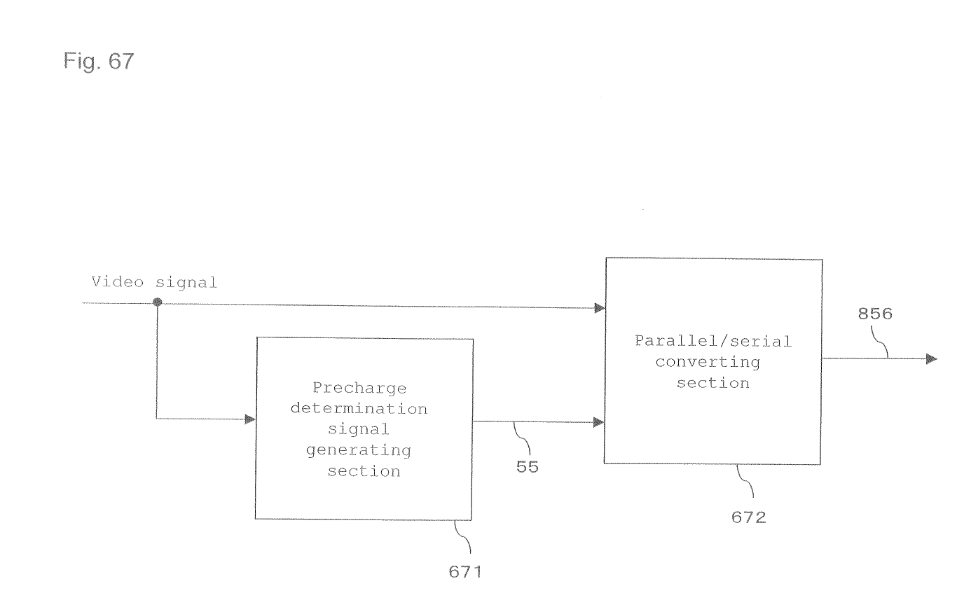

As a result of FIG. 62, the precharge determination signal 55 is added to the video signal as shown in FIG. 67. (The determination in FIG. 62 is made by the precharge determination signal generating section 671).

The parallel/serial converting section 672 is not necessarily required. However, if a signal is transferred from the control IC to the source driver without conversion, a transfer line for 33 bits is required because 8 bits of video signal and 3 bits of precharge determination signal 55, a total of 11 bits, are required for each of the three colors. This disadvantageously increases the number of connection signal lines and large amounts of time and effort are required to route the required wires. Further, an increase in the number of input/output pins disadvantageously increases the package size. Accordingly, the wiring is preferably adapted for serial transfers. If the control IC and the source driver are composed of an IC in the same package, serial conversion is not required because the wiring can be provided within the IC.

FIGS. 1 and 28 shows examples of the output waveforms of the parallel/serial output section 856 obtained during a serial transfer. The precharge determination signal 55, the video signal, and the command from the source driver are transferred over the same signal line in this order. Fundamentally, these signals are transferred through the wiring between the control IC and the source driver.

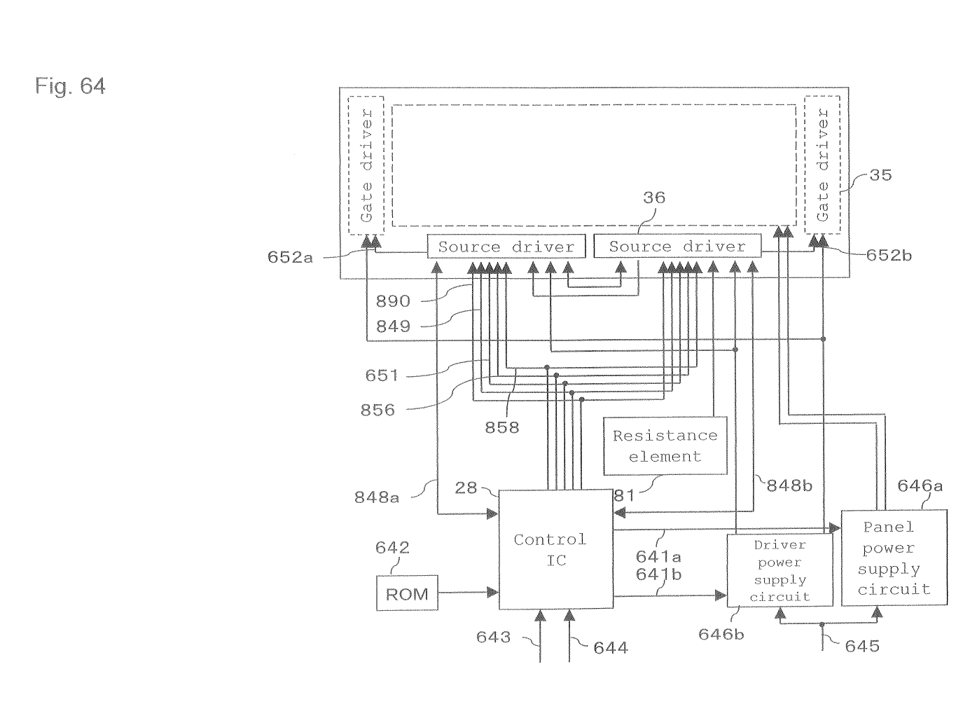

FIG. 64 shows a panel configuration according to an embodiment of the present invention. The control IC 28 is provided with the synchronous signal 643 and the video signal 644 from the apparatus main body. The control IC 28 then converts the signals into a format in which the signals can be input to the source driver; the control IC 28 outputs a video signal and a command signal as a video signal line 856. In addition, the following are input to the source driver 36: a clock 858 for shift register operations performed inside the source driver 36, shift direction control 890, start pulse 848, a timing pulse 849 that determines the time at which an analog current is output, and a gate line 651 having a reduced number of signal lines because of serial transfers.

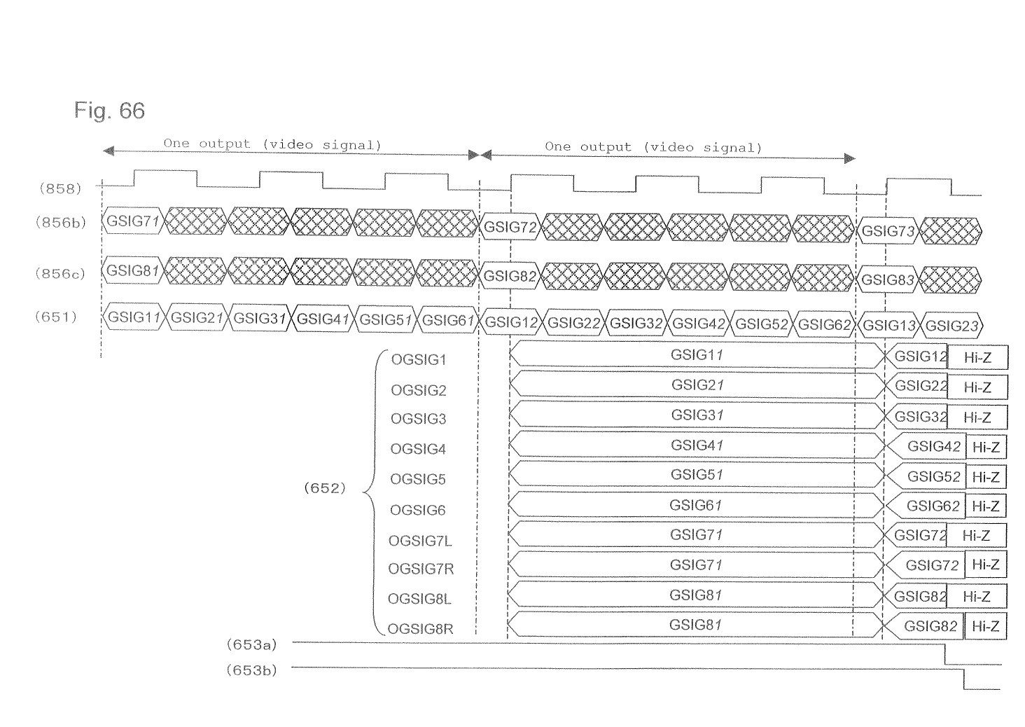

The gate line 651 is transferred in accordance with the time chart shown in FIG. 66. The gate driver 35 has two circuits (the circuit for controlling the switches 66a and 66b and the circuit for controlling the switch 66c) each requiring a start pulse, an output enable signal, a clock, and shift direction control; a total of eight signals are required. Thus, since the six-times speed transfer can send only six signals in one output, the remaining two signals are placed in a free part of the green data 856b and 856c. Once the eight signals are input, they are output to the gate driver line 652 at a time. This enables the signal line of the gate driver to be varied at increments each corresponding to at least one output. One source driver can control two gate drivers, the source driver 36 outputs a gate driver control line 652 for one circuit on each of its right and left sides. If the gate driver 35 is controlled using two source drivers as shown in FIG. 64, the adjacent source drivers 36 need not output the gate driver control line 652. Thus, gate output enable signals L and R (653) are provided which can prevent the right and left gate driver control lines 652 from being output. This eliminates unwanted outputs and suppresses the emission of noise to the exterior.

Moreover, a power supply control line 641 is output which controls the turn-on and -off of the power supply. During standby or non-display, the power supply control line 641 stops the power supply circuit 646 to reduce standby power. The power supply circuit is divided into a panel power supply circuit 646a and a driver power supply circuit 646b because of a difference in on/off timing. This is because the output from the gate driver 35 is unspecified when the power source is started up. In this case, the transistor 66 in the pixel circuit 67 is unintentionally set in the conductive state. For example, when the switch 66c is set in the conductive state, if the charges in the storage capacity 65 are in a 255-gray-level display state, this pixel is lighted. Two frames after power-on, a predetermined gray level current is written to the pixel 67. The level of the output from the gate driver 35 varies according to the start pulse for the gate driver. Consequently, a predetermined current flows through the EL element 63 to provide a predetermined gray level. Since a gray level different from the predetermined one may occur during the two frames after power-on, disadvantageously the panel may flash instantaneously during power-on. Thus, the power supply to the EL power supply line is turned on one frame later to preclude the EL power supply line 64 from supplying power even if a gray level different from the predetermined one is stored in the storage capacity 65 of the pixel or if the transistor 66 cannot be appropriately controlled. Accordingly, the EL element 63 does not emit light. This avoids the disadvantageous instantaneous flashing of the panel. Thus, two power supply control lines 641 are required.

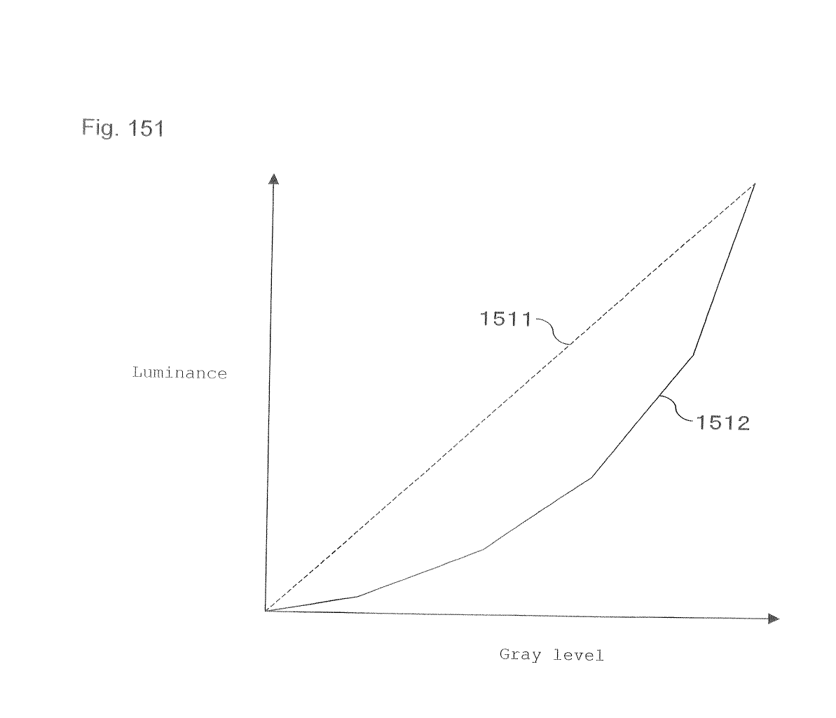

In such a configuration, it is optimum to transmit data by serial transfers as shown in FIG. 1 or 28 in order to reduce the number of signal lines between the control IC 28 and the source driver 36. A dotted line 1511 in FIG. 151 indicates the relationship between the gray level input to the source driver and the display luminance when a current output type source driver is used. The figure shows that the luminance is in proportion to the gray level.

On the other hand, in view of the characteristics of the human eyes, the relationship between the gray level and the luminance must be subjected to gamma correction as shown by a curve 1512 before output.

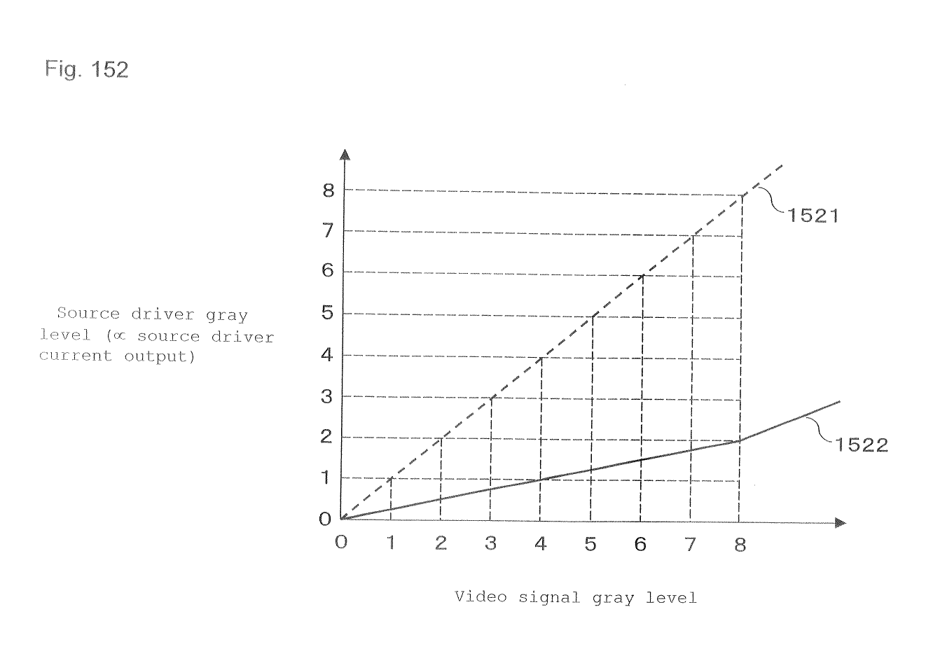

It is difficult to change the relationship between the gray level and luminance characteristic of the source driver. Accordingly, to realize the curve shown at 1512 in FIG. 151, a timing controller or the like is used to change the relationship between the gray level of the video signal and the gray level for the source driver. For example, the relationship shown at 1521 in FIG. 152 is changed to the one shown at 1522.

Smooth gray level display can be realized by thus associating the output gray level of the source driver with the gray level of the video signal for gamma correction. In this case, if for example, the video signal it at gray level 2, the source driver outputs gray level 0.5. However, since the source driver cannot output gray level 0.5, an output corresponding to gray level 0.5 is falsely provided using frame decimation, dithering, error diffusion, or the like. For example, by displaying gray level 1 at one of the two opportunities and gray level 0 at the other opportunity, it is possible to provide an output corresponding to gray level 0.5 on average. Similarly, for video signal gray level 1, if there are four display opportunities, gray level 0 is displayed at three opportunities, while gray level 1 is displayed at one opportunity. Video signal gray levels 5 to 7 are realized by varying the ratio of the number of times gray level 1 displayed to the number of times gray level 2 displayed. When a gray level that is not displayable is specified, two gray levels similar to the gray level that cannot be displayed are preferably used in order to prevent flickers.

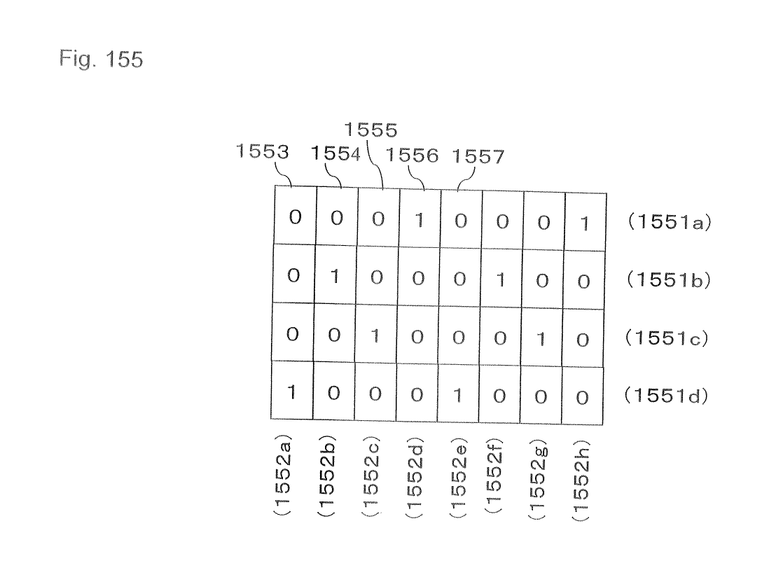

FIG. 155 shows an example of the pattern of gray level output from the source driver in a certain frame when for example, video signal gray level 1 is displayed all over the screen (This figure shows a monochromatic display panel for simplification. For a color panel, the pattern in FIG. 155 may be displayed in each color).

Display with a reduced amount of flicker can be provided by displaying, in a certain display area, one-fourth of the pixels at gray level 1 and three-fourths at gray level 0, and for the same pixel between frames, displaying gray level 1 for one-fourth of the total period and gray level 0 during three-fourths. For a color panel, the amount of flicker in white display can be reduced by varying pixels displayed at gray level 1 depending on the colors.

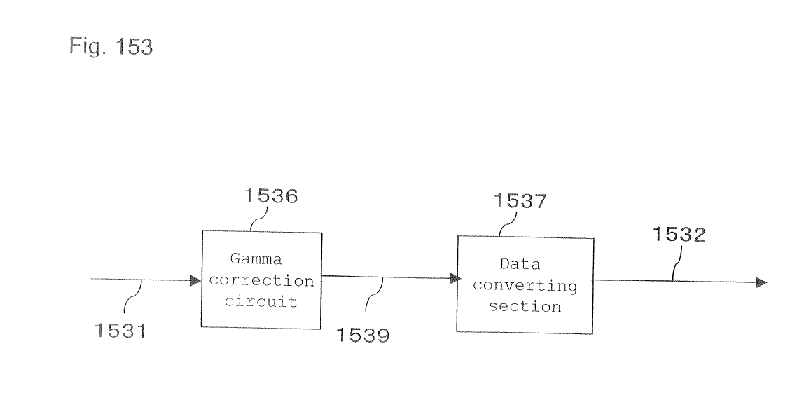

FIG. 153 shows a circuit block used to realize the straight line shown at 1522 in FIG. 152. A gamma correction circuit 1536 converts an input video signal 1531. On this occasion, a gray level conversion is carried out so as to reduce the luminance of the lower gray level part so that the luminance conforms to the visual characteristic of human beings. At lower gray levels, the gray level must be increased at smaller increments than that of the visual signal. As a result, a gamma corrected video signal 1539 has more bits than the video signal 1531.

If the gamma corrected video signal 1539 has the same number of bits as that in the video data for the source driver 36, the signal may be input as it is. However, an increase in the number of bits increases the number of bits latched by the latch section 22. This results in an increase in the number of gray level display current sources 103 and switches 108 in the current output stage 54 by a value equal to the increase in the number of bits. As a result, the circuit scale and costs of the source driver 36 increase.

Thus, in general, the gamma corrected video signal 1539 has more bits than the video data for the source driver 36. An increase in the difference in the number of bits increase the number of gray levels that must be subjected to frame decimation or the like before display as described for FIG. 152. For organic light emitting devices and the like, owing to their high reaction speed, noticeable flickers tend to result from the difference in two gray levels used for frame decimation. Actual display has demonstrated that if the frame frequency is 60 Hz and frame decimation is used, display must be completed within four frames in order to avoid flickers.

It is assumed that the gamma corrected video signal 1539 contains M bits (M is a natural number and is larger than N) and that the video data for the source driver 36 contains N bits (N is a natural number). Then, a data converting section 1537 is required to convert M bits into N bits.

Thus, in FIG. 153, the data converting section 1537 converts the gamma corrected video signal 1539 into a converted video signal 1532 (N bits).

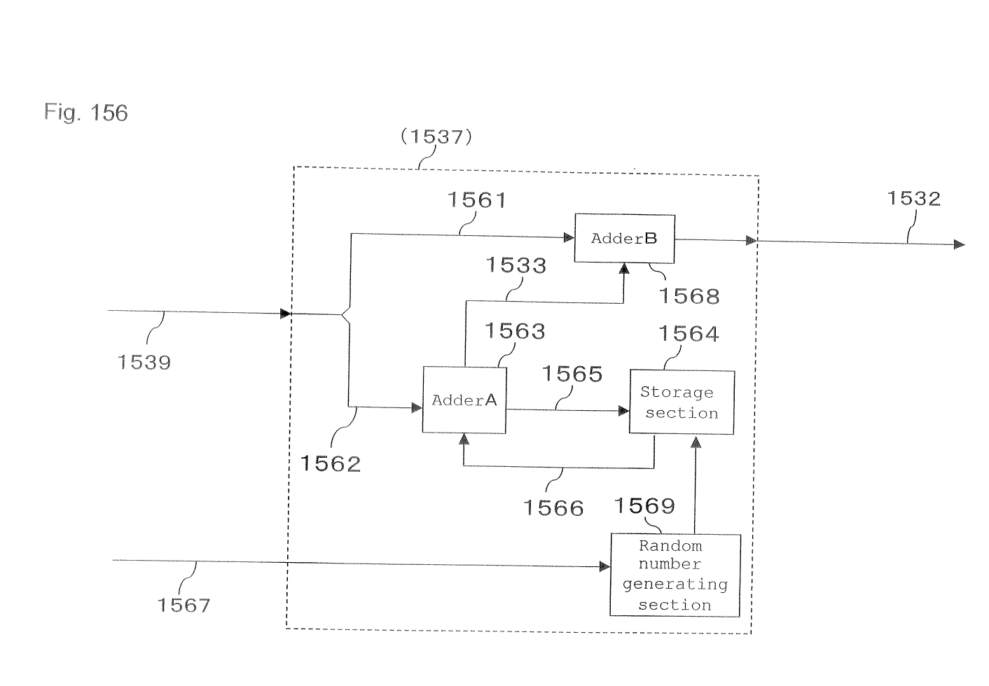

For the conversion, the input M bits are divided into the upper N bits and lower (M-N) bits as shown in FIG. 156. The upper N bits are directly supplied in association with the gray level for the source driver. A required current value per gray level is multiplied by 2^{(M-N)} before output. Then, display can be appropriately provided every 2^{(M-N)} gray levels. However, this precludes the intermediate gray level expression, and the substantial expression is such that the data is dropped every 2^{(M-N)} gray levels. To correct this, a storage section 1564 and an adder A 1563 are used to hold and add together the lower (M-N) bit data of the gamma corrected video signal 1539, which is dropped. Then, when the amount of drop (the value for the sum of the lower (M-N) bit data) is at least 2^{(M-N)}, 1 is added to the upper N data 1561 of the gamma corrected video signal to compensate deficiency of gray level due to dropping. For this purpose, an adder B1568 is provided. This makes it possible to correct a decrease in display gray level caused by the failure to input the lower (M-N) bits to source driver 36.

For the same pixel, flickers may occur unless the correction is completed within four frames. Accordingly, the lower (M-N) bits are preferably (M-N)≦2. If the display material exhibits a low reaction speed, this value need not necessarily be at most 2. The upper limit value for (M-N) may be determined depending on the display panel. The number of bits for and the costs of the source driver increase with decreasing (M-N). However, image quality is improved because of the omission of frame decimation and dithering. Image quality and costs can be traded off with each other, so that (M-N) may be determined as required.

Description will be given of the application of the present invention to a display panel using an organic light emitting device. Accordingly, the value M-N is assumed to be 2.

In the relationship between the video signal gray level (subjected to a gamma process; M bits) and the source driver gray level (N bits) such as the one shown at 1522 in FIG. 152, the number of bits for the source driver is assumed to be 8. Then, 10 bits result from the gamma process and enable 1024-gray level expression.

Using the gray level for the source driver as a reference, the data in the gamma processed video signal is expressed at 256 gray levels at the minimum 2.5 gray level increments.

FIG. 155 shows an example in which gray level 0.25 is displayed all over the screen. The upper 8 bits of the gamma corrected video signal are always 0, whereas the lower 2 bits are always 1. At the beginning of display, the value in the storage section 1564 is determined from the value in a random number generating section 1569 that generates a random number for each display row. That is, the value in the storage section 1564 is in advance varied depending on display rows to shift, for each row, the time when the same display gray level of the source driver increases by one, to make flickers unnoticeable. The value generated by the random number generating section 1569 is from to 0 to 3 because 1562 is 2-bit data.

For the first row 1551a in FIG. 155, the output from the random number generator 1569 is 0, so that the value in the storage section 1564 is 0 in its initial state. When the data 1539 corresponding to a pixel 1553 is input, the signal line 1561 outputs 0, while the signal line 1562 outputs 1. The adder A 1563 provide outputs 1533 and 1565. Outputs 1533 and 1565 from the adder A 1563 correspond to the addition of the 2-bit inputs 1562 and 1566; the output 1565 corresponds to the result of the lower 2 bits, whereas the output 1533 is a carry output. As a result, the output 1533 is 0, while the output 1565 is 1. Further, 1 is stored in the storage section 1564.

Consequently, the adder B outputs the data 1561 as it is. The converted video signal 1532 is 0.

The data (gray level 0.25) corresponding to a pixel 1554 is input. Upper 8-bit data 1561 and 1562 are 0 and 1, respectively. Outputs 1533 and 1565 from the adder A 1563 are 0 and 2, respectively, because the data in the storage section 1564 is 1. As a result, an output from the adder B 1568 is 0 similarly to the signal line 1561.

Then, when the data (gray level 0.25) corresponding to a pixel 1555 is input, the data 1561 and 1562 are 0 and 1, respectively. The outputs 1565 and 1533 from the adder A 1563 are 3 and 0, respectively, on the basis of the data 1562 and 1566. As a result, the output from the adder B 1568 is 0.

Then, when the data (gray level 0.25) corresponding to a pixel 1556 is input, the data 1561 and 1562 are 0 and 1, respectively. Since the data in the storage section 1564 is 3, the outputs 1565 and 1533 from the adder A 1563 are 0 and 1, respectively. Thus, the output from the adder B 1568 is 1, which is output to the pixel 1566.

If the entire row is at gray level 0.25, the above four states are repeated.

The final-column data in the storage section 1564 is not carried over to the beginning of the next row. A value generated by the random number generator 1569 is input to the storage section 1564 for data inputs and outputs. The random number generator 1569 does not necessarily have to generate random numbers but it is only necessary that at the beginning of 2^{(M-N)} rows, the value in the storage section 1564 indicates the output of 2^{(M-N)} data.

This realizes the relationship between the source driver gray level and the video signal gray level shown by the line 1522 in FIG. 152.

The circuit shown in FIG. 153 and having an improved gray level characteristic was introduced into the present invention, and the converted video signal 1532 was input to the precharge determination signal generating section. Then, disadvantageously, for combinations of particular gray levels, flickers occurred near the row in which the gray level changed.

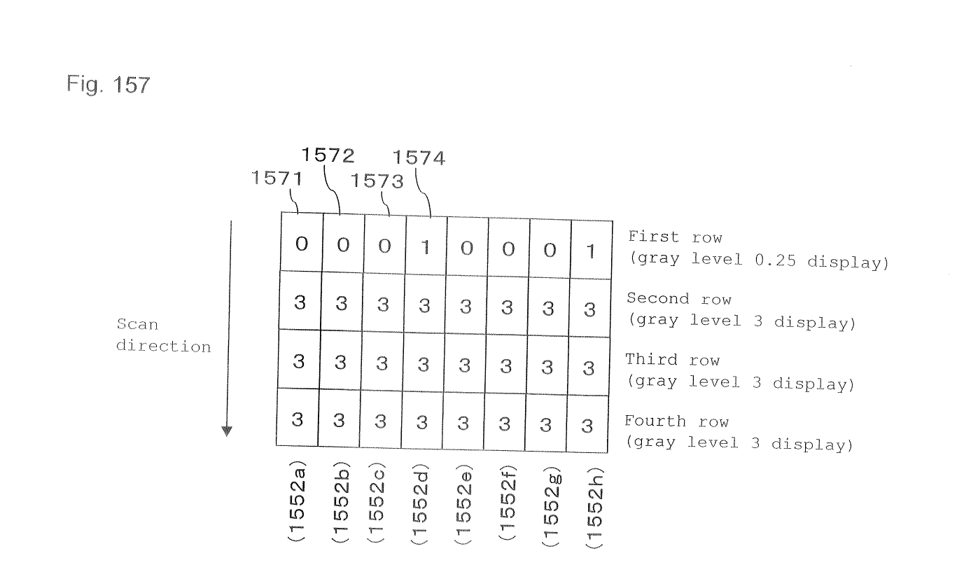

If for example, for such a source driver as shown in FIG. 157, the first row is at gray level 0.25 and the second and subsequent rows are at gray level 3, then for each pixel in a certain frame, the output gray level pattern of the driver is determined by the circuit block shown in FIG. 156, as shown in FIG. 157.

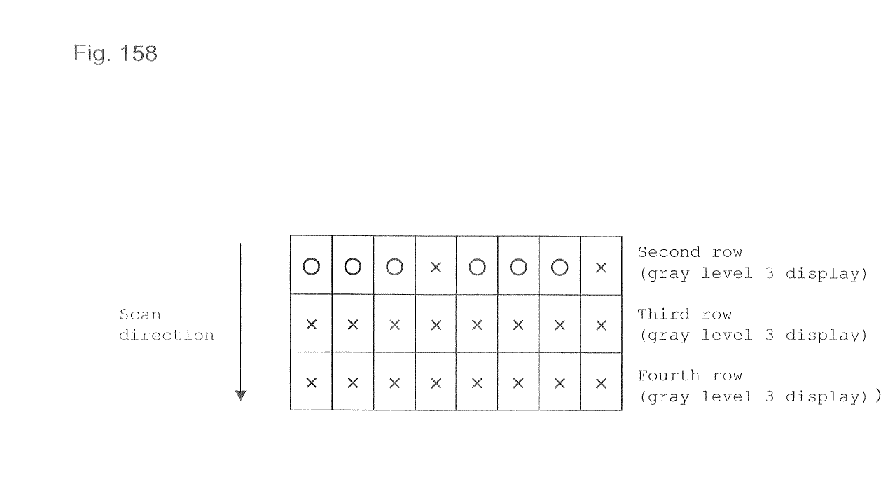

For example, this pattern is set so that precharge is not carried out when the difference in gray level between the preceding and current rows is at most two gray levels and that precharge is carried out when the difference is at least three gray levels. Then, for the second row, since the gray level in the first row varies with the columns, current precharge is carried out for the first to third columns because the gray level difference is 3 and is not carried out for the fourth column because the gray level difference is 2. FIG. 158 shows the determination, for each pixel, as to whether or not to carry out precharge.

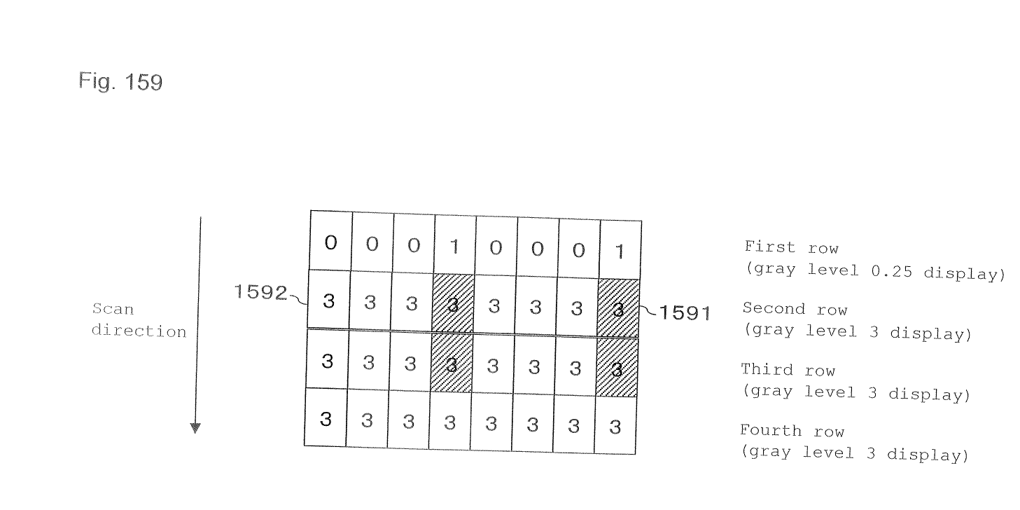

As a result, for columns for which current precharge is not carried out, it is more difficult for the current value to change to the predetermined gray level. The data in the preceding row brings an insufficient write operation, and even gray level 3 display results in a lower luminance. Such a pixel range as shown at 1591 in FIG. 159 lowers the luminance. For columns for which the first row output is 1, the luminance lowers. Consequently, a column with a reduced luminance appears every four columns. At a lower gray level, more time is required to change to the predetermined gray level and there is a larger difference between the current value and the predetermined gray level. This produces a larger difference from the predetermined luminance and thus more noticeable dark parts. The dark parts and the predetermined luminance parts vary with frames and move sequentially. This causes flickers in which dark vertical lines appear to move in a lateral direction.

Flickers occur if a different gray level is displayed at least once every four pixels owing to the presence of the data converting section 1537, shown in FIG. 156, even through the first and second rows always exhibit the same gray level. In particular, when the signal 1533 becomes 1 and the adder B 1568 adds 1 to the signal, an insufficient write operation occurs, which may lead to flickers.

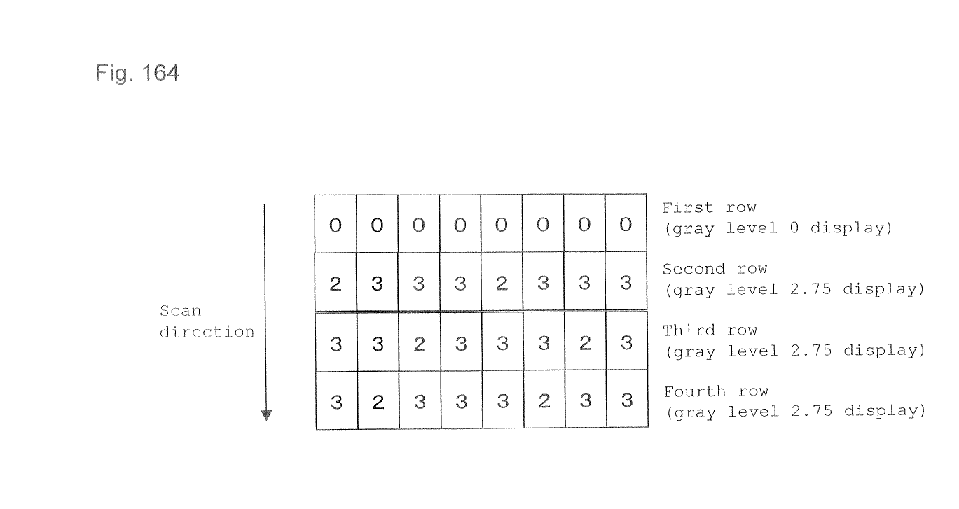

Flickers may also occur in the pattern shown in FIG. 164, where although the display of the preceding row remains unchanged, the current row (in this case, the second row) displays gray level 2.75, so that the display of the columns varies between gray level 2 and gray level 3. Also in this case, current precharge is not carried out for columns with gray level 2. Consequently, an insufficient write operation causes the display of a luminance lower than that corresponding to gray level 2. For columns with gray level 3, the predetermined gray level, gray level 3, is displayed because current precharge is carried out. More noticeable flickers result from a larger difference in luminance between a gray level 2 display area and a gray level 3 display area.

For signals output by the source driver as video signals, a change may cause flickers or an incorrect display gray level, thus lowering display grade.

Thus, the present invention provides a separate signal for the gray level determination by the precharge determination signal generating section 1538 or offers a new determination signal to prevent flickers.

Three examples will be shown as methods of realizing this.

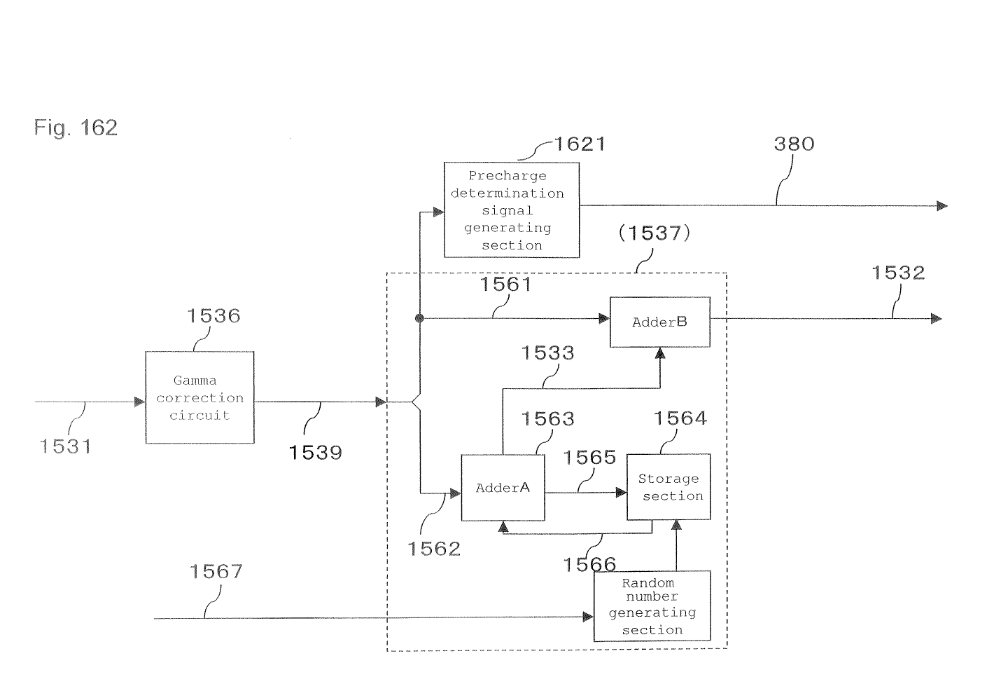

FIG. 162 shows a circuit block that implements a first method. In response to an input video signal line, the gamma corrected video signal 1532 and the precharge flag 380 are output; the precharge flag 380 is used to determine whether or not to carry out precharge as well as the type of precharge. This method differs from the conventional one in that the signal input to a precharge determination signal generating section 1621 is not the output from the data converting section 1537 but the upper N bit data 1561 of the gamma corrected video signal. The operation of the data converting section 1537 is the same as that shown in FIG. 156.

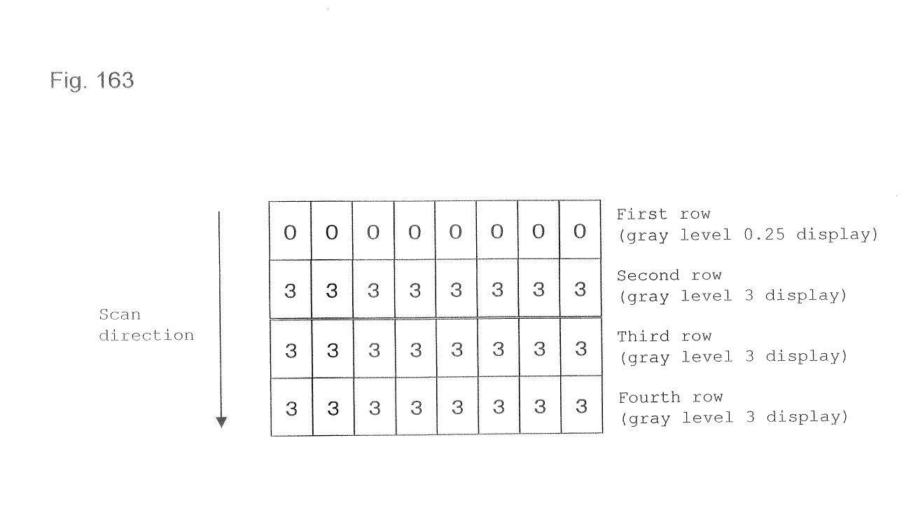

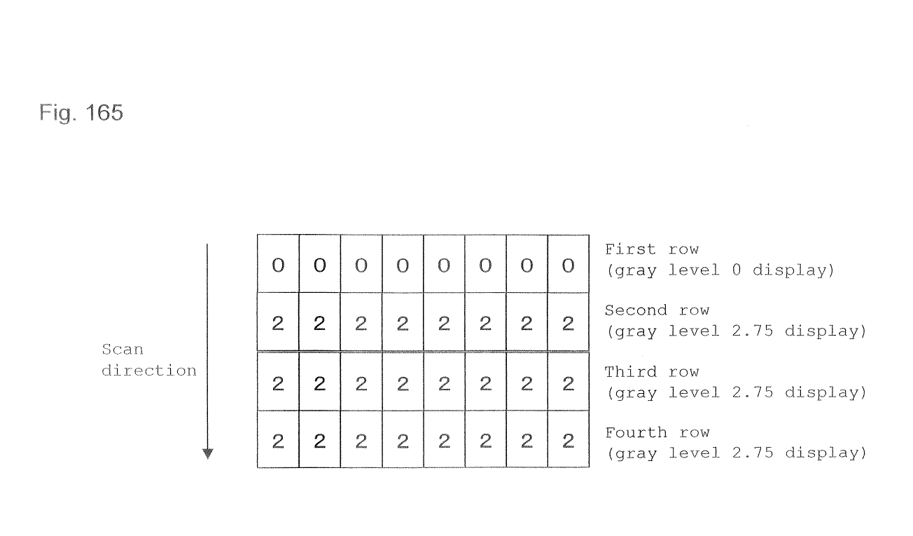

Thus, the data used for determination does not pass through the adder B 1568. Accordingly, determination is made using the data corresponding to the input signal from which the lower 2 bits are dropped. For example, even though the display shown in FIG. 164 is provided, the signal for precharge determination has such a pattern as shown in FIG. 165. Consequently, the gray level difference is always 2 and thus precharge is not carried out. Therefore, no flickers occur. On the other hand, even with the display pattern shown in FIG. 157, such a precharge determination signal as shown in FIG. 163 is input. Consequently, current precharge is always carried out, thus preventing flickers.

When two consecutive rows are displayed at the same gray level, a fixed determination is made as to whether or not to carry out precharge. This makes it possible to prevent flickers occurring depending on whether or not precharge is carried out.

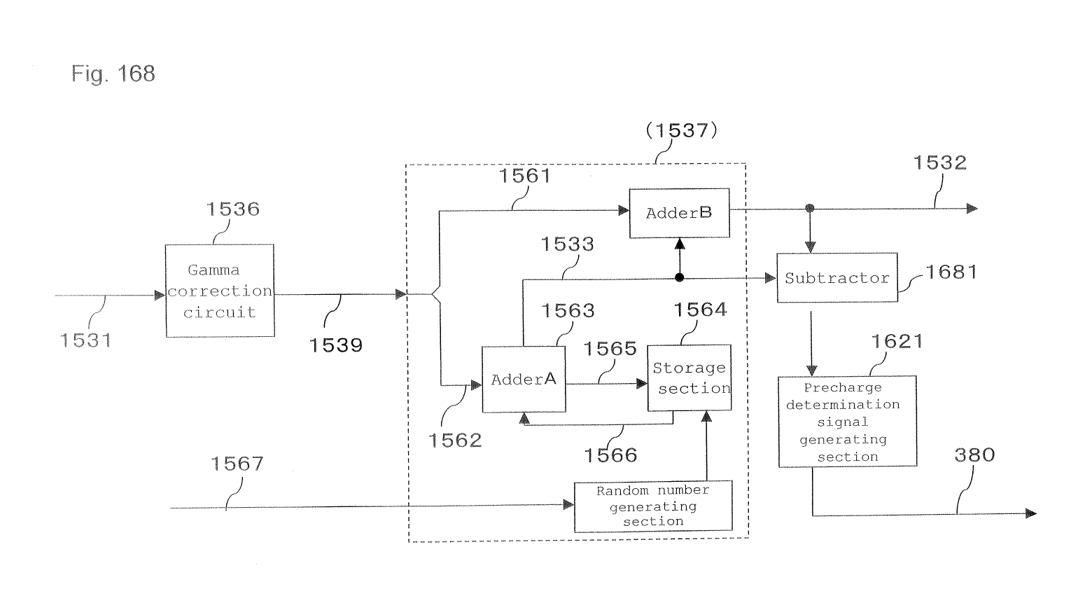

FIG. 168 shows a second method.

This method uses the converted video signal 1532 generated by the adder B 1568 from the upper N bit data 1561 of the gamma corrected video signal. Flickers may occur if this signal is input to the precharge determination signal generating section 1621 as it is. Thus, data obtained by subtracting the addition by the adder B1568 at a subtractor 1681 is input to the precharge determination signal generating section 1621.

Thus, a signal that is the same as the upper N bit data 1561 of the gamma corrected video signal is input to the precharge determination signal generating section 1621. Like the first method, this method has made it possible to prevent flickers occurring depending on whether or not precharge is carried out.

The second method is effective in the following case: a significant signal delay occurs inside the circuit in the data converting section 1537, so that the precharge determination signal generating section and the like, shown in FIG. 162, require a timing adjustment holding circuit in order to synchronize the precharge flag 380 with the converted video signal 1532, and the holding circuit has a larger circuit scale than the subtractor 1681.

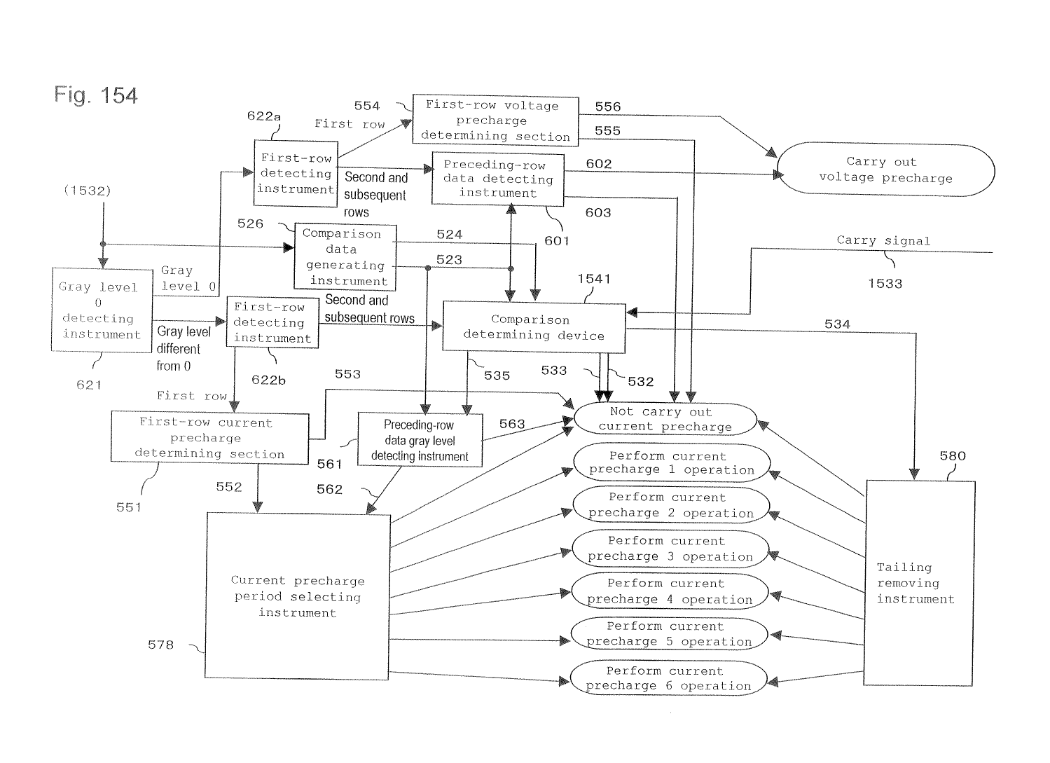

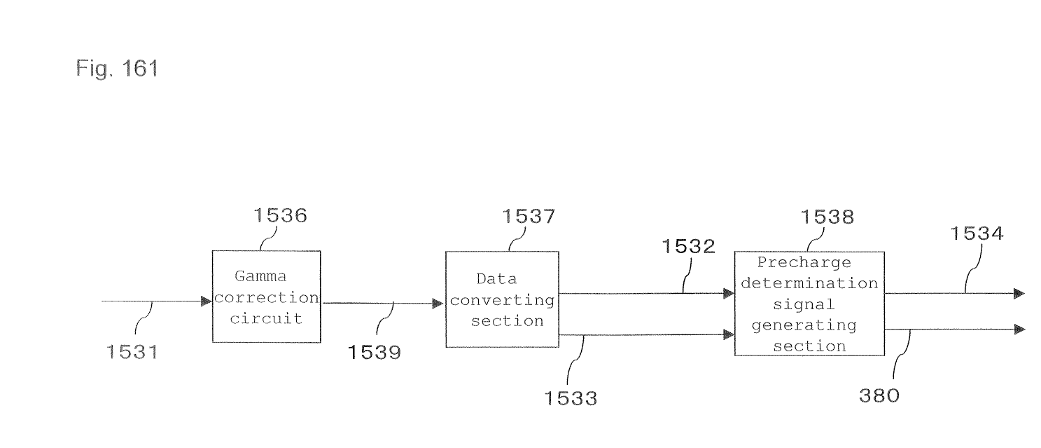

FIG. 161 shows a circuit block for a third method. FIG. 154 shows the block of the precharge determination signal generating section 1538, used for FIG. 161.

The method according to the present invention differs from the first and second methods in that the data converting section 1537 outputs the carry signal 1533 and in that both converted video signal 1532 and carry signal 1533 are used to determine the output of the precharge flag 380.

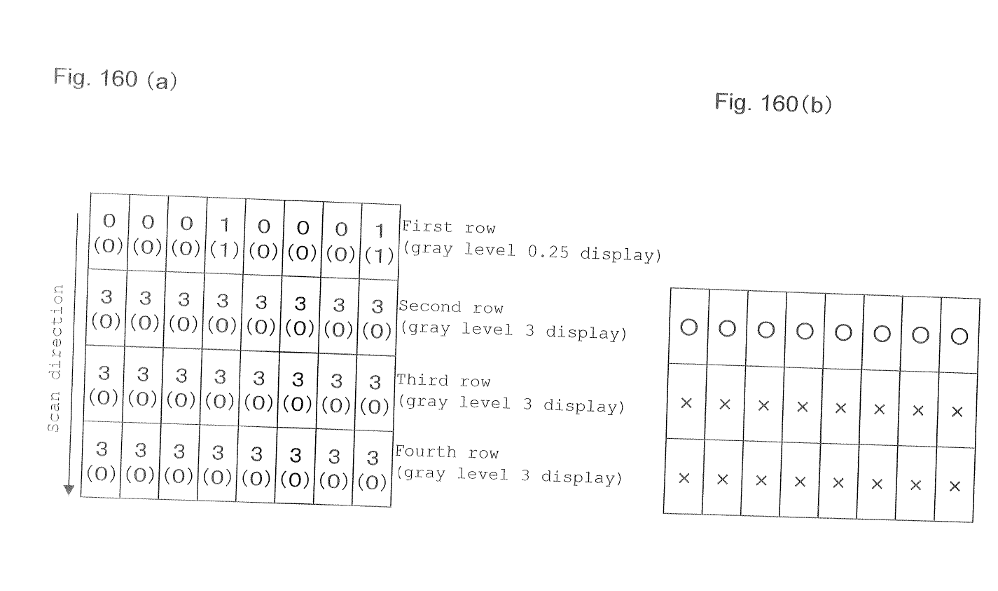

In FIG. 159, some pixels 1591 are incompletely set at gray level 3, while other pixels 1592 are completely set at gray level 3. This is because the data in the preceding row is 0 in some cases and 1 in other causes and because this corresponds to the display of gray level 0.25. The gray level is 0 without the carry signal 1533 and is 1 with the carry signal 1533. FIG. 160 (a) shows a display pattern describing the display gray level of each pixel and the value for the carry signal 1533, shown in parentheses.

This figure indicates that if precharge is not carried out even with pixel gray level 3 display, the carry signal 1533 corresponding to the pixel in the preceding row is sure to be 1. If current precharge is to be carried out for a gray level difference of at least three and if precharge is determined to be executed when the carry signal 1533 becomes 1 to change the difference in gray level from the preceding row to 2, then current precharge is carried out on all the pixels displayed at gray level 3. This makes it possible to prevent flickers resulting from the failure to write a predetermined gray level.

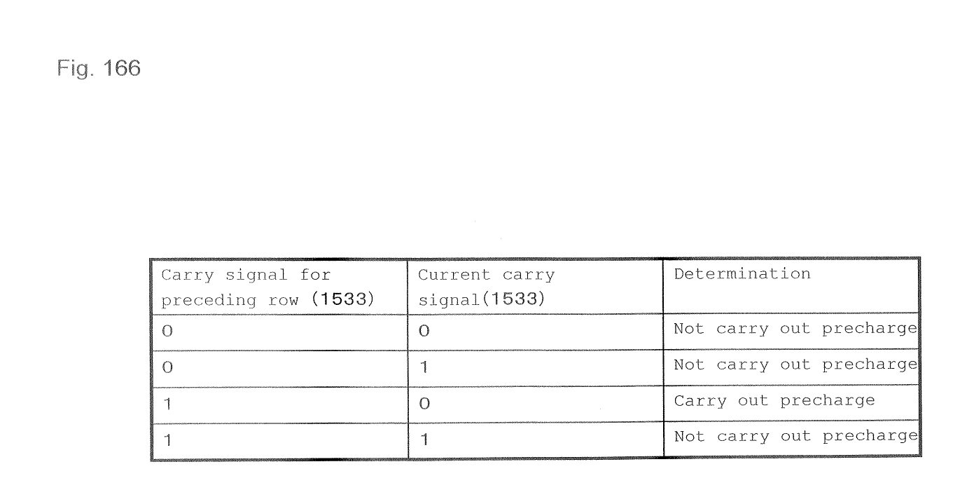

In general, if precharge is to be carried out for at least N gray level difference, then as shown in FIG. 166, the carry signal 1533 is also referenced when the gray level difference is N−1. When the carry signal 1533 for the preceding row is 1 and the carry signal for the current row is 0, current precharge is carried out in spite of the specification for the at least N gray level difference. In the three other cases, even without the carry signal, precharge need not be carried out because the difference in gray level from the preceding row is less than N.

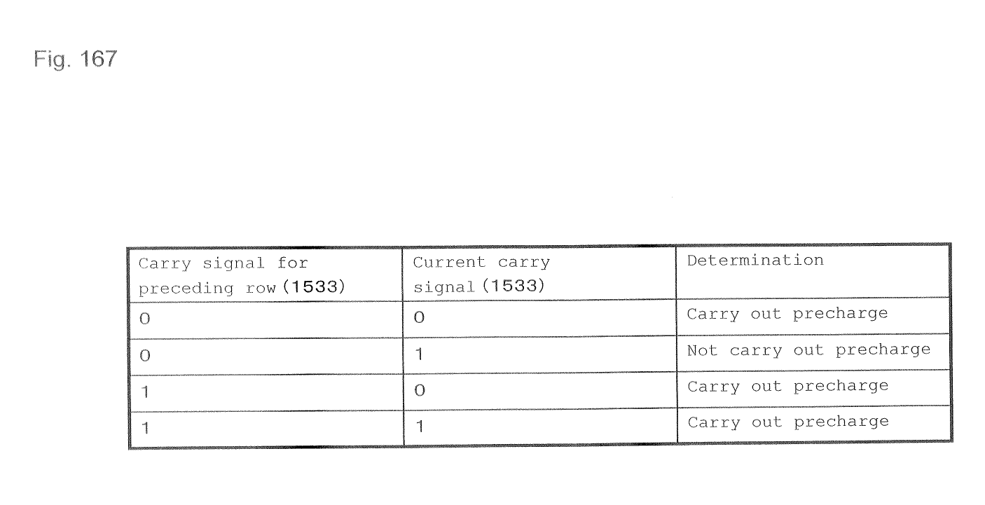

Moreover, even for an N gray level difference, whether or not to carry out precharge is determined on the basis of the value for the carry signal 15533 as shown in FIG. 167. If for example, the row next to the one displayed at gray level 0 is displayed at gray level 2.25, three-fourths of the columns offer a two gray level difference, whereas one-fourth of the columns offer a three gray level difference owing to the carry signal 1533. On this occasion, if current precharge is carried out only on pixels with a three gray level difference, the difference in luminance between gray levels 2 and 3 increases to cause flickers. Thus, as shown in FIG. 167, when the carry signal 1533 for the current pixel is 1 and the carry signal for the pixel in the preceding row is 0, precharge is not carried out even with an N gray level difference. This makes it possible to prevent flickers occurring depending on whether or not precharge is carried out.

For an N+1 or more gray level difference, the gray level difference is at least N regardless of whether or not the carry signal is present. Accordingly, precharge determination is made regardless of the carry signal as previously described.

To achieve this determination, the carry signal 1533 is input to the precharge determination signal generating section 1538 in addition to the converted video signal 1532 as shown in FIG. 161. Then, whether or not to carry out precharge is determined on the basis of the video signal and the carry signal.

In this case, the carry signal 1533 must be compared with the data in the preceding row. Consequently, in contrast to the above embodiments of the present invention, the comparison determining device 1541 requires a line memory for the carry signal of 1 bit, which is different from the one for the video signal.

The line memory for the carry signal 1533 enables the determinations shown in FIGS. 166 and 167. This in turn enables the present invention to be implemented.

According to the above invention, even with such a gray level display pattern as shown in FIG. 160 (a), whether or not to carry out precharge is determined as shown in FIG. 160 (b). This has made it possible to prevent flickers occurring when the presence or absence of precharge varies with the columns in spite of the same gray level display. That is, the object of the present invention is accomplished.

In the description of the present invention, the organic lighting device is used as a display element. However, the present invention can be implemented using any display element such as a light emitting diode, an SED (surface electric field display), or an FED in which current is in proportion to luminance.

Further, as shown in FIGS. 21 to 23, by applying a display apparatus using the display element according to the present invention to a television, a video camera, or a cellular phone, it is possible to provide a product with an improved gray level display performance.

In a color display apparatus using an organic light emitting device, the efficiency of organic light emitting devices for the tree primary colors, red, green, and blue, with respect to current varies depending on a material for each luminescent color or the configuration of the devices. At present, green is about two to five times as efficient as blue. Thus, blue requires about two to five times as much current per gray level as green.

On the other hand, the capacity parasitic on the source signal line and the horizontal scan period are common to all the colors. Consequently, the time required to change the current to the predetermined value varies with the display colors by a factor of about 2 to 5 even with the same gray level display.

Thus, with the same current precharge period, pixels of display colors with low luminescent efficiency require large quantities of current. Consequently, the voltage and current of the source signal line change greatly after voltage precharge. Therefore, these pixels exhibit a luminance higher than a predetermined one. Pixels of display colors with high luminescent efficiency require only small quantities of current. Consequently, the voltage and current of the source signal line change insignificantly after voltage precharge. Therefore, these pixels are displayed darkly. That is, the insufficient write phenomenon occurs.

Thus, the present invention varies the lengths of the six current precharge pulses depending on the display colors. For output terminals corresponding to display colors with high luminescent efficiency at which writing shortage occurs, the precharge pulse and thus the period of the maximum current are extended. This prevents the insufficient write phenomenon.

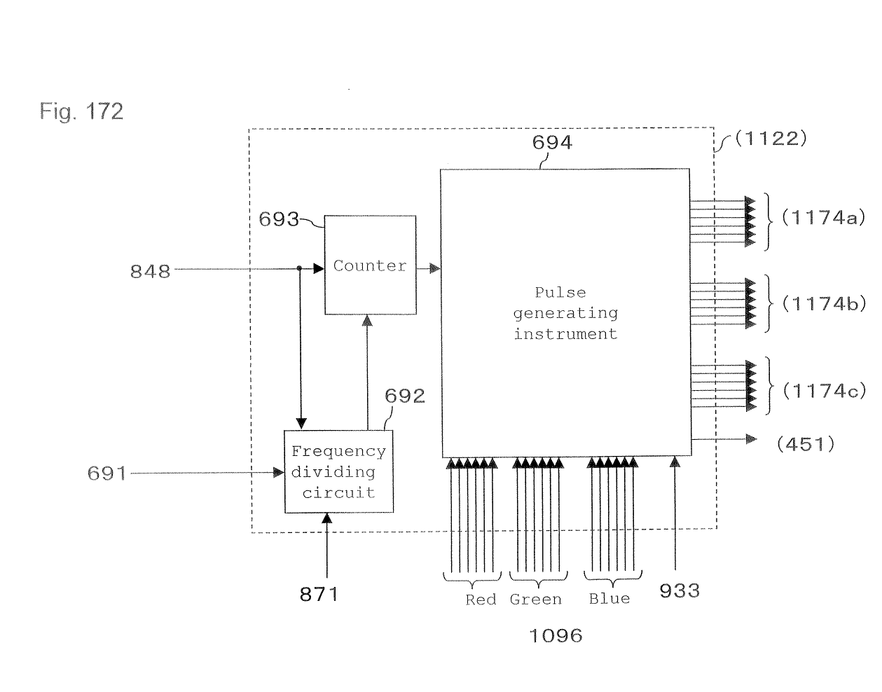

FIG. 172 shows a first method of implementing the present invention. This method allows the current precharge pulse width to be set independently for each of the three colors, red, green, and blue and also allows a current precharge pulse group 1691 to be output of six precharge pulses to be set independently for each color. This enables the precharge current output period shown in FIG. 123 to be controlled independently for each color.

In terms of the luminescent efficiency of the current organic light emitting device, the current for a red display pixel is about 80% of the current for blue display pixel. The current for a green display pixel is about 50% of the current for blue display pixel.

With a current difference of ±20%, the current changes to the predetermined current value during the period of a normal current even under the same current precharge conditions. Accordingly, the current precharge pulse width need not be set individually for each color. However, with a current difference of 50% as in this example, application of the optimum current precharge pulse for blue does not sufficiently change the current value for green to the predetermined gray level. Consequently, the luminance lowers. Thus, if a white box pattern is displayed, only the luminance of green lowers in the first white line scanned. This changes white display to magenta. As a result, the edges of the box pattern appear colored, thus lowering the display grade.

Thus, when the pulse width of the current precharge corresponding to green was doubled, the predetermined gray level could be displayed for green.

The same voltage precharge pulse 451 is used regardless of the colors. The same voltage precharge pulse is used regardless of the display colors because the voltage corresponding to black display is applied on the basis of the relationship between the gate voltage and drain current of the driving transistor 62. The voltage precharge pulse need not be set for each display color because the time required to reach the predetermined voltage is determined by the capacity of the source signal line and the driving capability of the operational amplifier used in the precharge voltage generating section. As shown in FIG. 172, only the current precharge pulse group 1174 can be adjusted individually for each color.

The gray levels that can be written without current precharge vary depending on the display colors. If the preceding row is displayed at gray level 0, then for blue, gray level 36 or higher can be written without current precharge. However, for red, current precharge is required up to gray level 48, and gray level 49 or higher can be written without current precharge. For green, current precharge is required up to gray level 75, and gray level 76 or higher can be written without current precharge. Thus, the maximum gray level for which the longest current precharge pulse (the pulse corresponding to 1174f in FIG. 123) is set is determined to be the required gray level for each color. This can be accomplished by allowing the commands D to I to be set individually for each color, the commands D to I being input to the current precharge pulse selecting instrument 578, shown in FIG. 57. With the method of inserting current precharge according to the present invention, since 4 bits of data are stored in the preceding row, when the data in the preceding row is at gray level 15 or higher, that gray level cannot be determined. Accordingly, although depending on the command A set value, if for example, the command A has a value of 1 and if the data in the preceding row is at gray level 14 or higher, current precharge cannot be carried out for gray level 13 or higher. However, gray level 70 for green cannot be written when the data in the preceding row is 0. Provided that the data in the preceding row is displayed at gray level 14 or higher, even for green, data with gray level 14 or higher can be written. In this case, no display problems are presented.

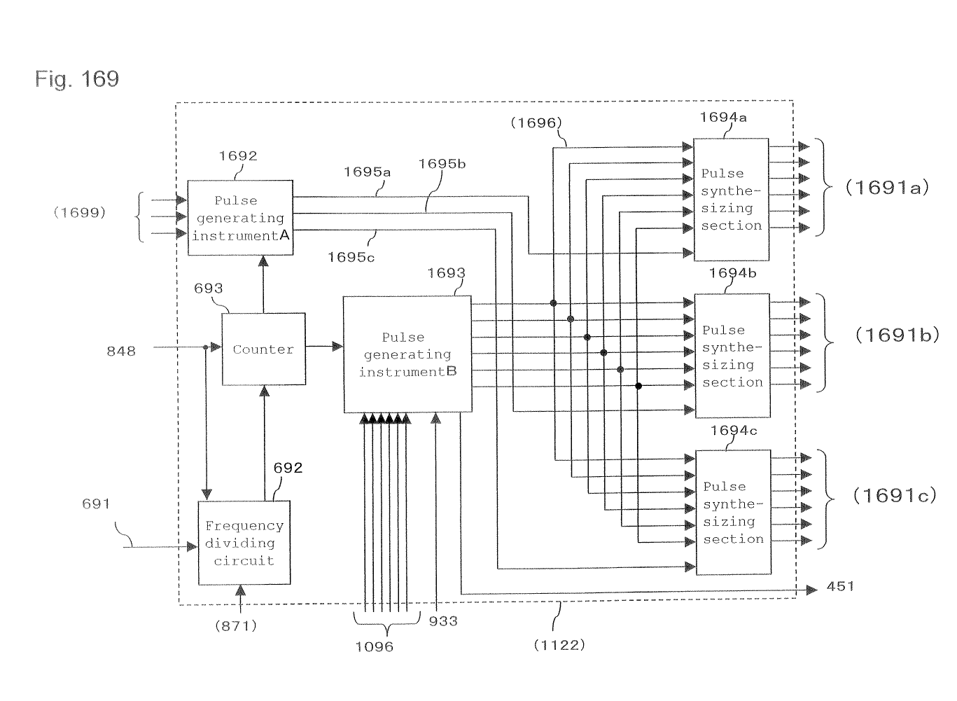

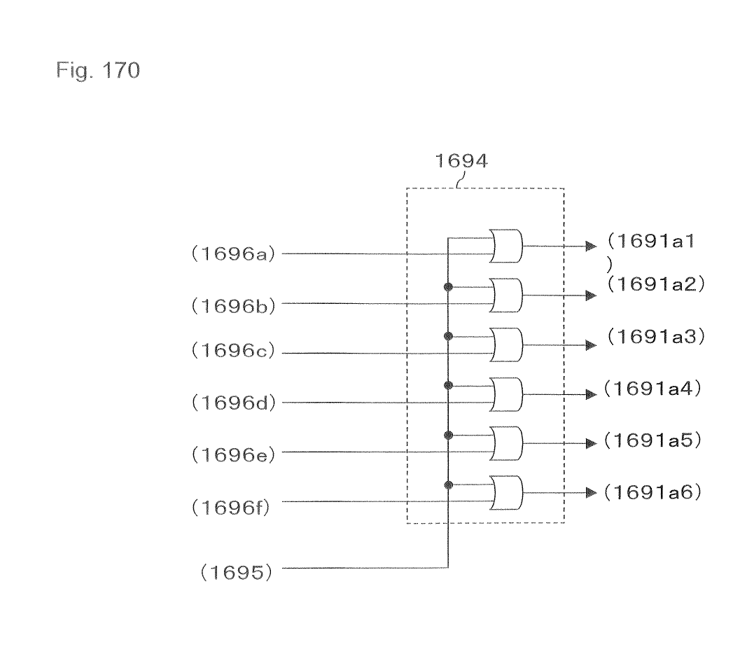

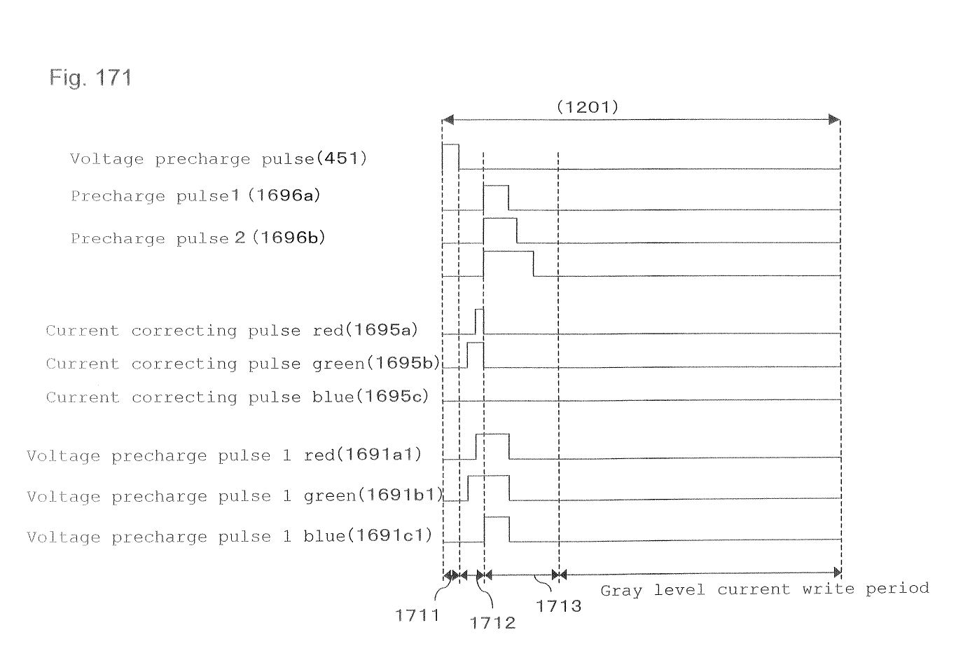

FIG. 169 shows a second method according to the present invention. FIG. 170 shows an example of an internal circuit in the pulse synthesizing section 1694 shown in FIG. 169. FIG. 171 shows examples of the waveforms of current precharge pulses output when the pulse generating section 1122 shown in FIG. 169 is used.

In the configuration shown in FIG. 172, the pulse generating instrument 694 has a circuit scale three times as large as that of a circuit shared by all the colors.

Thus, according to the present invention, the same generating section is used for the six current precharge pulses. For outputs corresponding to pixels of colors which require only small quantities of current and which are unlikely to vary, a specified period during which the pulses corresponding to the display colors are output is set before or after the current precharge pulse. In FIG. 171, a period 1712 is set before the current precharge pulse; different pulse widths corresponding to the respective colors are inserted into the period 1712 (a common pulse width may be used or the provision of the pulses may be avoided if a sufficient current change can be achieved as shown at 1695c).

Thus, the horizontal scan period starts with a voltage precharge period 1711, followed by the period 1712 during which current difference correction pulses are input, that is, the six level pulses common to red, green, and blue are input, and ends with a period during which the predetermined current is written (gray level current write period).

The circuit configuration can be simplified by making the total length of the period 1711 equal to the total length of the period 1712 to fix the start position of the current precharge pulse 1691. If the sum of the lengths of the voltage precharge pulse and current difference correction pulses is small, the timing is adjusted by setting a normal gray level current write period between the voltage precharge pulse and the current difference correction pulses.

Thus, the pulses output during the period 1713 can be provided by pulse generating instrument B 1693 in accordance with a counter and set values 1096 and 933 as in the case of the prior art. The only difference from the prior art is a rise timing of the pulse. Consequently, this part does not increase the circuit scale.

On the other hand, the current difference correction pulses 1695 are output in accordance with a counter 693 and a correction value set signal 1697. Since the three pulses are used, the circuit scale can be reduced to half of that of the pulse generating instrument B 1693.

The actual current precharge period corresponds to the sum of the current difference correction pulses 1695 and precharge pulse 1696 (one of the six pulses is selected). Accordingly, the pulse synthesizing section 1694 is provided to take the logical OR of the current difference correction pulses 1695 and precharge pulse 1696 for each display. This has realized current precharge pulses 1691 having different lengths for the respective display colors. FIG. 171 shows the waveform of the current precharge pulse 1 by way of example. A longer current precharge period can be set for green, for which the current is most difficult to vary. FIG. 170 shows the logical OR circuit. However, to reduce the circuit scale, a NAND circuit may be constructed by pre-inverting the outputs of the precharge pulse 1696 and current difference correction pulses 1695.

Thus, if the sum of the circuit scales of the pulse synthesizing section 1694 and pulse generating instrument A 1692 is smaller than the triple of the scale of the pulse generating instrument B 1693, a circuit configuration smaller than that according to the prior art can be used to implement the circuit that can set different current precharge periods for the respective luminescent colors according to the present invention.

To maximize the period of gray level current write period succeeding the current precharge period, the start position of current precharge is allowed to be changed depending on the length of the voltage precharge application period 1711 rather than setting the start period of 1713 at a fixed value. The period 1712 starts immediately after the application of voltage precharge. The period 1712 varies with the display colors. However, the current precharge period 1713 is fixed regardless of the display colors. To vary the start position of the period 1713 depending on the colors, it is necessary to vary the time when the current precharge pulse is generated, depending on the colors. Therefore, different precharge pulses must be generated for the respective colors. Since the circuit scale is advantageously reduced by generating a common precharge pulse regardless of the colors, the period 1712 must have a fixed value. In this case, the period 1712 may be set equal to the maximum width that can be set by the command or the command being input may be detected so as to make the length of the period 1712 equal to that of the current difference correction pulse 1695 outputting the maximum pulse width.

If the pixel selection period is shortened by an increase in the size of the display panel or in the number of pixels in the vertical direction, then even at a gray level higher than an intermediate level requiring a large current value, it is difficult to change the current value to the predetermined gray level if the video signal has changed greatly from the preceding row.

Even if the pulse width of the current precharge pulse group 1174 is maximized, for the maximum gray level, the current for the precharge period has the same value as that for the current corresponding to the gray level. Consequently, the precharge effect is not exerted.

Thus, the present invention provides a function for setting the current flowing during the current precharge period larger than the maximum gray level so that even during the maximum gray level display, the current can be changed quickly to the predetermined current value using precharge.

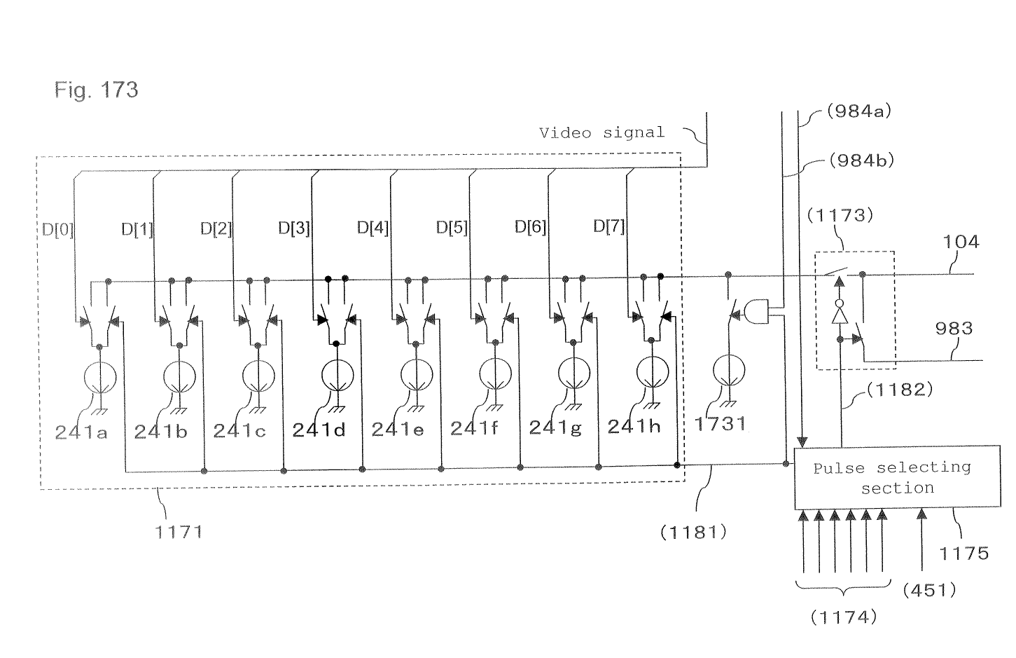

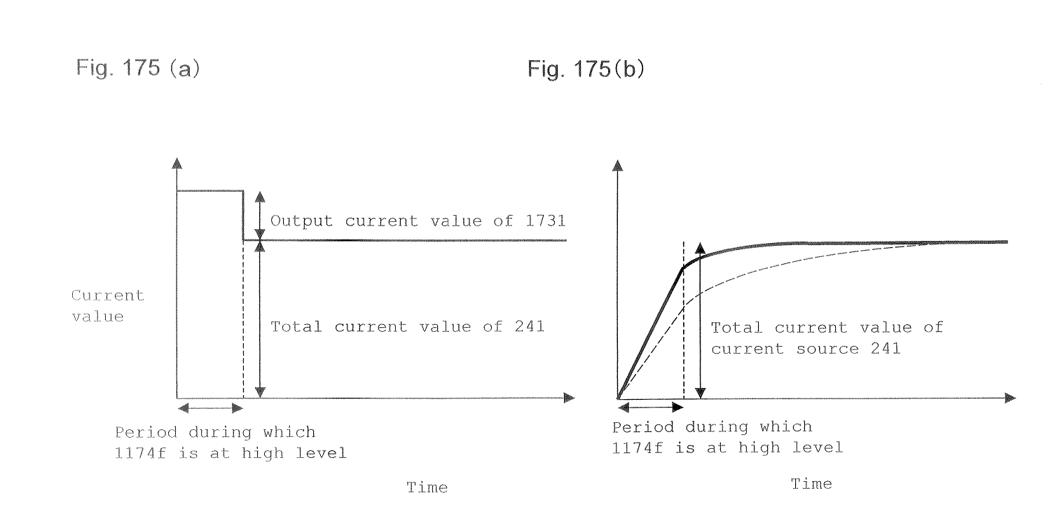

FIG. 173 shows the circuit configuration of a current output stage used to implement the above arrangement. FIG. 175 (a) shows a method of controlling a output current obtained when the precharge determination line 984 has a value of 14 and when gray level 255 is output. FIG. 175 (b) shows how the current value of the source signal line varies.

To allow the flow of a current larger than the maximum one, a current source 1731 is provided in addition to the current source 241 for gray level display. The current source 1731 provides an output on the basis of the newly added precharge determination line of 1 bit (984b) while the current precharge control line 1181 is at the high level.

The current precharge period is selected using 3 bits of the precharge determination line. The precharge current value is selected using 1 bit. In this case, the lower 3 bits determine the period, while the upper 1 bit determines the current quantity. However, any bits may be used for these purposes.

Assigning the different functions to the respective bits enables a reduction in the scale of a circuit for decoding the precharge determination line 984. Compared to the circuit configuration enabling one of the six precharge periods to be selected, the present configuration enables one of twelve precharge periods to be selected on the basis of the current value. However, the increased circuit can be implemented simply by adding a current source 1731, a switch that turns on and off the current source 1731, and a control circuit (2-input logical AND circuit) for the switch. Accordingly, current precharge effective even on high gray level display can be realized while minimizing an increase in the scale of the logic circuit except for the current source 1731.

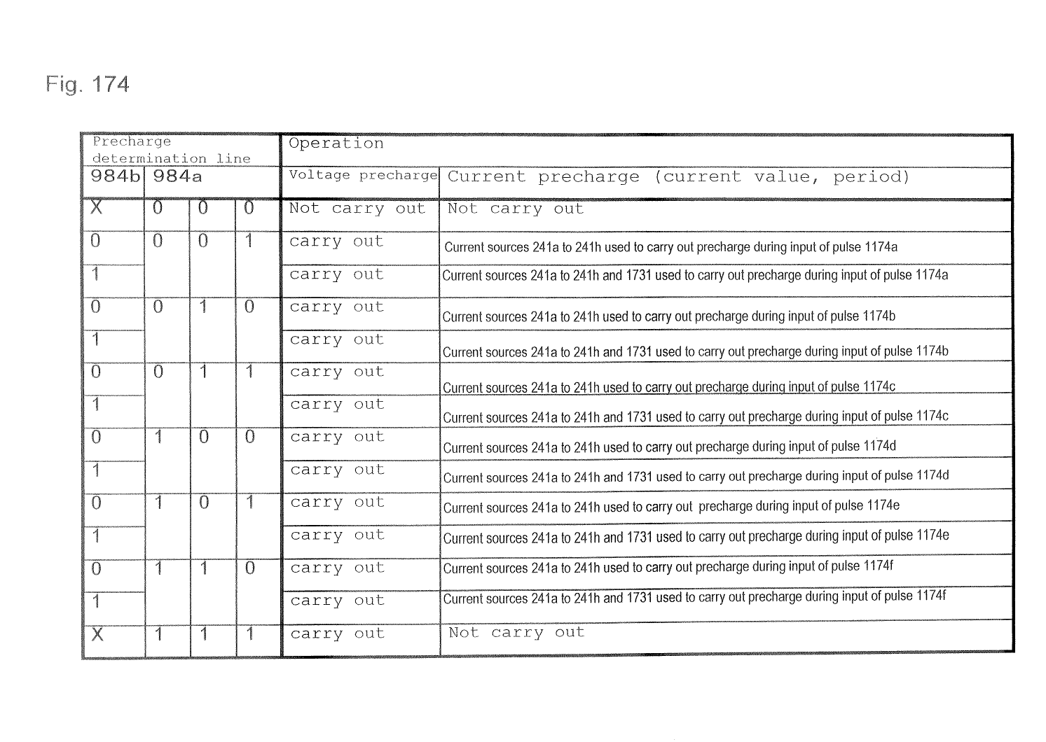

FIG. 174 shows the relationship between the value for the precharge determination line and the precharge operation. The lower 3 bits are used to select the current precharge period. The upper 1 bit is used to select the current value.

Thus, for lower gray levels, current precharge is carried out at six levels using a white gray level current with a small current value. For intermediate to higher gray levels, current precharge is carried out by adjusting the six-level periods with the current value increased and with the current from the current source 1731 added. Then, even for the intermediate to higher gray levels, the current can be varied at higher speed to enable the predetermined gray level to be written in all gray level regions.

The current value of the current source 1731 is determined using the panel size or the number of pixels in the vertical direction. Thus, the chip size of the source driver is reduced if each horizontal scan period is long. Consequently, the current source 1731 offers a current value about 20 to 50% of the total current value of the current source 241. This brings a marked insufficient write phenomenon if each horizontal scan period is short. Accordingly, the current value for precharge must be increased, and the current source 1731 preferably offers a current value 50 to 100% of that of the current source 241.

In the description of this example, the scale of the current source is selected using the 1 bit, and the length of the precharge period is selected using the 3 bits. However, similar effects can be produced using arbitrary bit numbers.

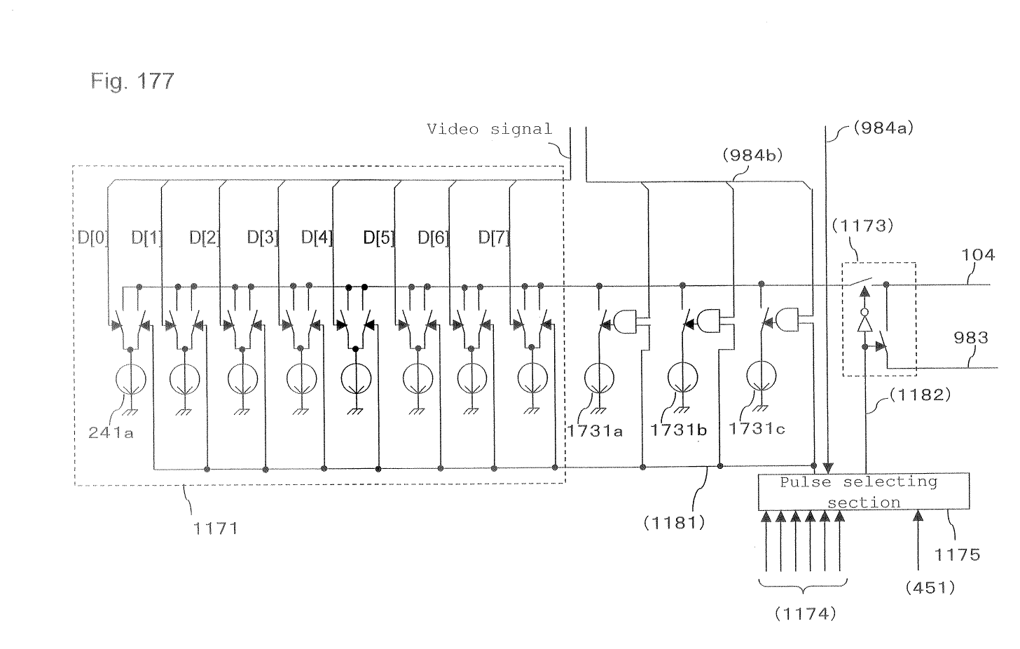

If for example, 3 bits are used to select the scale of the current source, three current sources 1174 (that output different current values corresponding to the weights of the bits) may be provided so as to take the logical AND of the current precharge control line 118 and the control line determining which of the current sources 1174 outputs current. This is shown in FIG. 177.

On the other hand, an increase in the number of precharge period types requires an increase in the number of internal arrangements in the pulse selecting section 1175 and in the number of pulses in the current precharge pulse group 1174. The pulse selecting section 1175 may have a circuit configuration in which the number of internal arrangements increases in accordance with the truth table shown in FIG. 119. For example, for 4 bits, it is possible to use a method of providing a maximum of 14 current precharge pulses.

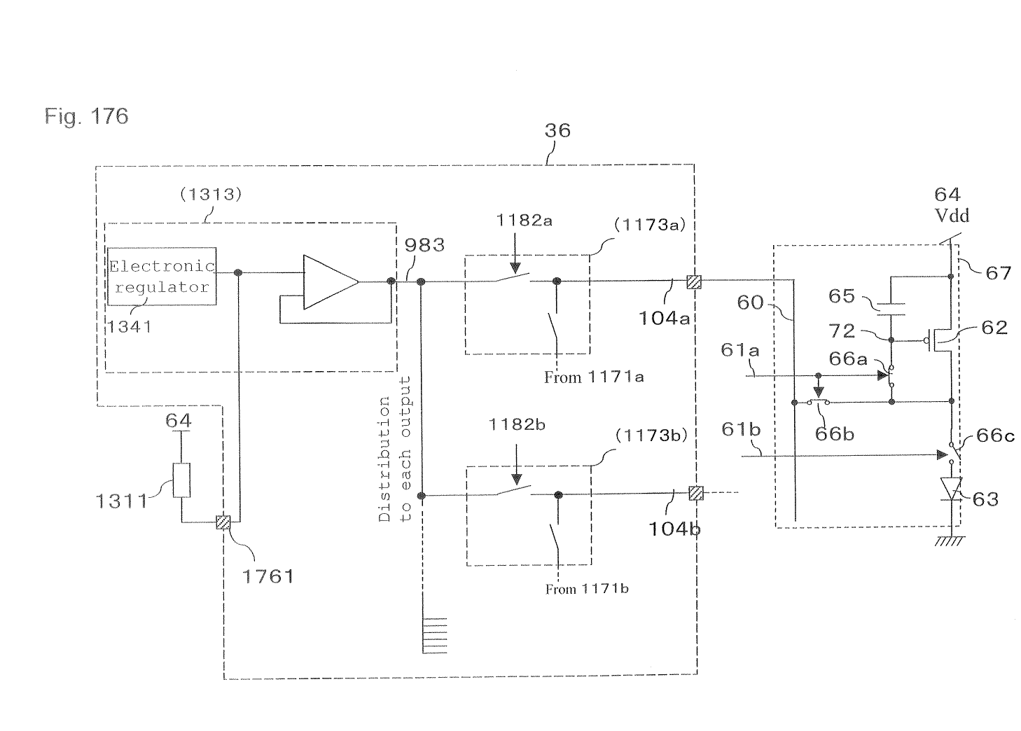

FIG. 176 shows a circuit in which the temperature compensation element 1311 is provided outside the source driver to vary the precharge voltage with temperature. The voltage output by the precharge voltage generating section 1313 is determined by the sum of a resistance value offered by the electronic regulator 1341 and the resistance value of the temperature compensation element 1311.

Thus, a variation in precharge voltage among panels is adjusted using the electronic regulator 1341. A variation in voltage in the same panel caused by temperature is dealt with by varying the resistance value of the temperature compensation element 1311 and thus the voltage value.

This eliminates for an adjustment volume for the source driver 36, thus enabling a reduction in costs.

If display is provided using at least two source drivers, only one electronic regulator 1341 is allowed to provide voltage outputs, whereas the outputs of the electronic regulators 1341 on the other chips are disconnected from the operational amplifier. The same precharge voltage can be output regardless of the number of source drivers by connecting terminals of the temperature compensation element 1311 which are different from the power source 64, to the external inputs 1761 of all the source drivers 36.

In a display apparatus using an organic light emitting device that provides display using a current output source driver, if there is a vertical blanking period, outputs from the source driver float because no pixels are selected during the vertical blanking period.

An output of the source driver is configured, for example, as shown in FIG. 10. If the gray level data 54 has a value different from 0, at least one gray level display current source 103 operates to draw current from the source signal line.

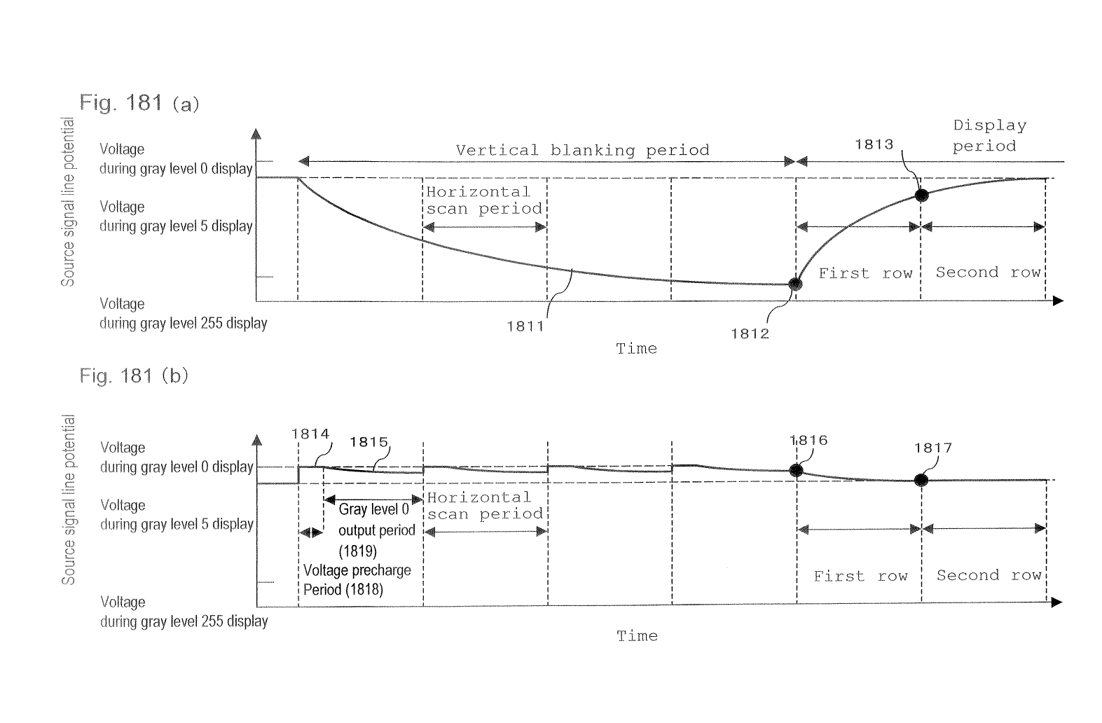

Then, when the output from the source driver starts to float, the gray level display current source 103 operates to lower the drain potential in order to draw in current. As a result, as shown in FIG. 181 (a), even with a pattern in which gray level 5 is displayed all over the screen, during the vertical blanking period, the potential across the source signal line lowers from the voltage measured during gray level 5 display, as shown at 1811. The example includes four horizontal scan periods, and the potential has lowered to 1812 when the blanking period is over.

In this state, when the current for gray level 5 is written, a large quantity of current is required to change voltage and a long time is required to effect the change because of the small current value. Hence, as shown in FIG. 181 (a), the potential voltage does not change to the gray level 5 display voltage and reaches a potential 1813 when the horizontal scan period is over. In such an active matrix panel as shown in FIG. 6 or 44, the state at the end of the horizontal scan period (at the end of the pixel selection period) is stored in each pixel and displayed. Thus, the first row is displayed at a luminance higher than that corresponding to the predetermined gray level (gray level 5).

A change in the second row starts with the state at the end of the first row. Thus, the amount of change in the second row is smaller than that in the first row. The voltage can change to the predetermined potential to appropriately display the gray level.

In this manner, in the first row, a larger amount of change occurs in the source signal line than in the other rows. When raster display is provided, the first row disadvantageously appears bright particularly at lower gray levels.

If the quantity of current per gray level is small or an increase in the size of the panel shortens the horizontal scan period or increases the capacity of the source signal line, it becomes difficult to change the potential across the source signal line. Thus, the predetermined luminance may not be displayed even in the second or subsequent row. In other words, the ability to display the first row inevitably enables the second and subsequent rows to be appropriately displayed.

Thus, the present invention has devised a method of utilizing a voltage precharge function provided by the source driver during the vertical blanking period to apply the voltage corresponding to black display to prevent a rapid drop in source signal line potential.

A first method involves causing the controller to transfer gray level 0 to the source driver during the vertical blanking period. On this occasion, if gray level 0 is inserted into the video signal input to the precharge determination signal generating section 1621, the precharge determination signal generating section 1621 generates a precharge flag. In this case, if the condition “precharge is always carried out” is set for voltage precharge, the voltage corresponding to black display is applied once during one horizontal scan period during the vertical scan period. The source signal voltage thus varies in the vertical blanking period as shown in FIG. 181 (b). Consequently, during the period in which voltage precharge is applied (1818), gray level 0 display voltage shown at 1814 is provided. During a gray level 0 output period 1819, the potential varies as shown by 1815. Since the gray level is 0, the switch 108 inside the source driver disconnects the gray level display current source 103 from the source signal line. As a result, the potential across the source signal line does not substantially vary. However, leakage current from the switch 108 may change the potential, so that FIG. 181 (b) shows a potential change at 1815. The leakage current is so small (at most 1 nA) that the amount of change is small. Thus, the potential 1816 at the beginning of a write operation performed on the first row does not decrease sharply. Since the amount of change in potential is small in spite of low gray level display, the predetermined gray level can be sufficiently displayed. Since the first row can be properly displayed, the second and subsequent rows can be surely displayed.

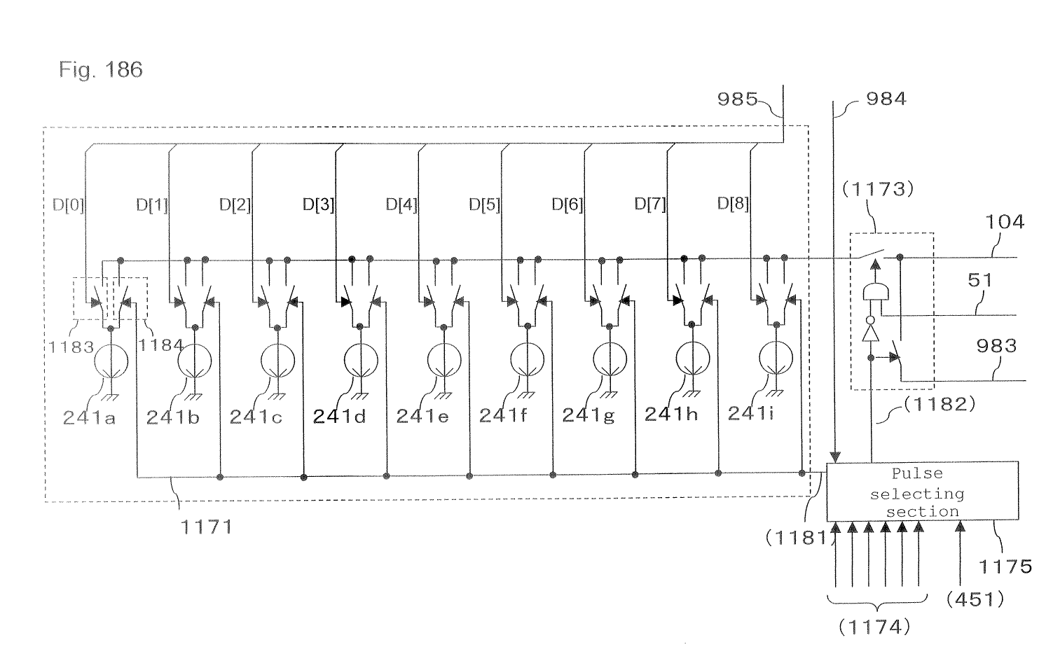

If the leakage current is small and the amount of change in the potential across the source signal line is small during the output of gray level 0, a write operation can be sufficiently performed on the first row regardless of the settings in FIG. 61. Further, in this case, instead of inserting gray level 0 into the video signal, it is possible to use the functions of the output enable 51 of the source driver 36 to disconnect the gray level display current source 103 of the source signal line from the source signal line. The output enable 51 is connected to all the outputs of the source driver 36. Accordingly, when the enable function starts to operate, the current output section 1171 is disconnected from the output 104, as shown in FIG. 186. This disconnects the source signal line from the source driver to make it possible to prevent a decrease in potential.

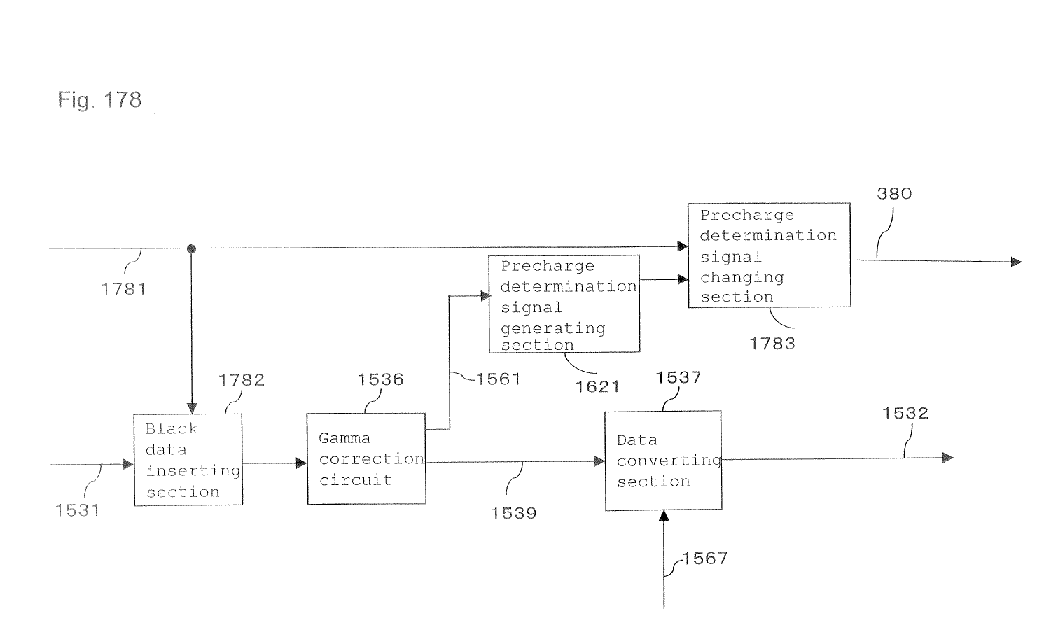

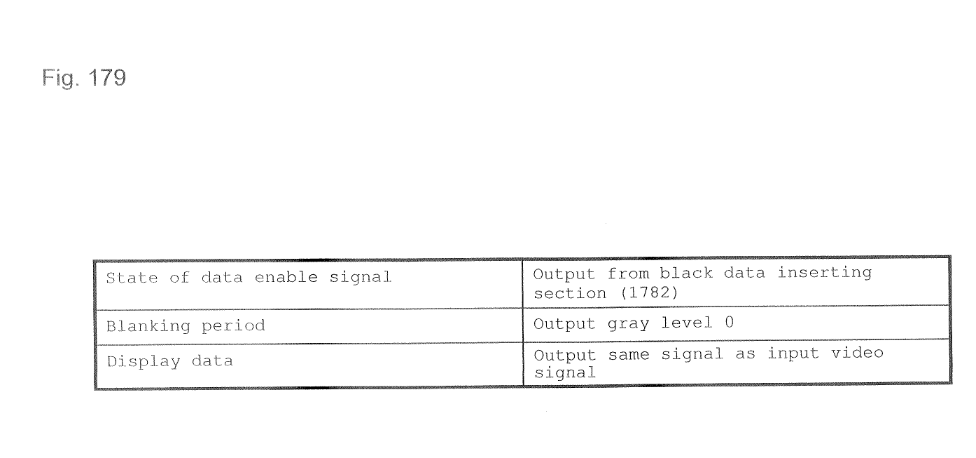

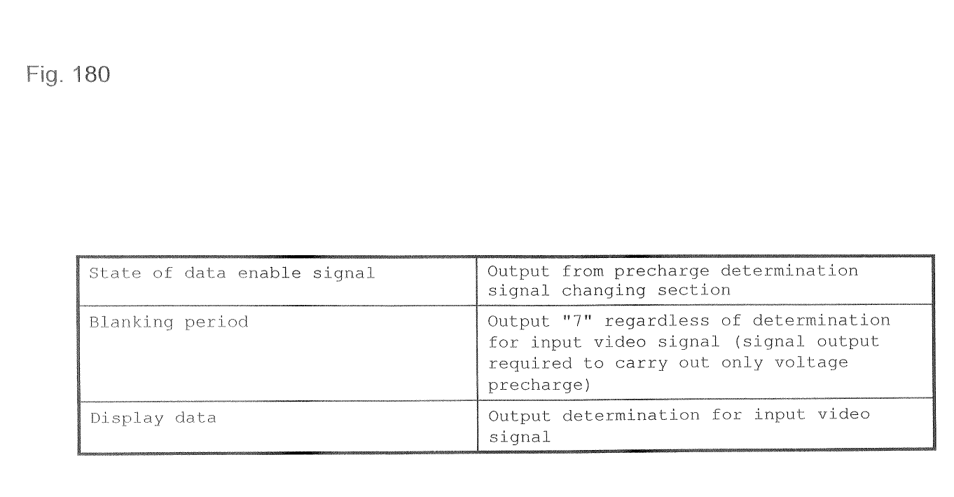

Moreover, as shown in FIG. 178, a data enable signal 1781 is input to a black data inserting section 1782 and the precharge determination signal generating section 1621 to make such determinations as shown in FIGS. 179 and 180; the data enable signal 1781 is used to detect a blanking period in the input video signal. Then, a voltage precharge period 1818 can be inserted into each horizontal scan period within the vertical blanking period regardless of the setting for voltage precharge during gray level 0 display. This allows the potential across the source signal line to vary as shown in FIG. 181 (b). In FIG. 180, the precharge determination signal generating section outputs 7 during the vertical blanking period. This is because the source driver makes precharge determinations as shown in FIG. 119. However, with different set values, an output value is used such that in the source driver, the current precharge control line is always at the “L” level and that the voltage precharge control line is the same as the pulse 451.

If the source signal line potential does not drop before current is written to the first row following the end of the vertical blanking period, the predetermined gray level can be written to the first row. Therefore, voltage precharge may be carried out to output gray level 0 at least during the horizontal scan period immediately before the writing operation performed on the first row.

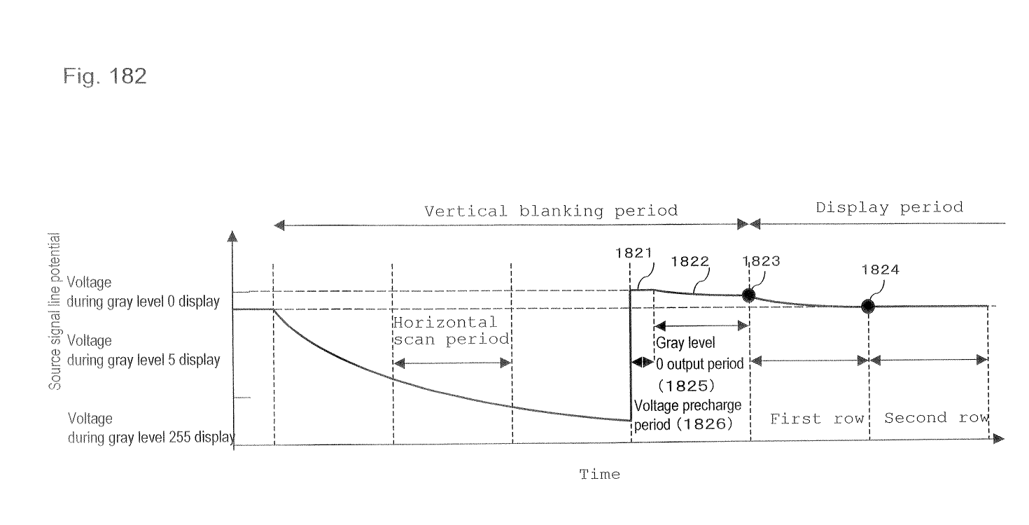

FIG. 182 shows a variation in source signal line potential which is observed if voltage precharge is carried out during the horizontal scan period before the write operation performed on the first row. Gray level output is arbitrary and precharge may or may not be carried out until two horizontal scan periods before the write operation performed on the preceding row. Even if the potential drops to the minimum value, the potential changes to a level 1821 during a voltage precharge period 1826, and then the change in potential is minimized during a gray level 0 output period 1825 (1822). This makes it possible to set, at a level 1823, the source signal line potential before the write operation performed on the first row. Therefore, the write operation can be performed with a small amount of change at lower gray levels.

Consequently, voltage precharge and gray level 0 output may be carried out during the final horizontal period at the end of the vertical blanking period. These operations need not necessarily be performed during the previous periods. It is possible to select a method by which the data can be easily processed. If the data enable signal 1781 is utilized, since it is difficult to determine the end of the vertical blanking period, the same operation is conveniently operated throughout the vertical blanking period.

The source driver according to the present invention enables the first-row detecting instrument to independently carry out precharge on the data in the first row as shown in FIG. 62. In FIG. 55, the command C selects the execution of current precharge, and the command B selects the execution of voltage precharge. Thus, voltage precharge is surely carried out for gray level 0 to sufficiently write the black level voltage.

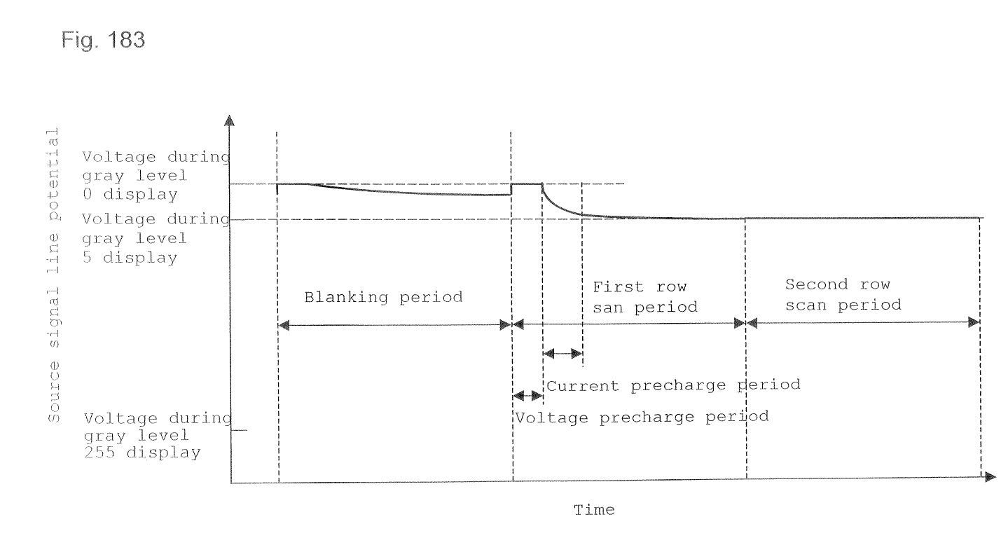

For the gray levels except 0, in response to the commands D to I, shown in FIG. 57, the current precharge period selecting instrument 578 adjusts the period of current precharge in accordance with the gray level and selects the avoidance of current precharge if a sufficient write operation can be performed. Thus, even for lower gray levels, as shown in FIG. 183, the source signal line voltage is instantaneously forcibly set to the gray level 0 display voltage during the voltage precharge period. Then, the source signal line voltage is changed rapidly to the predetermined voltage value during the current precharge period. Finally, the normal current value is used to write the predetermined voltage value in accordance with the characteristics of the pixel transistor.

Gray levels that can be sufficiently written are originally high and thus require only low source signal line potentials. Thus, even if the voltage drops during the blanking period, the amount of the change is small. If the current used for the change corresponds to a higher gray level, the voltage can sufficiently be changed to the predetermined gray level. On the other hand, for lower gray levels, the current precharge operation is performed to forcibly change the voltage to the black level. Accordingly, voltage precharge enables the change to be effected without posting any problems regardless of the potential during the vertical blanking period. The subsequent operation is the same as that performed on the first row. Therefore, a sufficient write operation can be accomplished.

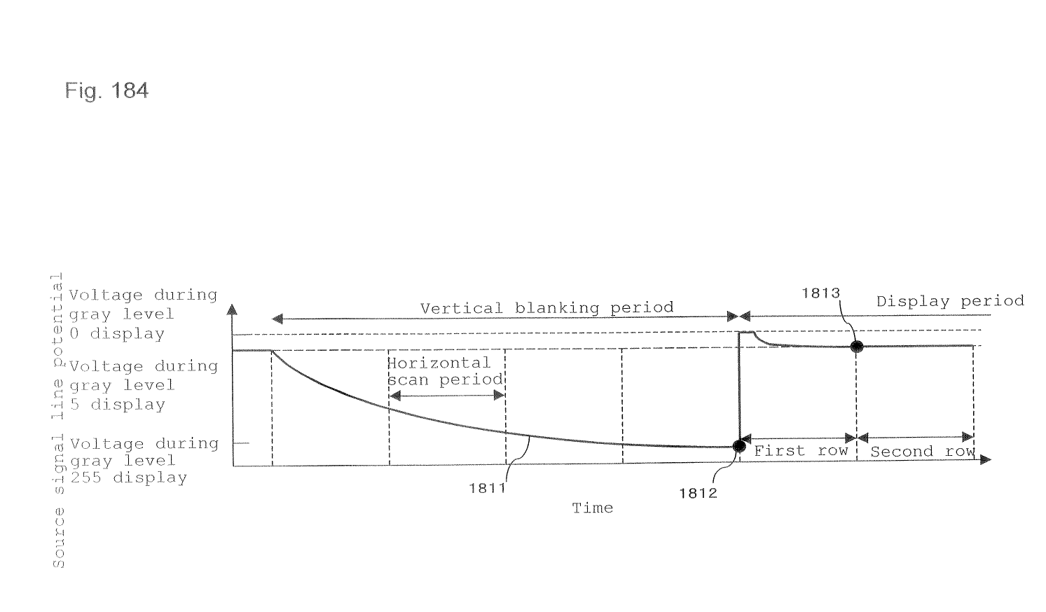

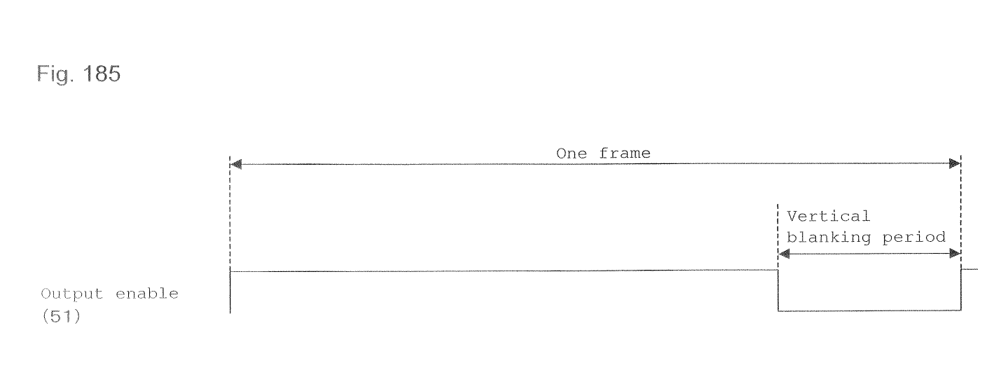

Thus, as shown in FIG. 184, by carrying out current precharge in the first row, it is possible to provide the predetermined luminance for the first row without any particular control during the vertical blanking period.

The above operation has enabled the predetermined luminance to be achieved in the first row, thus providing a display apparatus with a high display grade.

Moreover, it is possible to prevent the source signal line potential from varying toward white by allowing the source driver to always carry out voltage precharge to output a voltage during the vertical blanking period.

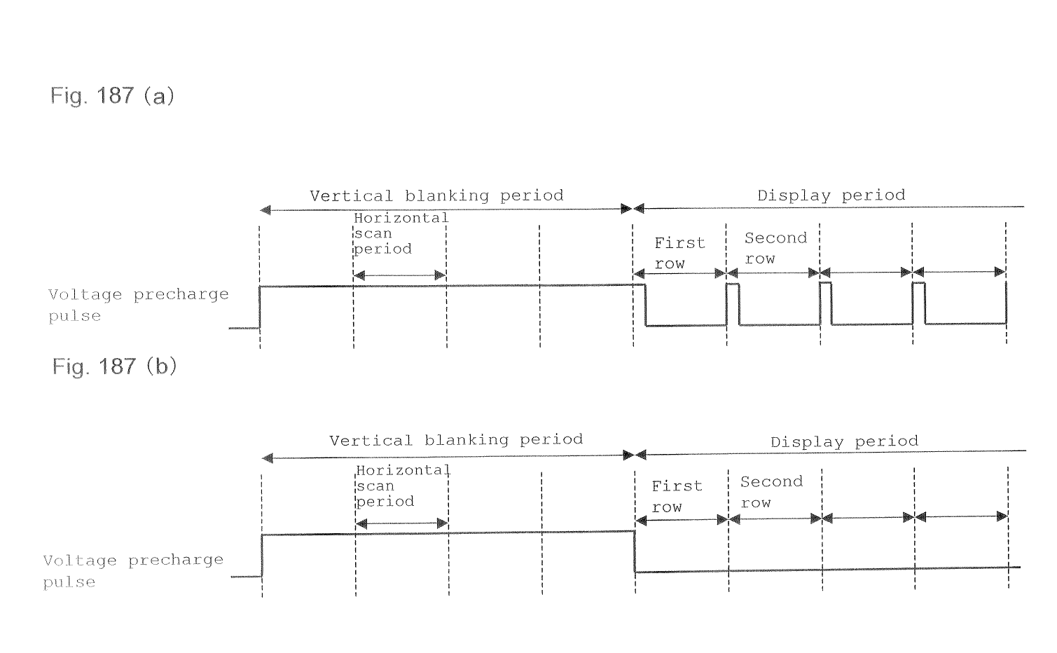

For this purpose, the voltage precharge pulse must be varied between the vertical blanking period and the normal display period as shown in FIG. 187 (a). For normal display, the voltage precharge pulse may be 1 to 3 μs in length. On the other hand, during the vertical blanking period, the voltage precharge pulse must always be at the high level (if voltage precharge is carried out at the high level). If each gray level can be displayed correctly without voltage precharge, voltage precharge need not be applied during the display period. Accordingly, the precharge flag may be set to 0 or may always be at the low level as shown in FIG. 187 (b). The present invention is characterized in that the voltage precharge pulse during the vertical blanking period is different from that during the display period.

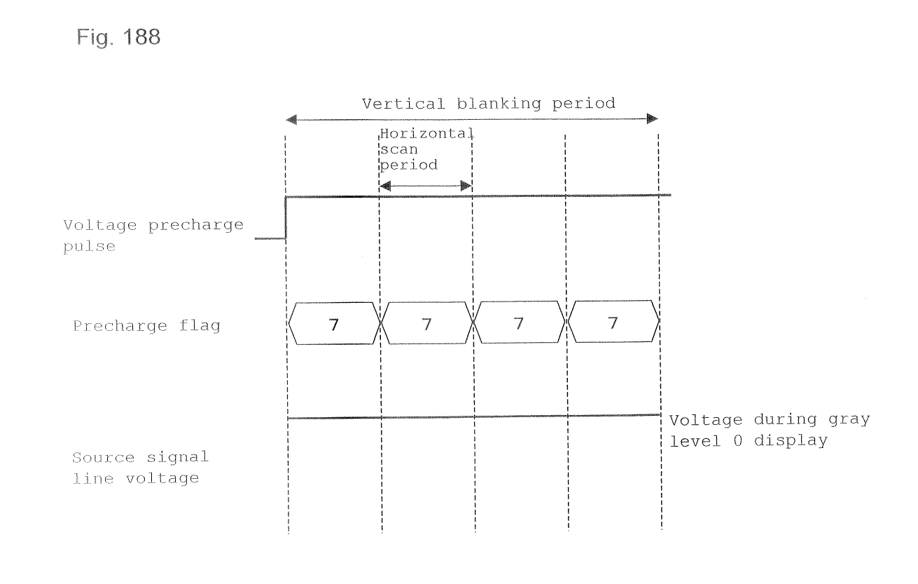

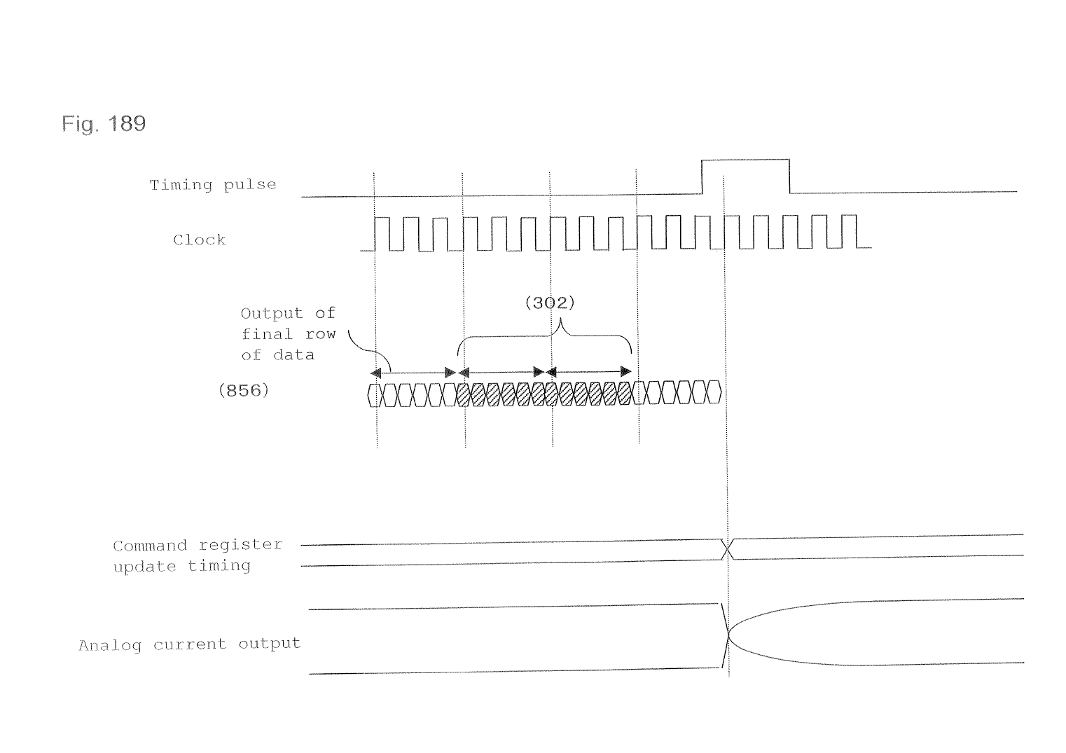

Moreover, the precharge flag must be defined in order to apply the voltage for gray level 0 display to the source signal line during the vertical blanking period. Therefore, as shown in FIG. 188, if the source driver according to the present invention is used, the precharge flag is controlled so that the flag exhibits a value of 7. As a result, the precharge voltage is always output together with the precharge pulse.

To determine whether the period is for vertical blanking or for display to vary the width of the precharge pulse, it is necessary to be able to set the length of the precharge pulse for each horizontal scan period.

The present invention uses the source driver to which data and commands are input as shown in FIGS. 28, 29, and 30 so that the commands can be changed once during one horizontal scan period. Moreover, the commands are transferred to the register inside the source driver when the timing pulse 849 is input after the command transfer period 302. The values for the commands are held in the register. The timing pulse is input once during one horizontal scan period. Accordingly, this function may be used to allow the command for setting of the voltage precharge pulse width to be input when commands are input during the command input period shown in FIG. 29 so as to vary the pulse width between the vertical blanking period and the display period.

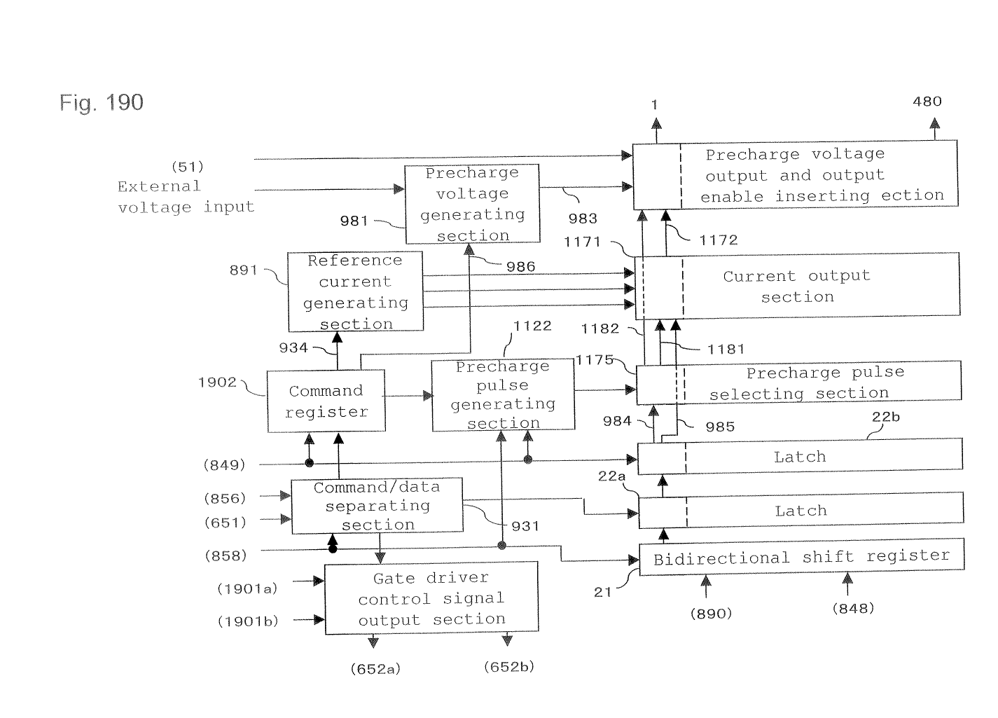

FIG. 190 shows a circuit block diagram of a source driver including a command register 1902. The command/data separating section 931 separates the data on the video signal line 856 into display data, various setting data, and a gate driver control signal in accordance with a command/data identification signal. The display data and the gate driver control signal change serially transferred data to data suitable for parallel transfers and sequentially transfer the data to the interior of the driver. On the other hand, for the various commands (an electronic regulator setting for adjusting the reference current, an electronic regulator setting for adjusting the precharge voltage, settings for the pulse widths of the current precharge pulses 1 to 6 and voltage precharge pulse, and a setting for the precharge pulse generation clock; if red, green, and blue offer different luminescent efficiencies and thus their setting currents vary greatly, the source driver can preferably control the reference current and the pulse widths of the current precharge pulses 1 to 6 independently for each of red, green, and blue), particularly the settings for the precharge pulse widths, the counter 693 is used as shown in FIG. 69 to continuously output pulses until the set value is equal to the counter value. Thus, when the setting is changed while the counter is in operation, the relevant logic may become stable. Accordingly, the setting is changed after the timing pulse 848 has been input so as to be reliably changed after the counter operation has been finished.

Moreover, the source driver according to the present invention has a function for outputting two signals for controlling the gate drivers. This is because two gate signal lines for each pixel are required for the current copier pixel configuration shown in FIG. 6 and the current mirror pixel configuration shown in FIG. 44 and because two gate drivers are required for each display apparatus in order to sequentially scan the gate signal lines, so that the one source driver must send the two gate drivers control signal lines.

If the source driver need not output any gate driver control signals, a gate driver output enable signal 1901 is used to cut the unwanted outputs to avoid transmitting signals to external equipment.

If two source drivers are used, then on each chip, the enable function is sequentially activated for each of the control lines located farther from the gate driver to avoid outputting extra signals. This advantageously saves power consumption and suppresses noise generation.

The above description relates to the drivers for monochromatic outputs. However, the present invention is applicable to drivers for multicolor outputs. In this case, as many circuits as the display colors may be provided. For example, for three color outputs for red, green, and blue, three of the same circuit may be placed in the same IC so as to be each used for the corresponding one of red, green, and blue.

The above description relates to the MOS transistors. However, the present invention is also applicable to MIS transistors or bipolar transistors.

The present invention is applicable regardless of the material for the transistors; available materials include crystal silicon, low-temperature silicon, high-temperature silicon, amorphous silicon, and a compound of gallium and arsenic.

The program according to the present invention may allow a computer to perform operations for some or all of the steps of the method of driving the self-luminescent display apparatus according to the present invention. The program may operate in cooperation with the computer.

The present invention may be a medium carrying the program for allowing a computer to perform some or all of the operations for some or all of the steps of the method of driving the self-luminescent display apparatus according to the present invention. The program is readable and read by the computer to perform the operations in cooperation with the computer.

The expression “some of the steps” as used in the specification instrument some of the plurality of steps or some of the operations performed within one step.

The present invention includes a recording medium on which the program according to the present invention is recorded and which is readable by the computer.

In a usage of the program according to the present invention, the program may be recorded on the medium readable by the computer to operate in cooperation with the computer.

In a usage of the program according to the present invention, the program may be transmitted through a transmission medium and read by the computer to operate in cooperation with the computer.

The data structure according to the present invention includes a database, a data format, a data table, a data list, and a data type.

Available recording media includes a ROM, and available transmission media include a transmission mechanism such as the Internet and light, electric wave, and sound wave.

The computer according to the present invention is not limited to pure hardware such as a CPU but may be firmware, an OS, or peripheral equipment.

As described above, the configuration of the present invention may be implemented by software or hardware.

### INDUSTRIAL APPLICABILITY

According to the present invention, in display provided by a self-luminescent display apparatus, it is possible to increase the speed of a change from lower gray level to higher gray level which is otherwise slow. The present invention is useful for, for example, a display driving apparatus or a display apparatus.

1-30. (canceled)

31. A method of driving a self-luminescent display apparatus having self-luminescent elements arranged in a pattern of a matrix and each of pixel circuits provided in association with each of said self-luminescent elements, said method comprising:
applying a gray level current corresponding to a display gray level to each of said pixel circuits for a first period;
applying a display current based on said gray level current to said self-luminescent elements during a second period succeeding said first period to display corresponding said display gray level; and
applying a precharge current to said self-luminescent elements during a third period before said first period on the basis of a predetermined first condition.

32. The method of driving a self-luminescent display apparatus according to claim 31, wherein said third period is varied depending on a display gray level that provides a display current applied to said self-luminescent elements.

33. The method of driving a self-luminescent display apparatus according to claim 31, wherein a current value corresponding to a display gray level of display provided by said self-luminescent elements in a predetermined row on the same column of said matrix is compared with a current value corresponding to a display gray level of display to be provided by said self-luminescent elements in a row next to said predetermined row, and
as said predetermined first condition, if a difference between said current values has a value equal to or larger than at least a predetermined value, when said next row is displayed, the precharge current is applied to said self-luminescent elements in said next row during said third period.

34. The method of driving a self-luminescent display apparatus according to claim 33, wherein said third period is varied depending on the magnitude of said difference.

35. The method of driving a self-luminescent display apparatus according to claim 31, wherein the current value corresponding to the display gray level of the display provided by said self-luminescent elements in the predetermined row on the same column of said matrix is compared with the current value corresponding to the display gray level of the display to be provided by said self-luminescent elements in the row next to said predetermined row, and as said predetermined first condition, if the difference between said current values has a value smaller than a predetermined value, when said self-luminescent elements in said next row provide display, said precharge current is not applied.

36. The method of driving a self-luminescent display apparatus according to claim 33, wherein the current value corresponding to the display gray level of the display provided by said self-luminescent elements in the predetermined row on the same column of said matrix is compared with the current value corresponding to the display gray level of the display to be provided by said self-luminescent elements in the row next to said predetermined row, and as said predetermined first condition, if the difference between said current values has a value smaller than a predetermined value, when said self-luminescent elements in said next row provide display, said precharge current is not applied.

37. The method of driving a self-luminescent display apparatus according to claim 31, wherein as said predetermined first condition, if the display gray level of display provided by said self-luminescent elements has a current value corresponding to black display, when said display gray level is displayed, said precharge current is not applied.

38. The method of driving a self-luminescent display apparatus according to claim 31, wherein a value for said precharge current is a current value corresponding to white display.

39. The method of driving a self-luminescent display apparatus according to claim 31, wherein said third period is selected from a group of third periods corresponding to a plurality of pulse lengths prepared for a driving circuit.

40. The method of driving a self-luminescent display apparatus according to claim 31, further comprising applying a predetermined voltage to said self-luminescent elements during a fourth period before said third period on the basis of a predetermined second condition.

41. The method of driving a self-luminescent display apparatus according to claim 40, wherein the current value corresponding to the display gray level of the display provided by said self-luminescent elements in the predetermined row on the same column of said matrix is compared with the current value corresponding to the display gray level of the display to be provided by said self-luminescent elements in the row next to said predetermined row, and as said predetermined second condition, if the difference between said current values has a value equal to or larger than a predetermined value, when said self-luminescent elements in said next row provide display, said predetermined voltage is applied to said self-luminescent elements in said next row during said fourth period.

42. The method of driving a self-luminescent display apparatus according to claim 40, wherein as said predetermined second condition, if the display gray level of the display provided by said self-luminescent elements has a current value corresponding to the black display, when said display gray level is displayed, said predetermined voltage is applied to said self-luminescent elements during said fourth period.

43. The method of driving a self-luminescent display apparatus according to claim 40, wherein said predetermined voltage is equal to a voltage corresponding to a value for a current applied during a last display provided by said self-luminescent elements or corresponds to low gray level color display.

44. The method of driving a self-luminescent display apparatus according to claim 43, wherein said first voltage corresponds to the voltage for black display.

45. A display control device for a self-luminescent display apparatus having self-luminescent elements arranged in a pattern of a matrix and each of pixel circuits provided in association with each of said self-luminescent elements, said self-luminescent display apparatus applying a gray level current corresponding to a display gray level to each of said pixel circuits for a first period, and applying a display current based on said gray level current to said self-luminescent elements during a second period succeeding said first period to display the corresponding said display gray level, said display control device comprising:
precharge current applying instrument of applying a precharge current to said self-luminescent device during a third period before said first period on the basis of a predetermined first condition.

46. The display control device for the self-luminescent display apparatus according to claim 45, wherein said third period is varied depending on a display gray level that provides a display current applied to said self-luminescent elements.

47. The display control device for the self-luminescent display apparatus according to claim 45, wherein a current value corresponding to a display gray level of display provided by said self-luminescent elements in a predetermined row on the same column of said matrix is compared with a current value corresponding to a display gray level of display to be provided by said self-luminescent elements in a row next to said predetermined row, and
as said predetermined first condition, if a difference between said current values has a value equal to or larger than a predetermined value, when said next row is displayed, the precharge current is applied to said self-luminescent elements in said next row during said third period.

48. The display control device for the self-luminescent display apparatus according to claim 47, wherein said third period is varied depending on the magnitude of said difference.

49. The display control device for the self-luminescent display apparatus according to claim 45, wherein the current value corresponding to the display gray level of the display provided by said self-luminescent elements in the predetermined row on the same column of said matrix is compared with the current value corresponding to the display gray level of the display to be provided by said self-luminescent elements in the row next to said predetermined row, and as said predetermined first condition, if the difference between said current values has a value smaller than a predetermined value, when said self-luminescent elements in said next row provide display, a precharge current is not applied.

50. The display control device for the self-luminescent display apparatus according to claim 47, wherein the current value corresponding to the display gray level of the display provided by said self-luminescent elements in the predetermined row on the same column of said matrix is compared with the current value corresponding to the display gray level of the display to be provided by said self-luminescent elements in the row next to said predetermined row, and as said predetermined first condition, if the difference between said current values has a value smaller than a predetermined value, when said self-luminescent elements in said next row provide display, a precharge current is not applied.

51. The display control device for the self-luminescent display apparatus according to claim 45, wherein as said predetermined first condition, if the display gray level of display provided by said self-luminescent elements has a current value corresponding to black display, when said display gray level is displayed, said precharge current is not applied.

52. The display control device for the self-luminescent display apparatus according to claim 45, wherein a value for said precharge current is a current value corresponding to the value for white display.

53. A current output driving circuit for a self-luminescent display apparatus having self-luminescent elements arranged in a pattern of a matrix and each of pixel circuits provided in association with each of said self-luminescent elements, said self-luminescent display apparatus applying a gray level current corresponding to a display gray level to each of said pixel circuits for a first period, and applying a display current based on said gray level current to said self-luminescent elements during a second period succeeding said first period to display corresponding said display gray level, said current output driving circuit applying a precharge current to said self-luminescent device during a third period before said first period on the basis of a predetermined first condition, the current output driving circuit comprising:
third period generating instrument which simultaneously generates a plurality of said third periods having different time lengths.

54. The current output driving circuit for the self-luminescent display apparatus according to claim 53, wherein said plurality of third periods are generated on the basis of pulse lengths used when said precharge current is applied.

55. The current output driving circuit for the self-luminescent display apparatus according to claim 53, wherein said current output driving circuit is used as a current output source driver circuit.

56. A self-luminescent display apparatus comprising:
self-luminescent elements arranged in a pattern of a matrix;
each of pixel circuits provided in association with each of said self-luminescent elements; and
a driving circuit that drives said self-luminescent elements and said pixel circuit,
wherein said driving circuit has at least one of the current output driving circuit according to claim 53.

57. The self-luminescent display apparatus according to claim 56, wherein said self-luminescent elements are organic EL elements.

58. An electronic equipment comprising the self-luminescent display apparatus according to claim 57 as a display instrument.

59. The electronic equipment according to claim 58, wherein the electronic apparatus is used as a television.

60. A self-luminescent display apparatus comprising:
self-luminescent elements arranged in a pattern of a matrix;
each of pixel circuits provided in association with each of said self-luminescent elements; and
the display control device for the self-luminescent display apparatus according to claim 45;
wherein said display control device performs an operation for application of said precharge current.

61. The self-luminescent display apparatus according to claim 60, wherein said self-luminescent elements are organic EL elements.

62. An electronic equipment comprising the self-luminescent display apparatus according to claim 61 as a display instrument.

63. The electronic equipment according to claim 62, wherein the electronic apparatus is used as a television.

64. A self-luminescent display apparatus comprising:
self-luminescent elements arranged in a pattern of a matrix;
each of pixel circuits provided in association with each of said self-luminescent elements; and
an output driving circuit for the self-luminescent display apparatus according to claim 53,
wherein said display control device performs an operation for application of said precharge current.

65. The self-luminescent display apparatus according to claim 64, wherein said self-luminescent elements are organic EL elements.

66. An electronic equipment comprising the self-luminescent display apparatus according to claim 65 as a display instrument.

67. The electronic equipment according to claim 66, wherein the electronic apparatus is used as a television.

68. A recording medium on which a program for allowing a computer to execute a step of applying a gray level current corresponding to a display gray level to each of said pixel circuits for a first period, a step of applying a display current based on said gray level current to said self-luminescent elements during a second period succeeding said first period to display the corresponding said display gray level, and a step of applying a precharge current to said self-luminescent device during a third period before said first period on the basis of a predetermined first condition, the steps being included in the method of driving the self-luminescent display apparatus according to claim 31 is recorded, wherein the recording medium can be processed by a computer.
